(19) United States
(12) Patent Application Publication
(10) Pub. No.: US 2016/0093138 A1
(43) Pub. Date: Mar. 31, 2016

(54) GAMING MACHINE EXECUTING LINK GAME ON COMMON SCREEN SHARED BY GAMING TERMINALS

(71) Applicants: Universal Entertainment Corporation, Tokyo (JP); Aruze Gaming America, Inc., Las Vegas, NV (US)

(72) Inventors: Hiroki MUNAKATA, Tokyo (JP); Kenji ENOKIDO, Tokyo (JP); Hiroki SAITO, Tokyo (JP); Kensaku YOSHIKAWA, Tokyo (JP); Yukinori INAMURA, Tokyo (JP)

(21) Appl. No.: 14/865,084

(22) Filed: Sep. 25, 2015

(30) Foreign Application Priority Data
Sep. 26, 2014 (JP) 2014-196534
Mar. 16, 2015 (JP) 2015-052736

(51) Int. Cl. G07F 17/32

(52) U.S. Cl. CPC G07F 17/3211; G07F 17/3267; G07F 17/3258; G07F 17/3269; G07F 17/3272

(57) ABSTRACT

A gaming machine includes: a terminal controller configured to execute a bonus game on a common screen in accordance with a result of random determination made in a base game on a corresponding gaming terminal; a memory configured to accumulatively store a part of a bet amount bet in the base game as a capital source of a progressive payout; a center controller configured to execute a link game on the common screen; and a timer configured to output time information based on which the center controller makes, at predetermined time intervals, random determination about whether to execute the link game. When execution of the bonus game is triggered in accordance with the result of the random determination in the base game, the terminal controller executes a process of awarding a special payout from the capital source of the progressive payout, on condition that the link game is being executed.

### CROSS REFERENCE TO RELATED APPLICATION

The present application claims priority from Japanese Patent Application No. 2014-196534, which was filed on Sep. 26, 2014, and Japanese Patent Application No. 2015-052736, which was filed on Mar. 16, 2015, the disclosures of which are herein incorporated by reference in its entirety.

### BACKGROUND OF THE INVENTION

1. Field of the Invention

The present invention relates to a gaming machine configured to execute a link game on a common screen shared by a plurality of gaming terminals.

2. Description of Related Art

A known gaming machine includes a plurality of gaming terminals, terminal controllers provided for the respective gaming terminals to cause each gaming terminal to execute a game, and a center controller configured to control the terminal controllers. Such a known gaming machine is disclosed, for example, in U.S. Patent Publication No. 2006/0009283.

### SUMMARY OF THE INVENTION

Each terminal controller executes a game on the corresponding gaming terminal individually from the others, and awards a payout based on such execution of a game. The center controller executes a link game on a common screen shared by the plurality of gaming terminals. In the link game, a plurality of players compete for various jackpots, such as a progressive jackpot and a mystery jackpot, through the gaming terminals. In such a gaming machine, it is important to diversify the manner of effects in the game to enhance its entertainment factor.

An object of the present invention is to provide a gaming machine configured to execute a link game on a common screen shared by a plurality of gaming terminals, the gaming machine having an enhanced entertainment factor.

According to a first aspect of the invention, a gaming machine, configured to execute a link game on a common screen shared by a plurality of gaming terminals, includes: a terminal controller for each gaming terminal, the terminal controller configured to execute a base game on the corresponding gaming terminal, and to execute a bonus game on the common screen in accordance with a result of random determination made in the base game; a memory configured to accumulatively store a part of a bet amount bet in each gaming terminal each time the base game is executed, as a capital source of a progressive payout; a center controller configured to execute the link game not in sync with the base game and the bonus game executed by the terminal controller; and a timer configured to output time information based on which the center controller makes, at predetermined time intervals, random determination about whether to execute the link game. When execution of the bonus game is triggered in accordance with the result of the random determination made in the base game, the terminal controller executes a process of awarding a special payout from the capital source of the progressive payout stored in the memory, on condition that the link game is being executed.

With the above structure, when execution of the bonus game is triggered during execution of the link game, the special payout based on the capital source of the progressive payout is awarded. Thus, when execution of the bonus game using the common screen is triggered in the situation where the other games cannot be executed using the common screen because the link game is being executed thereon, an effect of awarding the special payout mysteriously is provided. As a result, the entertainment factor of the gaming machine is enhanced.

The above gaming machine may be arranged such that the link game needs qualification time for participation, and is structured so that out of the plurality of gaming terminals only one or more gaming terminals each having the qualification time are allowed to participate in the link game, and the center controller further comprises a counter configured to count the qualification time of each of the plurality of gaming terminals, and the center controller is configured to execute the following processes of: awarding an amount of game qualification time to each gaming terminal each time the base game is executed on that gaming terminal, and adding the awarded amount of game qualification time to a value in the counter; reducing the qualification time of each of the plurality of gaming terminals counted by the counter by a predetermined amount each time the random determination about whether to execute the link game is made; and when execution of the link game is triggered as a result of the random determination whether to execute the link game, executing the link game while synchronizing the gaming terminals each having the qualification time with one another.

With the above structure, the amount of the qualification time is awarded based on the base game. The qualification time of each gaming terminal is reduced by a predetermined amount each time the random determination about whether to execute the link game is made by the center controller. This prevents a difference among the gaming terminals in the number of times of execution of the random determination whether to execute the link game executed before the amount of qualification time awarded as a result of one-time execution of the base game is completely consumed. This motivates the player to continue the base game and also to participate in the link game, with the result that the entertainment factor is further enhanced.

The above gaming machine may be arranged such that: the center controller is configured to further execute the process of awarding an amount of game qualification time to each gaming terminal when the bonus game is executed thereon; and adding the awarded amount of game qualification time to a value in the counter.

With the above structure, the amount of game qualification time is awarded specially when the bonus game is executed. This decreases the possibility that the qualification time which keeps decreasing also during the bonus game becomes zero at the end of the bonus game. This further motivates the player to continue the base game, with the result that the entertainment factor is further enhanced.

The above gaming machine may be arranged such that the center controller reduces the qualification time counted by the counter only for one or more gaming terminals which do not participate in the link game when the random determination whether to execute the link game is made during execution of the link game.

With the above structure, the qualification time of each gaming terminal participating in the link game is not reduced. This prevents the qualification time of the gaming terminal participating in the link game becomes zero at the end of the link game. This further motivates the player to participate in the link game, with the result that the entertainment factor is further enhanced.

According to a second aspect of the invention, a gaming machine, configured to execute a link game on a common screen shared by a plurality of gaming terminals, includes: a terminal controller for each gaming terminal, the terminal controller configured to execute a base game on the corresponding gaming terminal; a center controller configured to execute the link game not in sync with the base game executed by the terminal controller; and a timer configured to output time information based on which the center controller makes, at predetermined time intervals, random determination about whether to execute the link game. The center controller executes a random determination process at predetermined time intervals based on the time information output by the timer; and when execution of the link game is triggered by a result of the random determination process, the center controller outputs a signal to cause the terminal controller to award a special payout on condition that the link game is being executed, and the terminal controller awards the special payout upon reception of the signal.

With the above structure, when execution of the link game is triggered during execution of the link game, the special payout is awarded. Thus, when execution of the link game is further triggered during execution of the link game, an effect of awarding the special payout mysteriously is provided. As a result, the entertainment factor of the gaming machine is enhanced.

The above gaming machine may be arranged such that: a qualification time to participate in the link game of each of the plurality of gaming terminals is set, in association with execution of the base game, by the corresponding terminal controller or by the center controller; whether to award the special payout in accordance with the result of the random determination process executed by the center controller is determined based on presence or absence of the qualification time; and only the terminal controller of each gaming terminal having the qualification time awards the special payout. With the above structure, the qualification time is set based on the base game, and this motivates the player to continue the base game, with the result that the entertainment factor is enhanced. Further, this reduces the possibility that the special payout is awarded to the gaming terminal on which no player plays a game.

It is possible to provide a gaming machine configured to execute a link game on a common screen shared by a plurality of gaming terminals, the gaming machine having an enhanced entertainment factor.

### BRIEF DESCRIPTION OF THE DRAWINGS

Other and further objects, features and advantages of the invention will appear more fully from the following description taken in connection with the accompanying drawings.

FIG. 1 illustrates the outline of a gaming machine.

FIG. 2 is a block diagram of a gaming terminal.

FIG. 3 is block diagram of a center controller.

FIG. 4 shows an internal connection layout of the gaming machine.

FIG. 5 is a front view of the entirety of the gaming machine.

FIG. 6 is a perspective view of the gaming terminal.

FIG. 7 is a block diagram of a control circuit of the terminal controller.

FIG. 8 is a block diagram of a control circuit of the center controller.

FIG. 9 is a block diagram illustrating a basic flow of a normal game.

FIG. 10A is a table showing symbol arrays on circumferential surfaces of video reel strips for a base game.

FIG. 10B is a table showing the symbol arrays on the circumferential surfaces of the video reel strips for the base game.

FIG. 10C is a table showing the symbol arrays on the circumferential surfaces of the video reel strips for the base game.

FIG. 10D is a table showing the symbol arrays on the circumferential surfaces of the video reel strips for the base game.

FIG. 11 illustrates a base game payout table.

FIG. 12 illustrates an example of a display screen of the base game.

FIG. 13 is a diagram illustrating a terminal screen wheel.

FIG. 14A is a diagram illustrating an example of a display screen on a terminal image display panel during a BONUS WHEEL game.

FIG. 14B is a diagram illustrating an example of a display screen on the terminal image display panel during the BONUS WHEEL game.

FIG. 15 illustrates a BONUS WHEEL random determination table.

FIG. 16 illustrates a display state on upper displays during a BONUS CHANCE WHEEL game.

FIG. 17 is a diagram illustrating a common screen wheel.

FIG. 18A is a diagram illustrating an example of a display screen on the terminal image display panel during the BONUS CHANCE WHEEL game.

FIG. 18B is a diagram illustrating an example of a display screen on the terminal image display panel during the BONUS CHANCE WHEEL game.

FIG. 19A illustrates a display screen on the upper displays during the BONUS CHANCE WHEEL game.

FIG. 19B illustrates a display screen on the upper displays during the BONUS CHANCE WHEEL game.

FIG. 20 illustrates a BONUS CHANCE WHEEL random determination table.

FIG. 21 illustrates a progressive payout setting table.

FIG. 22A is a diagram illustrating an example of a display screen during a progressive challenge.

FIG. 22B is a diagram illustrating an example of a display screen on the upper displays during the progressive challenge.

FIG. 22C is a diagram illustrating an example of a display screen on the upper displays during the progressive challenge.

FIG. 23 is a diagram illustrating a progressive challenge wheel.

FIG. 24A illustrates a progressive level random determination table.

FIG. 24B illustrates another progressive level random determination table.

FIG. 24C illustrates another progressive level random determination table.

FIG. 24D illustrates another progressive level random determination table.

FIG. 24E illustrates another progressive level random determination table.

FIG. 25A is a table showing symbol arrays on circumferential surfaces of video reel strips for SYMBOL MATCH FREE GAME.

FIG. 25B is a table showing the symbol arrays on the circumferential surfaces of the video reel strips for SYMBOL MATCH FREE GAME.

FIG. 25C is a table showing the symbol arrays on the circumferential surfaces of the video reel strips for SYMBOL MATCH FREE GAME.

FIG. 26 illustrates a SYMBOL MATCH random determination table.

FIG. 27A is a diagram illustrating an example of a display screen on the terminal image display panel during SYMBOL MATCH FREE GAME.

FIG. 27B is a diagram illustrating a SYMBOL MATCH FREE GAME wheel.

FIG. 28A is a diagram illustrating an example of a display screen on the terminal image display panel during SYMBOL MATCH FREE GAME.

FIG. 28B is a diagram illustrating an example of a display screen on the terminal image display panel during SYMBOL MATCH FREE GAME.

FIG. 28C is a diagram illustrating an example of a display screen on the terminal image display panel during SYMBOL MATCH FREE GAME.

FIG. 28D is a diagram illustrating an example of a display screen on the terminal image display panel during SYMBOL MATCH FREE GAME.

FIG. 29 illustrates a free game payout table.

FIG. 30 is a table showing symbol arrays on circumferential surfaces of video reel strips for MULTIPLIER FREE GAME.

FIG. 31 illustrates a payout multiplying factor random determination table.

FIG. 32A is a diagram illustrating an example of a display screen on the terminal image display panel during MULTIPLIER FREE GAME.

FIG. 32B is a diagram illustrating a MULTIPLIER FREE GAME wheel.

FIG. 33A is a diagram illustrating an example of a display screen on the terminal image display panel during MULTIPLIER FREE GAME.

FIG. 33B is a diagram illustrating an example of a display screen on the terminal image display panel during MULTIPLIER FREE GAME.

FIG. 33C is a diagram illustrating an example of a display screen on the terminal image display panel during MULTIPLIER FREE GAME.

FIG. 34A is a table showing symbol arrays on circumferential surfaces of video reel strips for WILD FREE GAME.

FIG. 34B is a table showing symbol arrays on the circumferential surfaces of the video reel strips for WILD FREE GAME.

FIG. 35 illustrates a number random determination table.

FIG. 36A is a diagram illustrating an example of a display screen on the terminal image display panel during WILD FREE GAME.

FIG. 36B is a diagram illustrating a WILD FREE GAME wheel.

FIG. 37A is a diagram illustrating an example of a display screen on the terminal image display panel during WILD FREE GAME.

FIG. 37B is a diagram illustrating an example of a display screen on the terminal image display panel during WILD FREE GAME.

FIG. 37C is a diagram illustrating an example of a display screen on the terminal image display panel during WILD FREE GAME.

FIG. 37D is a diagram illustrating an example of a display screen on the terminal image display panel during WILD FREE GAME.

FIG. 37E is a diagram illustrating an example of a display screen on the terminal image display panel during WILD FREE GAME.

FIG. 37F is a diagram illustrating an example of a display screen on the terminal image display panel during WILD FREE GAME.

FIG. 38 illustrates a base game qualification time awarding table.

FIG. 39 illustrates a BONUS WHEEL game qualification time awarding table.

FIG. 40 illustrates a BONUS CHANCE WHEEL game qualification time awarding table.

FIG. 41 illustrates a free game qualification time awarding table.

FIG. 42 illustrates a progressive challenge qualification time awarding table.

FIG. 43 illustrates a mystery bonus qualification time awarding table.

FIG. 44 illustrates a common game qualification time management table.

FIG. 45 illustrates a common game start random determination table.

FIG. 46 is a sequence diagram illustrating a relationship between the common game start random determination and the qualification time.

FIG. 47 illustrates a qualification time consumption condition management table.

FIG. 48 illustrates a maximum qualification time table.

FIG. 49 illustrates an accumulation calculation table.

FIG. 50 illustrates a common game type random determination table.

FIG. 51A illustrates an example of a common game start effect image.

FIG. 51B illustrates an example of a common game start effect image.

FIG. 51C illustrates an example of a common game start effect image.

FIG. 52 illustrates an example of a display screen during a RED OR BLACK game.

FIG. 53 is a diagram illustrating a roulette.

FIG. 54 illustrates an allocation number random determination table.

FIG. 55A illustrates an example of a display screen during the RED OR BLACK game.

FIG. 55B illustrates an example of a display screen during the RED OR BLACK game.

FIG. 55C illustrates an example of a display screen during the RED OR BLACK game.

FIG. 55D illustrates an example of a display screen during the RED OR BLACK game.

FIG. 55E illustrates an example of a display screen during the RED OR BLACK game.

FIG. 56 illustrates a first roulette random determination table.

FIG. 57 illustrates a second roulette random determination table.

FIG. 58 illustrates a stage payout table.

FIG. 59 illustrates a number of pips random determination table.

FIG. 60A illustrates an example of a display screen during a ROLL THE DICE game.

FIG. 60B illustrates an example of a display screen during the ROLL THE DICE game.

FIG. 60C illustrates an example of a display screen during the ROLL THE DICE game.

FIG. 60D illustrates an example of a display screen during the ROLL THE DICE game.

FIG. 60E illustrates an example of a display screen during the ROLL THE DICE game.

FIG. 60F illustrates an example of a display screen during the ROLL THE DICE game.

FIG. 61A illustrates an example of a display screen during a FUN WHEEL game.

FIG. 61B illustrates an example of a display screen during the FUN WHEEL game.

FIG. 61C illustrates an example of a display screen during the FUN WHEEL game.

FIG. 61D illustrates an example of a display screen during the FUN WHEEL game.

FIG. 61E illustrates an example of a display screen during the FUN WHEEL game.

FIG. 61F illustrates an example of a display screen during the FUN WHEEL game.

FIG. 62 illustrates a payout random determination table.

FIG. 63 illustrates a fixed payout allocation table.

FIG. 64 illustrates a LUCKY NUMBERS game payout table.

FIG. 65A illustrates a bingo card coordinate table.

FIG. 65B illustrates a number allocation table.

FIG. 65C illustrates an ID number table.

FIG. 65D is a table illustrating random determination order data.

FIG. 65E is a table illustrating random determination order data.

FIG. 65F is a table illustrating card data.

FIG. 65G is a table illustrating card data.

FIG. 65H is a table illustrating a probability that each gaming terminal is selected to play a role of a shooter in the LUCKY NUMBERS game.

FIG. 65I is a table illustrating the probability that each gaming terminal is selected to play the role of the shooter in the LUCKY NUMBERS game.

FIG. 66A illustrates an example of a display screen during the LUCKY NUMBERS game.

FIG. 66B illustrates an example of a display screen during the LUCKY NUMBERS game.

FIG. 66C illustrates an example of a display screen during the LUCKY NUMBERS game.

FIG. 66D illustrates an example of a display screen during the LUCKY NUMBERS game.

FIG. 66E illustrates an example of a display screen during the LUCKY NUMBERS game.

FIG. 66F illustrates an example of a display screen during the LUCKY NUMBERS game.

FIG. 66G illustrates an example of a display screen during the LUCKY NUMBERS game.

FIG. 66H illustrates an example of a display screen during the LUCKY NUMBERS game.

FIG. 67 illustrates a winning number random determination table.

FIG. 68A illustrates a 0-winning card random determination table.

FIG. 68B illustrates a 1-winning card random determination table.

FIG. 68C illustrates a 2-winning card random determination table.

FIG. 68D illustrates a 3-winning card random determination table.

FIG. 68E illustrates a 4-winning card random determination table.

FIG. 68F illustrates a 5-winning card random determination table.

FIG. 69A illustrates an example of a display screen during a HIGH or LOW game.

FIG. 69B illustrates an example of a display screen during the HIGH or LOW game.

FIG. 69C illustrates an example of a display screen during the HIGH or LOW game.

FIG. 69D illustrates an example of a display screen during the HIGH or LOW game.

FIG. 69E illustrates an example of a display screen during the HIGH or LOW game.

FIG. 69F illustrates an example of a display screen during the HIGH or LOW game.

FIG. 70 illustrates a first mystery bonus random determination table.

FIG. 71 shows an example of a display screen of a gaming terminal to which a mystery bonus is awarded.

FIG. 72 illustrates a second mystery bonus random determination table.

FIG. 73 is a diagram illustrating paylines.

FIG. 74 is a flowchart of a boot process.

FIG. 75 is a flowchart of an initial process.

FIG. 76 is a flowchart of a terminal-side normal game process.

FIG. 77 is a flowchart of a terminal-side bonus game process.

FIG. 78 is a flowchart of a terminal-side common game process.

FIG. 79 is a flowchart of a SYMBOL MATCH FREE GAME process.

FIG. 80 is a flowchart of a MULTIPLIER FREE GAME process.

FIG. 81 is a flowchart of a WILD FREE GAME process.

FIG. 82 is a flowchart of a qualification time management process.

FIG. 83 is a flowchart of a common game process.

FIG. 84 is a flowchart of a progressive related process.

FIG. 85 is a flowchart of a RED OR BLACK game process.

FIG. 86 is a flowchart of a ROLL THE DICE game process.

FIG. 87 is a flowchart of a FUN WHEEL game process.

FIG. 88 is a flowchart of a LUCKY NUMBERS game process.

FIG. 89 is a flowchart of a HIGH or LOW game process.

FIG. 90A illustrates an example of a display screen during the RED OR BLACK game.

FIG. 90B illustrates an example of a display screen during the RED OR BLACK game.

FIG. 90C illustrates an example of a display screen during the RED OR BLACK game.

FIG. 90D illustrates an example of a display screen during the RED OR BLACK game.

FIG. 90E illustrates an example of a display screen during the RED OR BLACK game.

FIG. 91A illustrates an example of a display screen during the ROLL THE DICE game.

FIG. 91B illustrates an example of a display screen during the ROLL THE DICE game.

FIG. 91C illustrates an example of a display screen during the ROLL THE DICE game.

FIG. 91D illustrates an example of a display screen during the ROLL THE DICE game.

FIG. 91E illustrates an example of a display screen during the ROLL THE DICE game.

FIG. 91F illustrates an example of a display screen during the ROLL THE DICE game.

FIG. 92A illustrates an example of a display screen during the FUN WHEEL game.

FIG. 92B illustrates an example of a display screen during the FUN WHEEL game.

FIG. 92C illustrates an example of a display screen during the FUN WHEEL game.

FIG. 92D illustrates an example of a display screen during the FUN WHEEL game.

FIG. 92E illustrates an example of a display screen during the FUN WHEEL game.

FIG. 92F illustrates an example of a display screen during the FUN WHEEL game.

FIG. 93A illustrates an example of a display screen during the LUCKY NUMBERS game.

FIG. 93B illustrates an example of a display screen during the LUCKY NUMBERS game.

FIG. 93C illustrates an example of a display screen during the LUCKY NUMBERS game.

FIG. 93D illustrates an example of a display screen during the LUCKY NUMBERS game.

FIG. 93E illustrates an example of a display screen during the LUCKY NUMBERS game.

FIG. 94A illustrates an example of a display screen during the HIGH or LOW game.

FIG. 94B illustrates an example of a display screen during the HIGH or LOW game.

FIG. 94C illustrates an example of a display screen during the HIGH or LOW game.

FIG. 94D illustrates an example of a display screen during the HIGH or LOW game.

FIG. 94E illustrates an example of a display screen during the HIGH or LOW game.

FIG. 94F illustrates an example of a display screen during the HIGH or LOW game.

FIG. 94G illustrates an example of a display screen during the HIGH or LOW game.

FIG. 94H illustrates an example of a display screen during the HIGH or LOW game.

FIG. 95 is a flowchart of a RED OR BLACK game process of a modification.

FIG. 96 is a flowchart of a ROLL THE DICE game process of a modification.

FIG. 97 is a flowchart of a FUN WHEEL game process of a modification.

FIG. 98 is a flowchart of a LUCKY NUMBERS game process of a modification.

FIG. 99 is a flowchart of a HIGH or LOW game process of a modification.

### DESCRIPTION OF THE PREFERRED EMBODIMENTS

The following will describe an embodiment of the present invention with reference to figures.

(Outline of Gaming Machine)

A gaming machine includes a plurality of gaming terminals and a center controller data-communicably connected to the gaming terminals. The gaming machine is configured to execute a base game using symbol columns on each gaming terminal independently from the other gaming terminals, and to execute a common game (link game) while synchronizing the gaming terminals with one another.

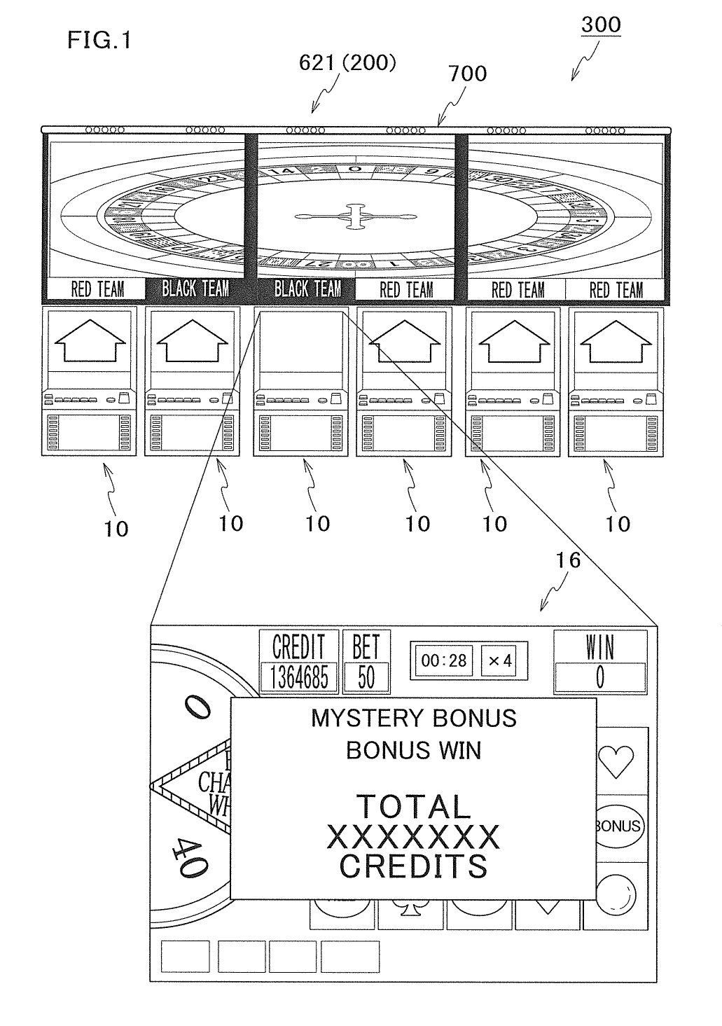

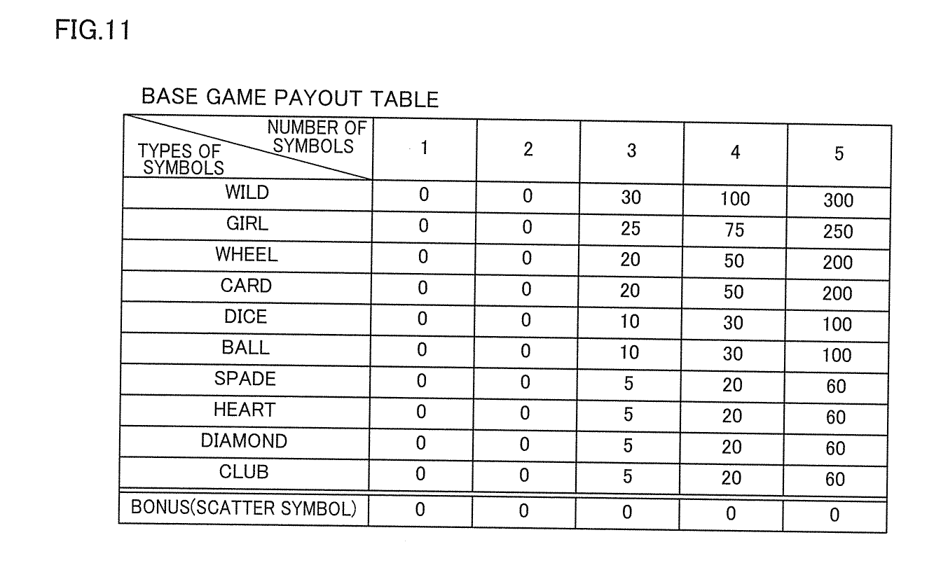

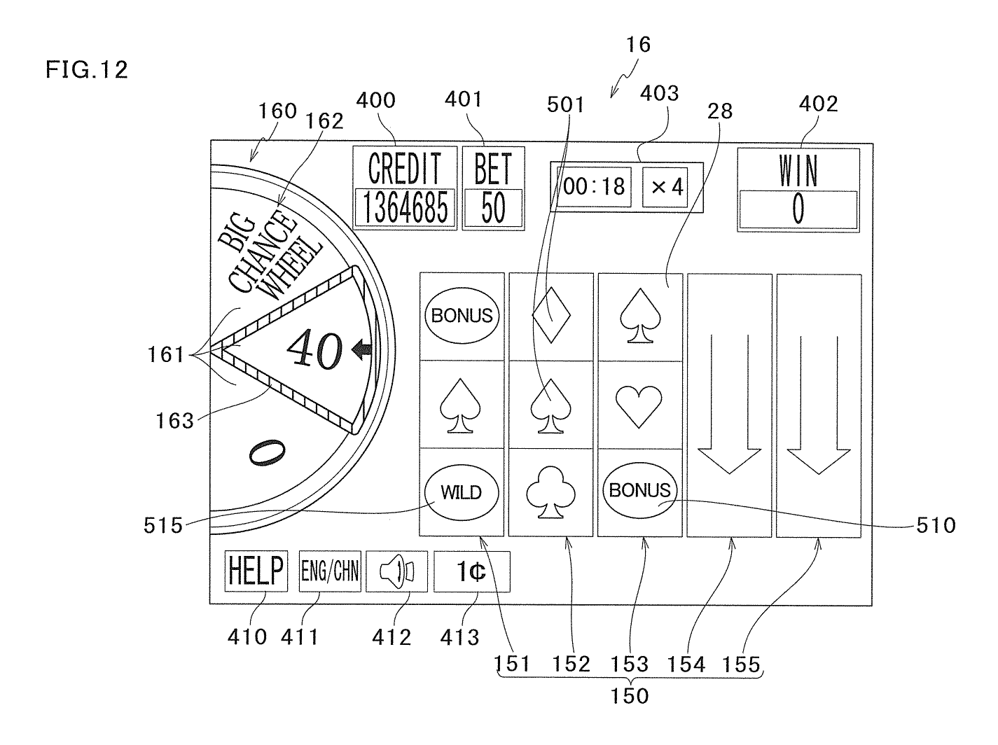

More specifically, as shown in FIG. 1 to FIG. 3, a gaming machine 300 of the present embodiment has a multi-player type structure, and gaming terminals 10 are connected in a parallel manner and in communication with a center controller 200. The gaming machine 300 is structured so that each gaming terminal 10 is able to individually execute a unit game such as a slot game, independently from the other gaming terminals 10. In the unit game, symbols 501 (see FIG. 12) are rearranged on a terminal display 614 (terminal image display panel 16) of the gaming terminal 10.

(Functional Block of Gaming Machine 300: Gaming Terminal 10)

The gaming machine 300 having the above structure includes the gaming terminals 10 and an external controller 621 (such as the center controller 200) data-communicably connected to the gaming terminals 10, as illustrated in FIG. 1 to FIG. 3. The external controller 621 is data-communicably connected to the gaming terminals 10 which are provided in a parallel manner.

Each gaming terminal 10 includes a bet button unit 601, a spin button unit 602, the terminal display 614, and a terminal controller 630 configured to control these units. Note that the bet button unit 601 and the spin button unit 602 each is a kind of an input device. Further the gaming terminal 10 includes a transceiver unit 652 which enables data communication with the external controller 621.

The bet button unit 601 has a function of accepting a player's operation for entering a bet amount. The spin button unit 602 has a function of receiving a start of a game such as base game through a player's operation; i.e., a start operation. The terminal display 614 has a function of displaying still image information of the various symbols 501, numerical values, marks, and the like, and displaying moving picture information such as effect images.

The terminal controller 630 includes: a bet/start-check unit 603; a base game execution unit 605; a bonus game execution unit 606; a common game execution unit 653; a random number sampling unit 615; a symbol determining unit 612; an effect-use random number sampling unit 616; an effect determining unit 613; a speaker unit 617; a lamp unit 618; a winning determining unit 619; a credit awarding unit 620; and a special payout storage unit 607. The special payout storage unit 607 stores therein data of various types of special payouts.

The bet/start-check unit 603 determines which one of the base game, the bonus game, the common game, and the like is to be started, and determines whether the determined one of the base game, the bonus game, the common game, and the like is startable, based on signals output from the bet button unit 601 and the spin button unit 602, a signal from the center controller 200, and the like.

The base game execution unit 605 has a function of executing a base game on condition that the bet button unit 601 is operated. The base game execution unit 605 determines whether shifting to a bonus game occurs, based on a combination of symbols 501 having rearranged in the base game.

Further, the base game execution unit 605 has a function of outputting the state of the base game to the center controller 200, via the transceiver unit 652. That is, the base game execution unit 605 outputs the running status information to the center controller 200. Further, the base game execution unit 605 has a function of outputting bet amount information indicating the amount of bet in the base game to the center controller 200.

The bonus game execution unit 606 has a function of executing the bonus game when the base game execution unit 605 determines that shifting to the base game occurs. When the bonus game is executed, the bonus game execution unit 606 has a function of controlling upper displays 700 via the center controller 200 to provide effects on the upper displays 700. The bonus game execution unit 606 further has a function of determining whether a common game is being executed. When the base game execution unit 605 determines that shifting to the bonus game occurs in the situation where the common game is being executed, the bonus game execution unit 606 has a function of awarding a special payout using, as a capital source, a progressive payout stored in a progressive payout storage unit 6219, which will be described later.

The common game execution unit 653 has a function of executing the common game, based on a game start command from the center controller 200.

The symbol determining unit 612 has: a function of determining symbols 501 to be rearranged, by using a random number given by the random number sampling unit 615; a function of rearranging selected symbols 501 on a symbol display region 614a of the terminal display 614; and a function of outputting information of the symbols 501 rearranged, to the winning determining unit 619.

More specifically, the symbol determining unit 612 has functions of: determining the symbols 501 to be rearranged on the symbol display region 614a according to the type of the game (the base game or the common game); scroll displaying the determined symbols 501 on the terminal display 614; and stopping the scroll display to rearrange the symbols 501 determined.

The effect-use random number sampling unit 616 has functions of, when receiving the effect instruction signal from the symbol determining unit 612, sampling an effect-use random number; and outputting the effect-use random number to the effect determining unit. The effect determining unit has: a function of determining an effect by using the effect-use random number; a function of outputting, to a video display region 614b of the terminal display 614, video information of the effect thus determined; and a function of outputting audio information and illumination information of the effect to the speaker unit 617 and the lamp unit 618, respectively.

The winning determining unit 619 has a function of determining whether a winning is achieved when rearrangement information of the symbols 501, which is a display state rearranged on the terminal display 614, is obtained, a function of calculating a credit amount based on a winning combination when it is determined that a winning is achieved, and a function of outputting an award signal based on the calculated credit amount to the credit awarding unit 620. The credit awarding unit 620 has a function of awarding a player a gaming value in the form of a coin, a medal, credit, or the like, based on a payout award signal from the winning determining unit 619 or the center controller 200.

The transceiver unit 652 has functions of: outputting the execution state of the base game to the center controller 200, along with the identification information of each gaming terminal 10; and receiving the common game start command and the payout award signal from the center controller 200.

(Functional Block of Gaming Machine 300: External Controller)

The gaming terminal 10 structured as above is connected to the external controller 621. This external controller 621 has a function of remotely operating and monitoring the operation state of each gaming terminal 10 and processes such as changes in various game setting values. Further, the external controller 621 has a function of executing the common game in a plurality of gaming terminals 10 simultaneously.

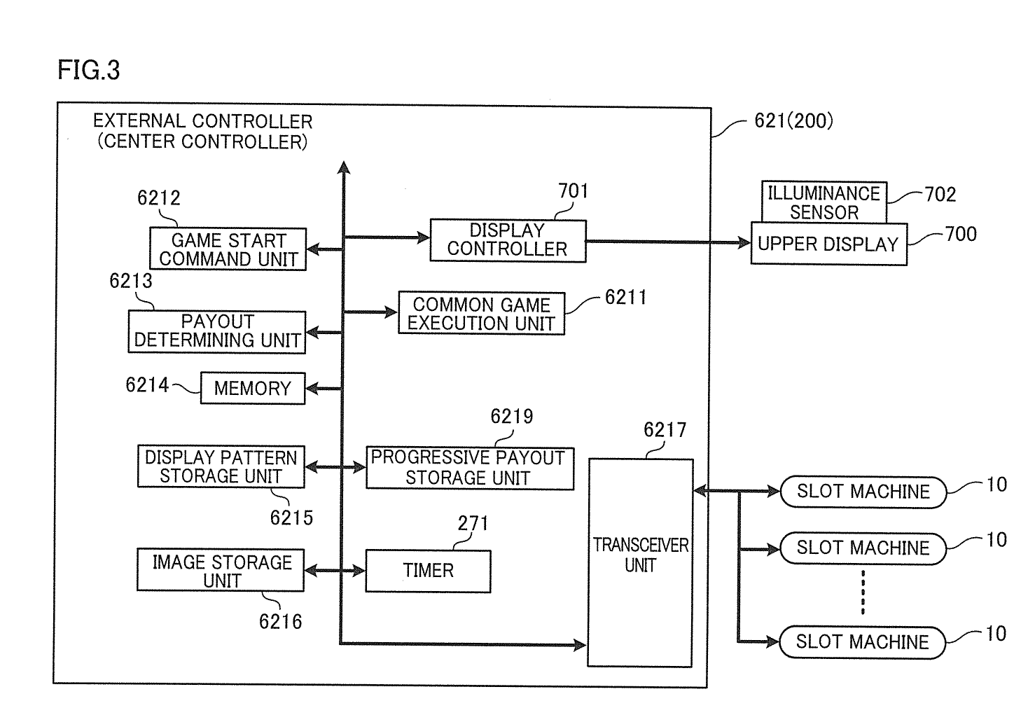

More specifically, as shown in FIG. 3, the external controller 621 includes a timer 271, a common game execution unit 6211, a game start command unit 6212, a payout determining unit 6213, a memory 6214, a transceiver unit 6217, a plurality of upper displays 700, display controllers 701, an image storage unit 6216, and a progressive payout storage unit 6219.

The timer 271 has a function of outputting time information at predetermined time intervals. The common game execution unit 6211 has functions of: determining whether to start the common game through random determination, every time it receives the time information output from the timer 271; and synchronizing the gaming terminals 10 for execution of the common game. The common game execution unit 6211 further has the following function: when it is determined to start the common game on a gaming terminal 10 during execution of the common game, transmitting, to the gaming terminal 10, an award signal indicating the special payout stored in the special payout storage unit 607 is awarded.

The game start command unit 6212 has a function of outputting the common game start command to the gaming terminals 10. The memory 6214 stores, for each gaming terminal 10, common game qualification times in association with respective multiplying factors. The transceiver unit 6217 has a function of allowing data exchange among the gaming terminals 10.

The upper displays 700 are provided in a parallel manner, and are controlled by the associated display controllers 701 so that the upper displays 700 form a single common effect display screen. The common effect display screen is arranged to display a plurality of individual images corresponding to the respective gaming terminals 10. Furthermore, the common effect display screen is arranged to display a common game start effect image. The common game start effect image is stored in the image storage unit 6216. The display controller 701 is controlled by the common game execution unit 6211.

The progressive payout storage unit 6219 stores a part of a bet amount bet in the base game executed in each gaming terminal 10, as a capital source of the progressive payout.

Thus, in the gaming machine 300, the common game is executed on the upper displays 700 shared by the plurality of gaming terminals 10. The terminal controller 630 of each gaming terminal 10 executes the base game, and can execute the bonus game on the upper displays 700, depending on the result of the random determination made in the base game. In the progressive payout storage unit 6219 (corresponding to a memory of the present invention) of the center controller 200, a part of a bet amount bet is accumulated and stored, as a capital source of the progressive payout, each time the base game is executed in each gaming terminal 10. The center controller 200 executes the common game not in sync with a game executed by each terminal controller 630. Every time the common game execution unit 200 receives the time information output from the timer 271 at predetermined time intervals, the center controller 200 makes random determination whether to start the common game. When the execution of the bonus game is triggered in accordance with the random determination made in the base game, the terminal controller 630 executes a process of awarding the special payout from the progressive payout stored in the progressive payout storage unit 6219, on condition that the common game is being executed.

With the above arrangement, when the execution of the bonus game is triggered in the situation where the common game is being executed, the special payout from the capital source of the progressive payout is awarded. Thus, when the execution of the bonus game is triggered in the situation where the other games cannot be executed using the upper displays 700 because the common game is being executed thereon, an effect of awarding the special payout mysteriously is provided. As a result, the entertainment factor of the gaming machine 300 is enhanced.

In the gaming machine 300, when the execution of the common game is triggered as a result of the random determination to determine whether the common game is started, the center controller 200 outputs the award signal to cause the eligible terminal controller 630 to award the special payout stored in the special payout storage unit 607 on condition that the common game is being executed. Upon reception of the award signal, the terminal controller 630 awards the special payout stored in the special payout storage unit 607.

With the above structure, when the execution of the common game is triggered during the execution of the common game, the special payout is awarded. Thus, when the execution of the common game is further triggered during the execution of the common game, an effect of awarding the special payout mysteriously is provided. As a result, the entertainment factor of the gaming machine is enhanced.

Note that the connection between the gaming terminals 10 and the center controller 200 may be wireless, wired, or a combination of these. Note that a unit of the bet amount may be a national or regional currency such as dollar, yen, and Euro. The unit of the bet amount may also be a game point used only at a hall where the gaming machine 300 is provided, or in the related industry.

The term “rearrange” means dismissing an arrangement of symbols 501, and once again arranging symbols 501. The term “arrangement” indicates a state in which the symbols 501 are visually recognizable by an external player.

Note that a unit game includes a series of operations performed within a period between a start of receiving a bet to a point where a winning may be resulted. In the present embodiment, the unit game is repeatable in a normal game. Thus, in the present embodiment, the normal game includes a base game and a bonus game. Note that the “base game” is a game executable on condition that a gaming value is bet, and in the base game, an amount of gaming value based on rearranged symbols 501 is awarded. In other words, the “base game” is a unit game which starts on the premise that a gaming value is consumed. The “unit game” in the present embodiment is so-called slot game which is executed in each gaming terminal 10 independently of the other gaming terminals 10.

In the bonus game, various states such as a state in which a larger amount of gaming values than in the base game is obtainable, a state in which the probability of obtaining a gaming value is higher than in the base game, and a state in which the amount of consumed gaming values is smaller than in the base game such as a free game may be realized independently or in combination.

The free game is a game which is executable with a smaller amount of gaming values bet than in the normal game. Note that “executable with a smaller amount of gaming values” encompasses a bet of 0 (zero) gaming value. Therefore, the free game may be a game which is executed without betting a gaming value and the gaming value is paid out for an amount corresponding to rearranged symbols 501. In other words, the free game may be a game that starts even if no gaming value is consumed. To the contrary, the “base game” is a game executable on condition that a gaming value is bet, and in the base game, an amount of gaming value based on rearranged symbols 501 is awarded. In other words, the “base game” is a game which starts on the premise that a gaming value is consumed.

The gaming machine 300 of the present embodiment has a state in which the base game or the bonus game is executable, and a state in which the common game is executable. The base game and/or the bonus game are also referred to as the normal game. Thus, the normal game includes a base game and/or a bonus game. Further, the common game and the period during which the common game is run are also referred to as “event time”.

The “gaming value” is a coin, bill, or electronic information corresponding to them. Note that the gaming value in the present invention is not particularly limited. Examples of the gaming value include game media such as medals, tokens, electronic money, tickets, and the like. Further, the ticket is not particularly limited and may be a ticket with a barcode or the like, for example.

Although the present embodiment describes the gaming machine 300 which has the center controller 200 in addition to the gaming terminals 10, the invention is not limited to this. The gaming machine 300 may be arranged so that at least one gaming terminal 10 has the function of the center controller 200 and the gaming terminals 10 are connected with each other to be able to exchange data therebetween.

(Internal Connection Layout of Gaming Machine 300)

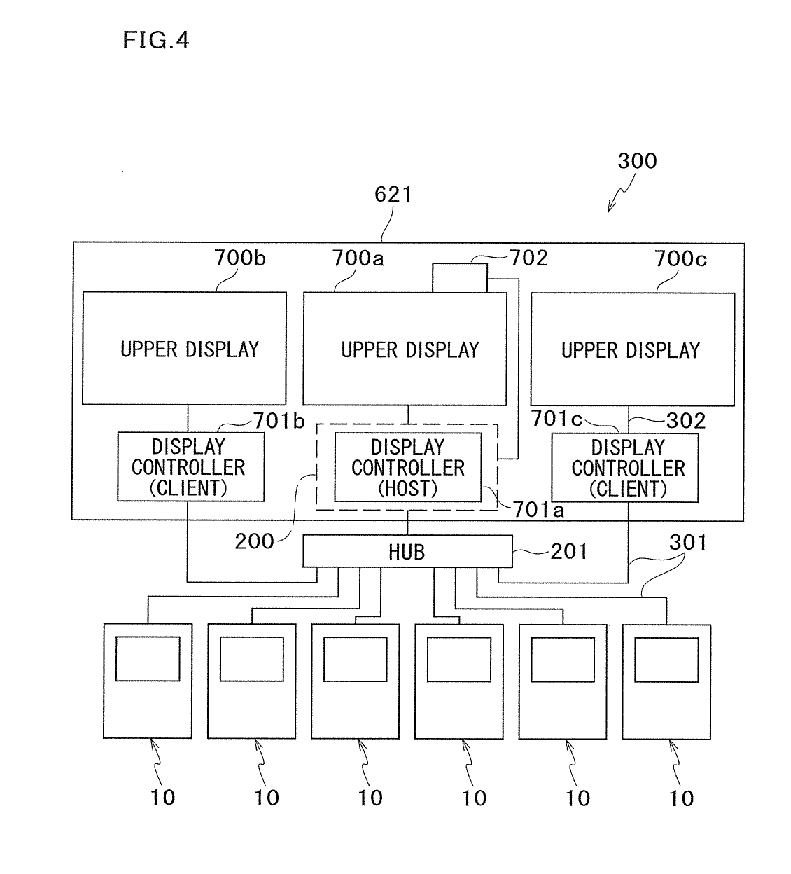

Now, referring to FIG. 4, the internal connection layout of the gaming machine 300 including the gaming terminals 10 will be described. FIG. 4 shows the gaming machine 300 including the gaming terminals 10 related to an embodiment of the present invention.

The gaming machine 300 includes six gaming terminals 10 and an external controller 621. The external controller 621 includes three upper displays 700 (700a, 700b, and 700c) and three display controllers 701 (701a, 701b, and 701c). The display controller 701a is a component of the center controller 200 and hosts the other display controllers 701b and 701c. In other words, the display controllers 701b and 701c are clients of the display controller 701a. The display controllers 701a, 701b, and 701c are connected with the respective upper displays 700a, 700b, and 700c via monitor cables 302, so as to function as system controllers controlling the respective upper displays 700.

In addition to the above, the gaming machine 300 is provided with a hub 201. Upstream of the hub 201, the display controller 701a (center controller 200) is connected via a LAN cable 301. Meanwhile, downstream of the hub 201, the gaming terminals 10 and the display controllers 701b and 701c are connected via the LAN cable 301. That is to say, the center controller 200 is data-communicably connected with the gaming terminals 10, and the center controller 200 (display controller 701a) is connected to be able to control the display controllers 701b and 701c. This makes it possible to control the display controllers 701a, 701b, and 701c to cause the upper displays 700 to display images as a single common effect display screen.

In addition to the above, the upper display 700a is provided with an illuminance sensor 702 configured to detect the brightness of disturbance light applied to the upper display 700a. The illuminance sensor 702 outputs a brightness signal always or at regular intervals to the center controller 200. This brightness signal indicates the brightness of the disturbance light applied to the upper display 700a. Receiving the brightness signal, the center controller 200 determines whether the currently-set brightness is appropriate by conducting comparison with a predetermined standard. If inappropriate, the center controller 200 controls the display controllers 701a, 701b, and 701c to change the brightness to a suitable level.

(Mechanical Structure of Gaming Machine 300)

The following describes a specific example of mechanical and electrical structures of the gaming machine 300 thus structured.

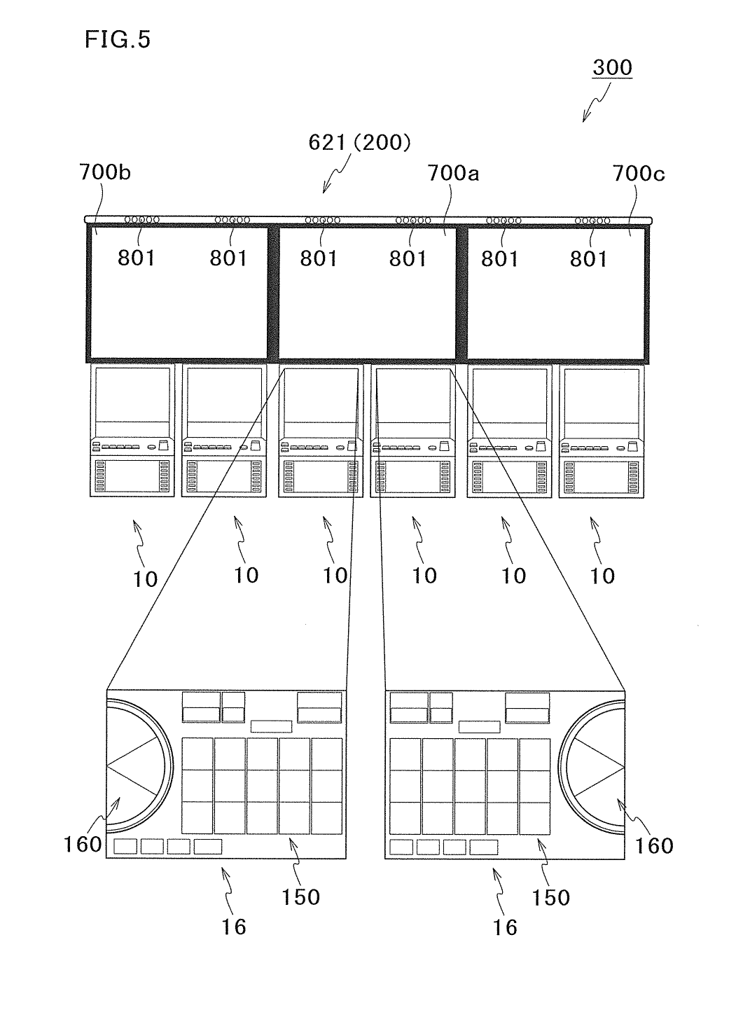

As shown in FIG. 5, the gaming machine 300 includes: the six gaming terminals 10 which are provided in a parallel manner and each independently executes the base game; and the external controller 621 (center controller 200) which is data-communicably connected with the gaming terminals 10 and executes the common game. The external controller 621 has the three upper displays 700a, 700b, and 700c arranged in a parallel manner aside from the gaming terminals 10. The upper displays form a single common effect display screen.

In addition to the above, the upper displays 700 are provided with LED units 801 corresponding to the respective gaming terminals 10. More specifically, the LED units 801 are provided at the upper parts of the frames of the upper displays 700, at positions above the respective gaming terminals 10. That is to say, the LED units 801 are provided along upper parts of the upper displays 700. For example, when a later-described BONUS CHANCE WHEEL game is started on a gaming terminal 10, the corresponding LED unit 801 produces an effect such as blinking to the gaming terminal 10. Further, when a later-described ROLL THE DICE game (a kind of the common game) is executed, to the gaming terminal 10 playing a role of a shooter, the LED unit corresponding thereto produces an effect such as blinking.

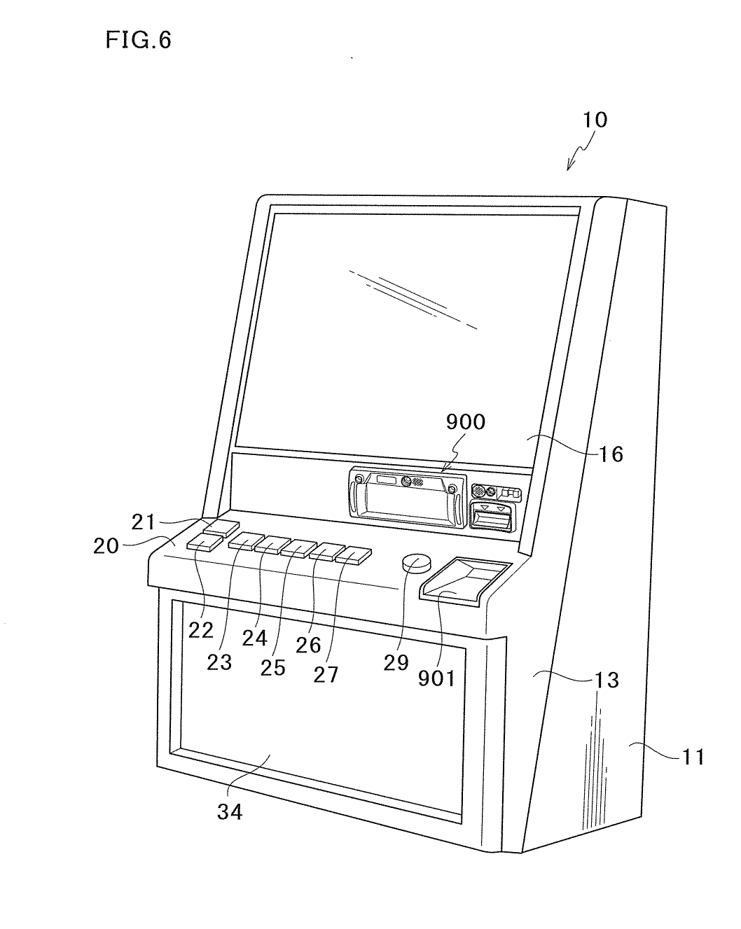

As shown in FIG. 6, the gaming terminal 10 includes a cabinet 11 and a main door 13 provided on the front surface of the cabinet 11. The main door 13 has a terminal image display panel 16. The terminal image display panel 16 has a transparent liquid crystal panel for displaying various kinds of information. The terminal image display panel 16 displays: a display window 150 (video reels 151 to 155) for scroll-displaying and arranging a plurality of symbols 501 (see FIG. 12); and a terminal screen wheel 160. The terminal image display panel 16 displays various information related to a game and effect images, as needed.

The present embodiment deals with a case where the terminal image display panel 16 electrically displays symbols 501 arranged in 5 columns and 3 rows. However, the present invention is not limited to this.

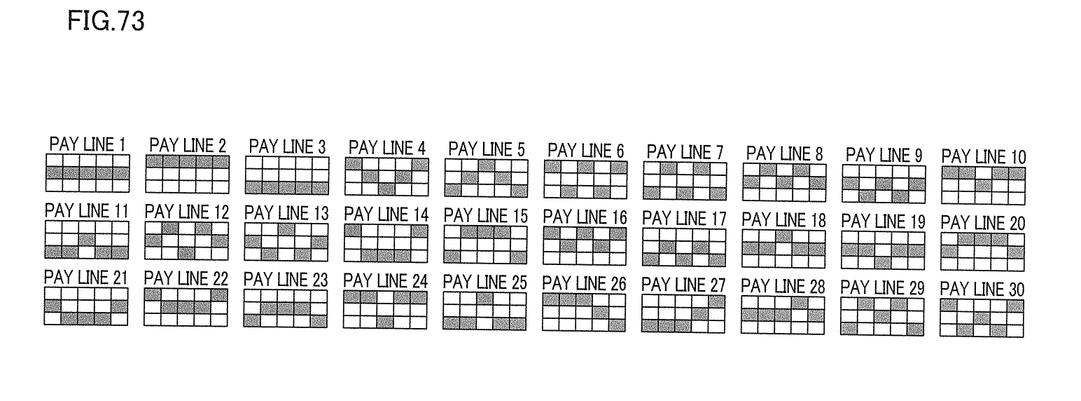

Furthermore, as shown in FIG. 73, in the gaming terminal 10, there are set paylines based on which winning determination is made for symbols 501 rearranged on the display window 150. As shown in FIG. 73, there are 30 paylines in the present embodiment. In the present embodiment, all the 30 paylines are activated without exception when a game is executed, irrespective of the bet amount. In a modification, the paylines may be individually activated in response to the player's selection.

Note that the terminal image display panel 16 may display a credit amount indicator 400. The credit amount indicator 400 displays a total value (hereinafter also referred to as a total credit value) which the gaming terminal 10 is able to award to a player.

Below the terminal image display panel 16 provided are a control panel 20, a PTS device 900, and a bill entry 901. The control panel 20 is provided with buttons 21 to 27 and 29. These buttons 21 to 27 and 29 allow the player to input instructions concerning the progress of a game.

On the control panel 20, a HELP button 21 and a CASHOUT button 22 are provided on an area on the player's left, BET buttons 23 to 27 are provided on a middle area, and a spin button 29 is provided on an area on the player's right, assuming that the player is standing in front of the gaming terminal.

The HELP button 21 is pressed when, for example, it is unclear how to play a game. As the help button 21 is pressed, various help information is displayed on the terminal image display panel 16. The CASHOUT button 22 is an operation button used to pay out the credit amount corresponding to the total credit value deposited in the gaming terminal 10.

The BET buttons 23 to 27 are buttons to designate the credit amount bet to each of the 30 paylines. The BET buttons 23 to 27 are respectively associated with credit amounts different from each other. A 1-BET button 23 associated with the credit amount of “1” is a button used to start a game with a bet of 1 credit per payline of the 30 paylines. That is, with a press of the 1-BET button 23, a game is started with a bet of 30 credits in total. A 2-BET button 24 associated with the credit amount of “2” is a button used to start a game with a bet of 2 credits per payline of the 30 paylines. A 3-BET button 25 associated with the credit amount of “3” is a button used to start a game with a bet of 3 credits per payline of the 30 paylines. A 5-BET button 26 associated with the credit amount of “5” is a button used to start a game with a bet of 5 credits per payline of the 30 paylines. A 10-BET button 27 associated with the credit amount of “10” is a button used to start a game with a bet of 10 credits per payline of the 30 paylines.

Thus, in the present embodiment, the credit amount bet per payline is selectable from five types of credit amounts: 1, 2, 3, 5, and 10 credit(s). Note that, in the present embodiment, there are four setting patterns of credit amounts in association with the BET buttons 23 to 27. Through AUDIT or the like, one of the four setting patterns is selectable. Specifically, the four setting patterns are as follows: a setting pattern in which the BET buttons 23 to 27 are in association with the credit amounts of 1, 2, 3, 4 and 5; a setting pattern in which the BET buttons 23 to 27 are in association with the credit amounts of 1, 2, 3, 5 and 10; a setting pattern in which the BET buttons 23 to 27 are in association with the credit amounts of 1, 2, 5, 10 and 15; and a setting pattern in which the BET buttons 23 to 27 are in association with the credit amounts of 1, 2, 5, 10 and 20.

The spin button 29 is for inputting an instruction to start scrolling of symbols 501, for example.

The bill entry 901 validates bills and receives genuine bills into the cabinet 11. The bill entry 901 is electrically connected with the PTS device 900. When receiving a genuine bill, the bill entry 901 transmits an input signal corresponding to the amount of the bill to the PTS device 900. The input signal includes information on credit data or the like related to the received bill.

The PTS device 900 is a unit in which an LCD (liquid crystal display), a human body detection camera, a microphone, and the like are integrated. The human detection camera makes it possible to detect the presence or absence of a player by the camera function. The microphone is used for the player's participation in a game by voice and for the authentication of a player by voice recognition. Further, the PTS device 900 has a card slot to which an IC card can be inserted. With this, the player is able to insert an IC card into the card slot and use the credits stored in the IC card in the gaming terminal 10.

On the lower front surface of the main door 13, that is, below the control panel 20, a belly glass 34 is provided. On the belly glass 34, a character of the gaming terminal 10, or the like is drawn.

(Electric Configuration of Gaming Machine 300)

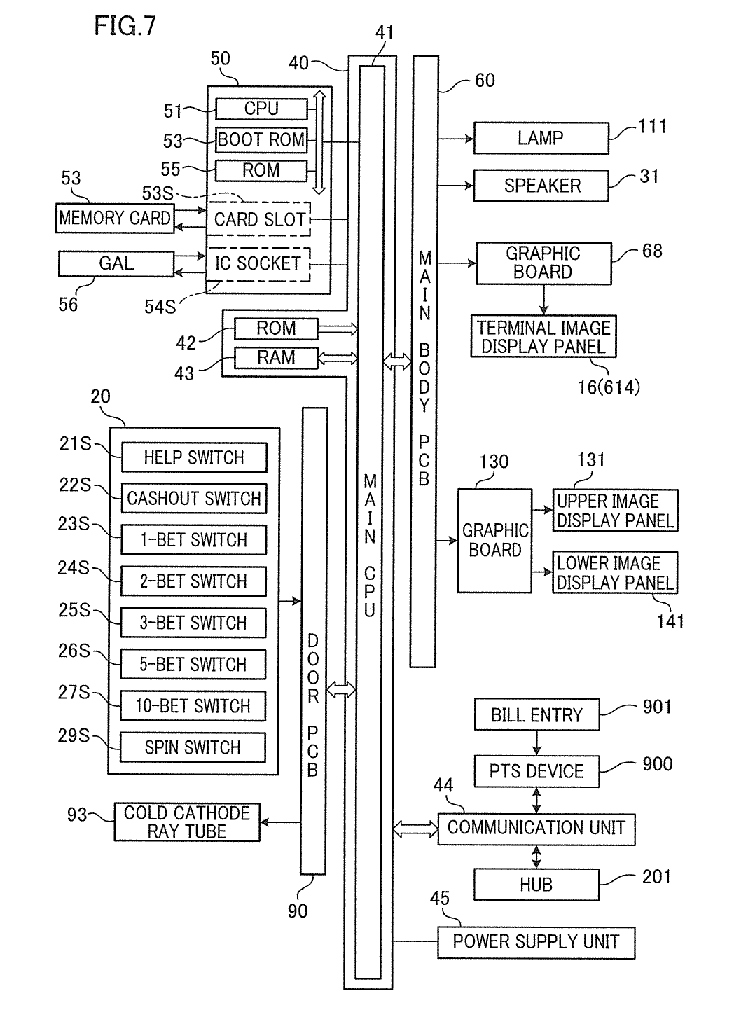

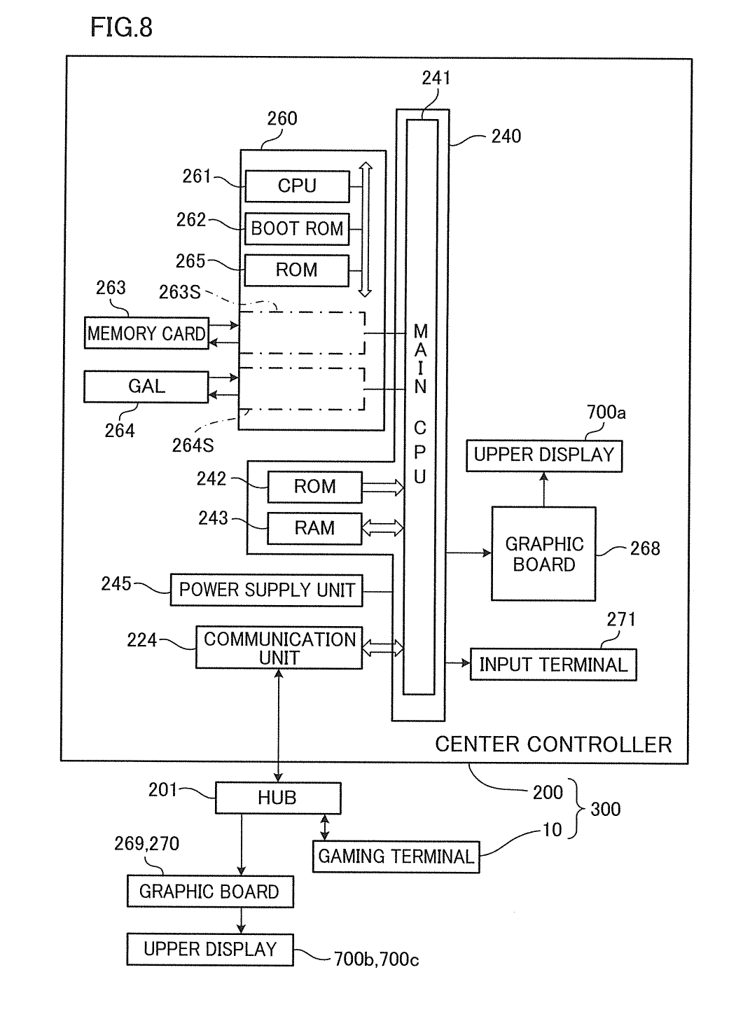

FIG. 7 and FIG. 8 are block diagrams each illustrating an electric configuration of the entire gaming machine 300.

(Electric Configuration of Gaming Terminal 10)

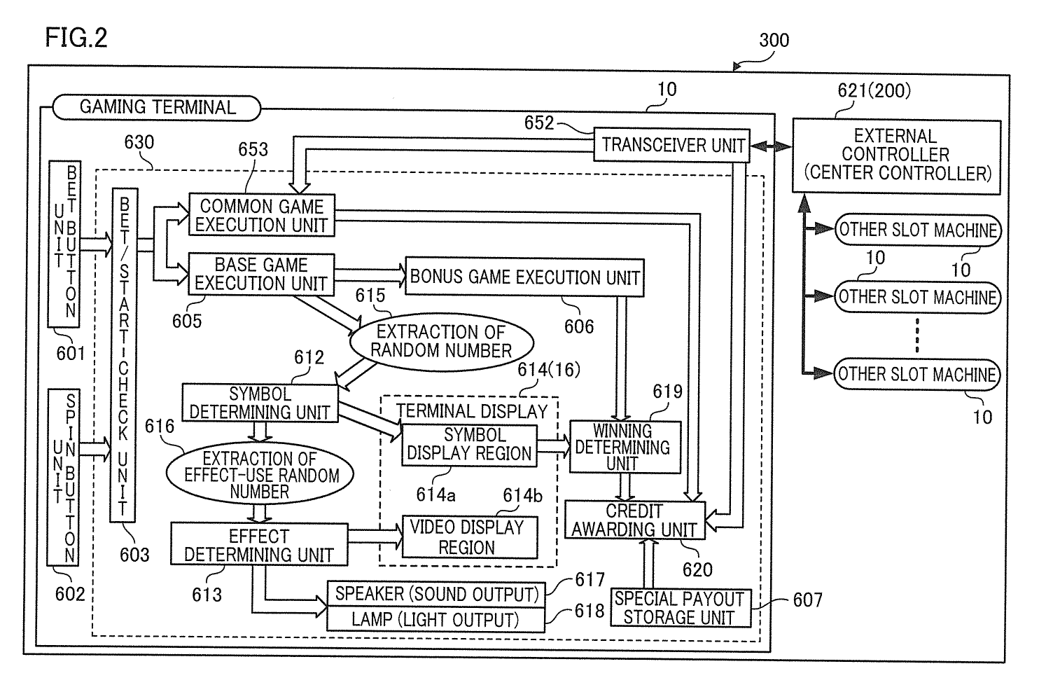

FIG. 7 is a block diagram illustrating an electric configuration of each of the gaming terminals 10. In the cabinet 11, there is provided a control unit including a terminal controller 630 (see FIG. 2). The control unit includes a motherboard 40, a main body PCB (Printed Circuit Board) 60, a gaming board 50, a door PCB 80, various switches, sensors, or the like, as shown in FIG. 7.

The gaming board 50 is provided with a CPU (Central Processing Unit) 51, a ROM 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a random determination program. The random determination program is for determining symbols (code number corresponding to the symbol) to be stopped on the display window 150. The details of the random determination program will be described later.

The card slot 53S is structured so as to allow the memory card 53 to be attached to/detached from the card slot 53S. This card slot 53S is connected to the motherboard 40 through an IDE bus. Thus, a type and contents of a game run at the gaming terminal 10 can be changed by detaching the memory card 53 from the card slot 53S, writing a different game program and a different game system program into the memory card 53, and inserting the memory card 53 back into the card slot 53S.

Each of the game programs includes a program related to the progress of the game and/or a program for causing a transition to a common game. Each of the game programs includes image data and audio data output during the game.

The GAL 54 has input ports and output ports. When the GAL 54 receives data via an input port, it outputs data corresponding to the input data from its output port.

IC socket 54S is structured so as to allow the GAL 54 to be attached to/detached from the IC socket 54S. The IC socket 54S is connected to the motherboard 40, via a PCI bus. Thus, the data to be output from the GAL 54 can be modified by: detaching the GAL 54 from the IC socket 54S, overwriting the program stored in the GAL 54, and attaching the GAL 54 back to the IC socket 54S.

The CPU 51, the ROM 55 and the boot ROM 52 connected through the internal bus are connected to the motherboard 40 through a PCI bus. The PCI bus communicates signals between the motherboard 40 and the gaming board 50 and supplies power from the motherboard 40 to the gaming board 50. The ROM 55 stores country identification information and an authentication program. The boot ROM 52 stores a preliminary authentication program and a program (boot code) for enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified. In short, the preliminary authentication program authenticates the authentication program.

The motherboard 40 is provided with a main CPU 41 (terminal controller 630), a ROM (Read Only Memory) 42, a RAM (Random Access Memory) 43, and a communication unit 44.

The main CPU 41 serves as a terminal controller 630 controlling the entire gaming terminal 10. In particular, the main CPU 41 controls the following operations: an operation of outputting an instruction signal instructing variable-displaying of symbols 501 to the graphic board 68, which is performed in response to pressing of the spin button 29 after betting of credit; an operation of determining symbols 501 to be stopped after the variable-displaying of symbols 501; and an operation of stopping the symbols 501 thus determined on the video reels 151 to 155.

In other words, the main CPU 41 serves as an arrangement controller which rearranges symbols 501 to form a new symbol matrix after scrolling symbols 501 displayed on the terminal image display panel 16. This main CPU 41 therefore determines symbols to be arranged in the symbol matrix by selecting symbols to be arranged from various kinds of symbols. Then, the main CPU 41 executes arrangement control to stop scrolling the symbols to present the symbols thus determined.

The ROM 42 stores a program such as BIOS (Basic Input/Output System) run by the main CPU 41, and permanently-used data. When the BIOS is run by the main CPU 41, each of peripheral devices is initialized and the game program and the game system program stored in the memory card 53 are read out through the gaming board 50. The RAM 43 stores data or a program used for the main CPU 41 to perform a process.

The communication unit 44 is provided to communicate with a host computer or the like equipped in the gaming facility, through a communication line. The communication unit 44 is also for communicating with the center controller 200 through the hub 201 and a communication line. In addition, the communication unit 44 is for communication with the PTS device 900.

Upon reception of an input signal from the bill entry 901, the PTS device 900 transmits credit data included in the input signal to the main CPU 41 via the communication unit 44. Further, when an IC card is inserted into the card slot, the PTS device 900 transmits credit data stored in the IC card to the main CPU 41 via the communication unit 44. Furthermore, based on a control signal received from the main CPU 41 via the communication unit 44, the PTS device 900 writes credit data stored into the IC card inserted in the card slot.

Further, the main body PCB (Printed Circuit Board) 60 and the door PCB 80 are connected to the motherboard 40, through a USB (Universal Serial Bus). Moreover, the motherboard 40 is connected to a power supply unit 45. The power supply unit 45 supplies power to the motherboard 40 to boot the main CPU 41 thereof. Meanwhile, the power unit 45 supplies power to the gaming board 50 through the PCI bus to boot the CPU 51 thereof.

The main body PCB 60 and door PCB 80 are connected to various devices or units which generate signals to be input to the main CPU 41, and various devices or units whose operations are controlled by control signals from the main CPU 41. Based on a signal input to the main CPU 41, the main CPU 41 runs the game program and the game system program stored in the RAM 43, to perform a calculation process. Then, the CPU 41 stores the result of the arithmetic process in the RAM 43, or transmits a control signal to the various devices and units to control them.

The main body PCB 60 is connected with a lamp 30, a speaker 31, and the graphic board 68.

The lamp 30 is turned on/off on the basis of a control signal from the main CPU 41. The speaker 31 outputs BGM sound or the like based on a control signal output from the main CPU 41.

The graphic board 68 controls image display on the terminal image display panel 16, based on a control signal from the main CPU 41. Further, the graphic board 68 is provided with a VDP (Video Display Processor) for generating image data on the basis of a control signal from the main CPU 41, a video RAM for temporarily storing the image data generated by the VDP, and the like. Note that image data used at the time of generating the image data by the VDP is in a game program which is read out from the memory card 53 and stored in the RAM 43.

The door PCB 80 is connected to the control panel 20 and a cold cathode tube 81. On the control panel 20, there are provided: a HELP switch 21S corresponding to the HELP button 21; a CASHOUT switch 22S corresponding to the CASHOUT button 22; a 1-BET switch 23S corresponding to the 1-BET button 23; a 2-BET switch 24S corresponding to the 2-BET button 24; a 3-BET switch 25S corresponding to the 3-BET button 25; a 5-BET switch 26S corresponding to the 5-BET button 26; a 10-BET switch 27S corresponding to the 10-BET button 27; and a spin switch 29S corresponding to the spin button 29. Each of the switches 21S to 27S and 29S outputs an input signal to the main CPU 41 when corresponding one of the buttons 23 to 27 and 29 is operated by a player.

The cold cathode tube 81 functions as a backlight mounted on a rear side of the terminal image display panel 16. This cold cathode tube 81 turns on according to a control signal from the main CPU 41.

(Electric Configuration of Center Controller 200)

FIG. 8 is a block diagram illustrating an electric configuration of the center controller 200. The center controller 200 is provided therein with a control unit. As illustrated in FIG. 8, the control unit includes a motherboard 240, a gaming board 260, an actuator, and the like.

The gaming board 260 has the same structure as that of the gaming board 50. The motherboard 240 has the same structure as that of the motherboard 40. The communication unit 224 communicates with the terminal controller 630 through a communication line.

The graphic board 268 has the same structure as that of the graphic board 68, except that the graphic board 268 controls display on the upper display 700a based on a control signal from the main CPU 241. In other words, the graphic board 268 functions as the display controller 701a. Furthermore, the graphic board 268 outputs a control signal to the graphic boards 269 and 270 respectively controlling the upper displays 700b and 700c, via the communication unit 224, the hub 201, and the communication line. In other words, the graphic boards 269 and 270 function as the display controllers 701b and 701c, respectively.

Further, the motherboard 240 is connected with the timer 271 configured to output time information at predetermined time intervals.

(Normal Game)

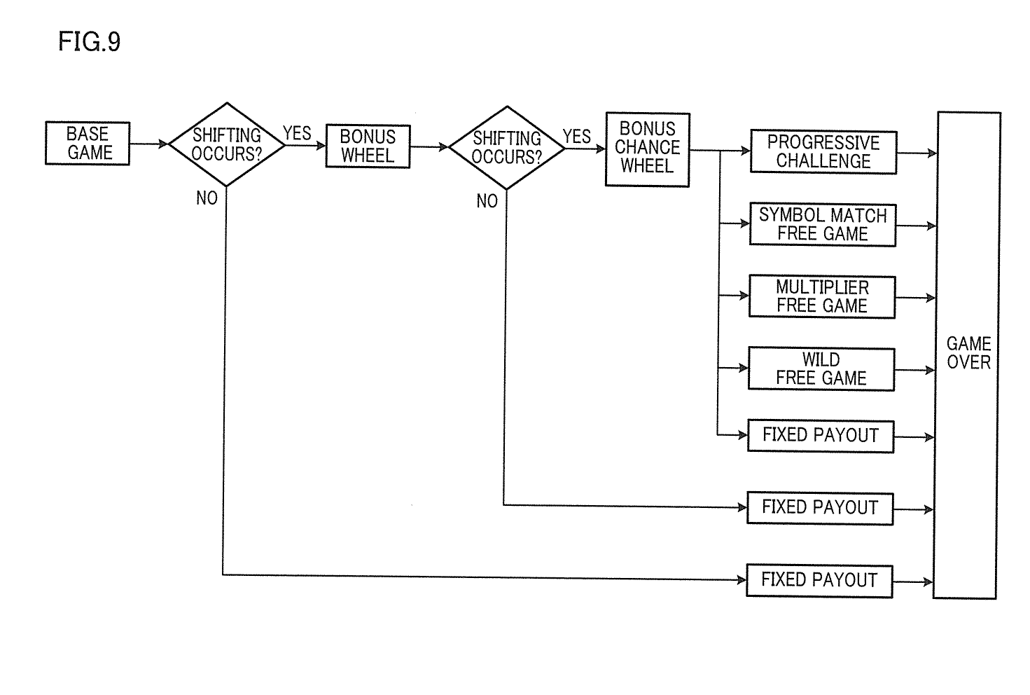

Now, a normal game independently executed in each gaming terminal 10 will be described. In the present embodiment, the normal game includes: the base game; a first bonus game (hereinafter, referred to as a BONUS WHEEL game); a second bonus game (hereinafter, referred to as a BONUS CHANCE WHEEL game); a progressive challenge; and three types of free games (SYMBOL MATCH FREE GAME, MULTIPLIER FREE GAME, and WILD FREE GAME). Now, a basic flow of the normal game will be described with reference to FIG. 9.

As shown in FIG. 9, to begin with, the base game is executed in the normal game. The base game is a slot game of rearranging a plurality of symbols 501 on the display window 150. When, as a result of a game of the base game, a right to shift to the BONUS WHEEL game is given, the BONUS WHEEL game is executed. The BONUS WHEEL game is a game for determining whether the right to shift to the BONUS CHANCE WHEEL game is given. When the right to shift to the BONUS CHANCE WHEEL game is given in the BONUS WHEEL game, the BONUS CHANCE WHEEL game is executed. In the BONUS CHANCE WHEEL game, a right to shift to the progressive challenge, a right to shift to one of the three types of free games, or a fixed payout is awarded.

(Base Game)

Now, the base game will be detailed. As shown in FIG. 12, the terminal image display panel 16 displays thereon the display window 150 formed by the video reels 151 to 155, to execute the base game. The display window 150 is constituted by 15 display blocks 28 forming a matrix of 5 columns and 3 rows. Each of the video reels 151 to 155 is therefore constituted by three display blocks 28.

Three successive symbols 501 in each of the symbol columns are, as shown in FIG. 12, respectively displayed (arranged) on an upper stage, a central stage, and a lower stage of the display window 150, to form a part of the symbol matrix of 5 columns and 3 rows on the display windows 150. The symbols 501 forming the symbol matrix start to scroll at least when a game starts in response to pressing of the spin button 29. The scrolling of the symbols 501 stops (rearrangement) after a predetermined period elapses from the beginning of the scrolling.

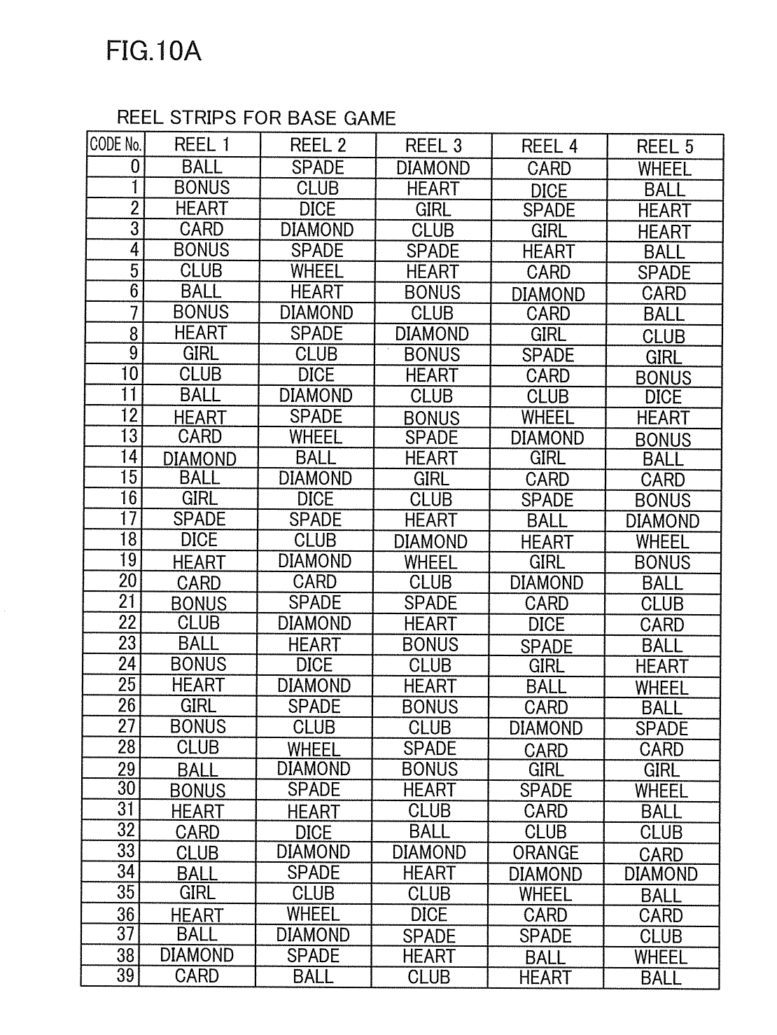

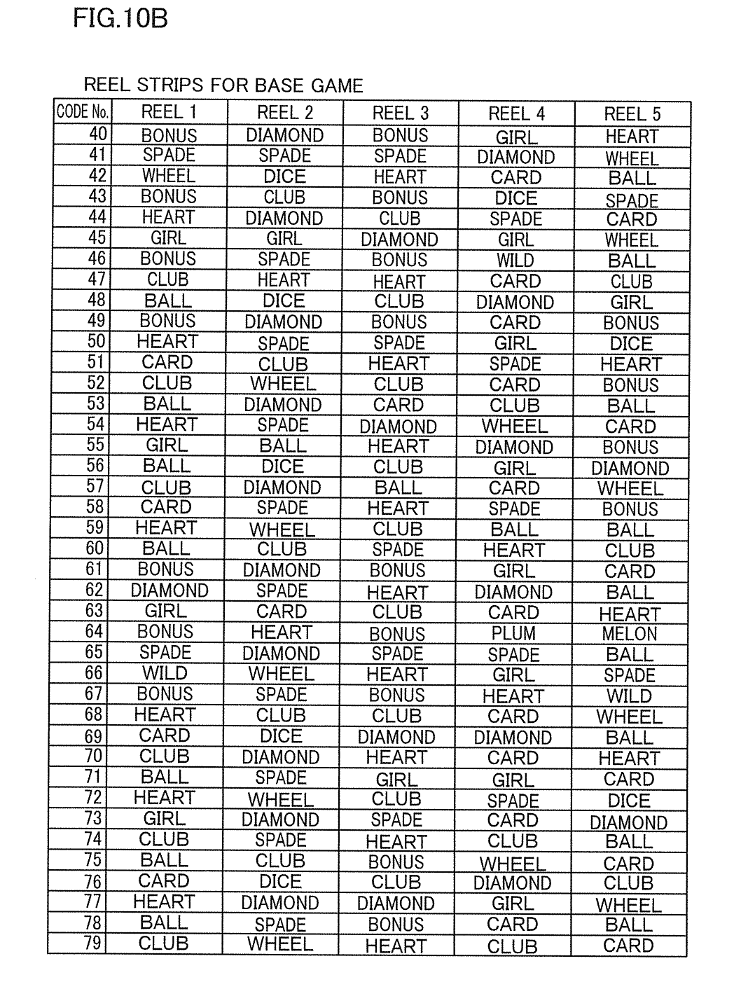

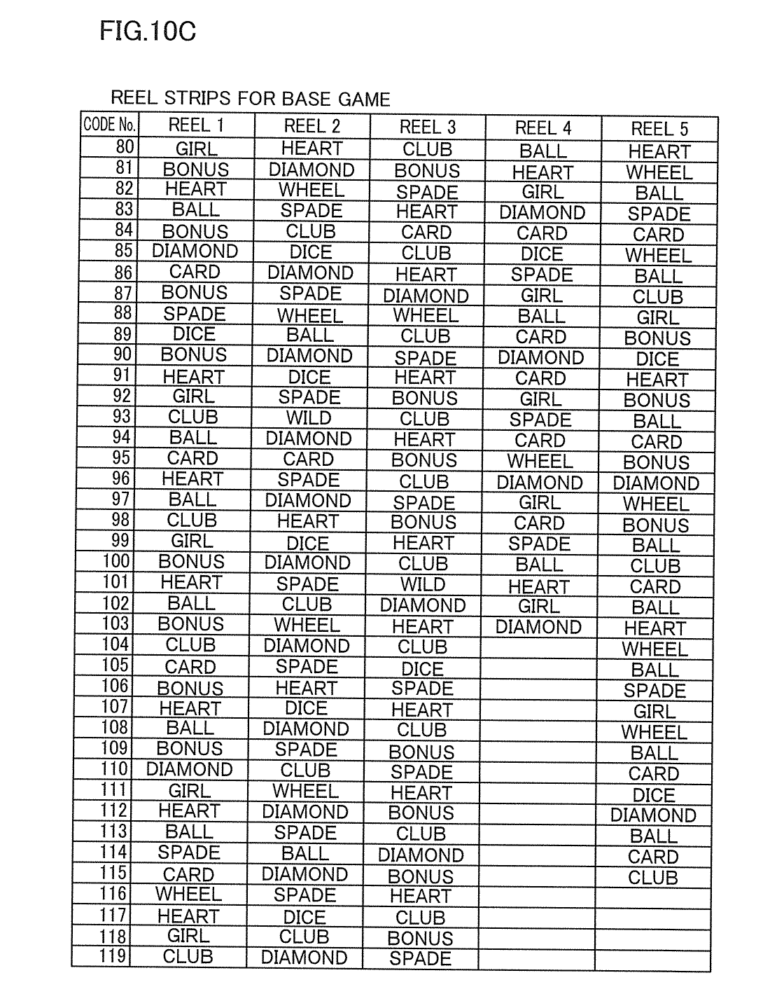

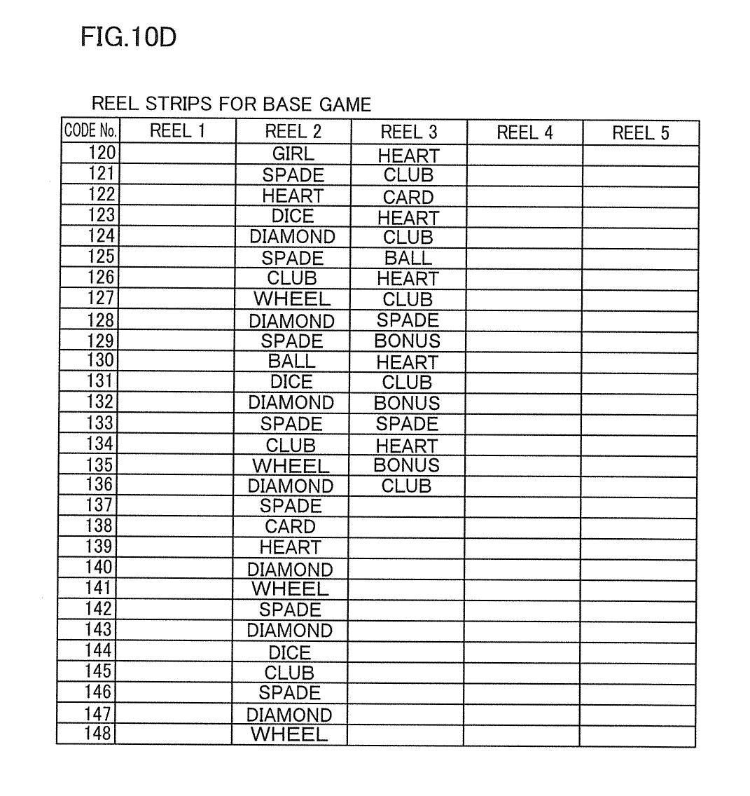

Each of FIG. 10A to FIG. 10D is a table showing the symbol arrays on the circumferential surfaces of the video reels 151 to 155 for the base game. As shown in FIG. 10A to FIG. 10D, a symbol array constituted by 120 symbols corresponding to code numbers “0” to “119” is allocated to a first video reel 151 (Reel 1) of the video reel strips for the base game. A symbol array constituted by 149 symbols corresponding to code numbers “0” to “148” is allocated to a second video reel 152 (Reel 2) of the video reel strips for the base game. A symbol array constituted by 137 symbols corresponding to code numbers “0” to “136” is allocated to a third video reel 153 (Reel 3) of the video reel strips for the base game. A symbol array constituted by 104 symbols corresponding to code numbers “0” to “103” is allocated to a fourth video reel 154 (Reel 4) of the video reel strips for the base game. A symbol array constituted by 116 symbols corresponding to code numbers “0” to “115” is allocated to a fifth video reel 155 (Reel 5) of the video reel strips for the base game.

As shown in FIG. 10A to FIG. 10D, the types of symbols of the video reel strips for the base game include: the normal symbols of “GIRL”, “WHEEL”, “CARD”, “DICE”, “BALL”, “SPADE”, “HEART”, “DIAMOND”, and “CLUB”; a “WILD” symbol 515 which is able to substitute for any of the normal symbols; and a “BONUS” symbol 510 which triggers the BONUS WHEEL game. The “BONUS” symbols 510 are on the video reels 151, 153, and 155 only.

In the base game, a to-be-stopped symbol on each of the video reels 151 to 155 is determined based on the random determination program stored in the memory card 53. The to-be-stopped symbol is one of the three symbols displayed on the display window 150, which is selected from the symbols constituting the corresponding symbol array. In the present embodiment, the symbol displayed on a predetermined area (e.g., the area in the upper stage) out of the three areas on the display window 150 is determined to function as the to-be-stopped symbol.

The above random determination program includes symbol determination data. The symbol determination data defines random numbers so that the probability of being selected is the same among the plurality of symbols constituting each of the symbol arrays corresponding to the video reels 151 to 155. For example, in the first video reel 151 (Reel 1) of the video reel strips for the base game, the data defines the random numbers so that the probability of being selected is the same among the 120 symbols (code numbers “0” to “119”) constituting the first video reel (that is, the probability is 1/120). However, various types of symbols whose numbers are different from each other are included in the 120 symbols, and therefore, the probability of being selected differs depending on the type of the symbols (that is, the weights are different). For example, referring to FIG. 10A to FIG. 10D, in the symbol array of the first video reel 151 (Reel 1) of the video reel strips for the base game, the number of the “GIRL” symbols is 13 while the number of “BALL” symbols is 21. Thus, the probability that a “GIRL” symbol is selected is 13/120, while the probability that a “BALL” symbol is selected is 21/120.

The present embodiment deals with a case where the data is defined so that the numbers of symbols constituting the symbol arrays corresponding to the video reels 151 to 155 are different from one another, however, the numbers of symbols constituting the symbol arrays of the video reels 151 to 155 may be the same. For example, the number of symbols of each of the symbol arrays of the video reels 151 to 155 of the video reel strips for the base game may be 120. This increases the degree of freedom in setting the probability that each kind of symbol is selected.

The to-be-stopped symbols for the respective video reels 151 to 155 thus determined by the random determination program are displayed on the display window 150, with the result that 15 symbols are rearranged on the display window 150. In the base game, a benefit is awarded based on one or more combinations made by the 15 symbols 501 rearranged on the display window 150.

The type of the benefit awarded in the base game is determined based on the base game payout table shown in FIG. 11. The base game payout table is a table defining relationship between: the combination of symbols related to a winning (WIN), in this case, the number of symbols of a kind; and the awarded credit amount. In the present embodiment, a winning is achieved when a combination of symbols displayed on each payline after scrolling of the symbol arrays of the video reels 151 to 155 is stopped matches any of the combinations of symbols defined in the base game payout table. As a winning is achieved, benefit such as credits is awarded to a player. No winning is achieved (a so-called loss) when a combination of symbols displayed on each payline does not match any of the combinations of symbols defined in the base game payout table.

In the present embodiment, basically, a winning is achieved when 3, 4, or 5 symbols of a kind is rearranged on a payline, as for the symbols of “GIRL”, “WHEEL”, “CARD”, “DICE”, “BALL”, “SPADE”, “HEART”, “DIAMOND”, “CLUB”, and “WILD”. The “WILD” symbol 515 is able to substitute for any of the normal symbols of “GIRL”, “WHEEL”, “CARD”, “DICE”, “BALL”, “SPADE”, “HEART”, “DIAMOND”, and “CLUB”.

The base game payout table shown in FIG. 11 defines credit amounts to be awarded on the premise that the credit amount bet per payline is 1 credit, which is the minimum bet amount. When the credit amount bet per payline is not 1 credit, a corresponding credit amount to be awarded shown in FIG. 11 is multiplied by a multiplying factor corresponding to the ratio of the credit amount bet to 1 credit, and the thus obtained value is determined as a credit amount to be awarded.

For example, when the credit amount bet per payline is 2 and three symbols of “GIRL” are arranged on one of the paylines, it is determined that a winning is achieved, and 50 (25×2) credits are awarded. When the credit amount bet per payline is 10 and five symbols of “HEART” are arranged on one of the paylines, it is determined that a winning is achieved, and 600 (60×10) credits are awarded. Hereinafter, the credit amount bet per payline is also referred to as “BET PER LINE”.

When three or more “BONUS” symbols 510, which trigger the BONUS WHEEL game, are rearranged on the display window 150, a winning combination of “BONUS WHEEL game trigger” is achieved, and therefore the right to shift (transition) to the BONUS WHEEL game is awarded. Note that, the winning combination of “BONUS WHEEL game trigger” is achieved irrespective of the location of each “BONUS” symbol 510 rearranged on the display window 150: the upper stage, the central stage, or the lower stage. That is, this winning combination is achieved regardless of the paylines. For example, the winning combination of “BONUS WHEEL game trigger” is achieved when: the “BONUS” symbol 510 is rearranged on the lower stage of the video reel 151; the “BONUS” symbol 510 is rearranged on the upper stage of the video reel 153; and the “BONUS” symbol 510 is rearrange on the central stage of the video reel 155.

(Base Game: Base Game Screen)

FIG. 12 shows an example of a base game screen displayed on the terminal image display panel 16 in the base game. More specifically, in the vertically-central portion of the base game screen, the display window 150 having five columns of video reels 151 to 155 is provided on the right side, while the terminal screen wheel 160 is provided on the left side. On the base game screen shown in FIG. 12, the video reels 151, 152, and 153 of the first to third columns are stopped whereas the video reels 154 and 155 of the fourth and fifth columns are scrolling. The terminal screen wheel 160 is for displaying a game result of the BONUS WHEEL game, not for displaying a game result of the base game.

At an upper portion of the terminal image display panel 16, a credit amount indicator 400 and a bet amount indicator 401 are provided on the left side whereas a WIN meter 402 is provided on the right side. The credit amount indicator 400 displays a credit amount. The bet amount indicator 401 displays a bet amount on the currently-running unit game. The WIN meter 402 displays the total credit amount for an obtained winning in an increment manner.

In the meantime, below the terminal image display panel 16 are provided a help button 410, a language switching button 411, a sound volume switching button 412, and a denomination display area 413. These members 410 to 413 are provided in this order from left to right as seen from a player.

The help button 410 allows the player to execute a help mode when pressed. The help mode is a mode for providing information to solve player's questions concerning games. The language switching button 411 is configured to switch the displayed language between English and Chinese when touched. The language switching button 411 is active only during the advertisement, and is darkened while it is disabled, e.g., during the rotation of the video reels 151 to 155. The sound volume switching button 412 is used for switching the game sound volume at three stages. Each time the button is touched, the game sound volume is switched such that, for example, from low to middle to high to low to middle. The denomination display area 413 displays the current denomination.

Above the terminal image display panel 16 (above the display window 150) is provided a payout multiplying factor indicator 403. The payout multiplying factor indicator 403 displays: a qualification time indicating the time for which participation of the common game is allowed; and a multiplying factor by which a unit payout amount obtained in the common game is multiplied. Unless the time indicated as the qualification time is zero second, the player of the gaming terminal is entitled to participate in the common game. The qualification time and the payout multiplying factor will be described later.

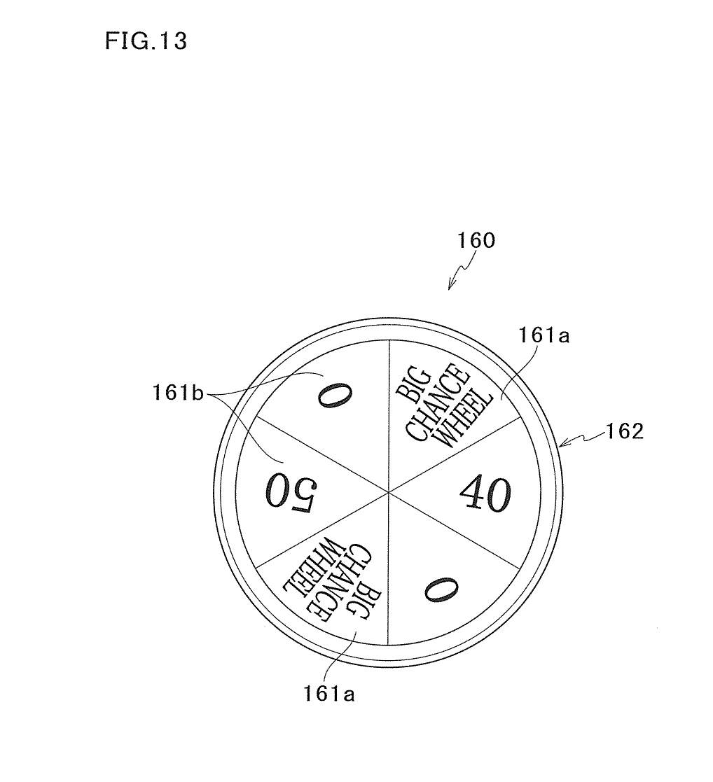

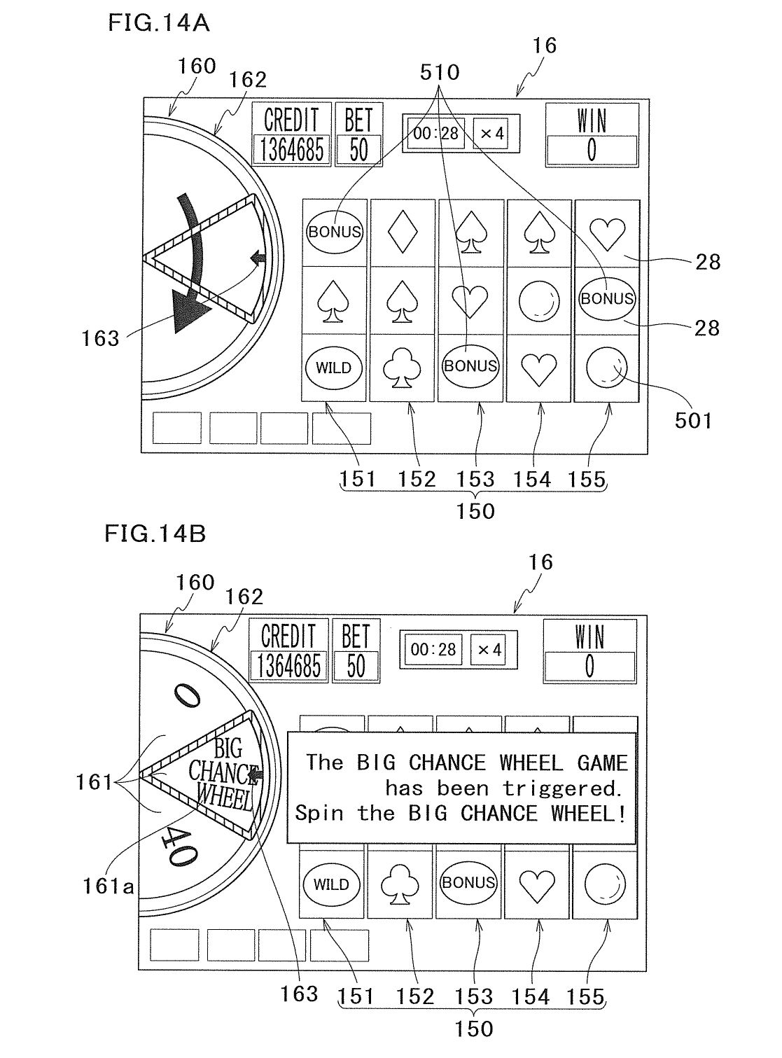

(BONUS WHEEL game) Now, the BONUS WHEEL game will be detailed. Shifting to the BONUS WHEEL game occurs when three or more “BONUS” symbols 510 are rearranged on the display window 150 in the base game (see FIG. 14A). The BONUS WHEEL game is a bonus game of which game result is displayed using the terminal screen wheel 160 displayed on the terminal image display panel 16. The terminal screen wheel 160 includes: a wheel 162 having a plurality of areas 161 respectively associated with predetermined benefits; and an indicator 163 displayed in a fixed manner for indicating a winning area 161. In the present embodiment, the wheel 162 has six areas 161 as shown in FIG. 13. Two of the six areas 161 are trigger areas 161a each of which is associated with a benefit of triggering the BONUS CHANCE WHEEL game, and the remaining four areas are fixed payout areas 161b each of which is associated with a fixed payout. Note that in the present embodiment, only a part of the wheel 162 is displayed on the terminal image display panel 16.

In the BONUS WHEEL game, a screen indicating that the BONUS WHEEL game is awarded is first displayed on the terminal image display panel 16, and then the wheel 162 is automatically rotated, as shown in FIG. 14A. Then the rotation of the wheel 162 is stopped, as shown in FIG. 14B. A benefit associated with the area 161 indicated by the indicator 163 at the time of the above stop is awarded to the player. When the awarded benefit is the benefit of triggering the BONUS CHANCE WHEEL game in the situation where the common game is not being executed, a screen indicating that the right to shift to the BONUS CHANCE WHEEL game is awarded is displayed on the terminal image display panel 16, as shown in FIG. 14B.

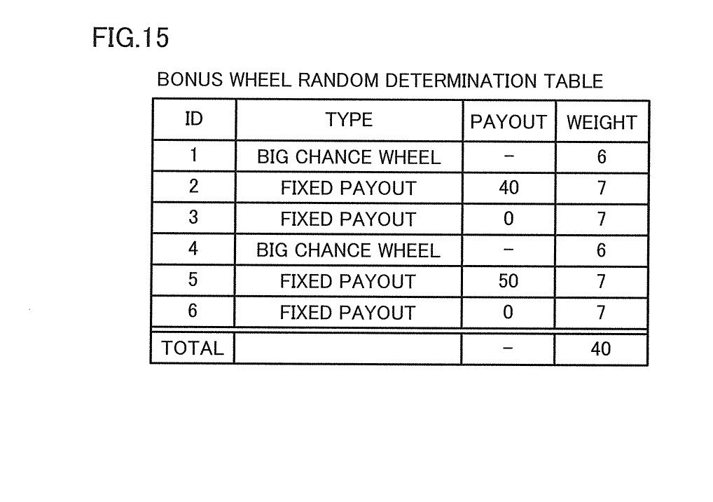

Which of the areas 161 is indicated by the indicator 163 at the time of stop of the wheel 162 (hereinafter the indicated area is also referred to as BONUS WHEEL use to-be-stopped area) is determined based on the above-mentioned random determination program stored in the memory card 53. The random determination program includes a BONUS WHEEL random determination table shown in FIG. 15. In the BONUS WHEEL random determination table, weights are respectively set for the six areas 161. Each weight represents the probability that the corresponding area 161 is selected as the BONUS WHEEL use to-be-stopped area. That is, the probability that one area 161 is selected as the BONUS WHEEL use to-be-stopped area is obtained by dividing the weight associated with that one area 161 by the total weights of all the areas 161. For example, as shown in FIG. 15, the probability that the area 161 associated with the benefit of a fixed payout of “50 credits” is determined as the BONUS WHEEL use to-be-stopped area is 7/40. Further, the probability that each of the two areas 161a associated with the benefit of “BONUS CHANCE WHEEL game trigger” is determined as the BONUS WHEEL use to-be-stopped area is 6/40.

When the benefit of triggering the BONUS CHANCE WHEEL game is awarded as a result of the BONUS WHEEL game, shifting to the BONUS CHANCE WHEEL game occurs on condition that the common game is not being executed.

(BONUS CHANCE WHEEL Game)

Now, the BONUS CHANCE WHEEL game will be detailed.

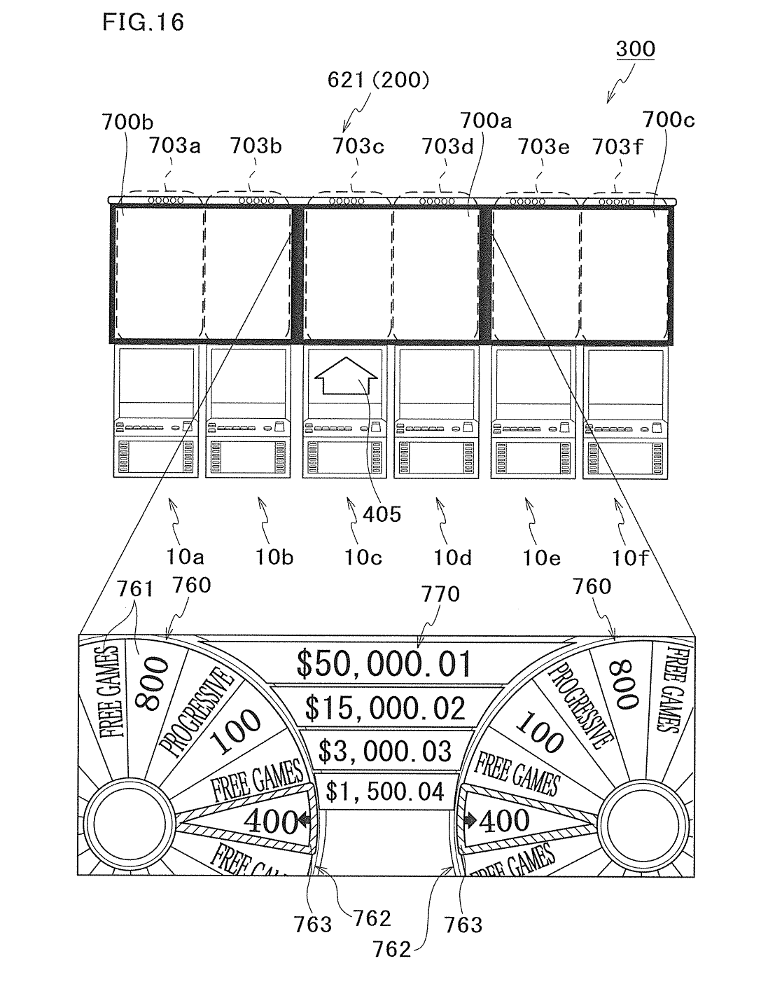

FIG. 16 illustrates a display state on the upper displays 700 during the BONUS CHANCE WHEEL game. The upper displays 700 which are specifically the three upper displays 700a, 700b, and 700c, are arranged to display a single common effect display screen. The common effect display screen is constituted by gaming terminal areas 703a to 703f respectively corresponding to the six gaming terminals 10a to 10f Specifically, each of the upper displays 700 has two gaming terminal areas formed thereon.

On each of the gaming terminal areas 703a to 703f, a common screen wheel 760 is displayed. In a central portion of each upper display 700, there is displayed a progressive payout image 770 indicating payout amounts of four types of progressive jackpots, which will be described later. In other words, each of the upper displays 700 displays: two common screen wheels 760 respectively corresponding to two gaming terminal areas; and one progressive payout image 770. The two common screen wheels 760 and the progressive payout image 770 are basically displayed on each upper display 700 unless the common game is being executed. The following description deals with a case, for example, where the gaming terminal 10c executes the BONUS CHANCE WHEEL game.

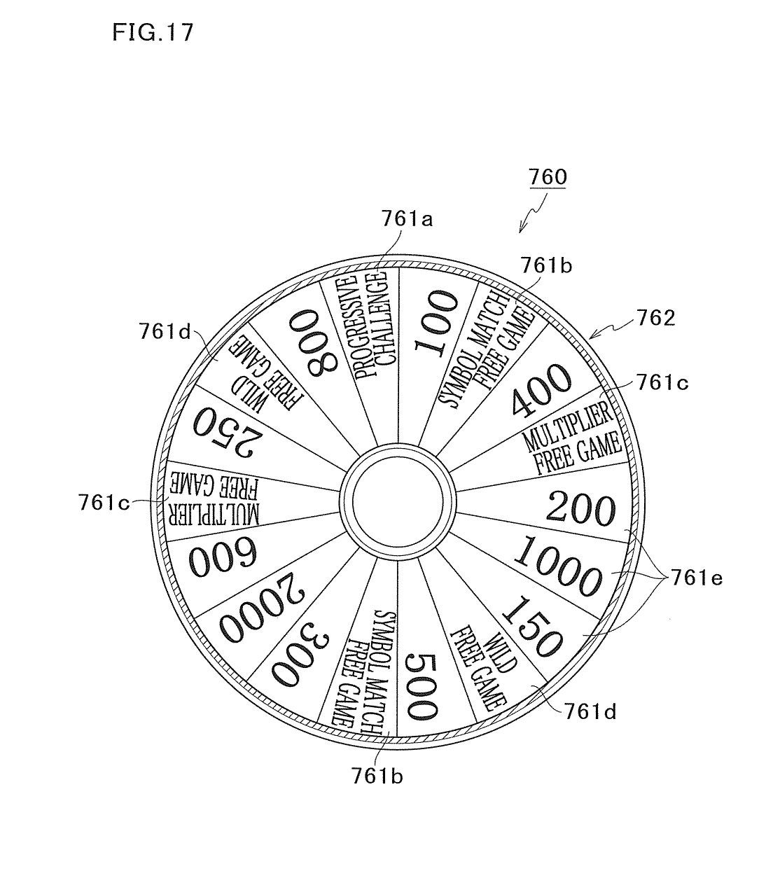

The common screen wheel 760 includes: a wheel 762 having a plurality of areas 761 respectively associated with predetermined benefits; and an indicator 763 displayed in a fixed manner for indicating a winning area 761. In the present embodiment, the wheel 762 has eighteen areas 761 as shown in FIG. 17. The eighteen areas 761 are constituted by: one area 761a associated with a benefit of shifting to the progressive challenge; two areas 761b each associated with a benefit of shifting to the SYMBOL MATCH FREE GAME; two areas 761c each associated with a benefit of shifting to the MULTIPLIER FREE GAME; two areas 761d each associated with a benefit of shifting to the WILD FREE GAME; and eleven areas 761e each associated with a benefit of fixed payout. Note that in the present embodiment, only some of the areas 761 of the wheel 762 are displayed on each of the gaming terminal areas 703a to 703f.

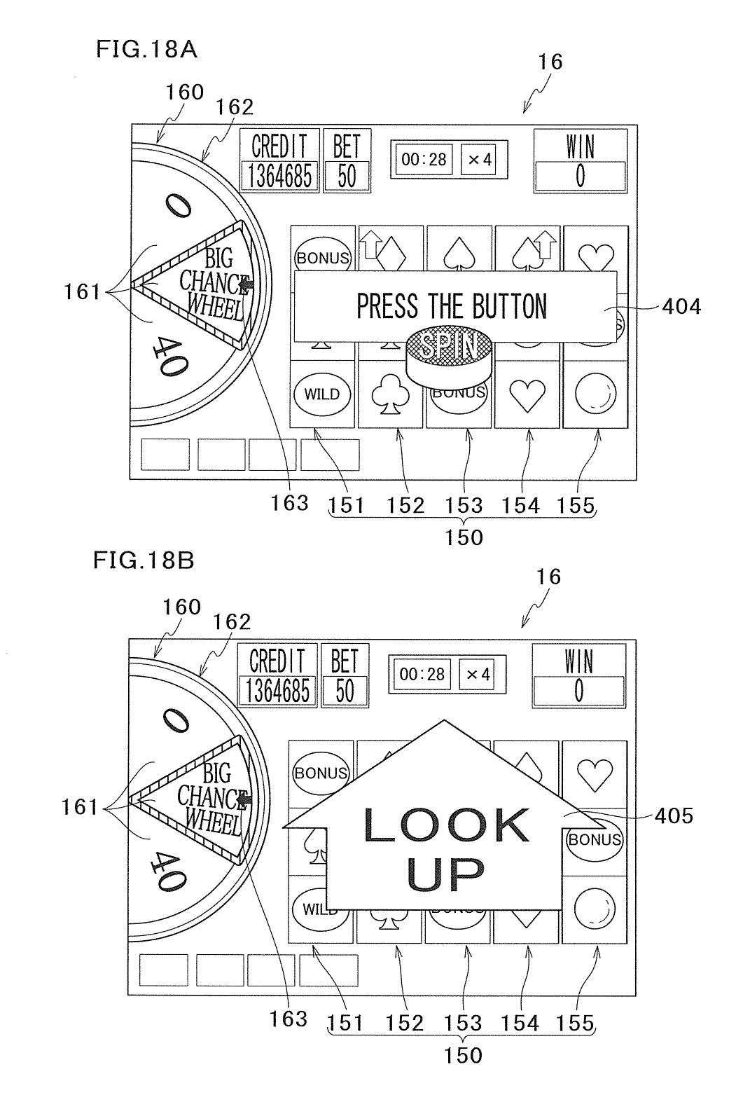

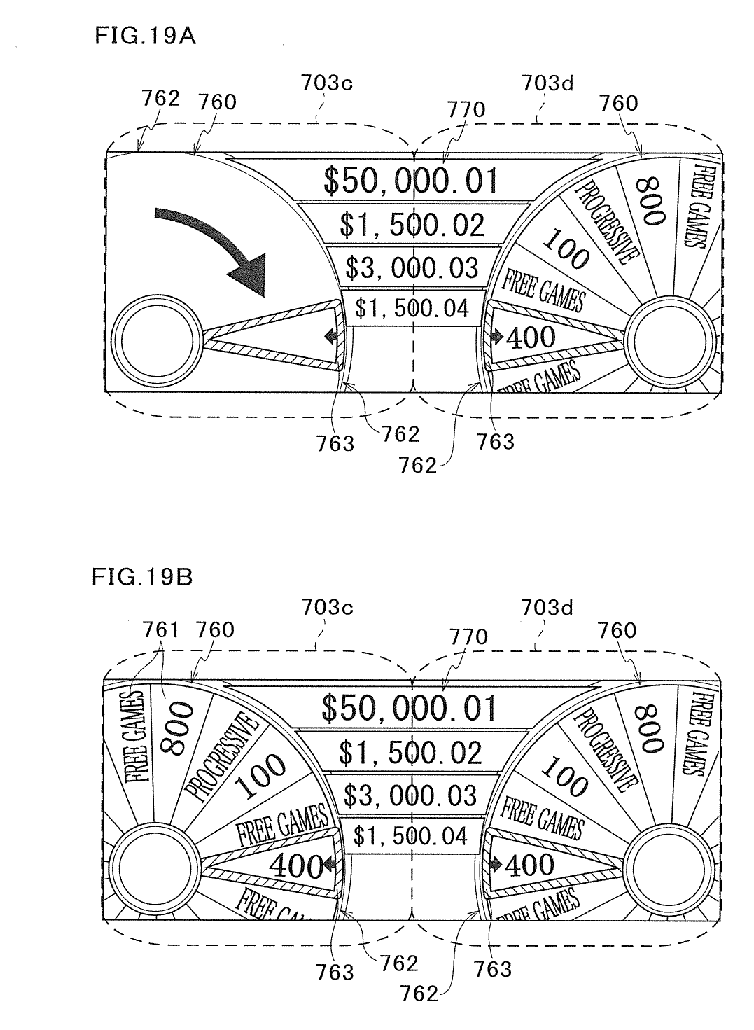

When the BONUS CHANCE WHEEL game is started by the gaming terminal 10c, first, an image 404 including a message encouraging a player to press the spin button 29 is displayed on the terminal image display panel 16 of the gaming terminal 10c, as shown in FIG. 18A. Upon pressing of the spin button 29 by the player, a look-up image 405 including a message encouraging the player to look at the upper displays 700 is displayed on the terminal image display panel 16, as shown in FIG. 18B, and rotation of the wheel 762 displayed on the gaming terminal area 703c is started, as shown in FIG. 19A. Then, the rotation of the wheel 762 is stopped as shown in FIG. 19B. The benefit associated with the area 761 indicated by the indicator 763 at the time of the above stop is awarded to the player.

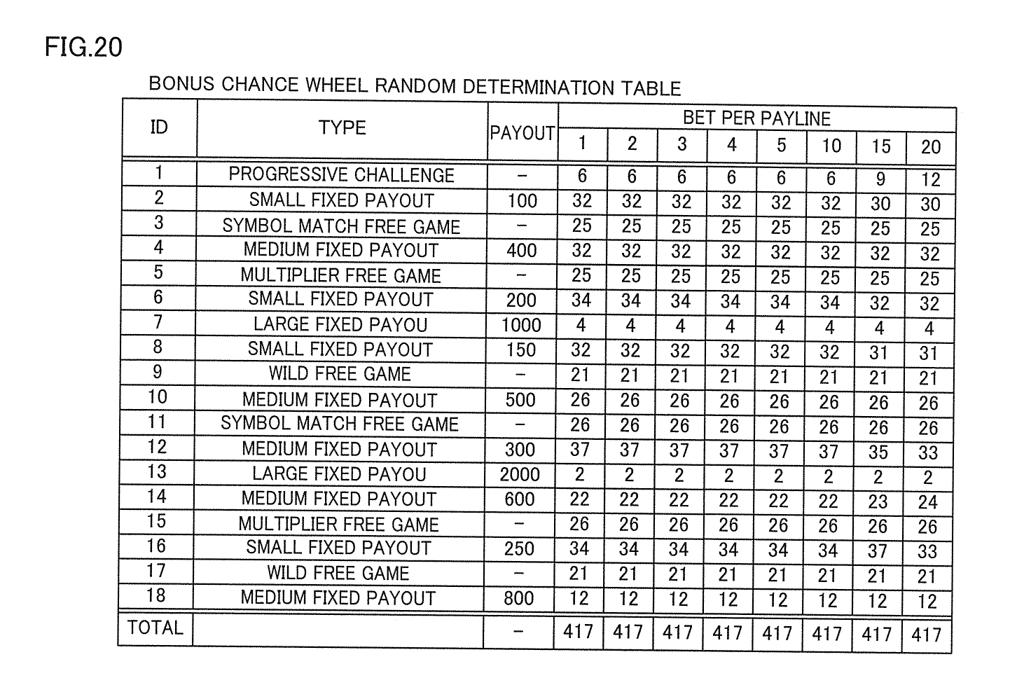

Which of the areas 761 is indicated by the indicator 763 at the time of stop of the wheel 762 (hereinafter the indicated area is also referred to as BONUS CHANCE WHEEL use to-be-stopped area) is determined based on the above-mentioned random determination program stored in the memory card 53. The random determination program includes a BONUS CHANCE WHEEL random determination table shown in FIG. 20. In the BONUS CHANCE WHEEL random determination table, for each credit amount bet per payline in the base game (BET PER LINE), weights are respectively set for the eighteen areas 761. Each weight represents the probability that the corresponding area 761 is determined as the BONUS CHANCE WHEEL use to-be-stopped area. That is, the probability that one area 761 is determined as the BONUS CHANCE WHEEL use to-be-stopped area is obtained by dividing the weight associated with that one area 761 by the total weights of all the areas 761. For example, as shown in FIG. 20, in the situation where the BET PER LINE is 1 in the base game, the probability that the area 761a associated with the benefit of shifting to the progressive challenge is determined as the BONUS CHANCE WHEEL use to-be-stopped area is 6/417. Further, in the situation where the BET PER LINE is 15 in the base game, the probability that the area 761e associated with the benefit of a fixed payout of “200 credits” is determined as the BONUS CHANCE WHEEL use to-be-stopped area is 32/417.

(Progressive Challenge)

The following describes the progressive challenge which is executed when the benefit of shifting to the progressive challenge is awarded as a result of the BONUS CHANCE WHEEL game. The progressive challenge is a game to determine which of the four types of progressive jackpots (“GRAND JACKPOT”, “MAJOR JACKPOT”, “MINOR JACKPOT”, “MINI JACKPOT”) is awarded as a prize. The game result of the progressive challenge is displayed on the corresponding one of the gaming terminal areas 703a to 703f on the upper displays 700. The following description deals with a case, for example, where the gaming terminal 10c executes the progressive challenge. In the present embodiment, description will be given for the case where there are four types of progressive jackpots; however, the disclosure is not limited to this. There may be a single type of progressive jackpot.

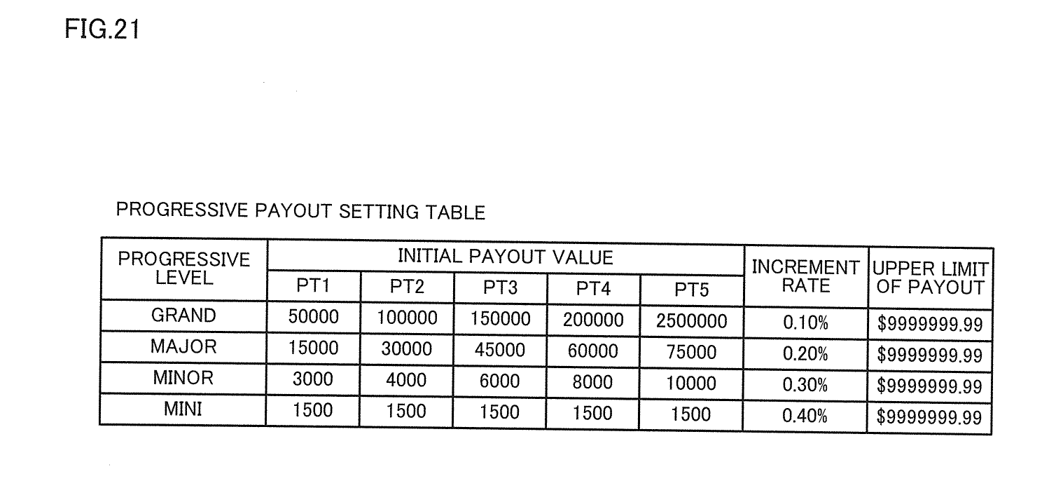

The payout amount of each of the four types of the progressive jackpots is a sum of: a progressive initial payout value; and a value of increments each constituted by a predetermined percentage (the increment rate) of a bet amount bet on each gaming terminal 10 each time the normal game is executed. The progressive initial payout values and the increment rates corresponding to the four types of progressive jackpots are defined in a progressive payout setting table shown in FIG. 21.

As shown in the progressive payout setting table of FIG. 21, “GRAND JACKPOT”, “MAJOR JACKPOT”, “MINOR JACKPOT”, and “MINI JACKPOT” are listed in the order of the progressive initial payout value from the largest to the smallest. For each of the four types of progressive jackpots, there are provided five types of progressive initial payout values corresponding to five types of progressive challenge settings PT1 to PT5. By selecting one of the five types of settings of PT1 to PT5 in AUDIT, it is possible to change the settings for the progressive initial payout values of the four types of progressive jackpots.

The initial payout value of “GRAND JACKPOT” is incremented by the value corresponding to 0.10% of the credit amount bet in the base game in each gaming terminal 10 each time the base game is executed, that is, 0.10% of the credit amount is accumulatively stored. In the same manner, the initial payout value of “MAJOR JACKPOT” is incremented by the value corresponding to 0.20% of the credit amount bet in the base game in each gaming terminal 10, the initial payout value of “MINOR JACKPOT” is incremented by the value corresponding to 0.30% of the credit amount bet in the base game in each gaming terminal 10, and the initial payout value of “MINI JACKPOT” is incremented by the value corresponding to 0.40% of the credit amount bet in the base game in each gaming terminal 10, every time the base game is executed, that is, the above percentages of the credit amount are accumulated. As shown in FIG. 21, there is an upper limit of the progressive payout in each of “GRAND JACKPOT”, “MAJOR JACKPOT”, “MINOR JACKPOT”, and “MINI JACKPOT”. The payout amount of each progressive jackpot is stored in a progressive payout storage area provided in the RAM 243 of the center controller 200.

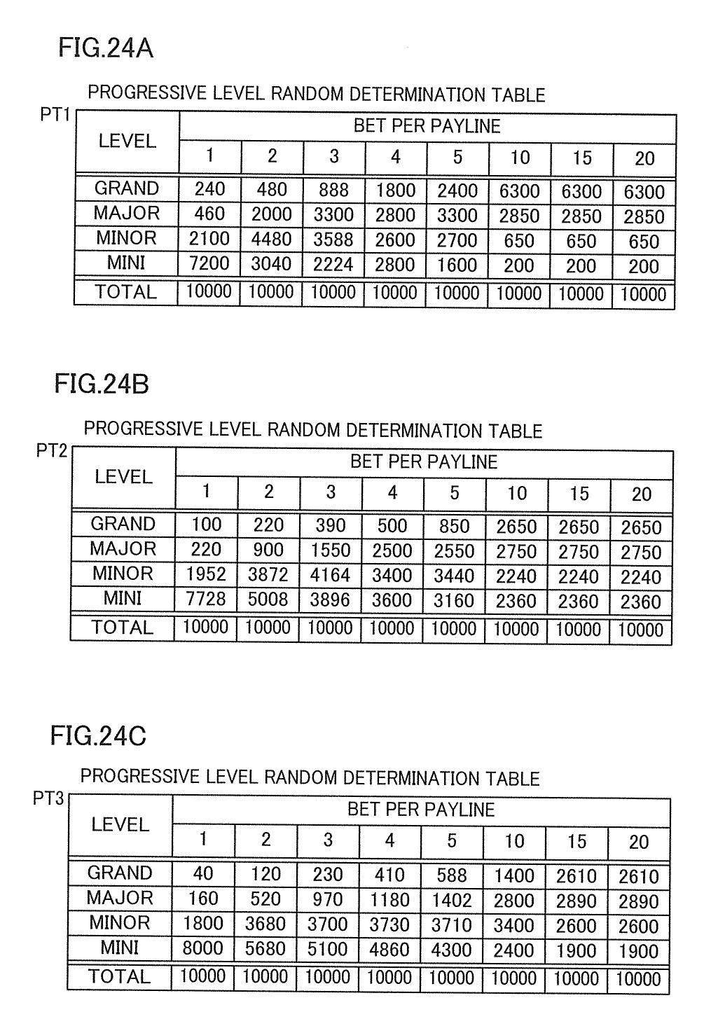

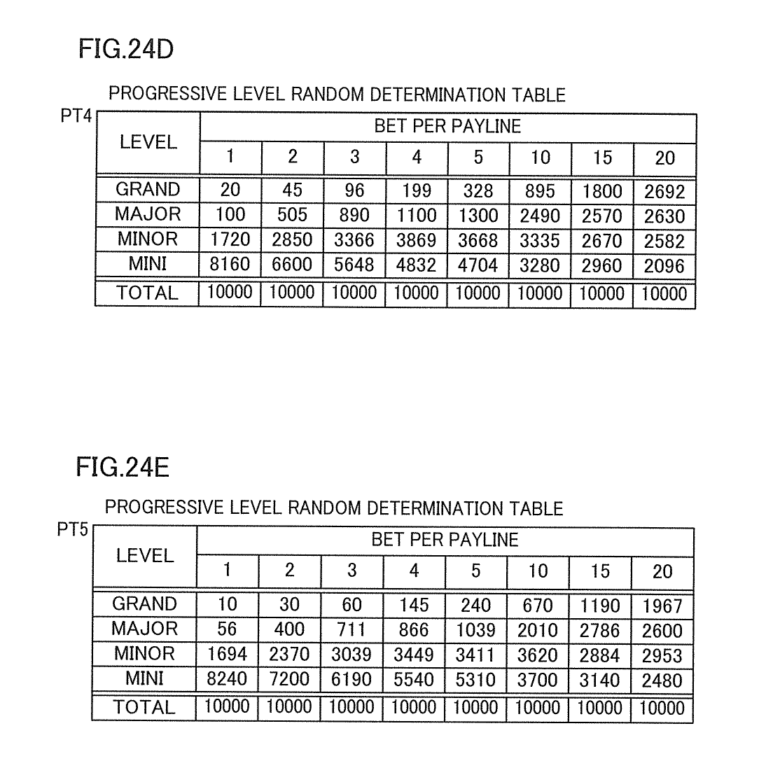

In the progressive challenge, a progressive level random determination process of determining which type of the progressive jackpots is awarded to the gaming terminal 10 is executed based on the random determination program stored in the memory card 53. The random determination program includes a progressive level random determination table shown in FIG. 24A. In the progressive level random determination table, for each credit amount bet per payline in the base game (BET PER LINE), weights are respectively set for the four types of progressive jackpots. Each weight represents the probability that the corresponding progressive jackpot is selected in the progressive level random determination process. For example, in the situation where the credit amount bet per payline in the base game is 1, the probability that “GRAND JACKPOT” is selected in the progressive level random determination process is 240/10000. There are five types of progressive level random determination tables corresponding to the five types of progressive challenge settings PT1 to PT5 (see FIG. 24A to FIG. 24E). By selecting one of the five types of settings of PT1 to PT5 in AUDIT, it is possible to select corresponding one of the progressive level random determination tables.

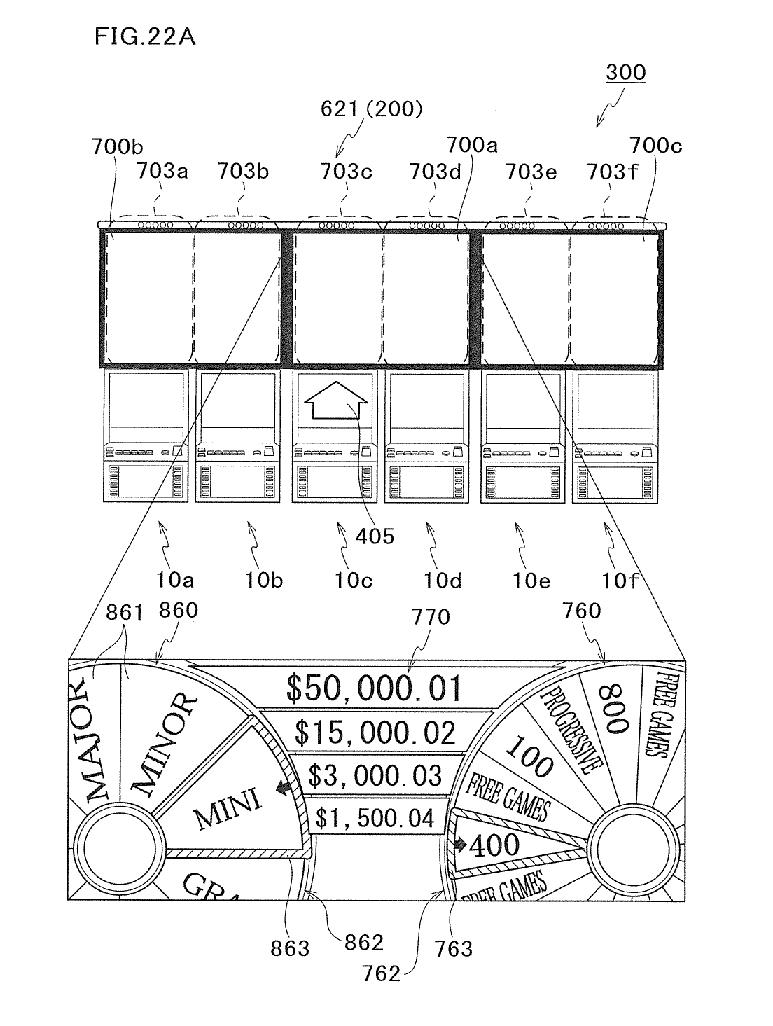

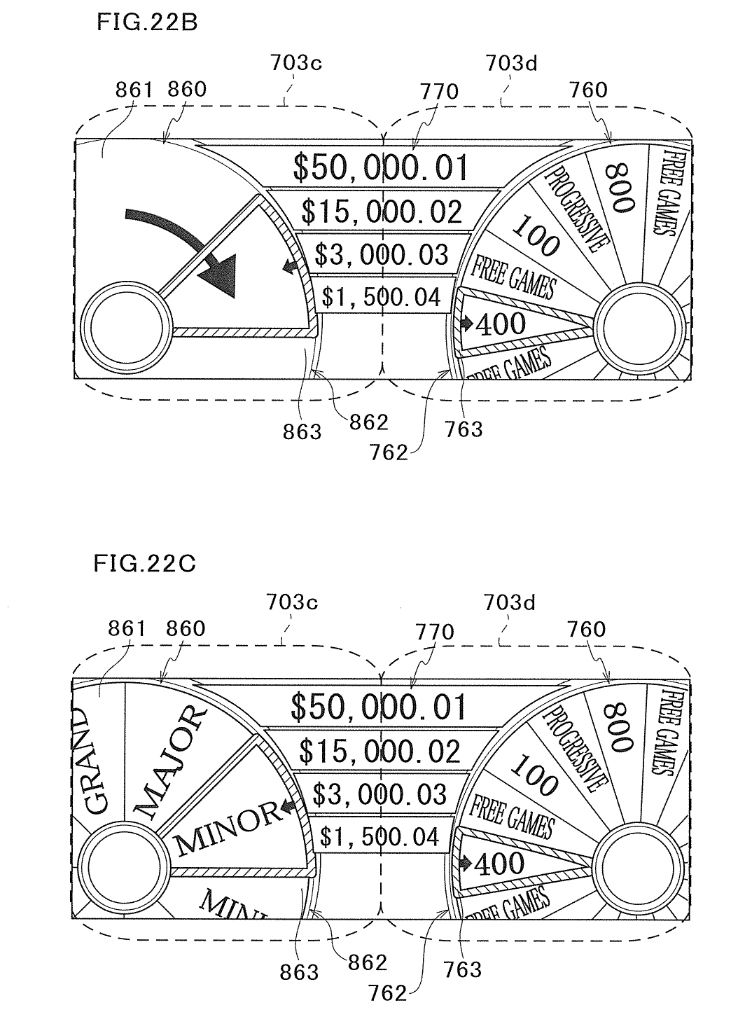

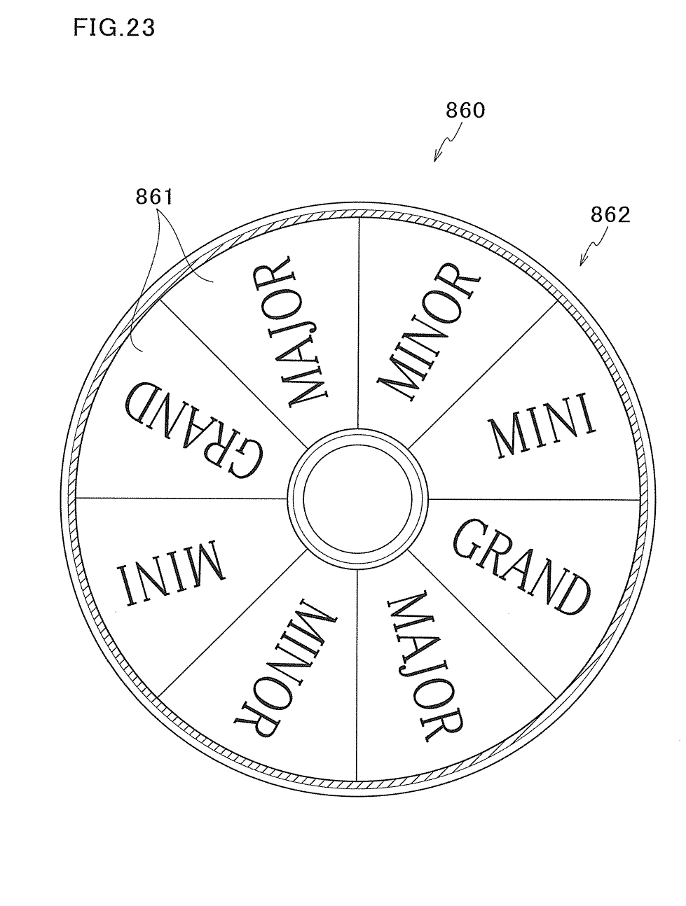

In the progressive challenge, the common screen wheel 760 displayed on the gaming terminal area 703c corresponding to the gaming terminal 10c is replaced to a progressive challenge wheel 860 as shown in FIG. 22A. As shown in FIG. 22A, the progressive challenge wheel 860 includes: a wheel 862 having six areas 861 (see FIG. 23) respectively associated with jackpots of “GRAND JACKPOT”, “MAJOR JACKPOT”, “MINOR JACKPOT”, and “MINI JACKPOT”; and an indicator 863 displayed in a fixed manner for indicating a winning area 861. Note that in the present embodiment, only a part of the wheel 862 is displayed on the terminal image display panel 16.

Then, the image 404 including a message encouraging the player to press the spin button 29 is displayed on the terminal image display panel 16 of the gaming terminal 10c, as shown in FIG. 18A. Upon pressing of the spin button 29 by the player, the look-up image 405 including a message encouraging the player to look at the upper displays 700 is displayed on the terminal image display panel 16, as shown in FIG. 18B. Then, rotation of the wheel 862 displayed on the gaming terminal area 703c is started, as shown in FIG. 22A. Thereafter, the rotation of the wheel 862 is stopped so that the area 861 displaying thereon the type of the progressive jackpot determined by the progressive jackpot random determination is stopped at the position indicated by the indicator 863 (see FIG. 22B). The benefit of the progressive jackpot displayed on the area 861 indicated by the indicator 863 at the time of the above stop is awarded to the player.

(SYMBOL MATCH FREE GAME)

The following describes the SYMBOL MATCH FREE GAME which is executed when the benefit of shifting to the SYMBOL MATCH FREE GAME is awarded as a result of the BONUS CHANCE WHEEL game.

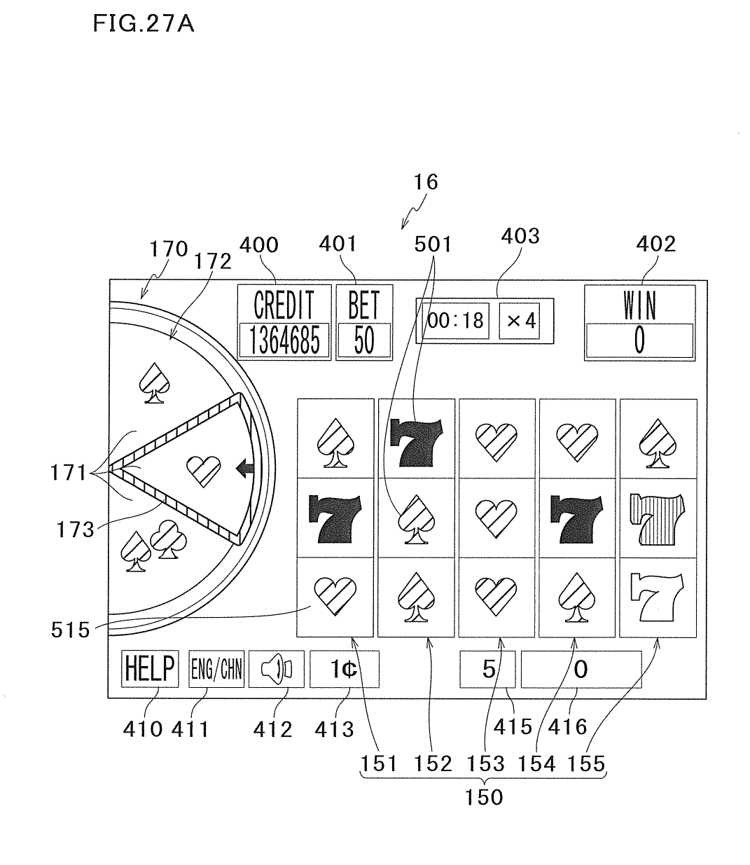

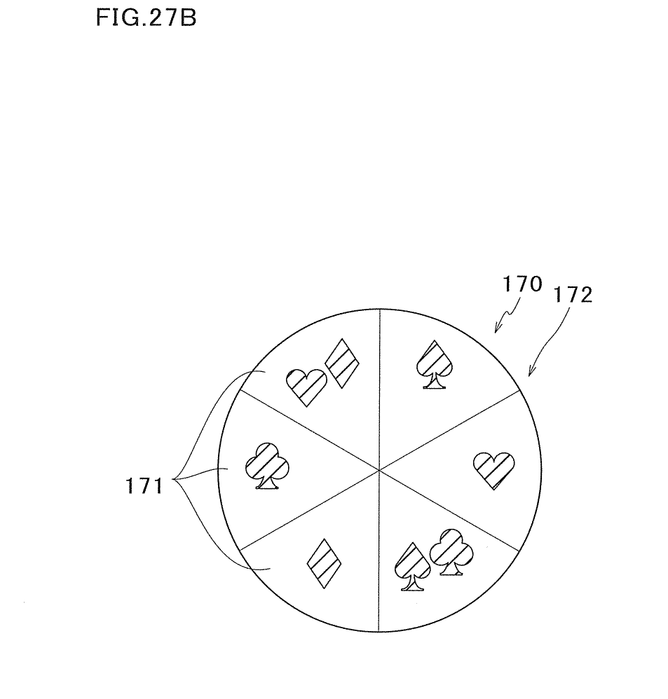

In the SYMBOL MATCH FREE GAME, it is possible to execute the free game multiple times (five times in the present embodiment). The free game is a slot game of rearranging a plurality of symbols 501 on the display window 150, similar to the base game. When the SYMBOL MATCH FREE GAME is executed, the terminal screen wheel 160 displayed on the terminal image display panel 16 of the gaming terminal 10 is replaced to a SYMBOL MATCH FREE GAME wheel 170, as shown in FIG. 27A. At a lower portion of the terminal image display panel 16, there is newly displayed: a game-number counter 415 indicating the remaining number of times of execution of the free game; a WIN meter 416 indicating the payout obtained in the free game. Note that the counter 415 and the WIN meter 416 are displayed in the same manner also during execution of the MULTIPLIER FREE GAME and the WILD FREE GAME.

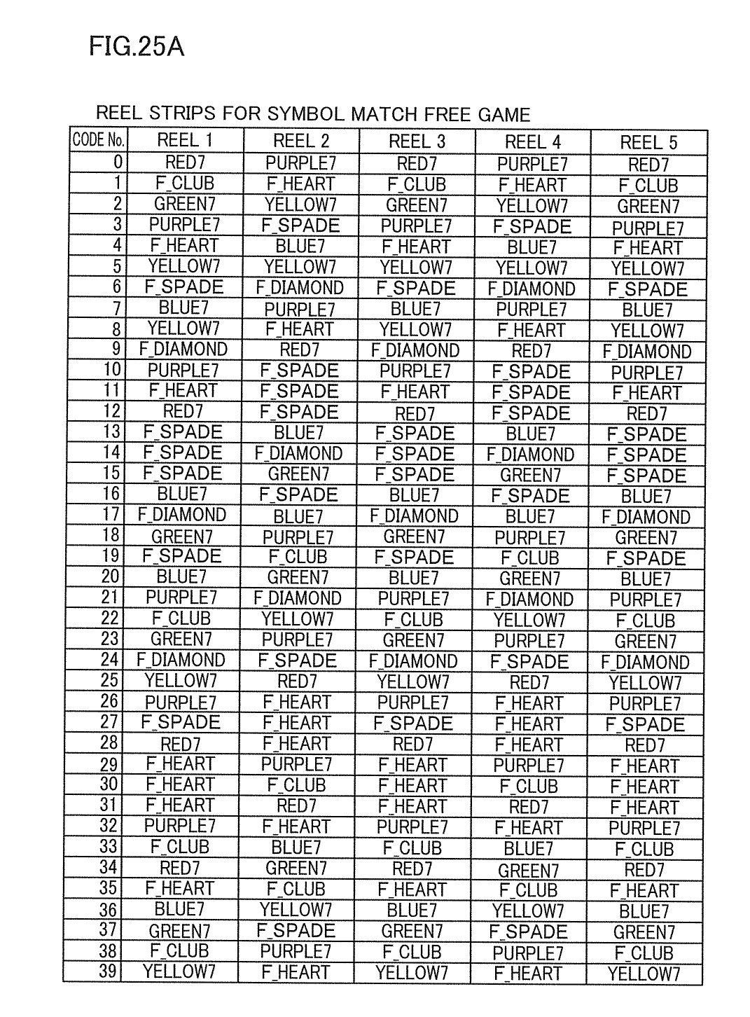

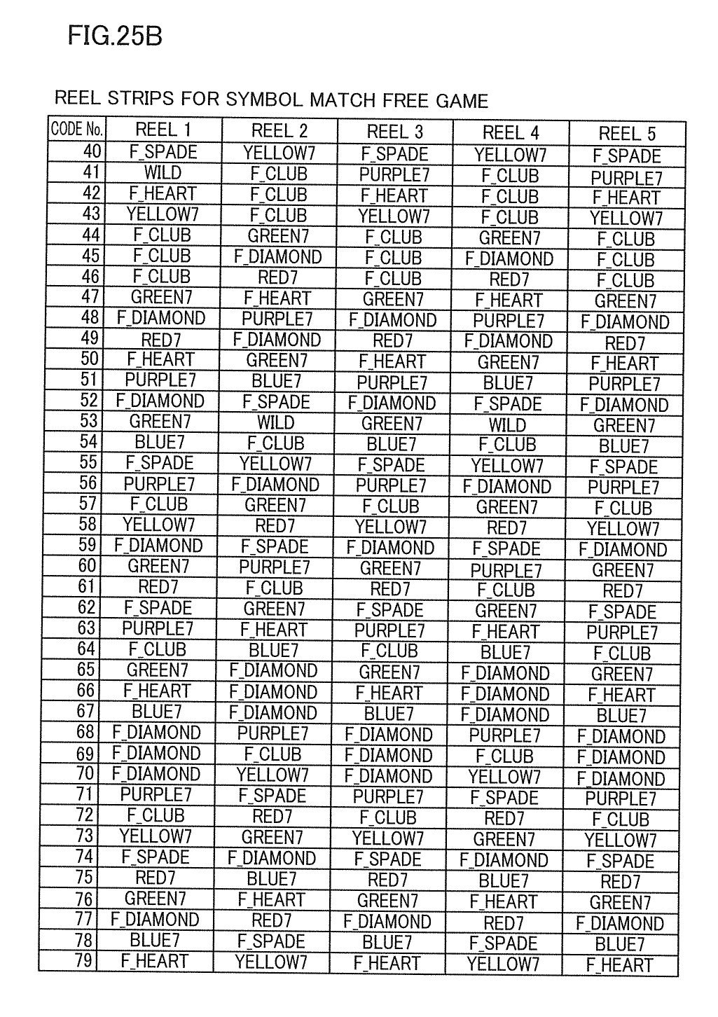

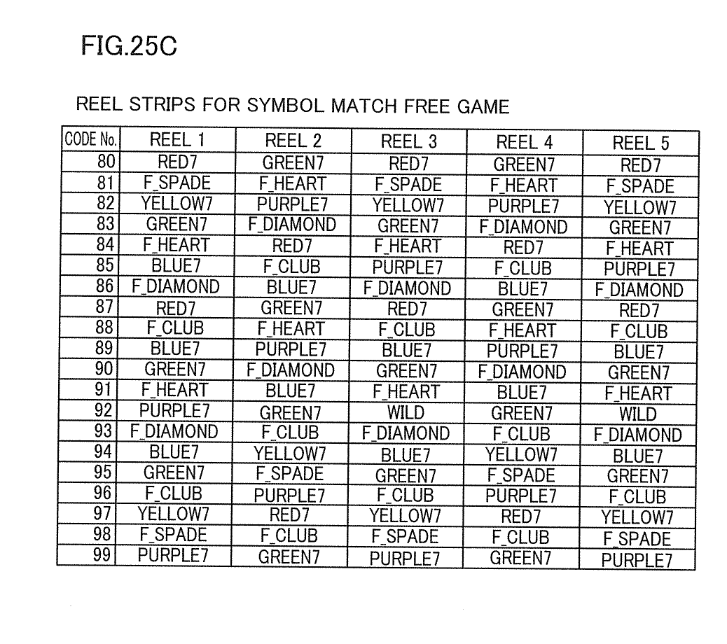

In the SYMBOL MATCH FREE GAME, video reel strips different from those of the base game are used. FIG. 25A to FIG. 25C show symbol arrays on the circumferential surfaces of the video reels 151 to 155 for SYMBOL MATCH FREE GAME. As shown in FIG. 25A to FIG. 25C, a symbol array constituted by 100 symbols corresponding to code numbers “0” to “99” is allocated to each of the first to fifth video reels 151 to 155 (Reel 1 to Reel 5) of the video reel strips for the SYMBOL MATCH FREE GAME.

As shown in FIG. 25A to FIG. 25C, the types of symbols of the video reel strips for the SYMBOL MATCH FREE GAME include: normal symbols of “RED7”, “BLUE7”, “YELLOW7”, “PURPLE7”, “GREEN7”, “F_SPADE”, “F_HEART”, “F_DIAMOND”, and “F_CLUB”; a symbol of “WILD” which is able to be substitute for any of the normal symbols; and the like. The types of symbols used are common among the three types of free games (SYMBOL MATCH FREE GAME, MULTIPLIER FREE GAME, and WILD FREE GAME).

In the SYMBOL MATCH FREE GAME, a to-be-stopped symbol on each of the video reels 151 to 155 is determined each time the free game is executed, based on the random determination program stored in the memory card 53. The to-be-stopped symbols for the respective video reels 151 to 155 are displayed on the display window 150, with the result that 15 symbols are rearranged on the display window 150.

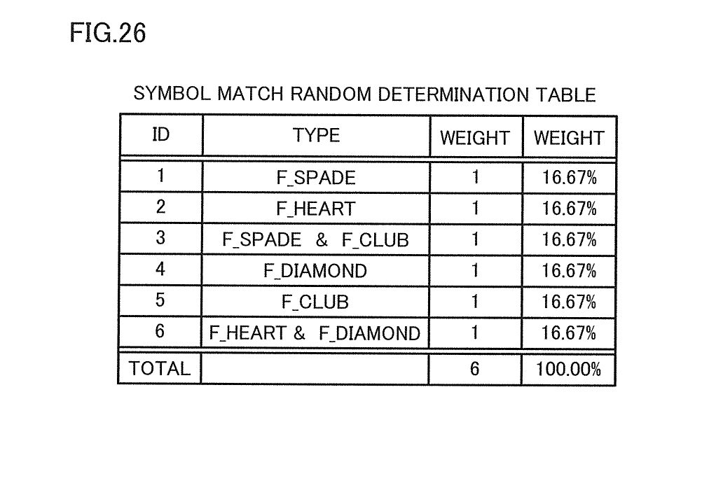

In the SYMBOL MATCH FREE GAME, a symbol type random determination process of randomly determining the type(s) of symbols to be changed to the “WILD” symbols 515 among the plural types of symbols based on a SYMBOL MATCH random determination table (see FIG. 26) included in the random determination program is executed each time the free game is executed. In the symbol type random determination process, the type(s) of the symbols to be changed to the “WILD” symbols are determined as follows: one of “F_SPADE”, “F_HEART”, “F_DIAMOND”, and “F_CLUB” is selected; “F_SPADE” and “F_CLUB” are selected; or “F_HEART” and “F_DIAMOND” are selected.

In the SYMBOL MATCH random determination table shown in FIG. 26, “F_SPADE”, “F_HEART”, “F_DIAMOND”, “F_CLUB”, “F_SPADE & F_CLUB”, and “F_HEART & F_DIAMOND” are associated with ID numbers of 1 to 6. For example, the ID number 6 is associated with the two types of symbols of “F_HEART” and “F_DIAMOND”. The ID numbers 1 to 6 are respectively associated with weights. Each weight represents the probability that the type of symbols in association with the corresponding ID number is selected in the symbol type random determination process. For example, as shown in FIG. 26, the probability that the “F_HEART” and “F_DIAMOND” associated with the ID number 6 is selected in the symbol type random determination process is ⅙. That is, in the free game, the probability that the symbols of the two types (“F_HEART” and “F_DIAMOND”) rearranged on the display window 150 are changed to “WILD” symbols is ⅙.

The result of the random determination in the symbol type random determination process is reported to the player by the SYMBOL MATCH FREE GAME wheel 170 displayed on the terminal image display panel 16. As shown in FIG. 27A, the SYMBOL MATCH FREE GAME wheel 170 includes: a wheel 172 having six areas 171 (see FIG. 27B) respectively associated with the ID numbers in the SYMBOL MATCH random determination table; and an indicator 173 displayed in a fixed manner for indicating a winning area 171. Note that in the present embodiment, only a part of the wheel 172 is displayed on the terminal image display panel 16.

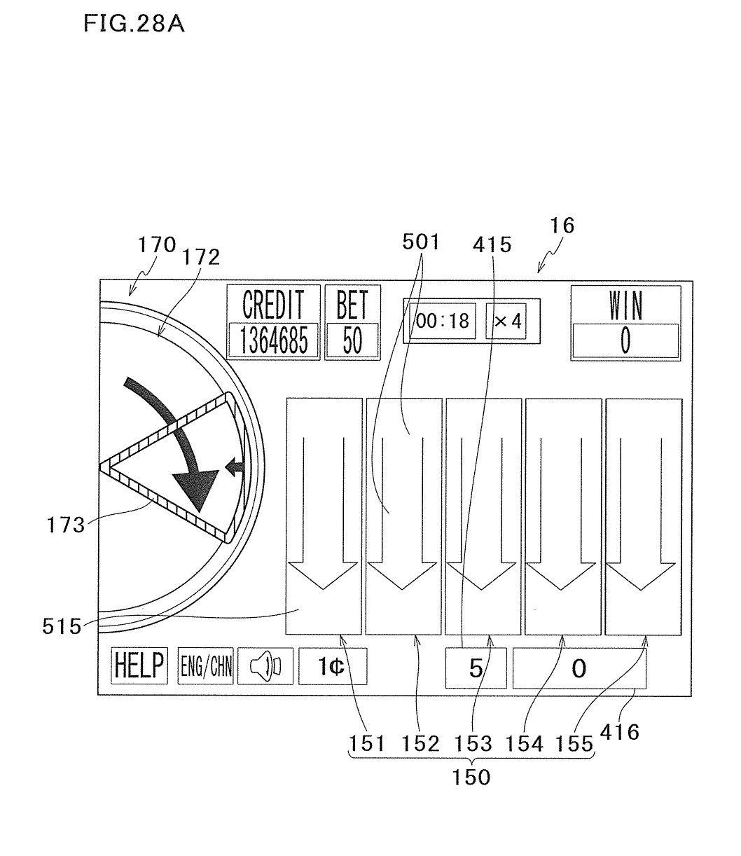

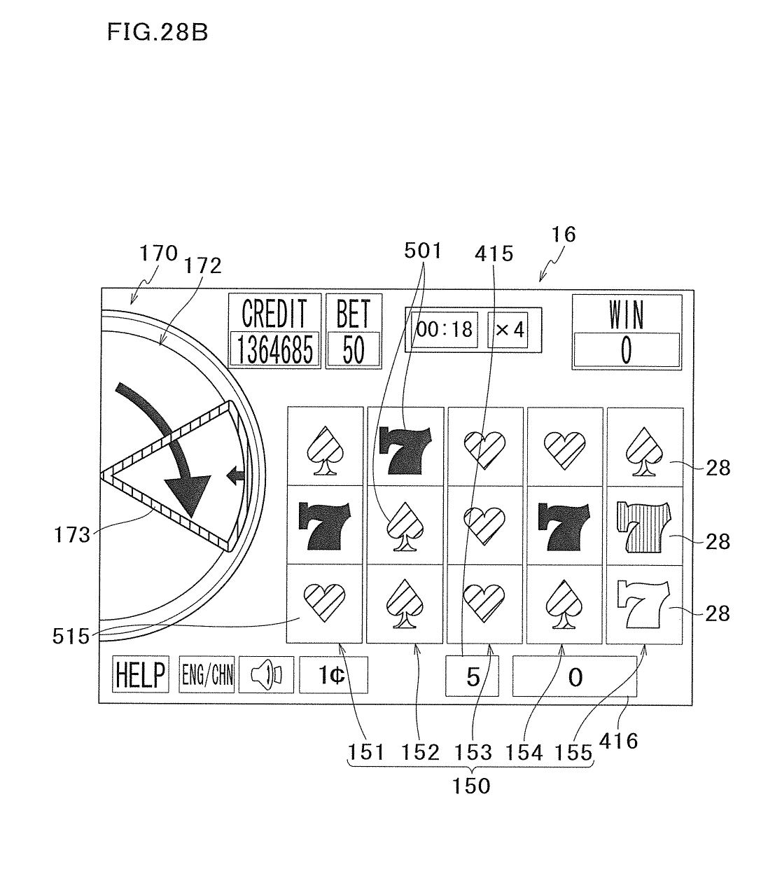

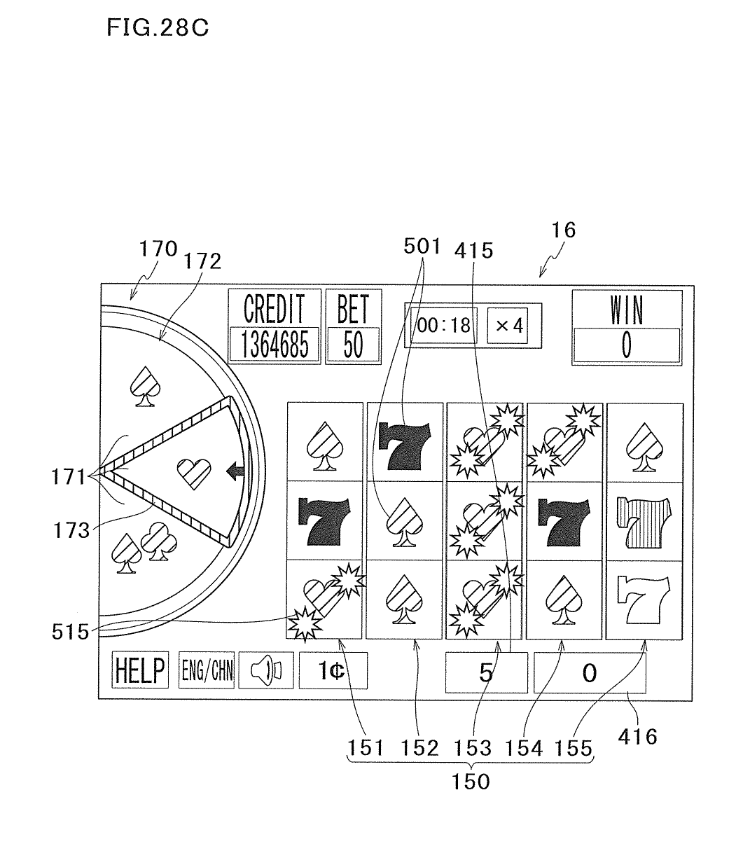

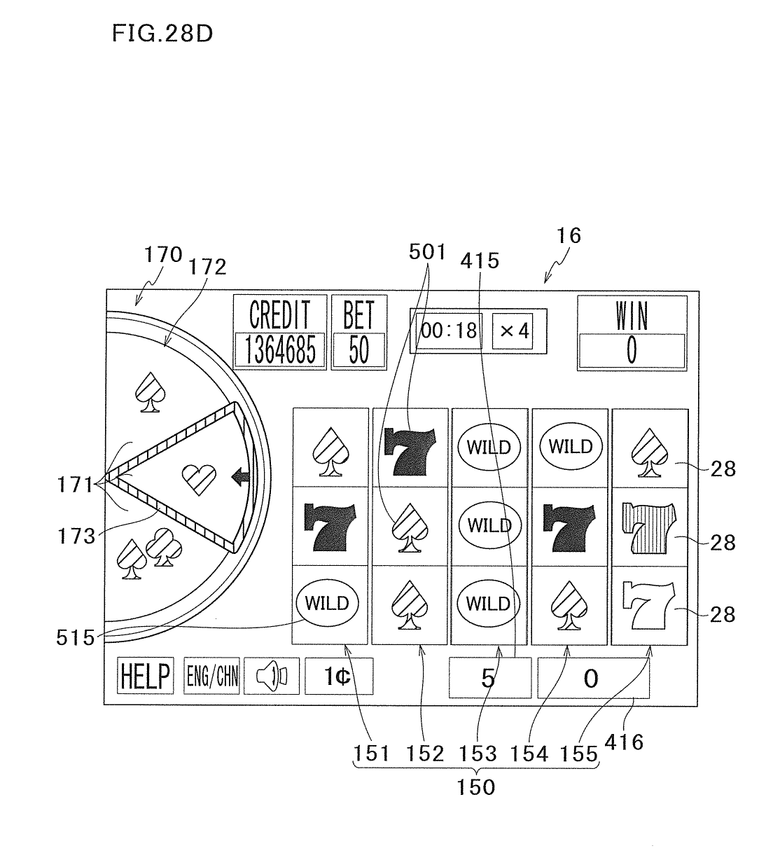

In the SYMBOL MATCH FREE GAME, when the free game is started in response to pressing of the spin button 29, rotation of the wheel 172 is first started as shown in FIG. 28A, and scrolling of the video reels 151 to 155 is started. The scrolling of the video reels 151 to 155 stops, as shown in FIG. 28B, after a predetermined period elapses from the beginning of the scrolling. At this time, the rotation of the wheel 172 continues. After a predetermined period elapses from the stop of the scrolling of the video reels 151 to 155, the rotation of the wheel 172 is stopped, as shown in FIG. 28C. Then, as shown in FIG. 28D, a symbol change process is executed to change the symbol(s) of the type associated with the ID number corresponding to the area 171 indicated by the indicator 173, among the symbols rearranged on the display window 150, to the “WILD” symbol(s) 515. FIG. 28C and FIG. 28D show an example where the symbols of “F_HEART” among the symbols rearranged on the display window 150 are changed to the “WILD” symbols 515. Then, as shown in FIG. 28C, when one or more of the symbols rearranged on the display window 150 are changed to the “WILD” symbol(s) 515, an effect, e.g., animation of blinking the symbols to be changed to the “WILD” symbols, is provided.

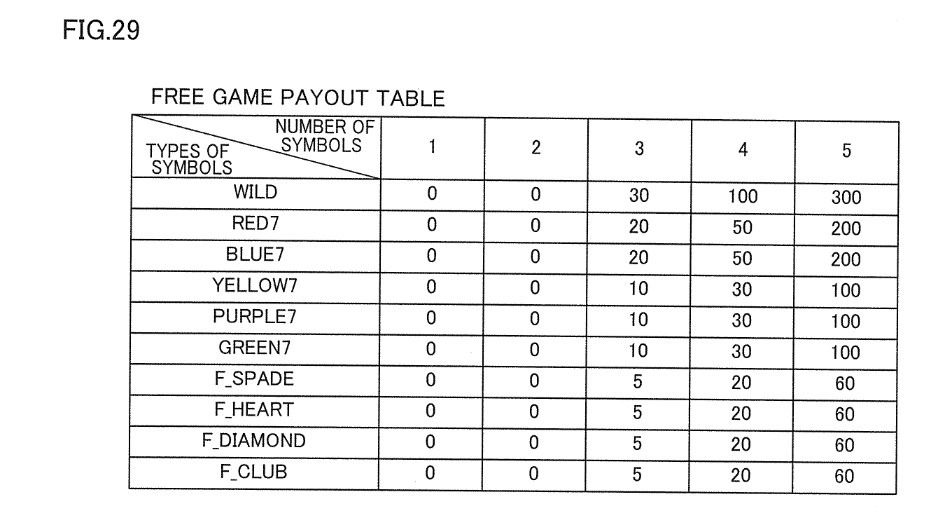

In the SYMBOL MATCH FREE GAME, after the symbol change process is executed, a benefit is awarded based on the combination(s) made by the 15 symbols 501 displayed on the display window 150. The type of the benefit awarded in the SYMBOL MATCH FREE GAME is determined based on a free game payout table shown in FIG. 29. The free game payout table is a table defining relationship between: the combination of symbols related to winning, in this case, the number of symbols of a kind; and the awarded credit amount. In the present embodiment, basically, a winning is achieved when 3, 4, or 5 symbols of a kind is rearranged on a payline, as for the symbols of “RED7”, “BLUE7”, “YELLOW7”, “PURPLE7”, “GREEN7”, “F_SPADE”, “F_HEART”, “F_DIAMOND”, “F_CLUB”, and “WILD”. As mentioned above, the “WILD” symbol 515 is able to substitute for any of the normal symbols of “RED7”, “BLUE7”, “YELLOW7”, “PURPLE7”, “GREEN7”, “F_SPADE”, “F_HEART”, “F_DIAMOND”, and “F_CLUB”. Note that the free game payout table shown in FIG. 29 is common among the three types of free games (SYMBOL MATCH FREE GAME, MULTIPLIER FREE GAME, and WILD FREE GAME).

(MULTIPLIER FREE GAME)

The following describes the MULTIPLIER FREE GAME which is executed when the benefit of shifting to the MULTIPLIER FREE GAME is awarded as a result of the BONUS CHANCE WHEEL game.

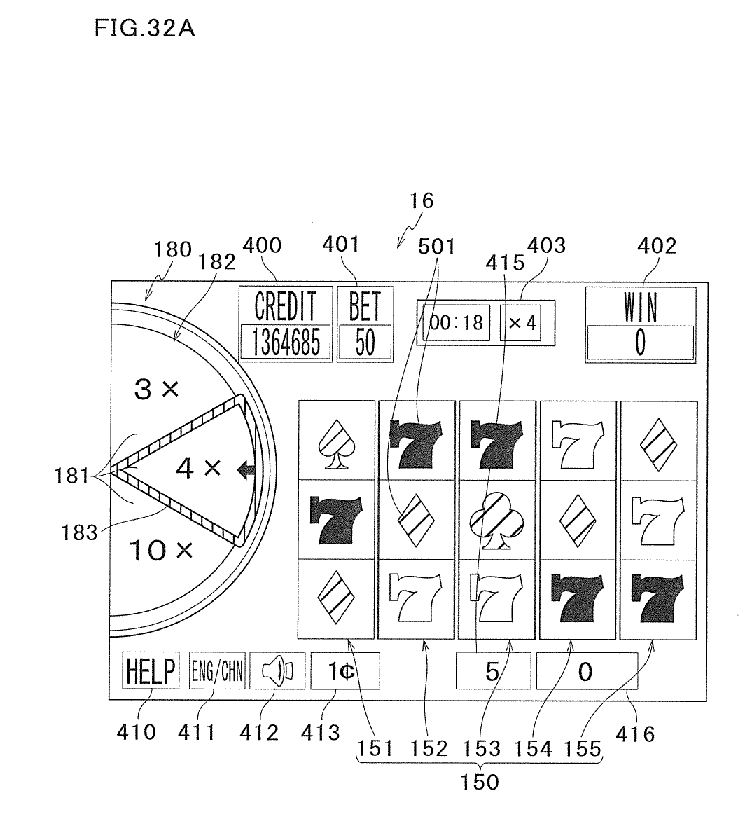

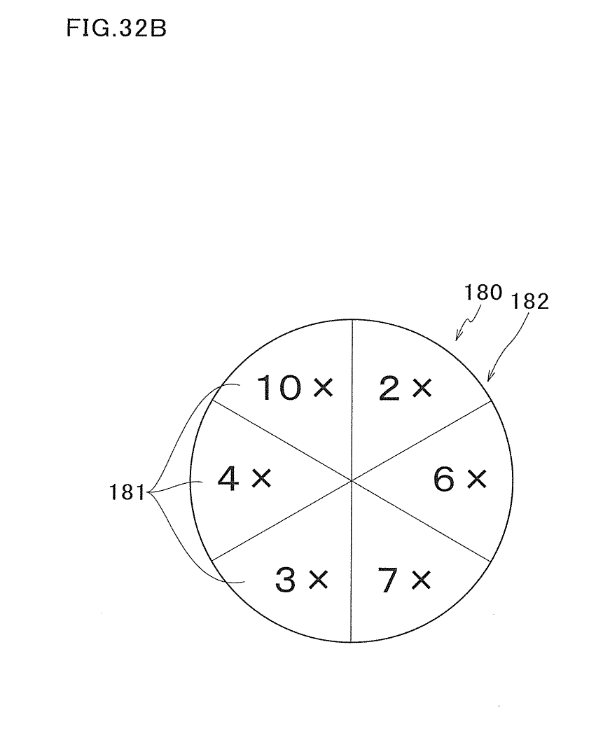

In the MULTIPLIER FREE GAME, it is possible to execute the free game multiple times (five times in the present embodiment). The free game is a slot game of rearranging a plurality of symbols 501 on the display window 150, similar to the base game. When the MULTIPLIER FREE GAME is executed, the terminal screen wheel 160 displayed on the terminal image display panel 16 of the gaming terminal 10 is replaced to a MULTIPLIER FREE GAME wheel 180 (see FIG. 32A).

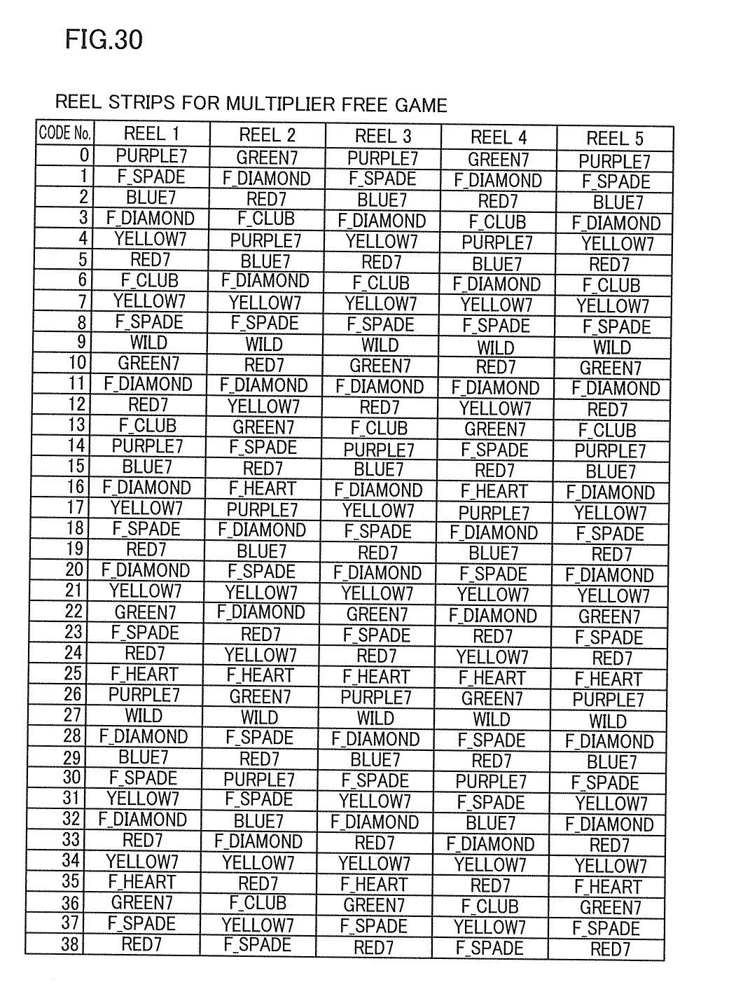

In the MULTIPLIER FREE GAME, video reel strips different from those of the base game are used. FIG. 30 shows symbol arrays on circumferential surfaces of the video reels 151 to 155 for MULTIPLIER FREE GAME. As shown in FIG. 30, a symbol array constituted by 39 symbols corresponding to code numbers “0” to “38” is allocated to each of the first to fifth video reels 151 to 155 (Reel 1 to Reel 5) of the video reel strips for the MULTIPLIER FREE GAME.

In the MULTIPLIER FREE GAME, a to-be-stopped symbol on each of the video reels 151 to 155 is determined each time the free game is executed, based on the random determination program stored in the memory card 53. The to-be-stopped symbols for the respective video reels 151 to 155 are displayed on the display window 150, with the result that 15 symbols are rearranged on the display window 150.

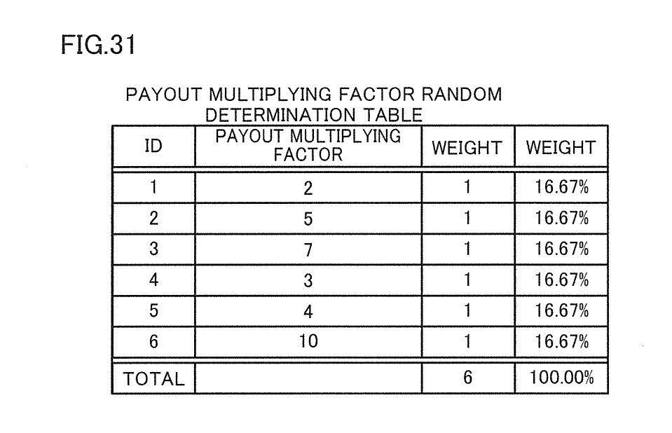

In the MULTIPLIER FREE GAME, a payout multiplying factor random determination process of determining the payout multiplying factor for the payout obtained in the free game based on a payout multiplying factor random determination table (see FIG. 31) included in the random determination program is executed each time the free game is executed. In the payout multiplying factor random determination process, one of the following six types of payout multiplying factors is selected by random determination: 2, 3, 4, 6, 7, and 10.

In the payout multiplying factor random determination table shown in FIG. 31, ID numbers 1 to 6 are respectively associated with the payout multiplying factors of 2, 3, 4, 6, 7, and 10. For example, the ID number 6 is associated with the payout multiplying factor of 10. The ID numbers 1 to 6 are respectively associated with weights. Each weight represents the probability that the multiplying factor in association with the corresponding ID number is selected in the payout multiplying factor random determination process. For example, as shown in FIG. 31, the probability that the payout multiplying factor of 10 associated with the ID number 6 is selected in the payout multiplying factor random determination process is ⅙.

The result of the random determination in the payout multiplying factor random determination process is reported to the player by the MULTIPLIER FREE GAME wheel 180 displayed on the terminal image display panel 16. As shown in FIG. 32A, the MULTIPLIER FREE GAME wheel 180 includes: a wheel 182 having six areas 181 (see FIG. 32B) respectively associated with the ID numbers in the payout multiplying factor random determination table; and an indicator 183 displayed in a fixed manner for indicating a winning area 181. Note that in the present embodiment, only a part of the wheel 182 is displayed on the terminal image display panel 16.

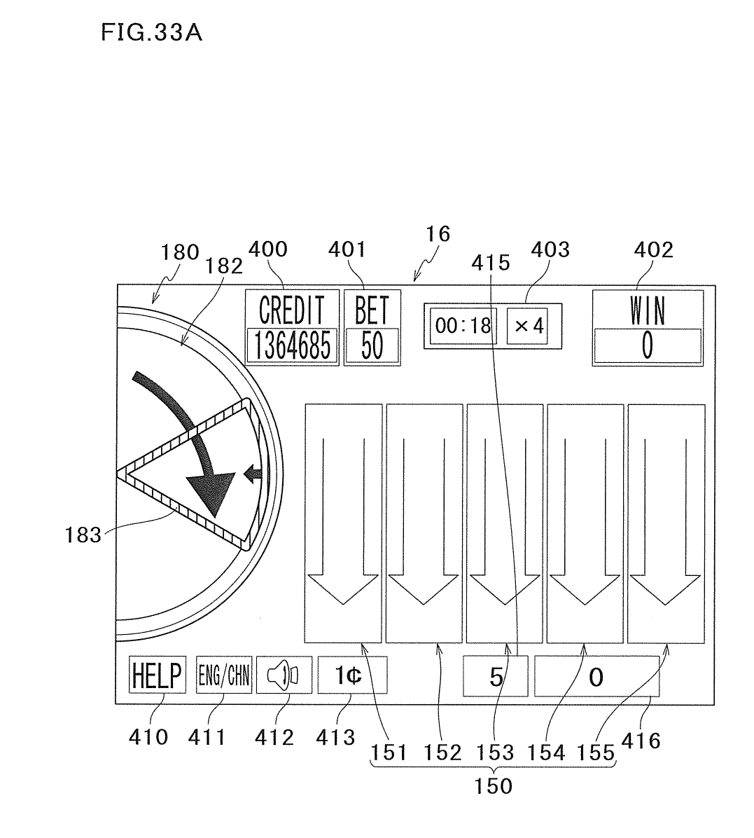

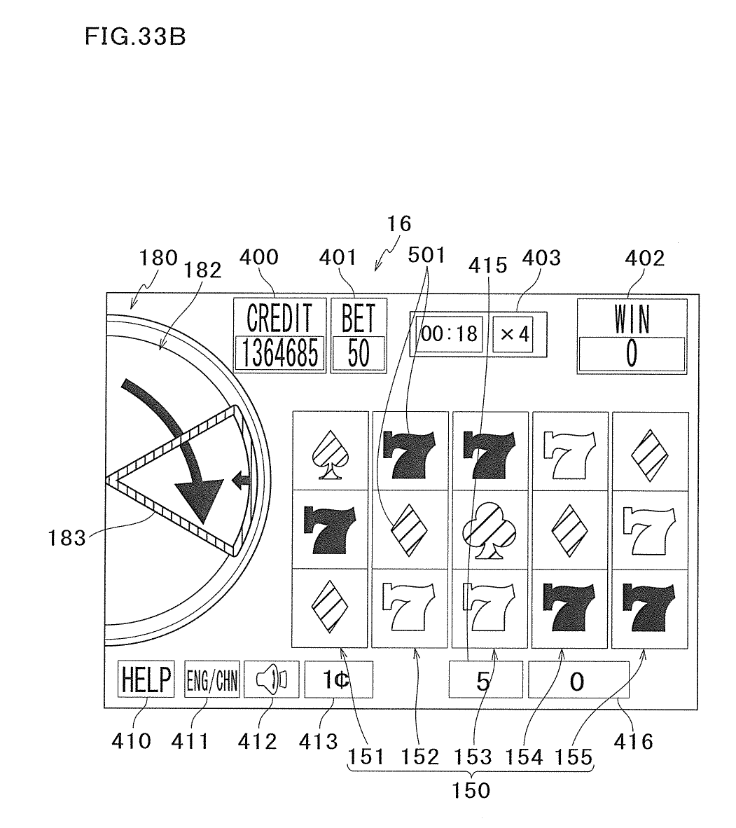

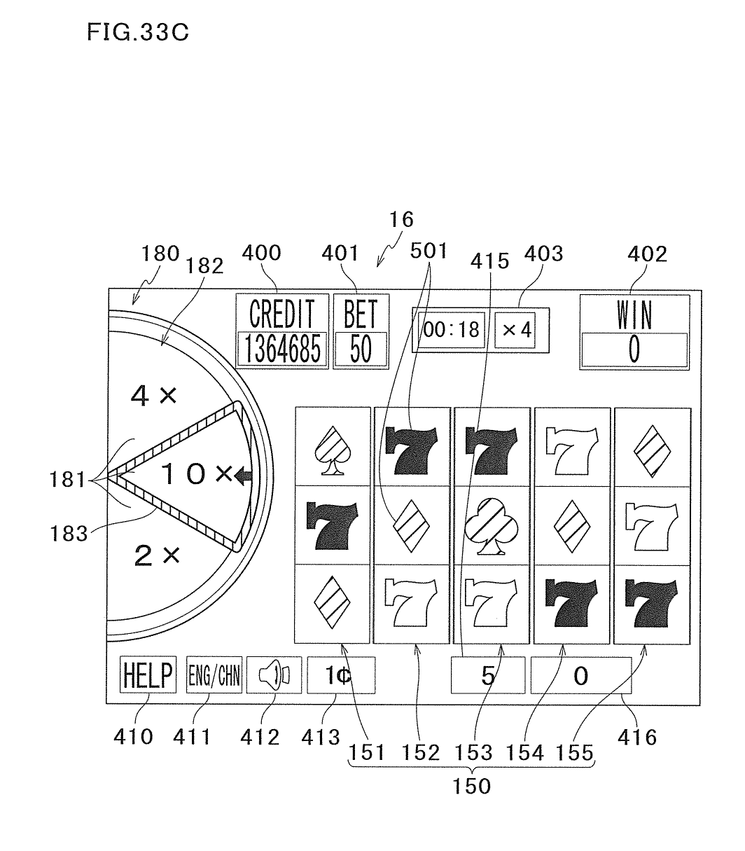

In the MULTIPLIER FREE GAME, when the free game is started in response to pressing of the spin button 29, rotation of the wheel 182 is first started as shown in FIG. 33A, and scrolling of the video reels 151 to 155 is started. The scrolling of the video reels 151 to 155 stops, as shown in FIG. 33B, after a predetermined period elapses from the beginning of the scrolling. At this time, the rotation of the wheel 182 continues. After a predetermined period elapses from the stop of the scrolling of the video reels 151 to 155, the rotation of the wheel 182 is stopped, as shown in FIG. 33C. The payout multiplying factor associated with the ID number corresponding to the area 181 indicated by the indicator 183 is used as the multiplying factor for the payout obtained in the free game.

In the MULTIPLIER FREE GAME, the payout obtained in the free game is determined based on one or more combinations made by the 15 symbols 501 rearranged on the display window 150, referring to the free game payout table shown in FIG. 29. The amount obtained by multiplying the payout obtained in the free game by the payout multiplying factor determined in the payout multiplying factor random determination process is a payout to be awarded to the player.

(WILD FREE GAME)

The following describes the WILD FREE GAME which is executed when the benefit of shifting to the WILD FREE GAME is awarded as a result of the BONUS CHANCE WHEEL game.

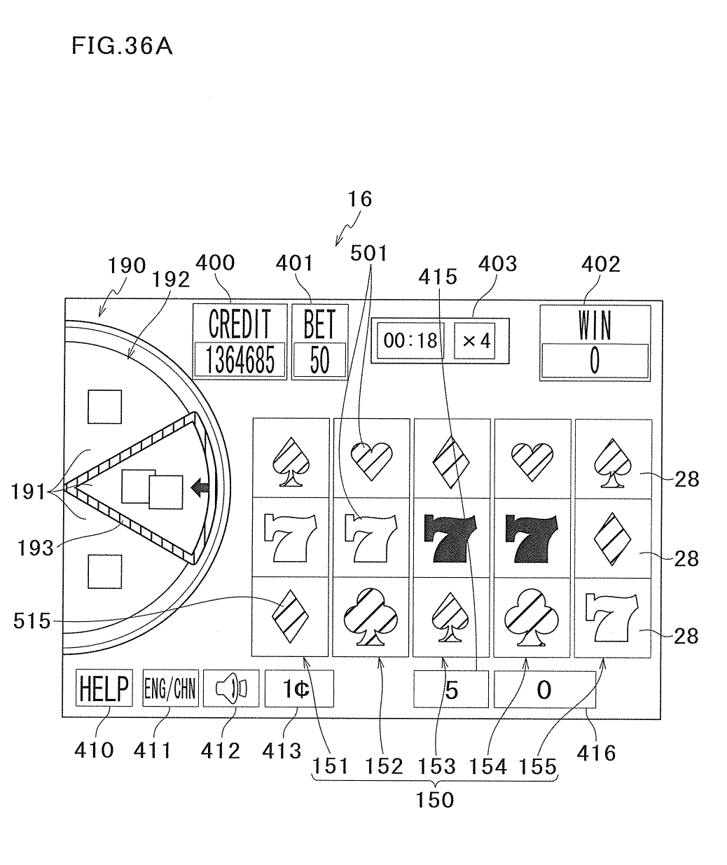

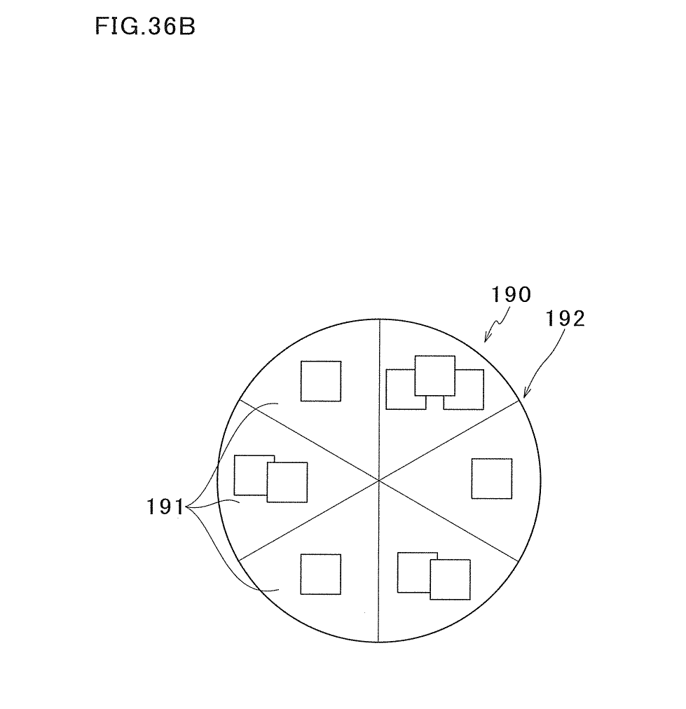

In the WILD FREE GAME, it is possible to execute the free game multiple times (five times in the present embodiment). The free game is a slot game of rearranging a plurality of symbols 501 on the display window 150, similar to the base game. When the WILD FREE GAME is executed, the terminal screen wheel 160 displayed on the terminal image display panel 16 of the gaming terminal 10 is replaced to a WILD FREE GAME wheel 190 (see FIG. 36A).

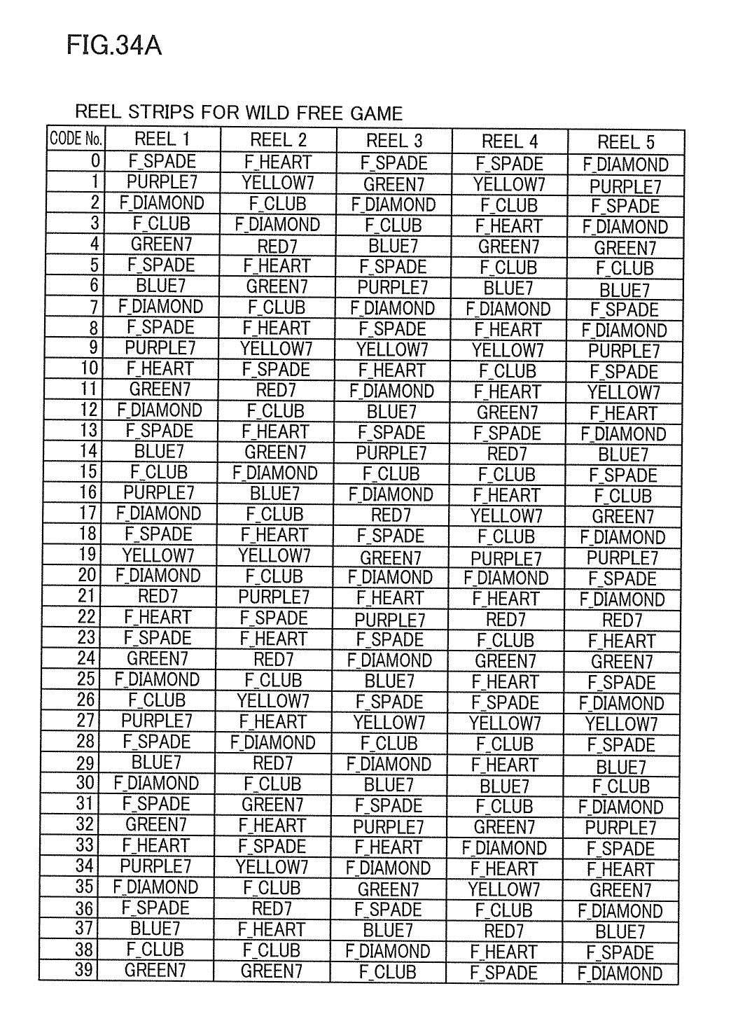

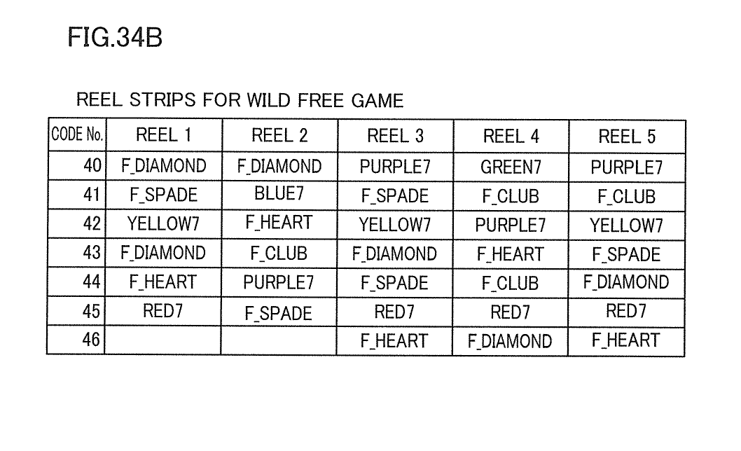

In the WILD FREE GAME, video reel strips different from those of the base game are used. FIG. 34A and FIG. 34B show symbol arrays on the circumferential surfaces of the video reels 151 to 155 for WILD FREE GAME. As shown in FIG. 30, a symbol array constituted by 46 symbols corresponding to code numbers “0” to “45” is allocated to each of the first and second video reels 151 and 152 (Reel 1 and Reel 2) of the video reel strips for the WILD FREE GAME; and a symbol array constituted by 47 symbols corresponding to code numbers “0” to “46” is allocated to each of the third to fifth video reels 153 to 155 (Reel 3 to Reel 5) of the video reel strips for the WILD FREE GAME.

In the WILD FREE GAME, a to-be-stopped symbol on each of the video reels 151 to 155 is determined each time the free game is executed, based on the random determination program stored in the memory card 53. The to-be-stopped symbols for the respective video reels 151 to 155 are displayed on the display window 150, with the result that 15 symbols are rearranged on the display window 150.

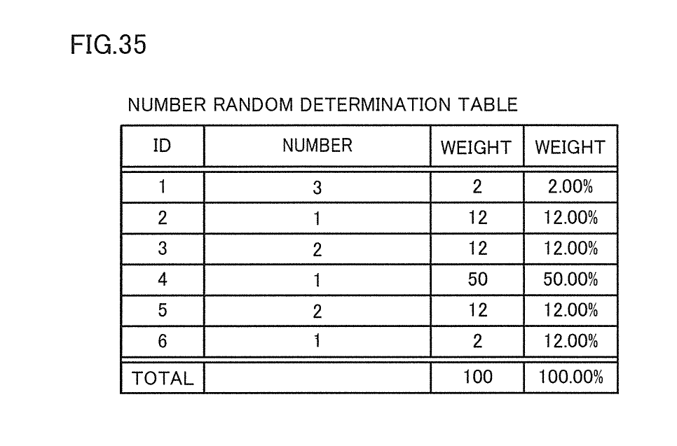

In the WILD FREE GAME, a number random determination process of determining the number of WILD symbols newly displayed in a fixed manner in the free game based on a number random determination table (see FIG. 35) included in the random determination program is executed each time the free game is executed. In the number random determination process, the number of WILD symbols newly displayed in a fixed manner is selected by random determination from the three numbers: 1, 2, and 3.

In the number random determination table shown in FIG. 35, ID numbers of 1 to 6 are respectively associated with the numbers of 3, 1, 2, 1, 2 and 1. For example, the ID number 3 is associated with the number of 2. The ID numbers 1 to 6 are respectively associated with weights. Each weight represents the probability that the number in association with the corresponding ID number is selected in the number random determination process. For example, as shown in FIG. 35, the probability that the number of 2 associated with the ID number 3 is selected in the number random determination process is 12/100.

The result of the random determination in the number random determination process is reported to the player by the WILD FREE GAME wheel 190 displayed on the terminal image display panel 16. As shown in FIG. 36A, the WILD FREE GAME wheel 190 includes: a wheel 192 having six areas 191 (see FIG. 36B) respectively associated with the ID numbers in the number random determination table; and an indicator 193 displayed in a fixed manner for indicating a winning area 191. Note that in the present embodiment, only a part of the wheel 192 is displayed on the terminal image display panel 16.

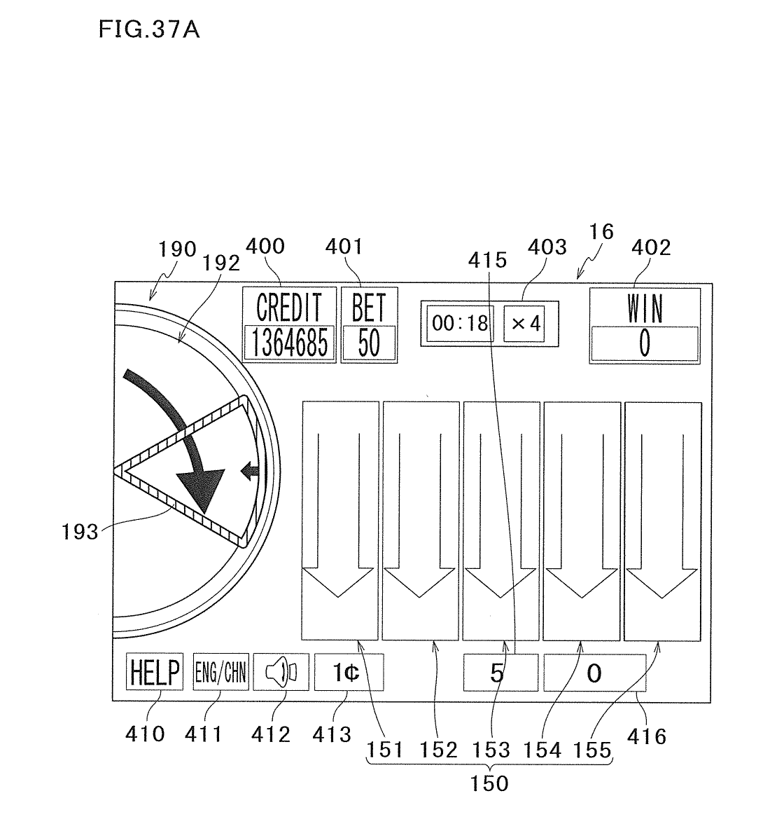

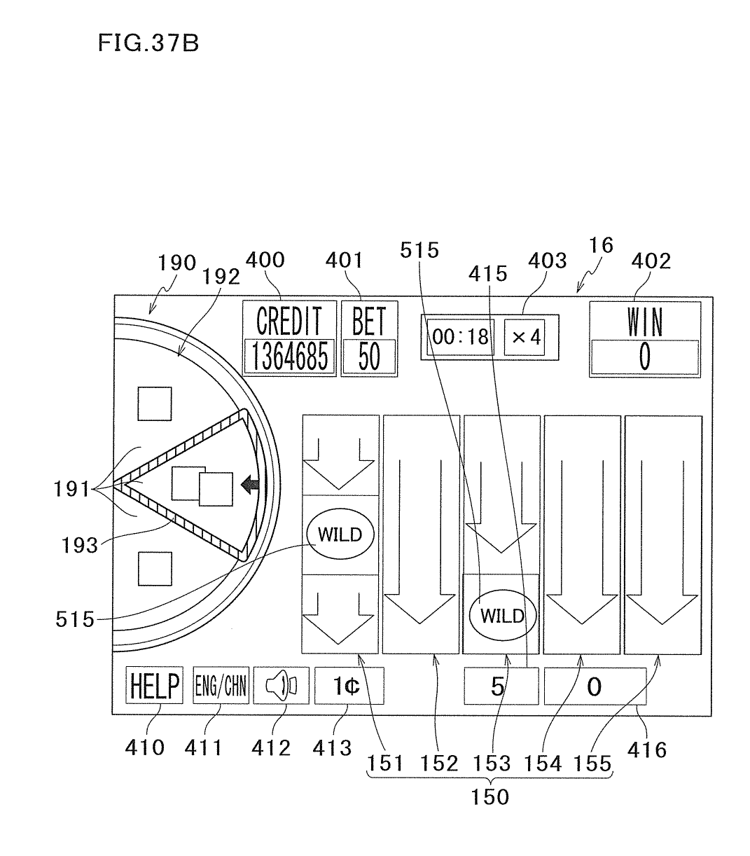

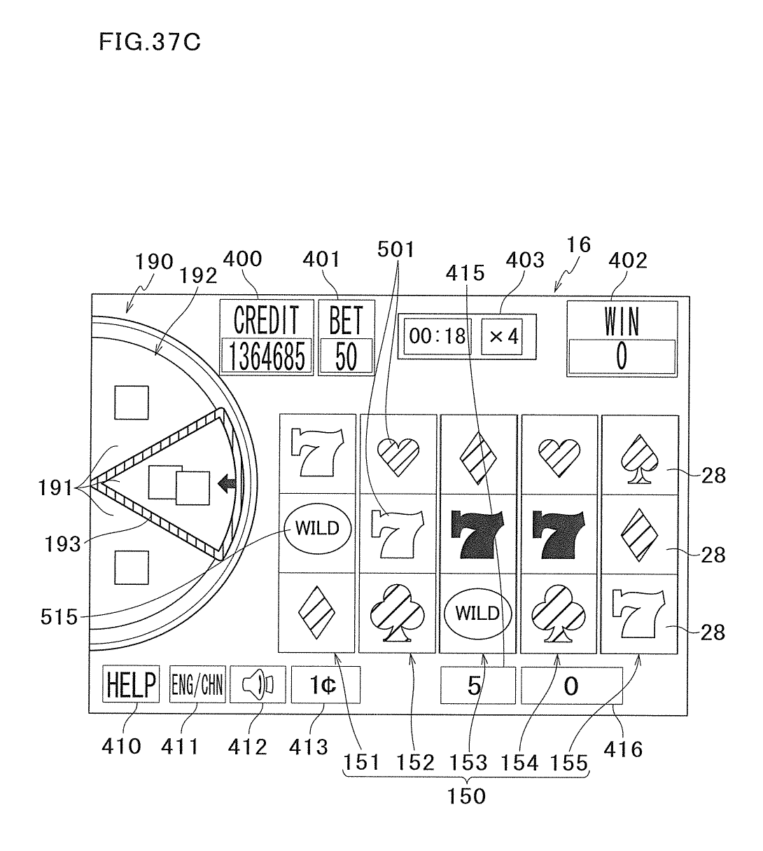

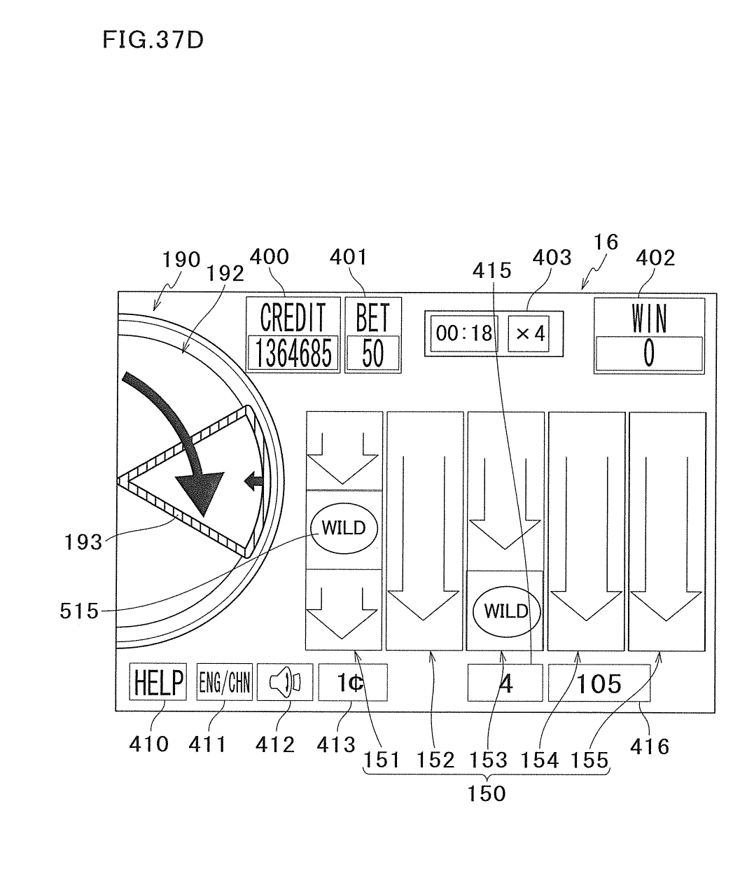

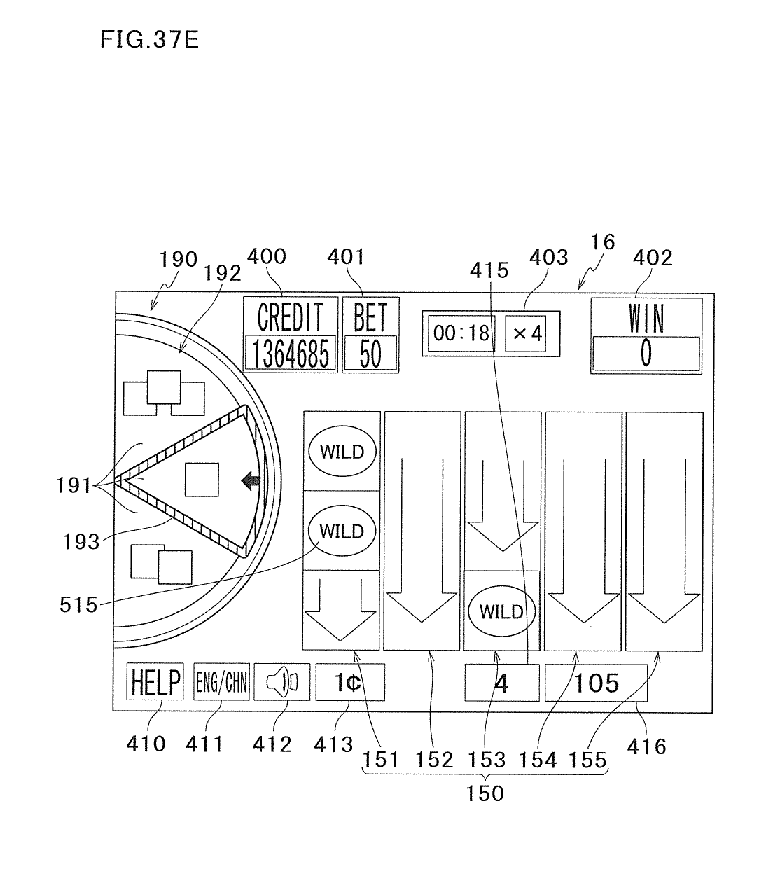

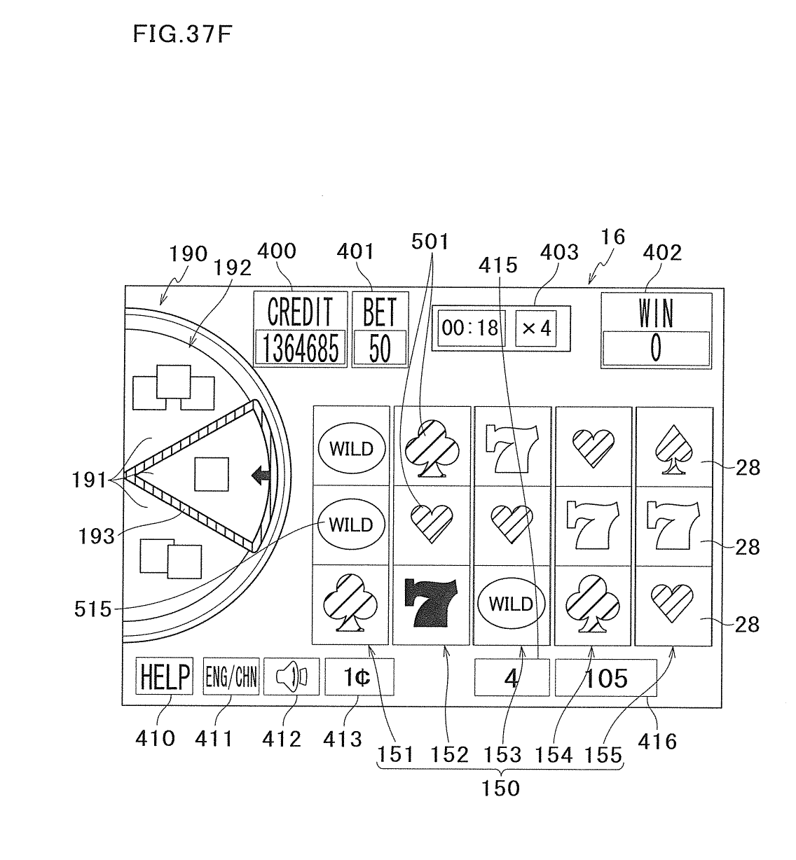

In the WILD FREE GAME, when the free game is started in response to pressing of the spin button 29, rotation of the wheel 192 is first started as shown in FIG. 37A, and scrolling of the video reels 151 to 155 is started. After a predetermined period elapses from the start of the rotation of the wheel 192, the rotation of the wheel 192 is stopped, as shown in FIG. 37C. Then, a fixed display process of displaying, in a fixed manner, the “WILD” symbol(s) 515 of which number is equal to the number associated with the ID number corresponding to the area 191 indicated by the indicator 193, on some of the 15 display blocks 28 of the display window 150. Note that the display block(s) 28 where the “WILD” symbol(s) 515 is/are displayed is/are randomly determined.

In the present embodiment, as shown in FIG. 37B, the “WILD” symbols 515 are displayed on the display window 150 in a fixed manner while the scrolling of the video reels 151 to 155 continues. The symbols on the circumferential surfaces of the video reels 151 to 155 are displayed, skipping the display blocks 28 where the “WILD” symbols 515 are displayed in a fixed manner. For example, when the display block 28 where the “WILD” symbol 515 is displayed in a fixed manner on the video reel 151 is the area in the central stage and the symbol of “YELLOW7” with the code number 19 is to be displayed on the display block 28 in the upper stage, the symbol of “F_DIAMOND” with the code number 20 is displayed on the display block 28 in the lower stage, skipping the display block 28 in the middle stage. Alternatively, in a modification, there is not adopted the above arrangement such that the symbols on the circumferential surfaces of the video reels 151 to 155 are displayed, skipping the display blocks 28 where the “WILD” symbols 515 are displayed in a fixed manner. That is, there may be arranged such that when the display block 28 where the “WILD” symbol 515 is displayed in a fixed manner on the video reel 151 is the area in the central stage and the symbol of “YELLOW7” with the code number 19 is to be displayed on the display block 28 in the upper stage, the symbol of “RED7” with the code number 21 is displayed on the display block 28 in the lower stage.

As shown in FIG. 37C, the scrolling of the video reels 151 to 155 is stopped after a predetermined period elapses from the display of the “WILD” symbol(s) 515 in a fixed manner. Then, the payout obtained in the free game is determined based on one or more combinations made by the 15 symbols 501 rearranged on the display window 150, referring to the free game payout table shown in FIG. 29.

Once the “WILD” symbol 515 is displayed in a fixed manner on a display block 28, the “WILD” symbol 515 remains displayed on the display block 28 in the free game executed thereafter, as shown in FIG. 37D. Further, as shown in FIG. 37E, the number random determination process and the fixed display process are executed in the second and subsequent times of execution of the free game. That is, the number of “WILD” symbols 515 displayed on the display window 150 in a fixed manner in each of the second and subsequent times of execution of the free game is obtained by adding the number of “WILD” symbols determined in the number random determination process of the current execution of the free game to the total number which is the sum of the numbers of “WILD” symbols determined in the number random determination processes of the free game executed before. For example, assuming that: the number of “WILD” symbols determined in the number random determination process in the first-time execution of the free game is 2; and the number of “WILD” symbols determined in the number random determination process in the second-time execution of the free game is 1, the total number of “WILD” symbols 515 displayed in a fixed manner when symbols are rearranged on the display window 150 in the second run of the free game is 3, as shown in FIG. 37F. Thus, in the WILD FREE GAME, with an increase in the number of times of execution of the free game, the number of “WILD” symbols 515 displayed in a fixed manner increases, and this increases the possibility of obtaining a payout.

(Common Game)

Now, the common game will be described. The common game is executed while one or more gaming terminals 10 qualified to participate in the common game are synchronized with one another. Whether each gaming terminal 10 is qualified to participate in the common game is determined based on the qualification time of the gaming terminal 10. The qualification time is a period of time for which the gaming terminal 10 is qualified to participate in the common game, and is determined based on the gaming situation of the normal game at the gaming terminal 10. Specifically, an amount of qualification time is awarded at the following timings when: the spin button 29 is pressed by a player in the base game; when shifting from the base game to the BONUS WHEEL game occurs; when shifting from the BONUS WHEEL game to the BONUS CHANCE WHEEL game occurs; when shifting from the BONUS CHANCE WHEEL game to any of the three types of free games occurs; when shifting from the BONUS CHANCE WHEEL game to the progressive challenge occurs; and when the right to shift to the BONUS CHANCE WHEEL game is obtained during execution of the common game. The following describes the amount of qualification time awarded at each of the above timings.

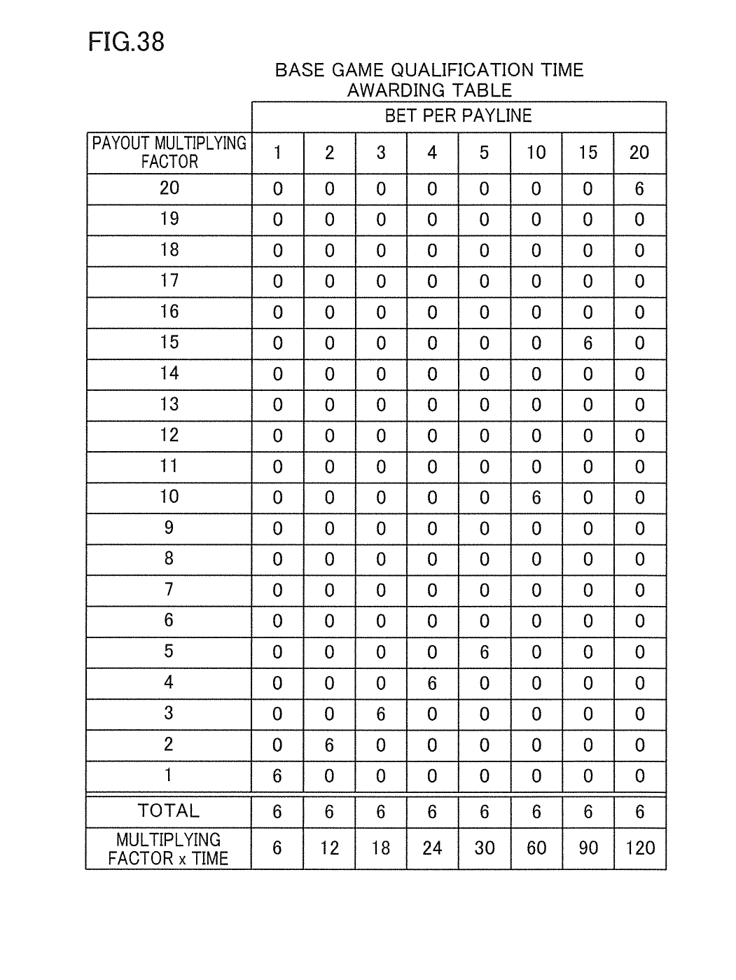

FIG. 38 shows a base game qualification time awarding table which is referred to when the spin button 29 is pressed by the player in the base game. The base game qualification time awarding table is stored in the RAM 243 of the center controller 200 (other qualification time awarding tables are also stored in the RAM 243). In the base game qualification time awarding table, for each credit amount bet per payline (BET PER PAYLINE), an amount of qualification time to be awarded in the base game is associated with a payout multiplying factor in the common game (hereinafter, also referred to as a common game payout multiplying factor).

In the present embodiment, 6 seconds of qualification time is awarded uniformly irrespective of the credit amount bet per payline in the base game. However, the payout multiplying factor associated with the 6 seconds of qualification time differs depending on the credit amount bet per payline in the base game. For example, when the credit amount bet per payline in the base game is 1, the payout multiplying factor during the awarded 6 seconds of qualification time is 1. When the credit amount bet per payline in the base game is 5, the payout multiplying factor during the awarded 6 seconds of qualification time is 5. As such, the larger the credit amount bet per payline in the base game is, the larger the payout multiplying factor associated with the awarded amount of qualification time.

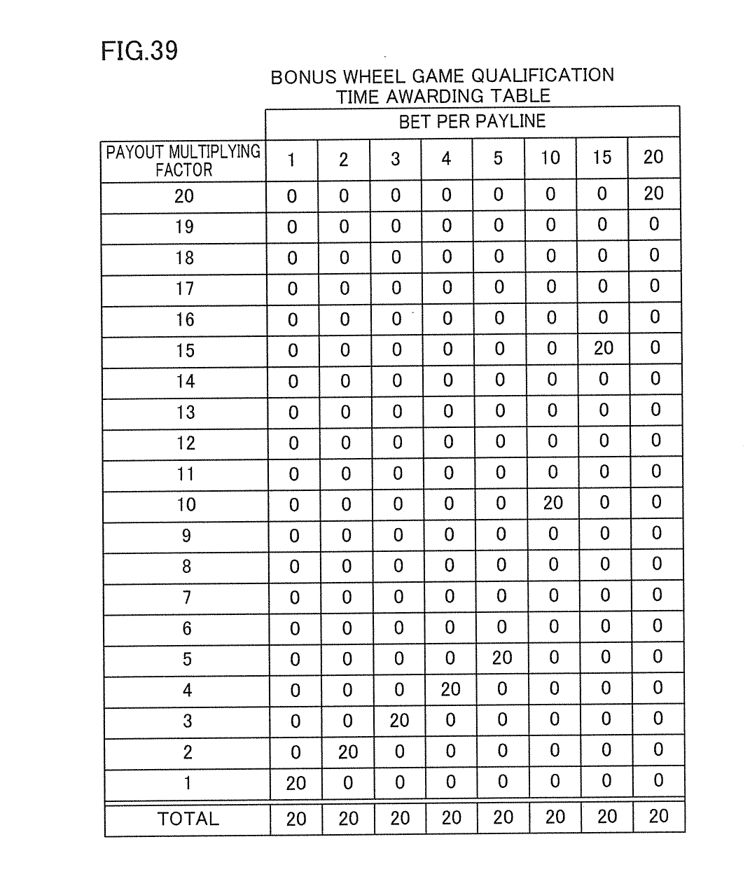

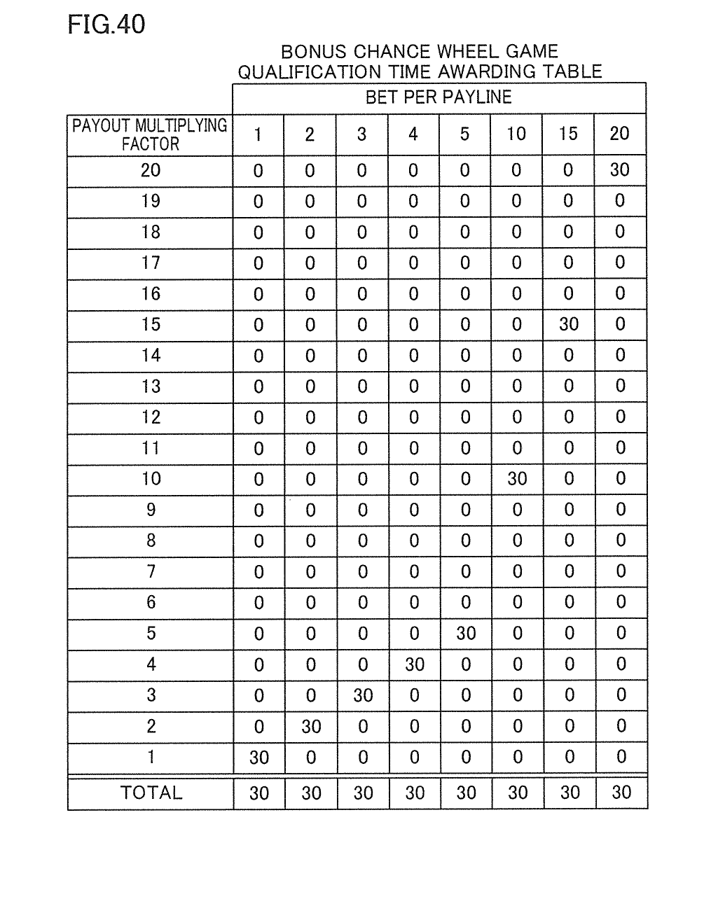

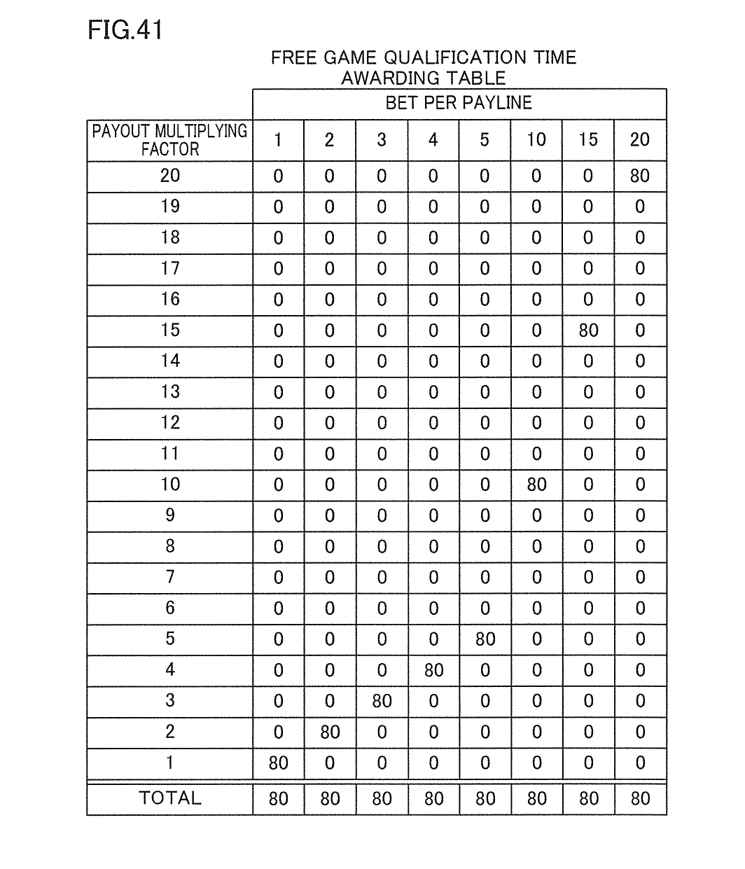

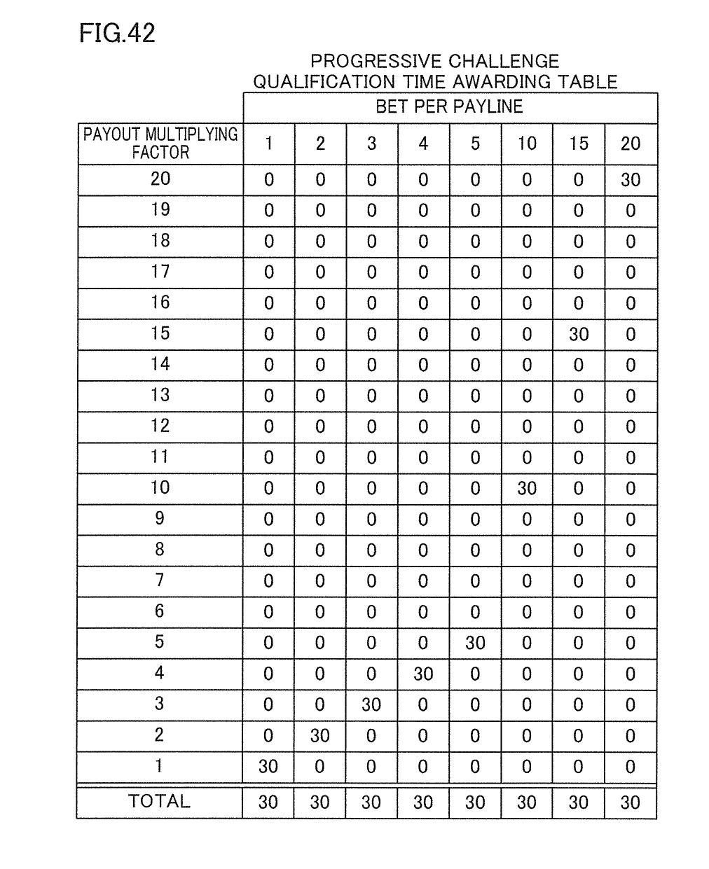

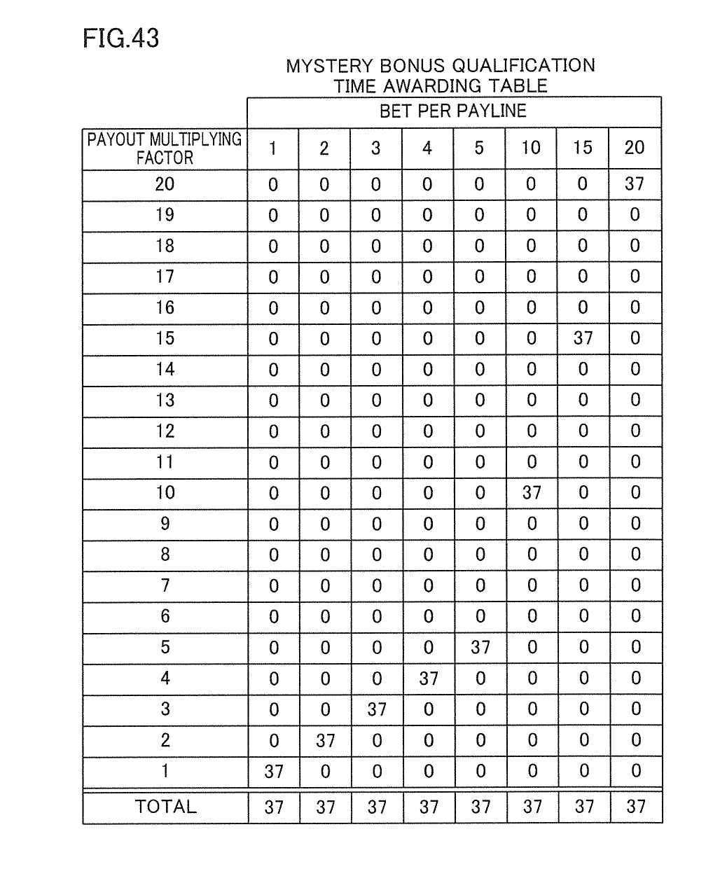

The same applied also in the BONUS WHEEL game qualification time awarding table (see FIG. 39) which is referred to when shifting from the base game to the BONUS WHEEL game occurs; the BONUS CHANCE WHEEL game qualification time awarding table (see FIG. 40) which is referred to when shifting from the BONUS WHEEL game to the BONUS CHANCE WHEEL game occurs; the free game qualification time awarding table (see FIG. 41) which is referred to when shifting from the BONUS CHANCE WHEEL game to any of the three types of free games occurs; the progressive challenge qualification time awarding table (see FIG. 42) which is referred to when shifting from the BONUS CHANCE WHEEL game to the progressive challenge occurs; and the mystery bonus qualification time awarding table (see FIG. 43) which is referred to when the right to shifting to the BONUS CHANCE WHEEL game is obtained during execution of the common game. That is, in the same way as in the base game qualification time awarding table, for each credit amount bet per payline (BET PER PAYLINE), an amount of qualification time to be awarded is associated with a payout multiplying factor in the common game.

(Common Game Qualification Time Management Table)

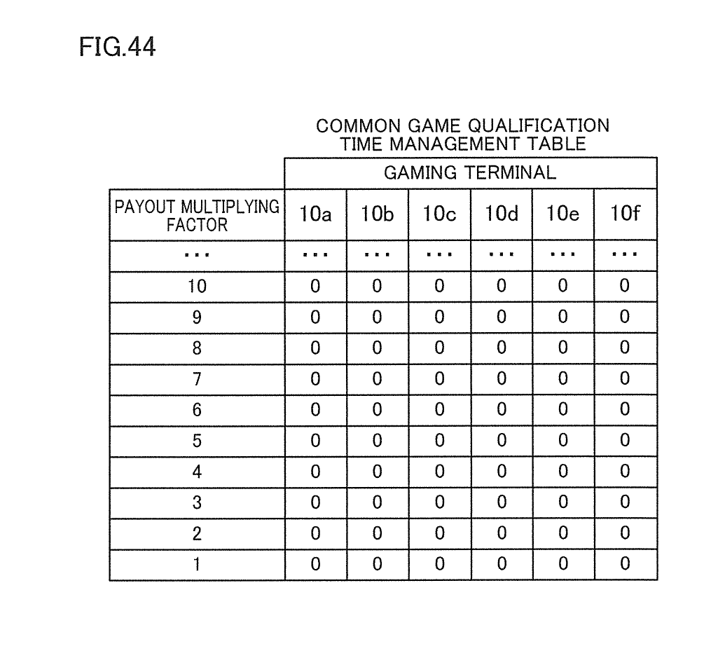

The qualification time of each gaming terminal 10 is managed in a common game qualification time management table (corresponding to a counter in the present invention) which is temporarily stored in the RAM 243. FIG. 44 shows the common game qualification time management table which is updated when an amount of game qualification time is awarded. In the common game qualification time management table, amounts of qualification time awarded for each payout multiplying factor are accumulatively stored (counted) for each gaming terminal 10.

For example, the qualification time of the gaming terminal 10a is constituted by: 6 seconds for the payout multiplying factor of 1, 12 seconds for the payout multiplying factor of 2, 18 seconds for the payout multiplying factor of 3, and 6 seconds for the payout multiplying factor of 4. When the gaming terminal 10a in this state participates in the common game and a unit payout amount is awarded, the unit payout amount is multiplied by 4, which is the highest multiplying factor, to be awarded. The payout multiplying factor indicator 403 of the gaming terminal 10a therefore displays “4×” which indicates that the payout multiplying factor is 4, and also displays the qualification time corresponding thereto, which is 6 seconds.

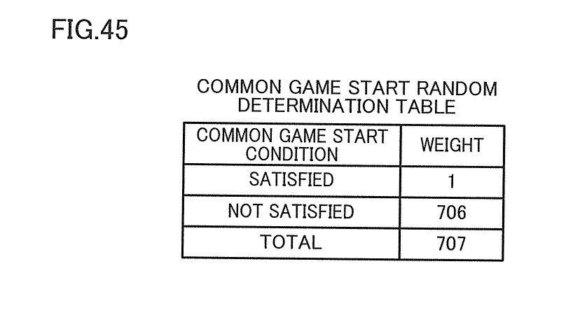

Every time the center controller 200 receives time information from the timer 271 (i.e., at constant time intervals: in the present embodiment, every second) a common game start random determination for determining whether a common game start condition to start the common game is satisfied is performed with reference to a common game start random determination table shown in FIG. 45.

(Common Game Start Random Determination Table)

As shown in FIG. 45, the common game start random determination table defines weights for the cases where the common game start condition is satisfied (“satisfied”) and where the common game start condition is not satisfied (“not satisfied”), respectively. Each weight represents the probability that corresponding one of items of “the common game start condition is satisfied” and “the common game start condition is not satisfied” is selected in the common game start random determination. That is, the common game start condition is satisfied with a probability of 1/707, and is not satisfied with a probability of 706/707.

Only the gaming terminal 10 having the qualification time is allowed to participate in the common game start random determination. In other words, the gaming terminal 10 which does not have the qualification time and which therefore does not participate in the common game start random determination cannot participate in the common game.

In the present embodiment, each time the gaming terminal participates in the common game start random determination, a unit time (the time interval between the common game start random determinations) is subtracted from the qualification time, from the qualification time for the highest multiplying factor. As described above, the common game start random determination is performed at the predetermined time intervals (in the present embodiment, every second), and therefore the qualification time is reduced at the predetermined intervals on condition of participating in the common game start random determination. Therefore, when some amount of qualification time is not awarded to the gaming terminal 10a in the situation shown in FIG. 44 within 6 seconds, the 6 seconds for the multiplying factor of 4 are consumed, and the multiplying factor of 3 becomes the highest payout multiplying factor.

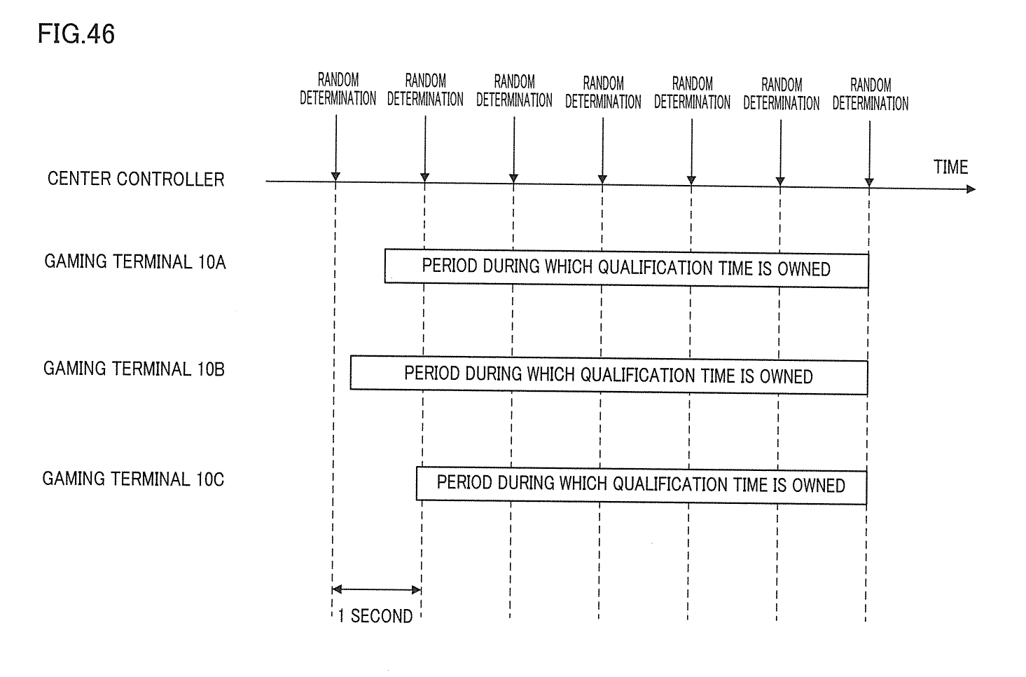

Note that the period of time from the timing when an amount of qualification time is awarded to the start of reduction of the qualification time by the unit time is not limited to 1 second. That is, there is a case where the amount of qualification time awarded does not match the period of time during which the qualification time is owned. For example, it is assumed that 6 seconds of qualification time is awarded to each of the gaming terminals 10a to 10c, as shown in FIG. 46. As shown in FIG. 46, although there is a difference among the gaming terminals 10a to 10c in the timing when the 6-second qualification time is awarded (the timing when the 6-second qualification time is obtained), the timing when the qualification time becomes zero is the same among all the gaming terminals 10a to 10c. This prevents a difference among the gaming terminals 10 in the number of times of execution of the common game start random determination executed before the amount of qualification time awarded as a result of one-time execution of the base game is completely consumed. Consequently, this motivates the player to continue the base game and also to participate in the common game, with the result that the entertainment factor of the gaming machine 300 is further enhanced.

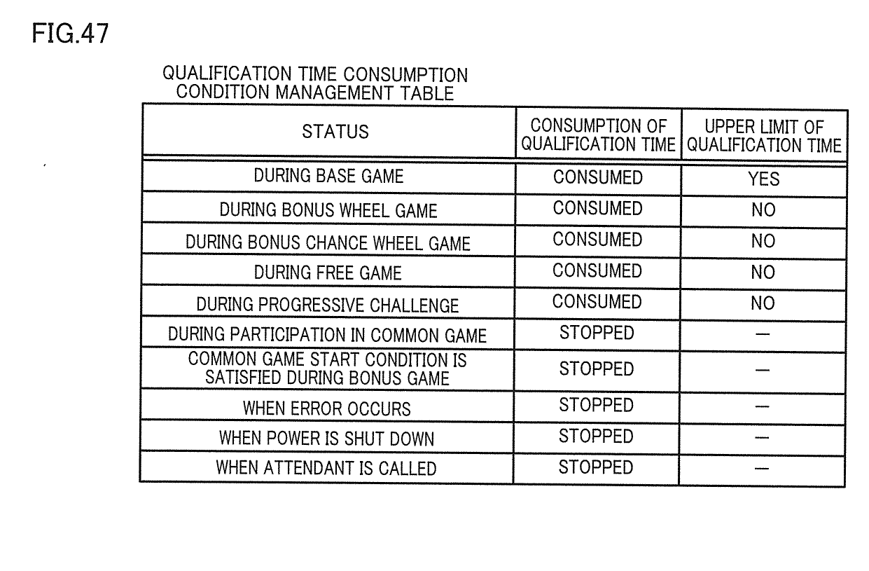

Note that, in the present embodiment, an amount of qualification time is not additionally added to each gaming terminal 10 participating in the common game. Further, if the qualification time of each gaming terminal 10 participating in the common game is also reduced during execution of the common game, there is a possibility that the qualification time of the gaming terminal 10 participating in the common game becomes zero at the end of the common game. As a result, the above gaming terminal 10 cannot participate in the common game even if the common game start condition is satisfied again, and this may be a disincentive for the player to continue to the game. Thus, in the present embodiment, as shown in FIG. 47, the qualification time is not reduced for each gaming terminal 10 participating in the common game. This motivates the player to participate in the common game, with the result that the entertainment factor of the gaming machine 300 is enhanced.

Further, as shown in FIG. 47, when the common game start condition is satisfied during execution of the bonus game by a gaming terminal 10, the start of the common game is suspended until the bonus game ends in the gaming terminal 10. In the present embodiment, the qualification time is not reduced during the period in which the start of the common game is suspended. Note that each gaming terminal 10 cannot participate in the common game start random determination in the situation where its qualification time is not reduced. In other words, even if the common game start condition is satisfied in the situation where the qualification time is not reduced, a mystery bonus or the like, which will be described later, is not awarded to the gaming terminal 10. Further, as shown in FIG. 47, the qualification time is not reduced when an error occurs and when an attendant is called.

(Maximum Qualification Time Table)

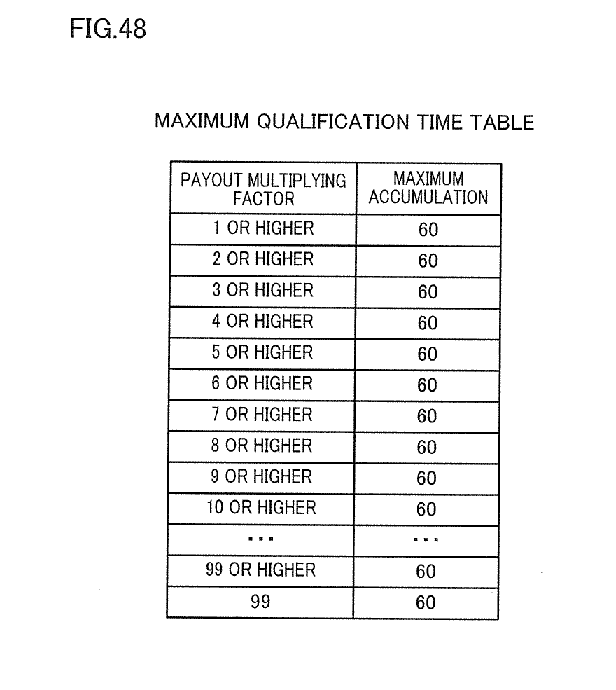

In addition to the above, the upper limit of the qualification time that each gaming terminal 10 can accumulatively store is defined in the maximum qualification time table in advance. The maximum qualification time table is stored in the RAM 243 of the center controller 200. As shown in FIG. 48, in the maximum qualification time table, each payout multiplying factor is associated with the maximum accumulation of the game qualification time. In the present embodiment, the upper limits of the accumulation of the game qualification time respectively associated with the payout multiplying factors are the same, i.e., 60 seconds.

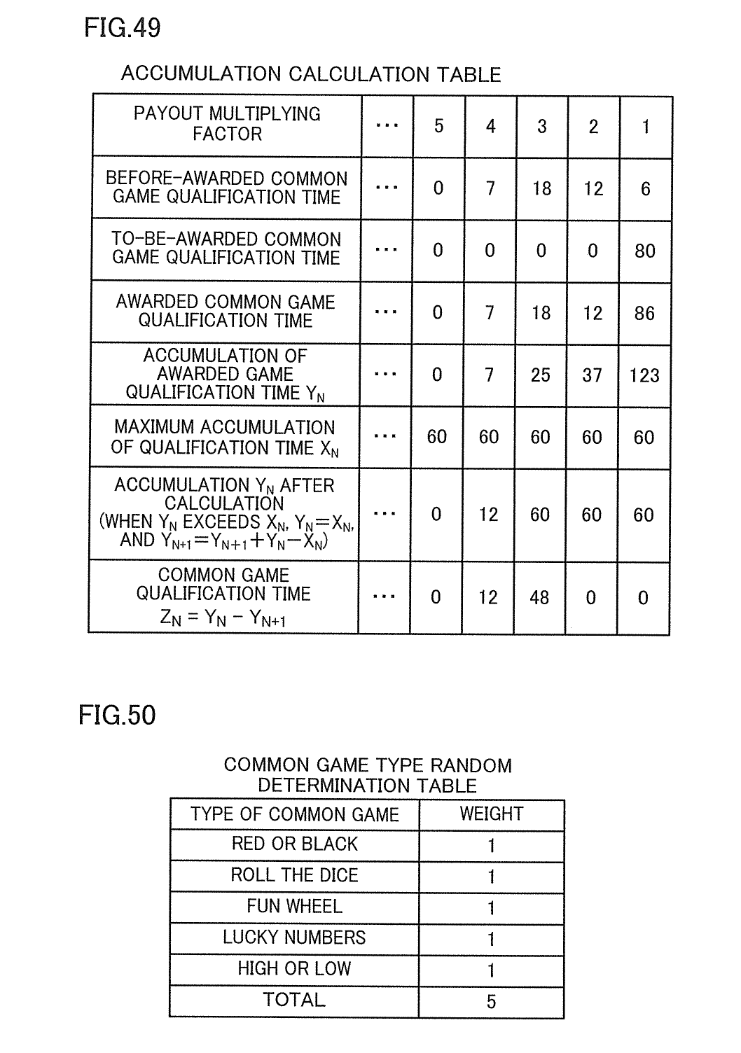

In the present embodiment, as shown in the accumulation calculation table of FIG. 49, when the total time calculated by summing up the qualification times for all the payout multiplying factors which have been awarded during the base game exceeds 60 seconds, a subtraction process of reducing the qualification time for a payout multiplying factor so that the total time is 60 seconds. In other words, the total time calculated by summing up the qualification times for all the payout multiplying factors is limited within 60 seconds. Meanwhile, when the total time calculated by summing up the qualification times for all the payout multiplying factors which are awarded during the bonus game (the BONUS WHEEL game, BONUS CHANCE WHEEL game, free game, and progressive challenge) exceeds 60 seconds, the above subtraction process of reducing the qualification time is not performed. However, when the total time calculated by summing up the qualification times for all the payout multiplying factors exceeds 60 seconds after the bonus game is over, the above subtraction process is performed. The above arrangement reduces the possibility that the qualification time is completely consumed during the bonus game.

(Accumulation Calculation Table)

When a qualification time is awarded, with reference to the above-described maximum qualification time table, calculation for updating the common game qualification time management table is carried out by using an accumulation calculation table. The accumulation calculation table is stored in the RAM 243 of the center controller 200. As shown in FIG. 49, the accumulation calculation table stores the following items for each payout multiplying factor. The stored items are: “before-awarded qualification time” in the common game qualification time management table; “to-be-awarded amount of game qualification time” from each qualification time awarding table; “awarded game qualification time” calculated by adding the “before-awarded game qualification time” to the “to-be-awarded amount of game qualification time”; “accumulation of awarded game qualification time” for all the payout multiplying factors; “maximum accumulation of qualification time” of each payout multiplying factor set out in the maximum qualification time table; “value of the excess over the maximum accumulation of qualification time”; and “value after subtraction of the excess over the maximum accumulation of qualification time” calculated by subtracting the “value of the excess over the maximum accumulation of qualification time” from the “accumulation of awarded game qualification time”.

For example, assuming that (i) the before-awarded common game qualification times are as follows: 0 second for each of the multiplying factors 5 or more; 7 seconds for the multiplying factor 4, 18 seconds for the multiplying factor 3, 12 seconds for the multiplying factor 2, and 6 seconds for the multiplying factor, and (ii) shifting from the BONUS CHANCE WHEEL game to any one of the three types of the free games occurs in the situation where 1 credit is bet per payline in the base game, 80 seconds corresponding to the multiplying factor 1 (see the free game qualification time awarding table of FIG. 41) is to be added to the common game qualification time. In this case, the awarded common game qualification time is as follows: 7 seconds for the multiplying factor 4, 18 seconds for the multiplying factor 3, 12 seconds for the multiplying factor 2, and 86 seconds for the multiplying factor 1. As a result, the accumulation of the qualification times for the multiplying factors of N or higher (Y_{N}) is as follows: 7 seconds for the multiplying factors of 4 or higher, 25 seconds for the multiplying factors of 3 or higher, 36 seconds for the multiplying factors of 2 or higher, and 123 seconds for the multiplying factors of 1 or higher.

However, the maximum qualification time table defines the upper limit of 60 seconds for each payout multiplying factor. The above 123 seconds for the payout multiplying factors 1 or higher exceed the maximum accumulation X_{N}. In this case, 60 seconds equal to the maximum accumulation is adopted as a new accumulation for the multiplying factor of 1, and the difference therebetween, 63 seconds, is added to the accumulation for the multiplying factor of 2. As a result, the accumulation for the multiplying factor of 2 becomes 100 seconds, and thus the upper limit of 60 seconds is adopted as a new accumulation for the multiplying factor of 2. Then, the difference therebetween, 40 seconds, is added to the accumulation for the multiplying factor of 3. As a result, the accumulation for the multiplying factor of 3 becomes 65 seconds, and thus the upper limit of 60 seconds is adopted as a new accumulation for the multiplying factor of 3. Then, the difference therebetween, 5 seconds, is added to the accumulation for the multiplying factor of 4. As a result, the accumulation for the multiplying factor of 4 becomes 12 seconds, which is not higher than the upper limit of 60 seconds, and therefore the accumulation for the multiplying factor of 4 is 8 seconds. That is, when Y_{N} exceeds X_{N}, the following calculation is repeated from the value for the smallest multiplying factor: Y_{N}=X_{N}, and Y_{N+1}=Y_{N}+1+Y_{N}−X_{N}.

Then, the qualification time Z_{N} for each payout multiplying factor is calculated from the formula Z_{N}=Y_{N}−Y_{N+1}, and the common game qualification time management table is updated referring to the calculation results. With the above calculation, the accumulation obtained by summing up values each calculated by multiplying each qualification time by the corresponding payout multiplying factor is unchanged between before and after the calculation.

Note that in the present embodiment, the amount of qualification time is awarded not only based on the running status of the base game, but also when, for example, shifting to a bonus game occurs (e.g., when shifting from the base game to the BONUS WHEEL game occurs), an amount of qualification time is specially awarded. If the gaming machine is arranged such that an amount of qualification time is not awarded when shifting to a bonus game occurs, the qualification time continues to decrease during the bonus game since the base game cannot be executed during the bonus game. Thus, in this arrangement, there is a possibility that the qualification time becomes zero at the end of the bonus game. As a result, such a gaming terminal 10 cannot participate in the common game even if the common game start condition is satisfied immediately after the end of the bonus game, and this may be a disincentive for the player to continue to the game. However, this embodiment is arranged such that an amount of qualification time is specially awarded when shifting to a bonus game occurs, and this decreases the possibility that the qualification time becomes zero at the end of the bonus game. Consequently, this motivates the player to continue the game, with the result that the entertainment factor is further enhanced.

When the common game is started after the common game start condition is satisfied, executed is a common game type random determination process of determining which type of common game is to be executed with reference to a common game type random determination table shown in FIG. 50. In the present embodiment, one of the following five types of common games is selected by random determination: RED OR BLACK game, ROLL THE DICE game, FUN WHEEL game, LUCKY NUMBERS game, and HIGH or LOW game. The common game type random determination table defines a weight for each of the five types of common games, and is stored in the RAM 243. Each weight represents the probability that the corresponding common game is selected in the common game type random determination. In the present embodiment, the probability that each of the common games is selected by the common game type random determination is set uniformly, i.e., the probability is ⅕.

(Common Game: Common Game Start Effect Image)

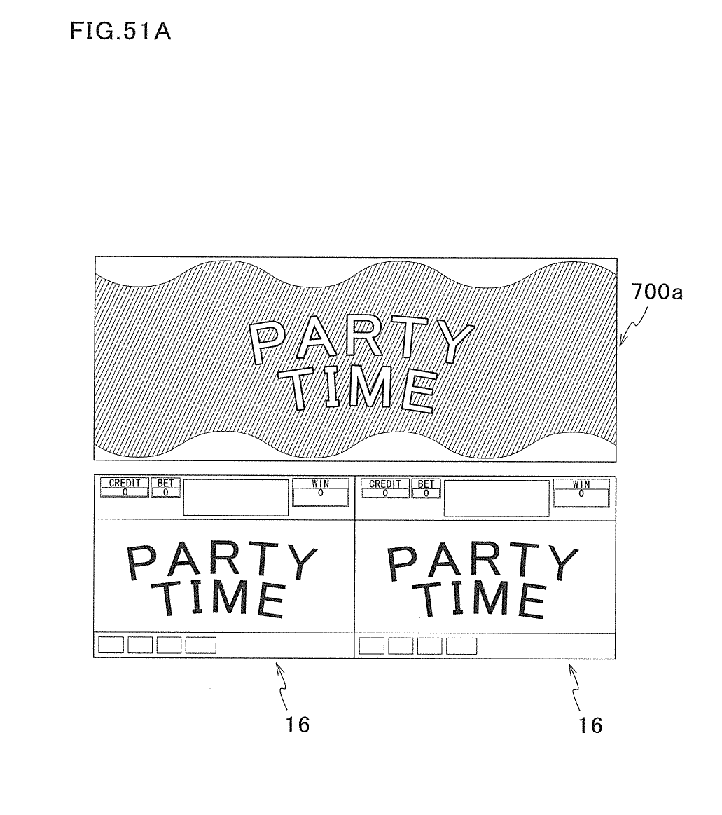

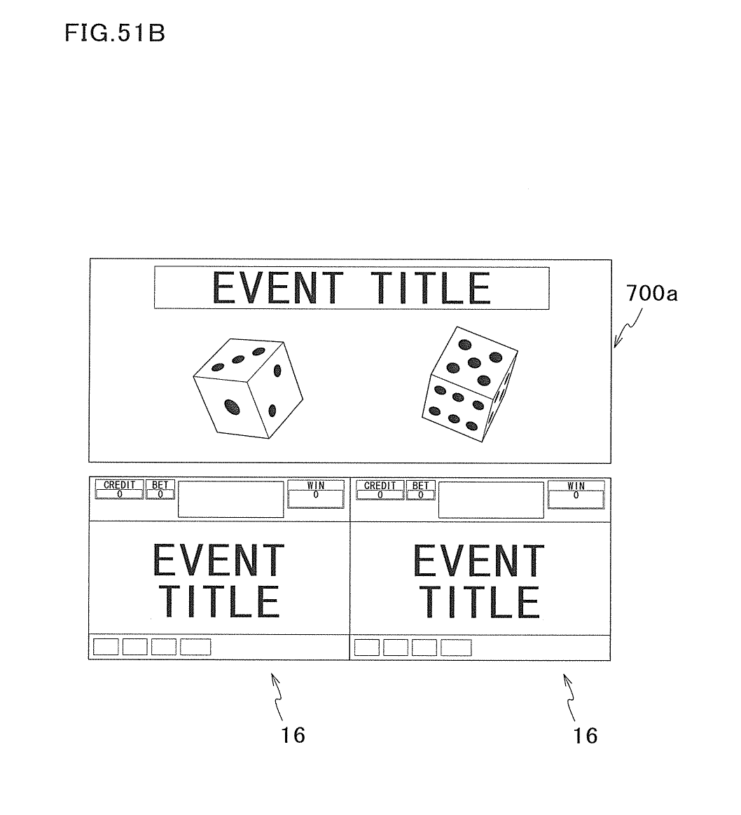

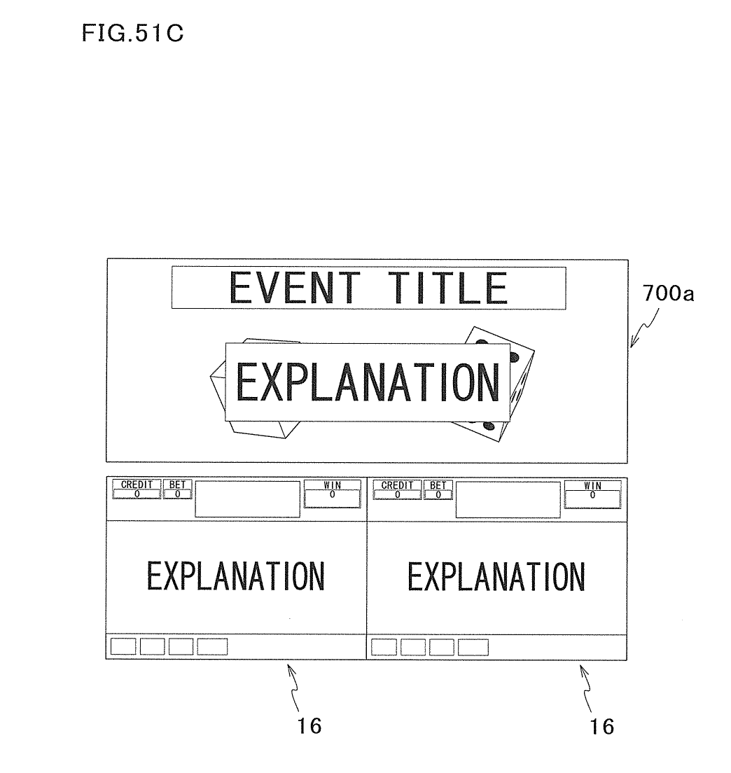

After which type of the common game is to be executed is determined, a common game start effect image corresponding to that common game is displayed. The common game start effect image is stored in the RAM 243 of the center controller 200. As shown in FIG. 51A, the same common game start effect image is displayed on the upper displays 700 and the terminal image display panel 16 of each of the gaming terminals 10 which participate in the common game. Then, after the title of the common game to be executed is displayed on the upper displays 700 and the terminal image display panel 16 of each of the gaming terminals 10 which participate in the common game (see FIG. 51B), the explanation for the contents of the common game to be executed is displayed. Note that in FIG. 51A to FIG. 51C, only the display screen of the upper display 700a out of the three upper displays 700 is illustrated.

In each common game, effects are provided using the upper displays 700 which are the three upper displays 700a, 700b, and 700c. In each common game, six persons participate as players. In the common game, each of gaming terminal 10 having the qualification time is given the role of the player. If the number of the gaming terminals 10 participating in the common game is smaller than 6, the center controller 200 plays, by auto play, the role(s) of the player(s) to which no gaming terminal 10 having the qualification time is allocated. On each gaming terminal 10 which do not participate in the common game, the normal game (base game) is able to be executed even during execution of the common game.

(RED OR BLACK GAME)

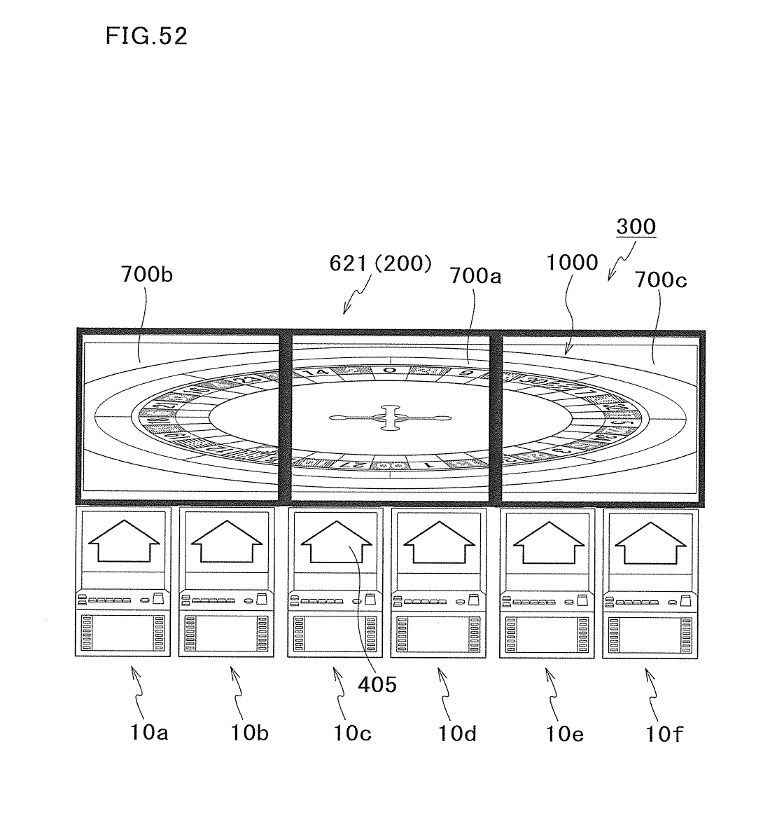

Now, the RED OR BLACK game will be described. FIG. 52 illustrates a display state on the upper displays 700 during the RED OR BLACK game. In FIG. 52, all the gaming terminals 10 are executing the common game, and the look-up images 405 are respectively displayed on the terminal image display panels 16 of all the gaming terminals 10. One roulette 1000 is displayed on the common effect display screen of the upper displays 700.

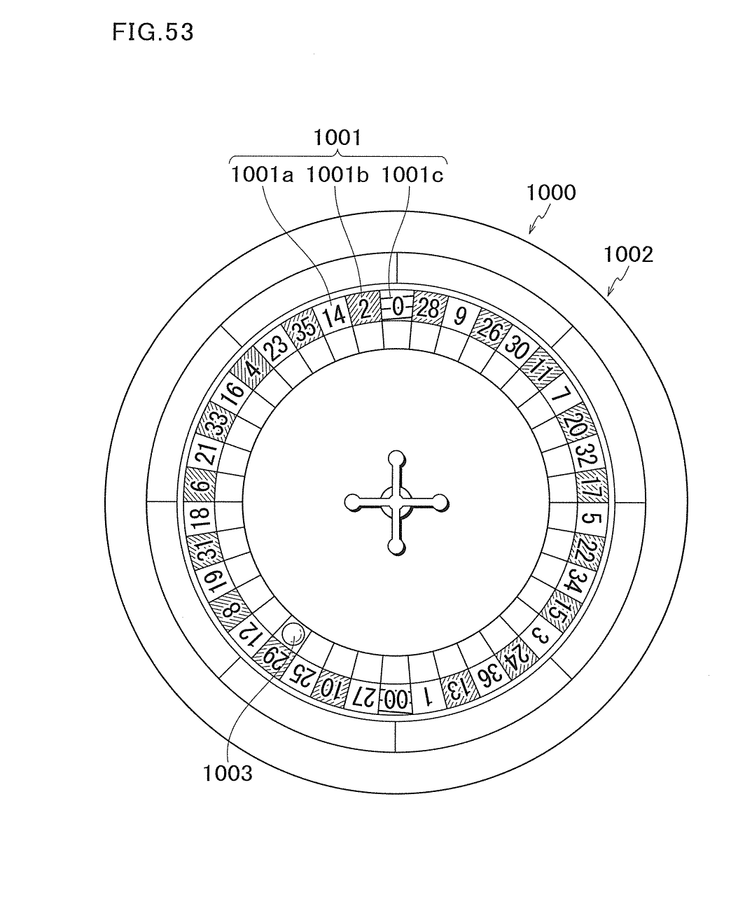

As shown in FIG. 53, the roulette 1000 includes: a wheel 1002 having 38 areas 1001; and a ball 1003 for indicating a winning area 1001. The 38 areas 1001 are constituted by: 18 red areas 1001a colored in red; 18 black areas 1001b colored in black; and 2 green areas 1001c colored in green. The 38 areas 1001 are respectively associated with numbers different from each other. Specifically, the red areas 1001a are associated with 18 numbers out of 36 numbers which are “1” to “36”, and the black areas 1001b are associated with the remaining 18 numbers. The green areas 1001c are respectively associated with the numbers “0” and “00”.

In the RED OR BLACK game, after the gaming terminals 10 are divided into two groups of a red group and a black group, a roulette game is executed once or twice. The roulette game is executed in the following manner: if the area 1001 where the ball 1003 thrown into the wheel 1002 stops is a red area 1001a, a payout is awarded only to the gaming terminal(s) 10 pertaining to the red group; and if the area 1001 where the ball 1003 stops is a black area 1001b, a payout is awarded only to the gaming terminal(s) 10 pertaining to the black group. The roulette game is executed twice only when the ball 1003 stops on one of the green areas 1001c in the first-time execution of the roulette game.

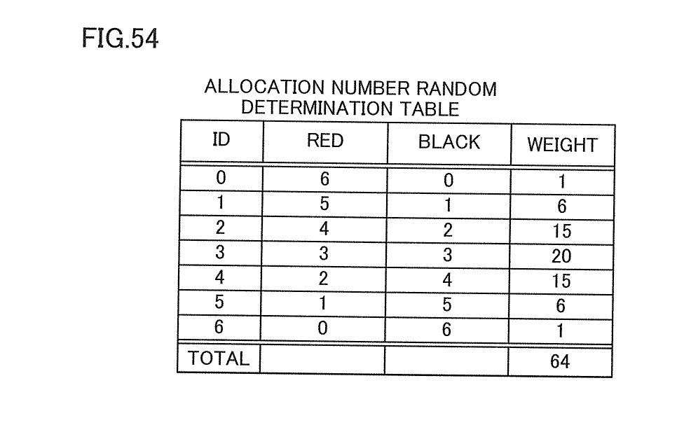

In the RED OR BLACK game, executed is an allocation number random determination process of determining the number of gaming terminals allocated to each of the red and black groups, based on the random determination program stored in the memory card 263. The random determination program includes an allocation number random determination table shown in FIG. 54. The allocation number random determination table defines a weight for each of seven allocation patterns each defining the number of the gaming terminals allocated to each of the red and black groups. Each weight represents the probability that the corresponding allocation pattern is selected in the allocation number random determination process. For example, the probability that six gaming terminals 10 are divided in such a manner that two of them are allocated to the red group and four of them are allocated to the black group is 15/64.

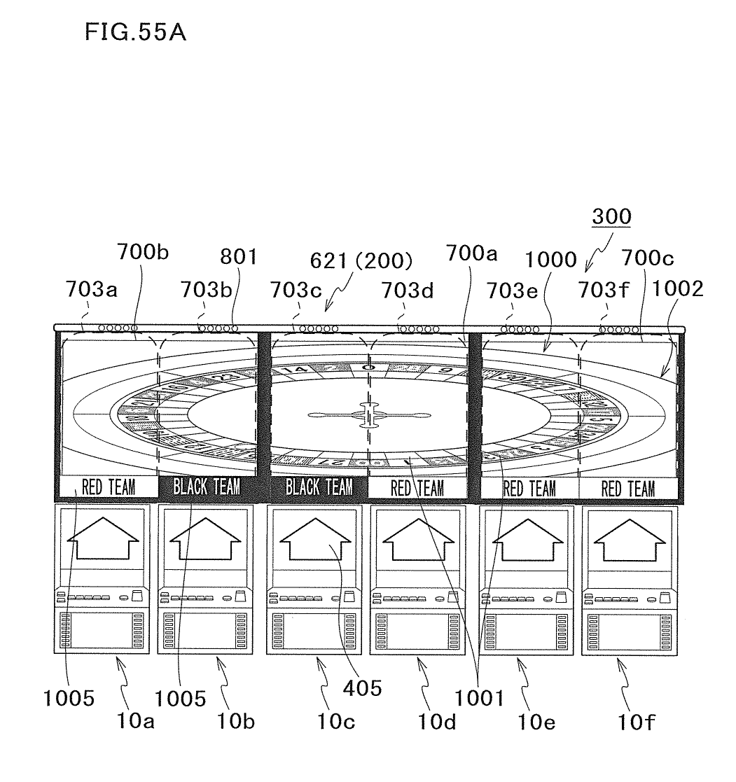

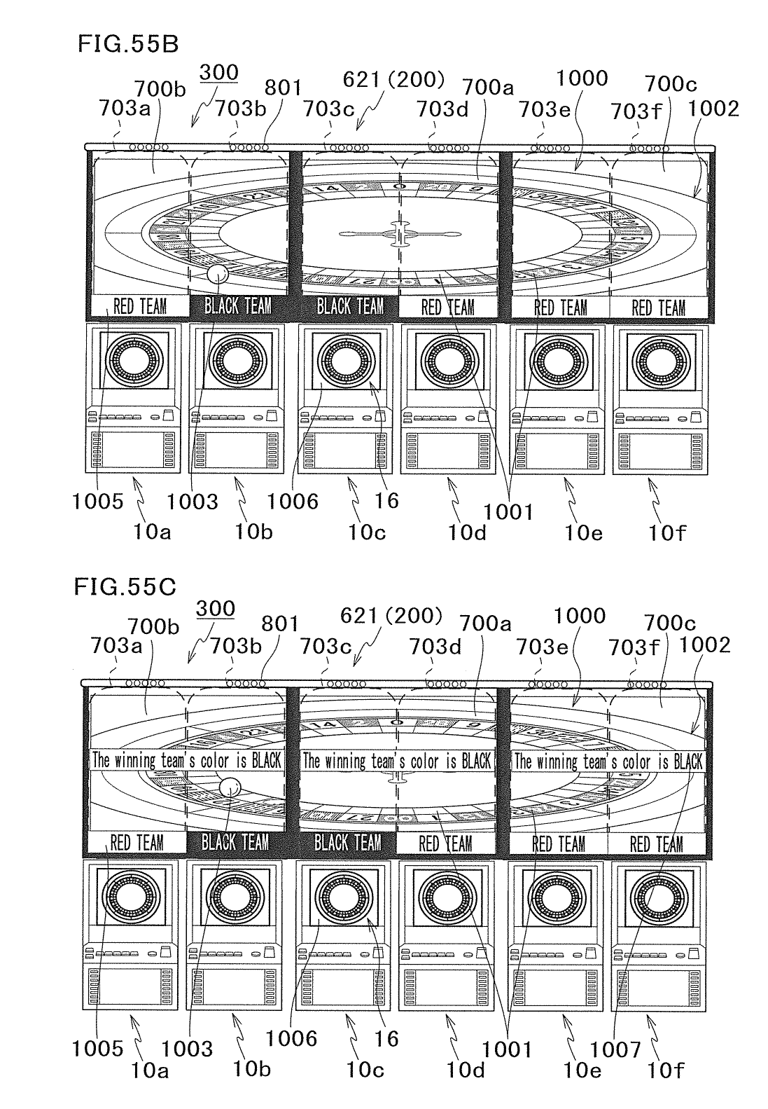

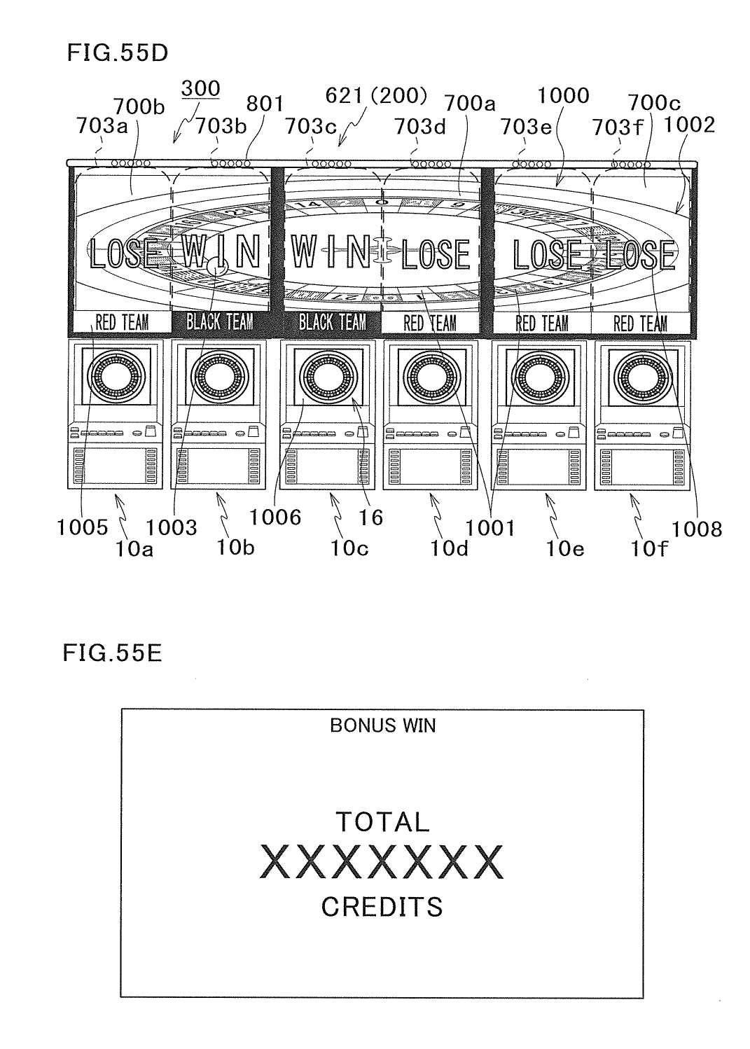

Then, executed is a group determination process of determining which of the groups each gaming terminal 10 pertains to, in accordance with the allocation pattern determined in the allocation number random determination process. After the group determination process, images 1005 each indicating the group to which the corresponding gaming terminal 10 pertains are respectively displayed on the gaming terminal areas 703a to 703f, as shown in FIG. 55A. This enables each player to recognize the group to which the player pertains to, i.e., the red group or the black group.

In the roulette game, as shown in FIG. 55B, the upper displays 700 display thereon a roulette effect image making it look as if the roulette game is executed thereon. Specifically, the upper displays 700 display thereon the roulette effect image showing that the ball 1003 is moved on the wheel 1002 of the roulette 1000, and then the speed of the movement is reduced to stop the ball 1003 any one of the 38 areas 1001. At the same time, the terminal image display panel 16 of each gaming terminal 10 participating in the RED OR BLACK game displays thereon an effect image 1006 similar to the above roulette effect image.

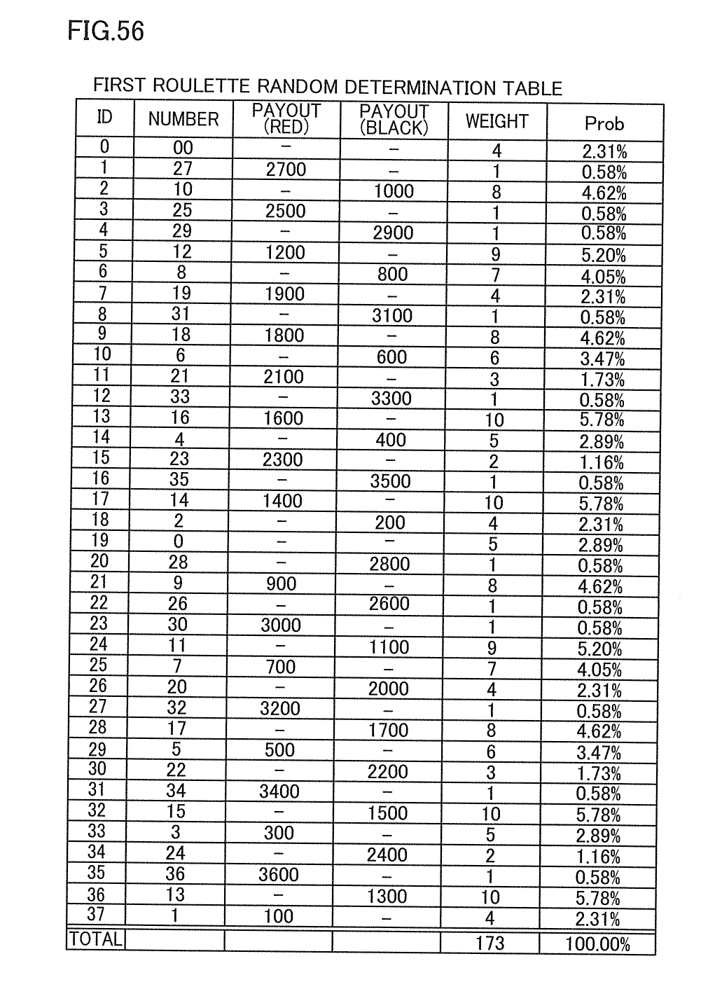

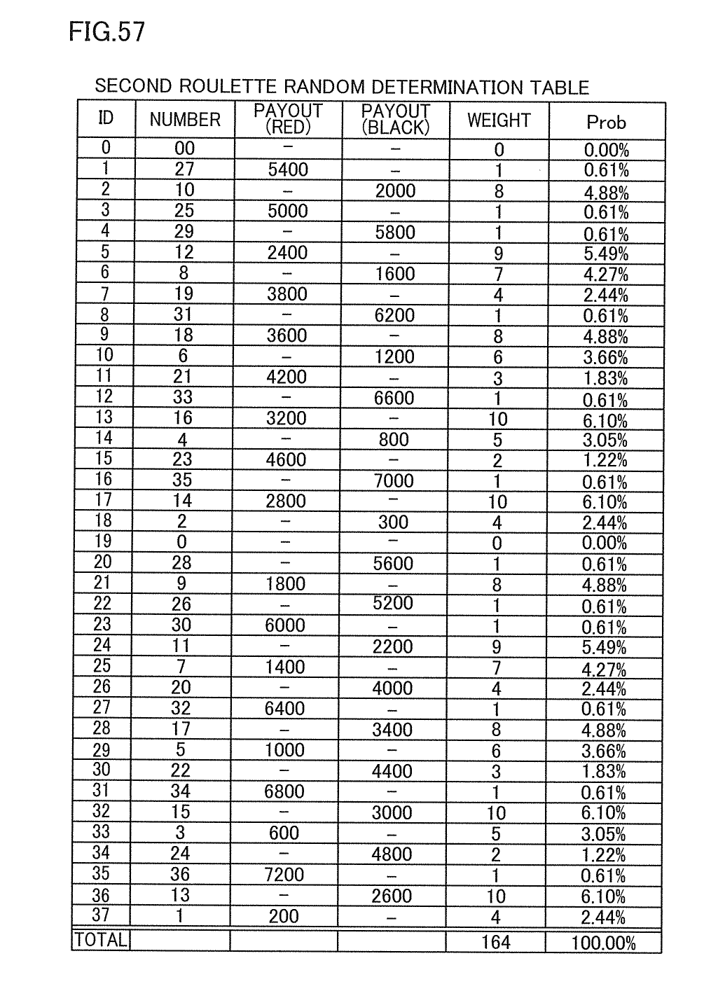

On which of the areas 1001 the ball 1003 is stopped is determined based on a roulette random determination table before each roulette game is started. The roulette random determination table is included in the random determination program stored in the memory card 263. A first roulette random determination table shown in FIG. 56 is used for the first-time execution of the roulette game, and a second roulette random determination table shown in FIG. 57 is used for the second-time execution of the roulette game. In each roulette random determination table, each of the 38 areas 1001 of the roulette 1000 is associated with a fixed payout and a weight. Each weight represents the probability that the ball 1003 is stopped on the corresponding area 1001. For example, as can be seen from the first roulette random determination table shown in FIG. 56, the probability that the ball 1003 is stopped on the area 1001 associated with the number “27” (ID number “1”) in the first-time execution of the roulette game is 1/173. Further, as can be seen from the second roulette random determination table shown in FIG. 57, the weight of each of the green areas 1001c associated with the numbers “0” and “00” is set to 0 to prevent the ball 1003 from being stopped on either of the green areas 1001c in the second-time execution of the roulette game.

In each of the first and second roulette random determination tables, the fixed payout associated with each area 1001 indicates the payout to be awarded to the gaming terminals 10 pertaining to the group corresponding to the area 1001 when the ball 1003 is stopped on the area 1001. In the present embodiment, each fixed payout defined in the first roulette random determination table is 100 times as large as the number associated with the corresponding area 1001.

For example, the fixed payout to be awarded when the ball 1003 is stopped on the area 1001 associated with the number “27” is 2700 (=27×100). In the second roulette random determination table, the fixed payout associated with each area 1001 is 200 times as large as the number associated with the corresponding area 1001. That is, in the second-time execution of the roulette game, a payout calculated by multiplying the number associated with the area 1001 on which the ball 1003 is stopped by 200 is awarded.

After the effect showing that the ball 1003 is stopped either a red area 1001a or a black area 1001b is provided, as shown in FIG. 55C, an image 1007, showing that the winner is the group of the color corresponding to the area 1001 on which the ball 1003 is stopped, is displayed on each of the upper displays 700a, 700b, and 700c. Then, as shown in FIG. 55C, an image 1008 showing whether the corresponding gaming terminal 10 wins is displayed on each of the gaming terminal areas 703a to 703f. In addition, as shown in FIG. 55E, an image indicating the total credit amount obtained in the RED OR BLACK game is displayed on each of the terminal image display panels 16 of the winning gaming terminals 10 and on each of the gaming terminal areas 703 for the winning gaming terminals 10.

(ROLL THE DICE GAME)

Now, the ROLL THE DICE game will be described. The ROLL THE DICE game is a game in which its game result is shared by the gaming terminals 10 participating in the common game. The ROLL THE DICE game is a dice game including six stages. Only after the gaming terminals acting as players clear one stage, it is possible to proceed to the next stage. To be more specific, one of the gaming terminals 10 participating in the common game plays a role of a shooter, to roll two dice. When the total number of pips of the two dice is 7, the stage is lost. When the total number of pips is not 7, it is possible to proceed to the next stage.

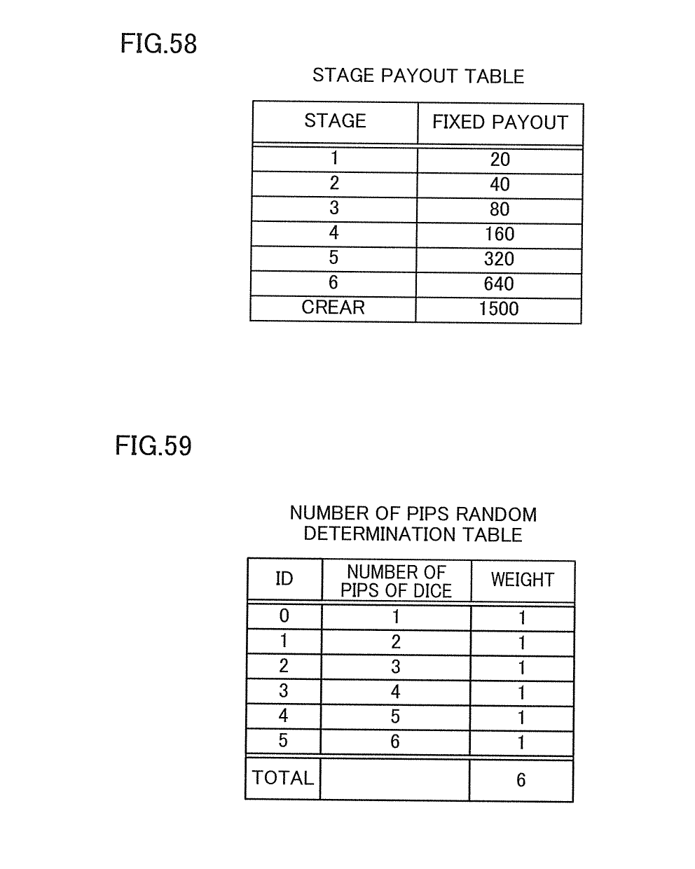

A stage payout table of FIG. 58, which is stored in the memory card 263, defines a fixed payout awarded after a loss of each stage in the ROLL THE DICE game, and a fixed payout awarded after all the six stages are cleared. The number of pips of each of the two dice is determined in a number of pips random determination process based on a number of pips random determination table stored in the memory card 263. The number of pips random determination table shown in FIG. 59 defines a weight for each of the six patterns of the number of pips of the dice. Each weight represents the probability that the corresponding pattern is selected in the number of pips random determination process. In the present embodiment, the probability that each of the six patterns is selected by the number of pips random determination process is set uniformly, i.e., the probability is ⅙.

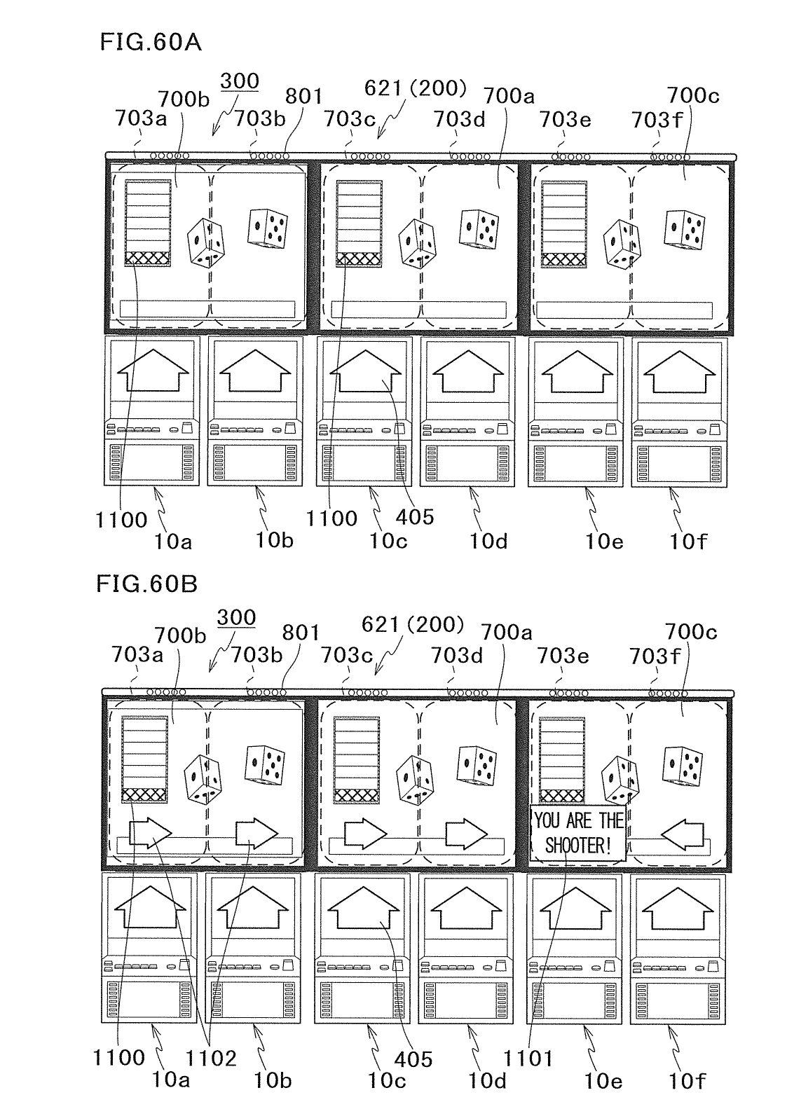

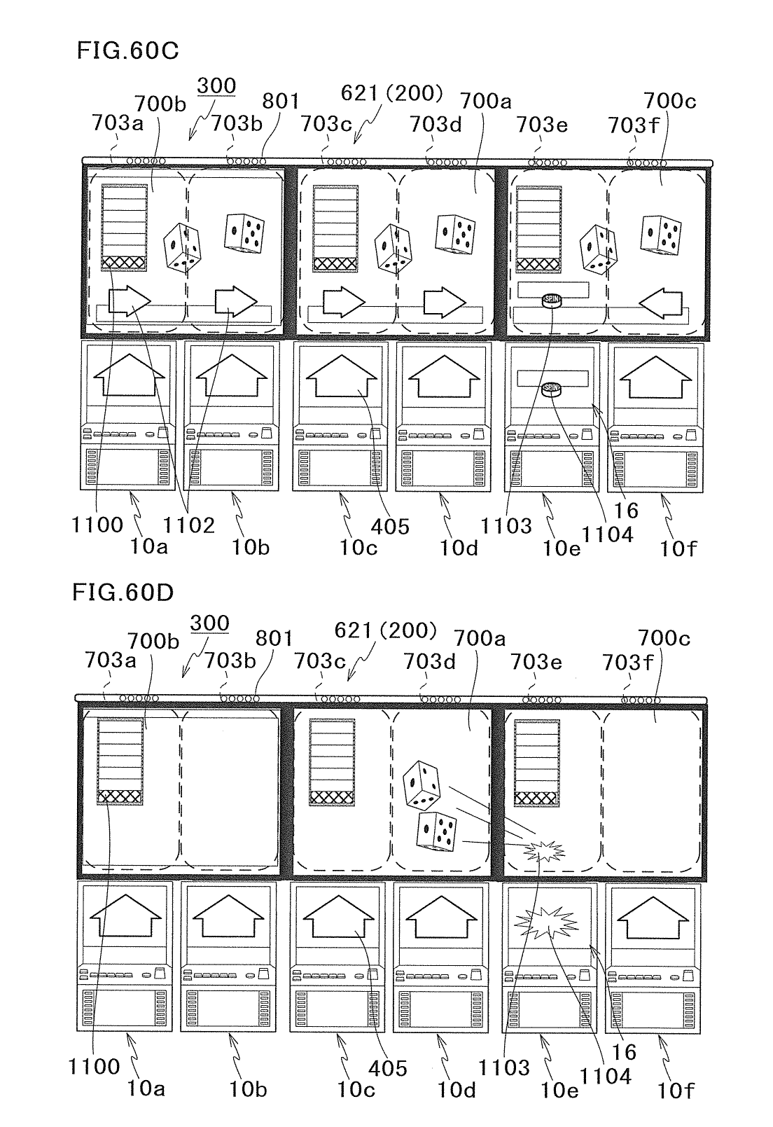

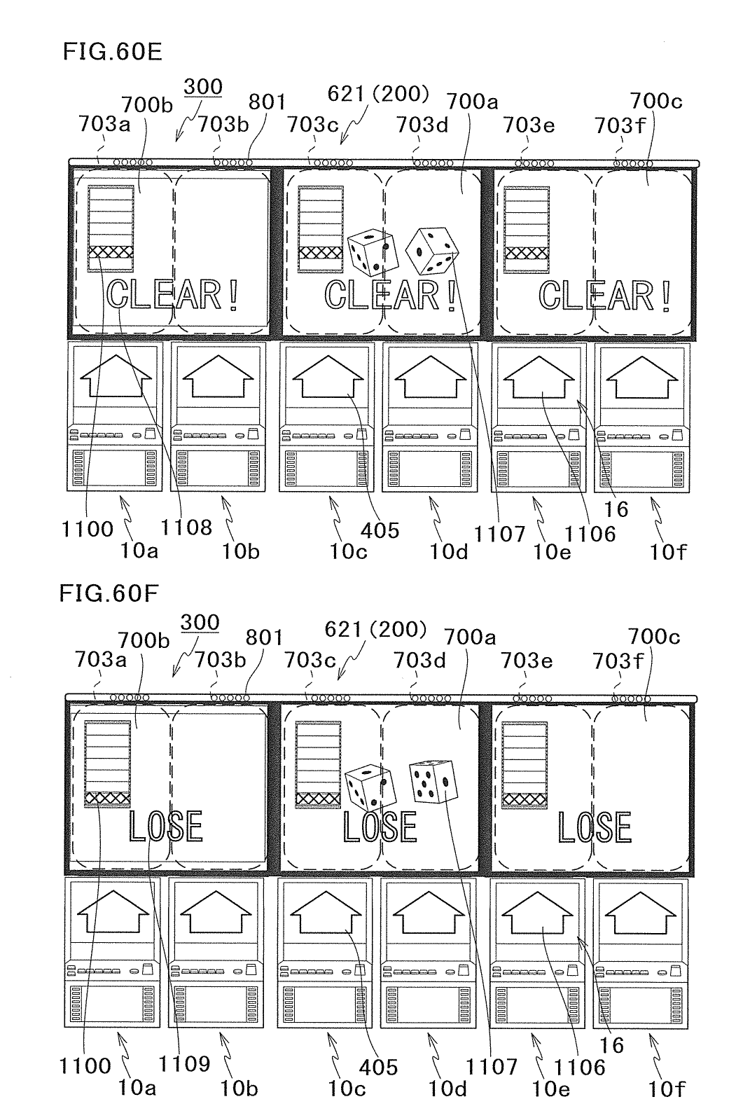

During the ROLL THE DICE game, each upper display 700 displays thereon, as shown in FIG. 60A, a stage image 1100 showing: the current stage; and each fixed payout to be awarded after the loss of each stage and the fixed payout to be awarded after all the six stages are cleared.

When the ROLL THE DICE game is started, first, which of the gaming terminals 10 plays the role of the shooter rolling the two dice is selected by random determination from the gaming terminals 10 participating in the common game. Then, provided is an effect to report the gaming terminal 10 selected as the shooter, as shown in FIG. 60B. Specifically, on the gaming terminal area 703 corresponding to the gaming terminal 10 selected as the shooter, an image 1101 indicating that the gaming terminal 10 is selected as the shooter is displayed. Meanwhile, on the gaming terminal area 703 corresponding to each gaming terminal 10 which is not selected as the shooter, an arrow image 1102 or the like pointing the gaming terminal 10 selected as the shooter is displayed. In an example shown in FIG. 60B, the gaming terminal 10e is selected as the shooter.

Then, as shown in FIG. 60C, a button image 1103 encouraging the player of the gaming terminal 10e selected as the shooter to press the spin button 29 is displayed on the gaming terminal area 703e. At the same time, the terminal image display panel 16 of the gaming terminal 10e also displays thereon a button image 1104 similar to the above button image 1103. Then, as shown in FIG. 60D, when the spin button 29 is pressed in the gaming terminal 10e selected as the shooter, an effect image 1105 making it look as if two dice are rolled is displayed on the upper displays 700, while an effect image 1106 making it look as if the dice are rolled by the gaming terminal 10e is displayed also on the terminal image display panel 16 of the gaming terminal 10e.

Then, as shown in FIG. 60E, a number of pips effect image 1107 showing the numbers of pips of the two dice determined in the number of pips random determination process is displayed on the upper display 700. In the number of pips effect image 1107, the face of each of the dice having the number of pips determined in the above number of pips random determination process is blinking, to facilitate the perception of the number of pips of each of the dice. When the total number of pips of the two dice is not 7, an image 1108 showing that the stage is cleared is displayed on each upper display 700, as shown in FIG. 60E. When the total number of pips of the two dice is 7, an image 1109 showing the loss of the stage is displayed on each upper display 700, as shown in FIG. 60F.

When the ROLL THE DICE game is lost at a certain stage, or when all the six stages of the game are cleared, an image similar to that in FIG. 55E, indicating the total credit amount obtained in the ROLL THE DICE game is displayed on each of the terminal image display panel 16 of the gaming terminals which have participated in the common game and on each of the gaming terminal areas 703 corresponding to these gaming terminals 10.

(FUN WHEEL GAME)

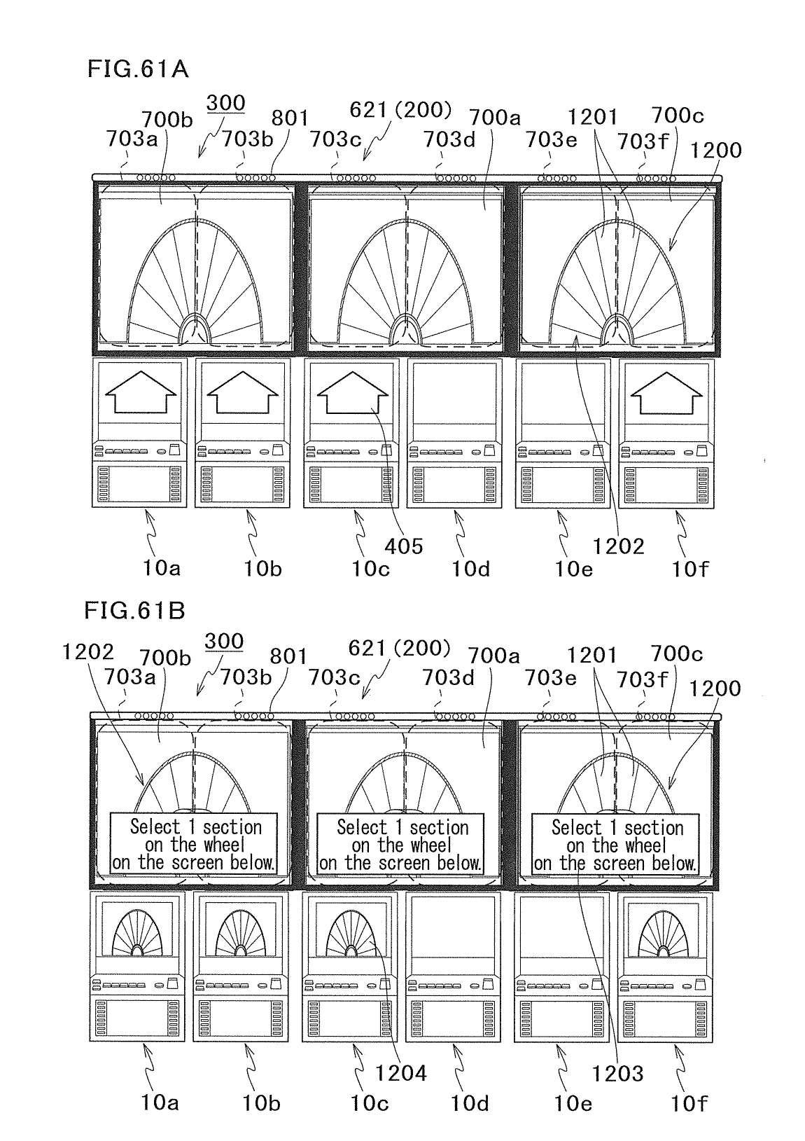

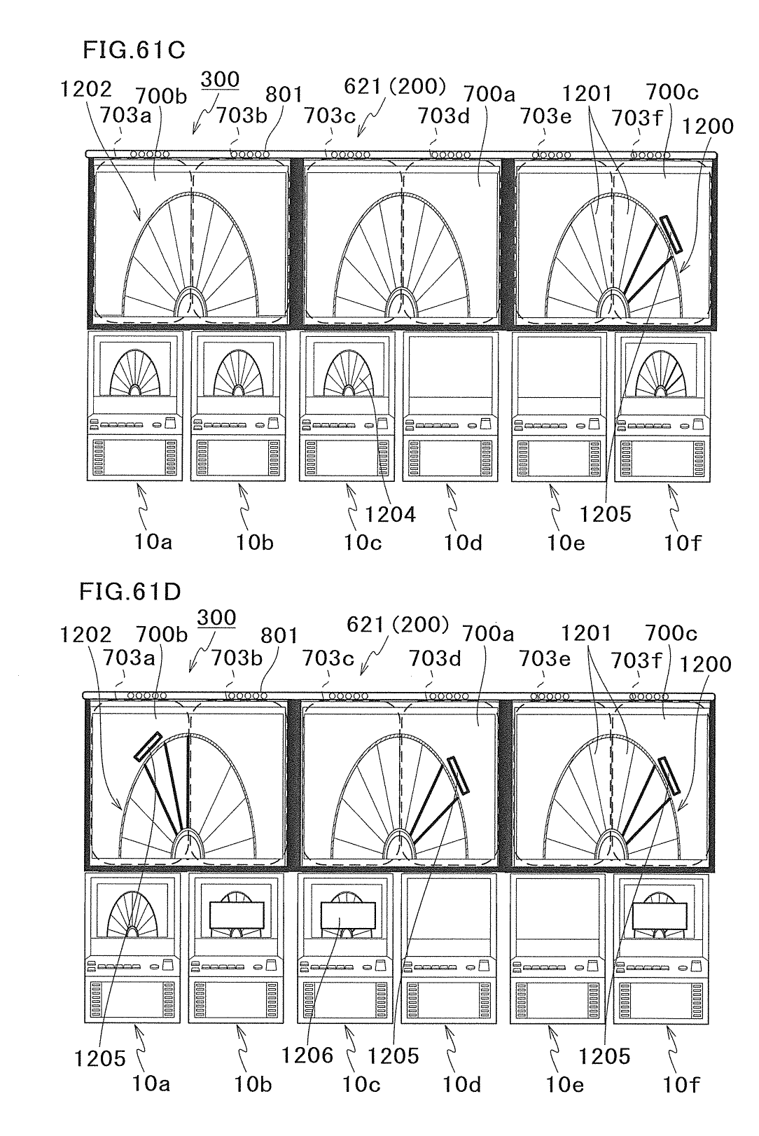

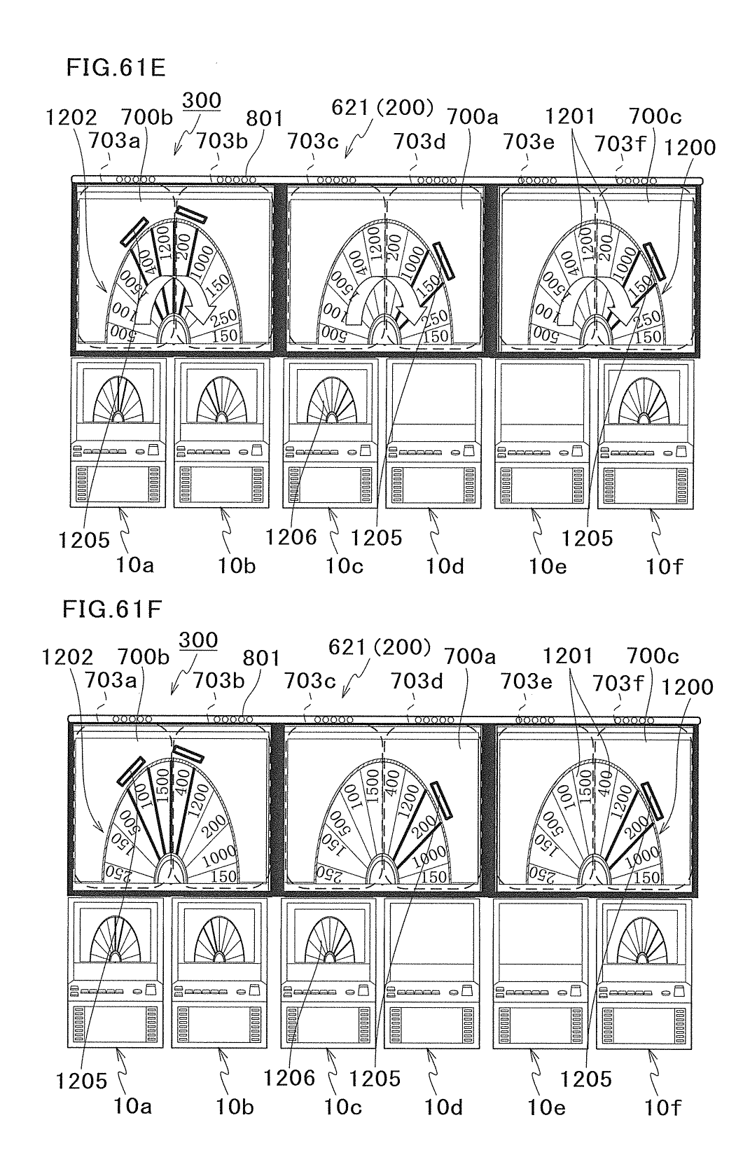

Now, the FUN WHEEL game will be described. FIG. 61A illustrates the display state on the upper displays 700 and on the terminal image display panels 16 during the FUN WHEEL game. In FIG. 61A, the gaming terminals 10a to 10c and 10f are executing the common game, and the look-up images 405 are displayed on the terminal image display panels 16 of these gaming terminals 10. Specifically, each of the upper displays 700 has one FUN WHEEL 1200 displayed thereon. That is, in the present embodiment, one FUN WHEEL 1200 is allocated to two gaming terminals 10. The FUN WHEEL 1200 has a wheel 1202 having a plurality of areas 1201. In the FUN WHEEL game, the wheel 1202 of the FUN WHEEL 1200 is rotated, and this rotation is stopped after a predetermined time elapses.

In the present embodiment, each upper display 700 is configured to display thereon a predetermined number of areas 1201 which are in an upper half portion of the wheel 1202 of the FUN WHEEL 1200. In other words, there are the predetermined number of positions where one area 1201 can be stopped on each upper display 700.

In the FUN WHEEL game, each of the players of the gaming terminals 10 participating in the common game selects any one of the predetermined number of stopped positions. After the selection by each player is completed, an image indicating predetermined fixed payouts for the respective of areas 1201 (see FIG. 61E). Then, when the wheel 1202 of the FUN WHEEL 1200 is stopped after rotated, the fixed payout displayed on the area 1201 stopped at the stopped position selected by each gaming terminal 10 is awarded to the gaming terminal 10.

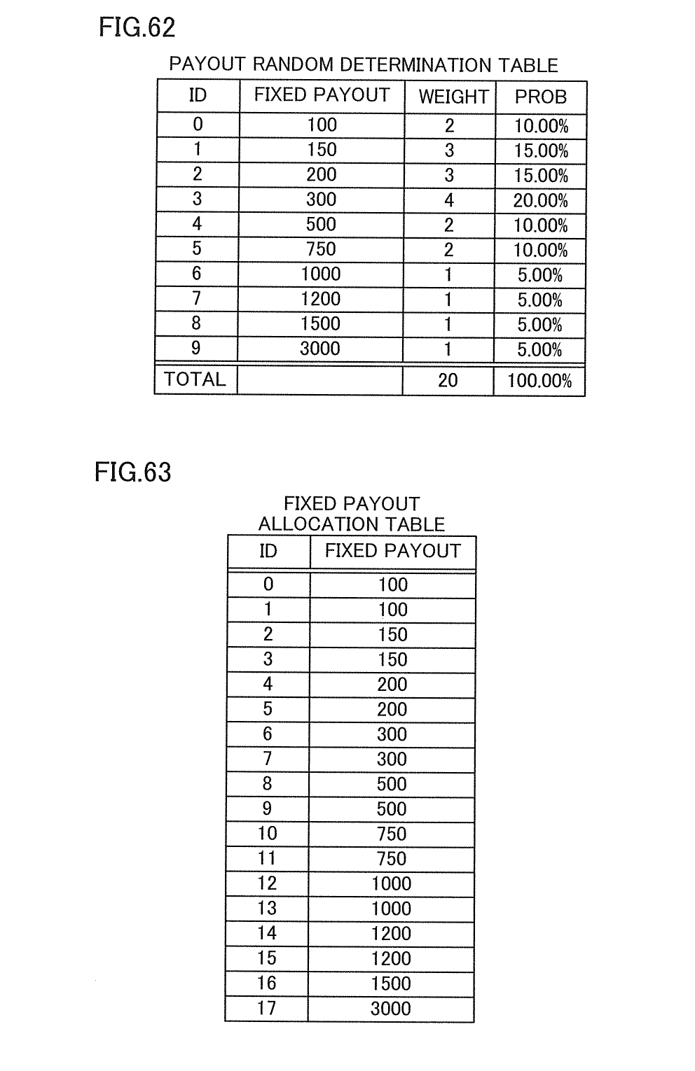

The fixed payouts respectively awarded to the gaming terminals 10 participating in the common game are determined in advance in a payout random determination process based on a payout random determination table stored in the memory card 263. The payout random determination table shown in FIG. 62 defines a weight for each of the plural types of fixed payouts of which amounts of payout are different from one another. Each weight represents the probability that the corresponding fixed payout is selected in the payout random determination process. For example, the probability that the fixed payout of 500 credits is selected in the payout random determination process is 2/20.

When the wheel 1202 of the FUN WHEEL 1200 is stopped, the area 1201 having the fixed payout determined as being for each gaming terminal 10 in the payout random determination process is stopped on the stopped position selected by that gaming terminal 10. The fixed payouts displayed on the areas 1201 stopped on the stopped positions which are not selected by the players among the predetermined number of stopped positions are randomly determined by random selection from 18 types of payouts defined in a fixed payout allocation table shown in FIG. 63.

The following describes the display states on the terminal image display panels 16 and the upper displays 700 during the FUN WHEEL game. After the FUN WHEEL 1200 is displayed on each upper display 700 as shown in FIG. 61A, an image 1203 encouraging the players of the gaming terminals 10 participating in the common game to select the stopped position is displayed on each upper display 700, as shown in FIG. 61B. Further, on the terminal image display panel 16 of each of the gaming terminals 10 participating in the common game, an image 1204 for selecting a stopped position is displayed.

After the stopped positions are selected by the players, images 1205 respectively indicating the stopped positions selected are displayed on the upper displays 700, as shown in FIG. 61C. The present embodiment is configured so that the same stopped position cannot be selected by the players of the gaming terminals 10 sharing the same FUN WHEEL 1200. Thus, for example, in the example shown in FIG. 61D, the players of the gaming terminals 10a and 10b cannot select the same stopped position. Meanwhile, the same stopped position can be selected by the players of the gaming terminals 10 which do not share the same FUN WHEEL 1200. Thus, for example, in the example shown in FIG. 61D, the players of the gaming terminals 10c and 10f can select the same stopped position.

In each gaming terminal 10 where the selection of the stopped position has been made by the player, as shown in FIG. 61D, there is displayed an image 1206 instructing the player to wait until the selection of the stopped position by the player of each of the other gaming terminals 10 has been completed.

After the selection by each player of all the gaming terminals 10 participating the common game is completed, as shown in FIG. 61E, an image of showing the fixed payouts on the respective areas 1201 of the FUN WHEEL 1200, and then the rotation of the wheel 1202 is started. Then, after a predetermined period elapses from the start of the rotation of the wheel 1202, the rotation of the wheel 1202 is stopped, as shown in FIG. 61F. Then, an image similar to that in FIG. 55E, indicating the total credit amount obtained in the FUN WHEEL game is displayed on each of the terminal image display panels 16 of the gaming terminals which have participated in the common game and on each of the gaming terminal areas 703 corresponding to these gaming terminals 10.

(LUCKY NUMBERS GAME)

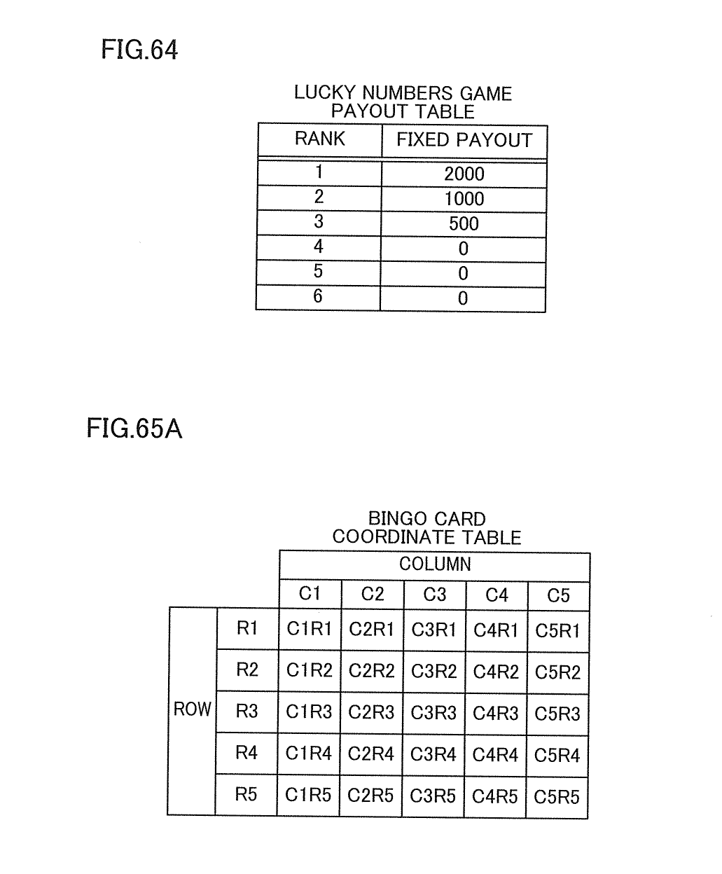

Now, the LUCKY NUMBERS game will be described. The LUCKY NUMBERS game is a bingo game played using a bingo card containing 25 squares in a matrix of 5 columns and 5 rows, each of which square having a number. After a bingo card is distributed to each of the gaming terminals 10, numbers selected by random determination are sequentially displayed on the upper displays 700. If the bingo card has a square having the number identical to the displayed number, the square is marked. In the LUCKY NUMBERS game, the gaming terminals 10 compete for the speed to make a vertical, horizontal, or diagonal line formed by marked squares (to get a BINGO) on a bingo card. In the present embodiment, as shown in a LUCKY NUMBERS game payout table of FIG. 64, fixed payouts are awarded only to the gaming terminals 10 which have got the first to third ranks as a result of the LUCKY NUMBERS game.

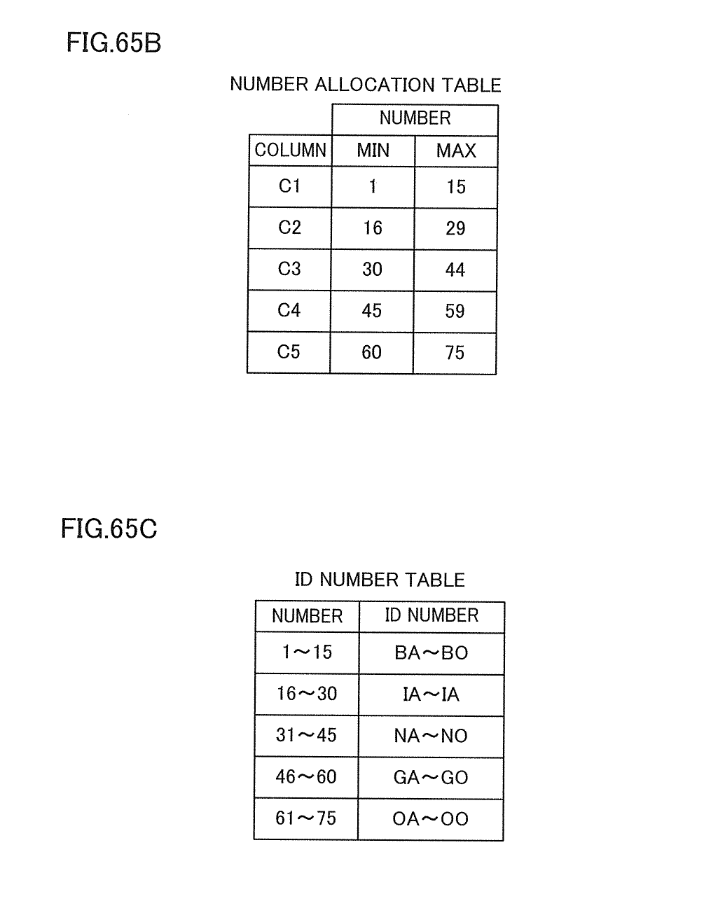

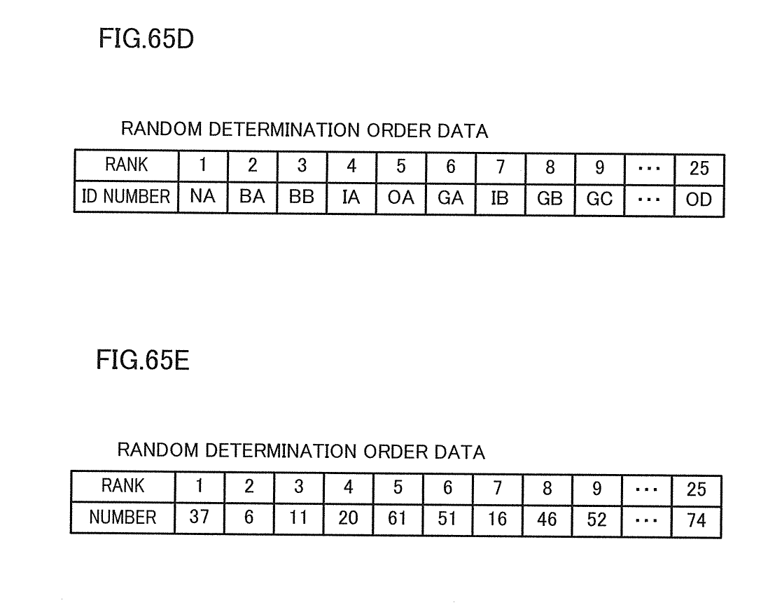

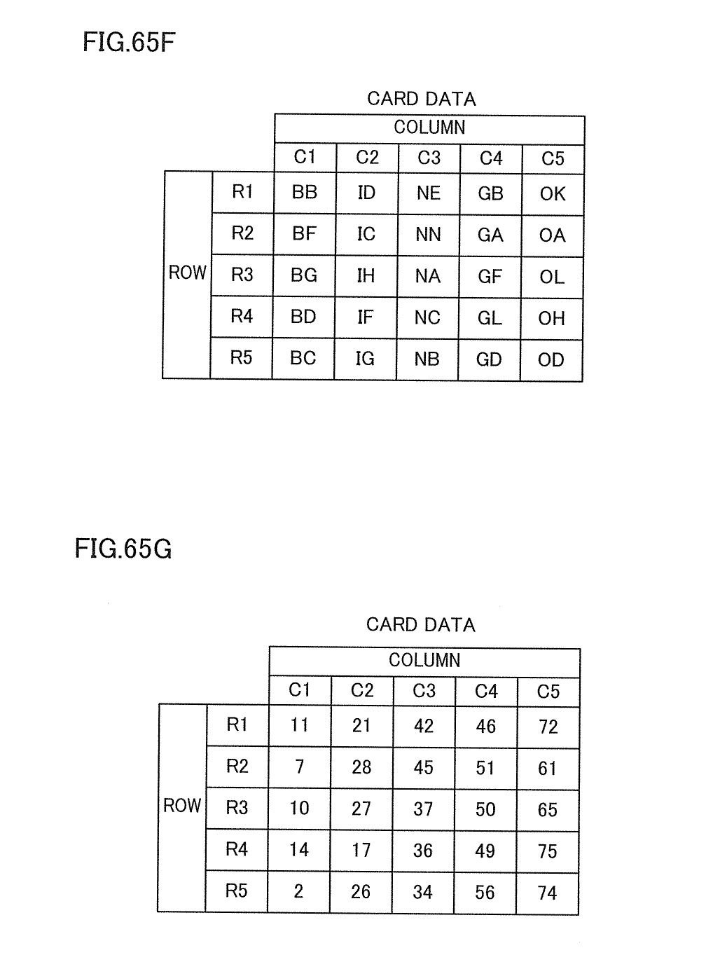

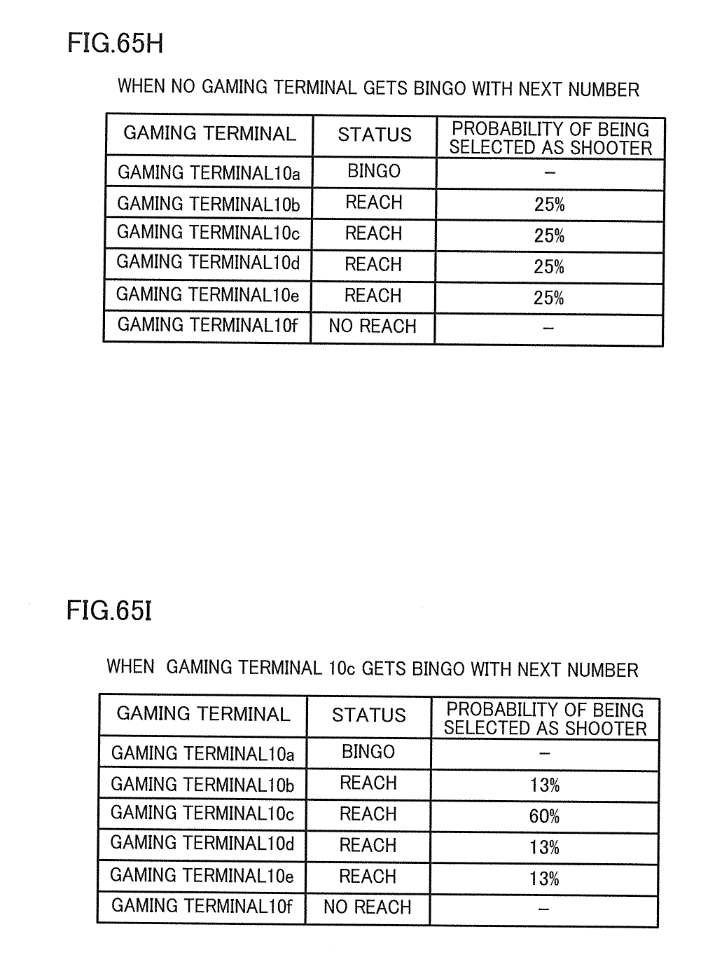

Now, the bingo card distributed to each gaming terminal 10 will be described. First, as shown in the bingo card coordinate table of FIG. 65A, coordinates are defined for the respective 25 squares of the bingo card. In the bingo card coordinate table of FIG. 65A, the five columns of the bingo card are respectively denoted by C1 to C5, while the five rows thereof are respectively denoted by R1 to R5. In the present embodiment, as shown in a number allocation table of FIG. 65B, the range of numbers allocated to each of the columns (C1 to C5) of the bingo card is predetermined. For example, in the column of C1, numbers in the range from 1 to 15 are allocated.

At the start of the LUCKY NUMBERS game, an ID number allocation process of allocating the numbers from 1 to 75 to 75 types of ID numbers which are different from one another. To be more specific, as shown in an ID number table of FIG. 65C, the numbers from 1 to 15 are allocated to ID numbers “BA” to “BO” by random determination; the numbers from 16 to 30 are allocated to ID numbers “IA” to “IO” by random determination; the numbers from 31 to 45 are allocated to ID numbers “NA” to “NO” by random determination; the numbers from 46 to 60 are allocated to ID numbers “GA” to “GO” by random determination; and the numbers from 61 to 75 are allocated to ID numbers “OA” to “OO” by random determination.

In the present embodiment, the maximum number of numbers selected in one-time execution of the LUCKY NUMBERS GAME (the number of numbers selected by random determination) is 25. That is, during the LUCKY NUMBERS game, there is provided is an effect making it look as if the random determination of a number is made 25 times at the maximum. At the start of the LUCKY NUMBERS game, random determination order data (see FIG. 65D) and six card data (see FIG. 65F) are prepared. In the random determination order data, any one of the 75 types of ID numbers is allocated to each of 25 times of execution of random determination. As described above, to each ID number, a number is allocated in the ID number allocation process, and therefore the random determination order data shown in FIG. 65E is made by replacing each ID number in the random determination order data shown in FIG. 65D to the allocated number. Note that the ID numbers corresponding to the random determination order 1 to 5 in the random determination order data are data for free spots. If, on a bingo card distributed to each gaming terminal 10, there is a number illustrated in a square which number is identical to any of the numbers corresponding to the above ID numbers, the square is marked at the start of the game.

The card data is data of the bingo card distributed to each gaming terminal 10. In the card data, an ID number is allocated to each of the coordinates shown in FIG. 65A. Note that the ID number allocated to the central square (the square in the column C3 and in the row R3) of the bingo card is the ID number associated with the random determination order 1 in the random determination order data. With this, the central square of the bingo card is always a free spot. The card data shown in FIG. 65G is made by replacing each ID number shown in FIG. 65F to the allocated number. Note that, in the present embodiment, the card data for each gaming terminal 10 is made so that two or more gaming terminals 10 do not get a BINGO at the same time in the LUCKY NUMBERS game.

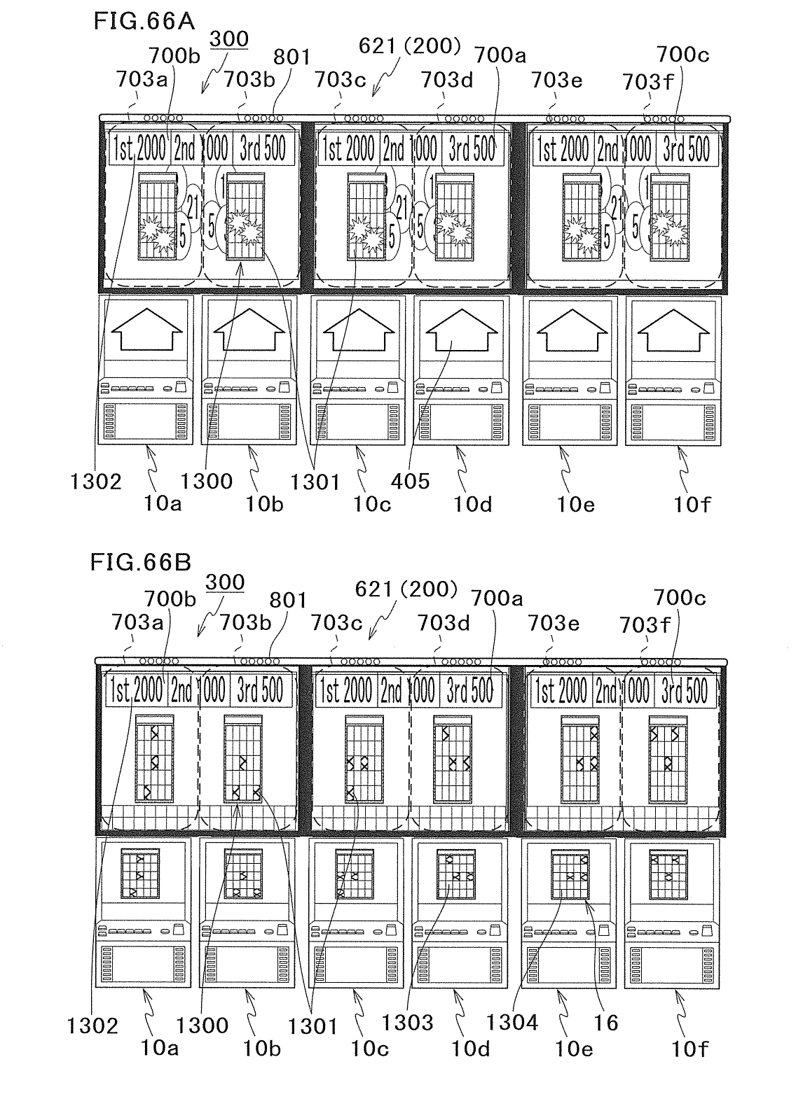

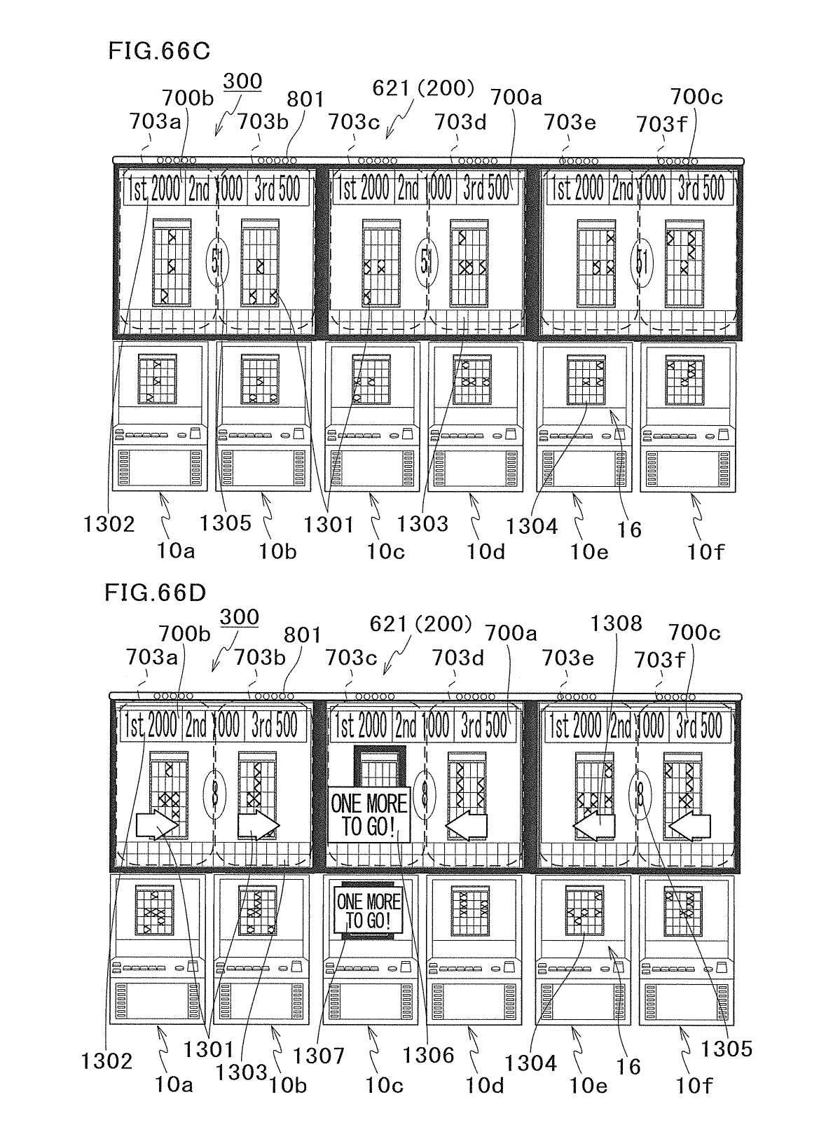

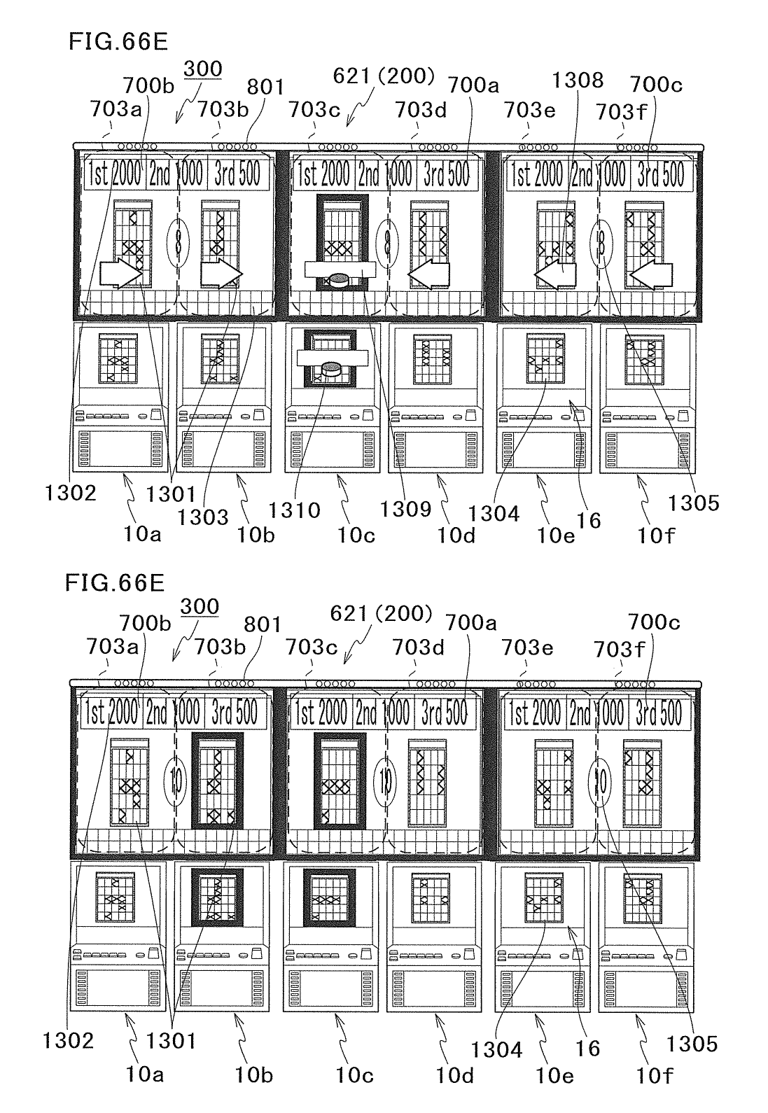

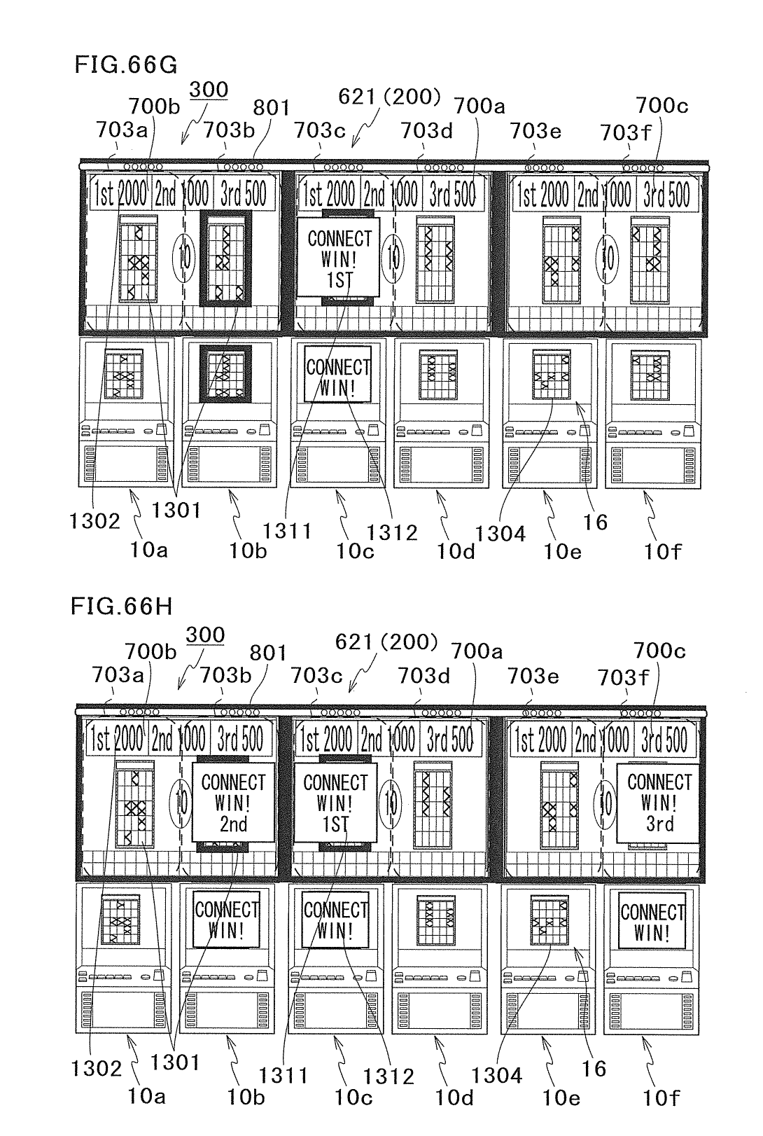

The following describes the display states on the terminal image display panels 16 and the upper displays 700 during the LUCKY NUMBERS game. When the LUCKY NUMBERS game is started, first, as shown in FIG. 66A, on the gaming terminal area 703 of each gaming terminal 10, a bingo card 1301 is distributed to each gaming terminal 10, and then an effect image 1300 of writing numbers into 25 squares of the bingo card 1301. The numbers written in the bingo card 1301 are numbers based on the card data (see FIG. 65G) prepared at the start of the LUCKY NUMBERS game. In this process, the color of the squares of the bingo card 1301 is white. During the LUCKY NUMBERS game, on an upper portion of each upper display 700, there is displayed an image 1302 showing payouts to be awarded to the first rank to the third rank in the LUCKY NUMBERS game.

Then, as shown in FIG. 66B, in the bingo card 1301 distributed to each gaming terminal 10, the color of the square corresponding to the free spot is changed from white to red, thereby showing that this square is marked. That is, if any of the numbers associated with 1st to 5th ranks in the random determination order in the random determination order data exists on the bingo card 1301, the square having such number is turned red. At this time, as shown in FIG. 66B, on a lower portion of each upper display 700, there is displayed an image 1303 showing one or more numbers which have already been selected by random determination. The terminal image display panel 16 of each gaming terminal 10 participating in the LUCKY NUMBERS game displays thereon a bingo card 1304 similar to the bingo card 1301 displayed on the gaming terminal area 703.

Then, as shown in FIG. 66C, on each upper display 700, there is displayed an effect image making it look as if random determination of a number is performed by an automatically appearing random determination ball 1305 with illustration thereon of numbers corresponding to the 6th rank in the random determination order in the random determination order data. That is, if there is a number associated with the 6th rank in the random determination order exists on the bingo card 1301, the square having the number is turned red. Thereafter, a similar process is repeated for the 7th and subsequent ranks in the random determination order in the random determination order data, until any of the gaming terminals 10 establishes REACH state, where a BINGO is going to be get with one more marked square.

When any of the gaming terminals 10 establishes the REACH state, an effect of reporting the gaming terminal 10 which has established the REACH state is performed, as shown in FIG. 66D. Specifically, on the gaming terminal area 703 corresponding to the gaming terminal 10 which has established the REACH state, an image 1306 indicating that the REACH state has been established, and a similar image 1307 is also displayed on the terminal image display panel 16 of the gaming terminal 10. Meanwhile, on the gaming terminal area 703 corresponding to each gaming terminal 10 which has not established the REACH state, an arrow image 1308 or the like pointing the gaming terminal 10 which has established the REACH state is displayed. In an example shown in FIG. 66D, the gaming terminal 10c has established the REACH state. After this, the random determination ball 1305 does not appear automatically, and the gaming terminal 10 which has established the REACH state plays a role of a shooter. By pressing the spin button 29 on this gaming terminal 10, the random determination ball appears.

As shown in FIG. 60E, a button image 1309 encouraging the player of the gaming terminal 10c which has established the REACH state to press the spin button 29 is displayed on the gaming terminal area 703c. In addition, on the terminal image display panel 16 of the gaming terminal 10c, there is displayed a button image 1310 similar to the above button image 1309. Then, upon pressing of the spin button 29 on the gaming terminal 10c, the random determination ball 1305 on which the number based on the random determination order data is illustrated is newly displayed, as shown in FIG. 66F.

If there are plural gaming terminals 10 which have established the REACH state, as shown in FIG. 66F, which one of the gaming terminals 10 plays the role of the shooter is determined by random determination from the plurality of gaming terminals 10 which have established the REACH state. If no gaming terminal 10 gets a BINGO with the number randomly selected next based on the random determination order data, the probability that each of the gaming terminals 10 which have established the REACH state is selected as the shooter is even. Meanwhile, if there is a gaming terminal 10 which gets BINGO with the number randomly selected next based on the random determination order data, the probability that the gaming terminal 10 which will make a BINGO with the next number is selected as the shooter is higher than the probability that another gaming terminal 10 is selected as the shooter. In the present embodiment, the probability that the gaming terminal 10 which will get a BINGO with the next randomly selected number is selected as the shooter is 60%.

For example, assumed is a case where a BINGO has been got on the gaming terminal 10a, the REACH state has been established on each of the gaming terminals 10b to 10e, but the REACH state has not been established on the gaming terminal 10f, as shown in FIG. 65H. In this circumstance, any of the gaming terminals 10b to 10e, on each of which the REACH state has been established, can be selected as the gaming terminal 10 playing the role of the shooter. If there is no gaming terminal 10 which will get a BINGO with the next randomly selected number, the probability that each of the gaming terminals 10b to 10e which have established the REACH state is selected as the shooter is even, i.e., 25%. Meanwhile, if the gaming terminal 10c will get a BINGO with the next randomly selected number, the probability that the gaming terminal 10c is selected as the shooter is set to 60%, and the probability that each of the gaming terminals 10b, 10d, and 10e is selected as the shooter is even 13%.

Then, when any of the gaming terminals 10 gets a BINGO, as shown in FIG. 66G, the gaming terminal area 703 of the gaming terminal 10 which gets a BINGO displays thereon an image 1311 showing a BINGO has been got and its rank; while the terminal image display panel 16 of the gaming terminal 10 also displays an image 1312 similar to the image 1311. The LUCKY NUMBERS game ends when the gaming terminal 10 at the third rank is determined, as shown in FIG. 66H. Then, an image similar to that in FIG. 55E, indicating the total credit amount obtained in the LUCKY NUMBERS game is displayed on each of the terminal image display panels 16 of the gaming terminals which have won the first to the third ranks and on each of the gaming terminal areas 703 corresponding to these gaming terminals 10.

(HIGH or LOW Game)

Now, the HIGH or LOW game will be described. The HIGH or LOW game is a game in which its game result is shared by the gaming terminals 10 participating in the common game. The HIGH or LOW game is a card game using playing cards and includes five stages. Only after the gaming terminals acting as players clear one stage, it is possible to proceed to the next stage. In the HIGH or LOW game, the center controller 200 plays a role of a dealer, and each gaming terminal 10 plays a role of a player. In each stage, one of the gaming terminals 10 selected by random determination predicts whether the card owned by the thus selected gaming terminal 10 has a number higher (or lower) than that of the card owned by the dealer. When the prediction is wrong, the stage is lost. When the prediction is correct, the stage is won, and it is possible to proceed to the next stage.

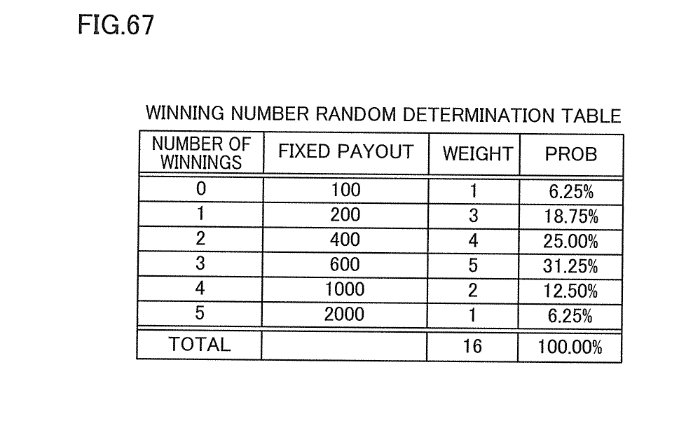

In the present embodiment, the number of stages which can be cleared by the gaming terminal acting as the player in the HIGH or LOW game is determined in advance in a winning number random determination process based on the winning number random determination table stored in the memory card 263. The winning number random determination table shown in FIG. 67 defines a weight for each number of winnings made by a “player” (the number of hits of the prediction). Each weight represents the probability that the corresponding number of winnings is selected in the winning number random determination process. For example, the probability that the number of winnings of the “player” is 3 (the “player” lose the game at the stage 4) is 5/16. The winning number random determination table also defines a fixed payout associated with each number of winnings, which payout is awarded to the gaming terminal 10.

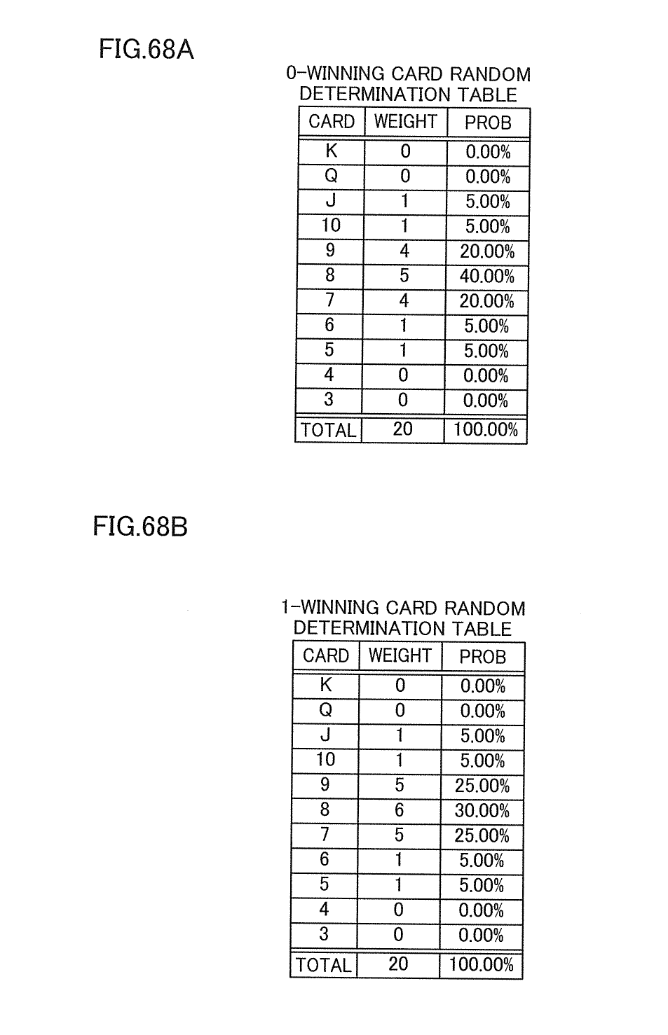

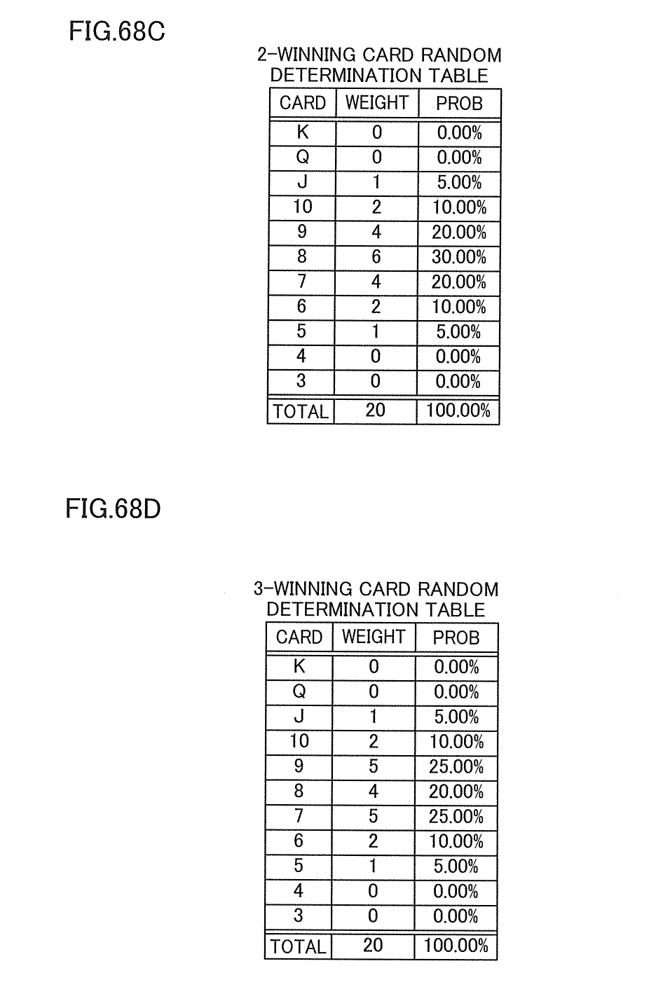

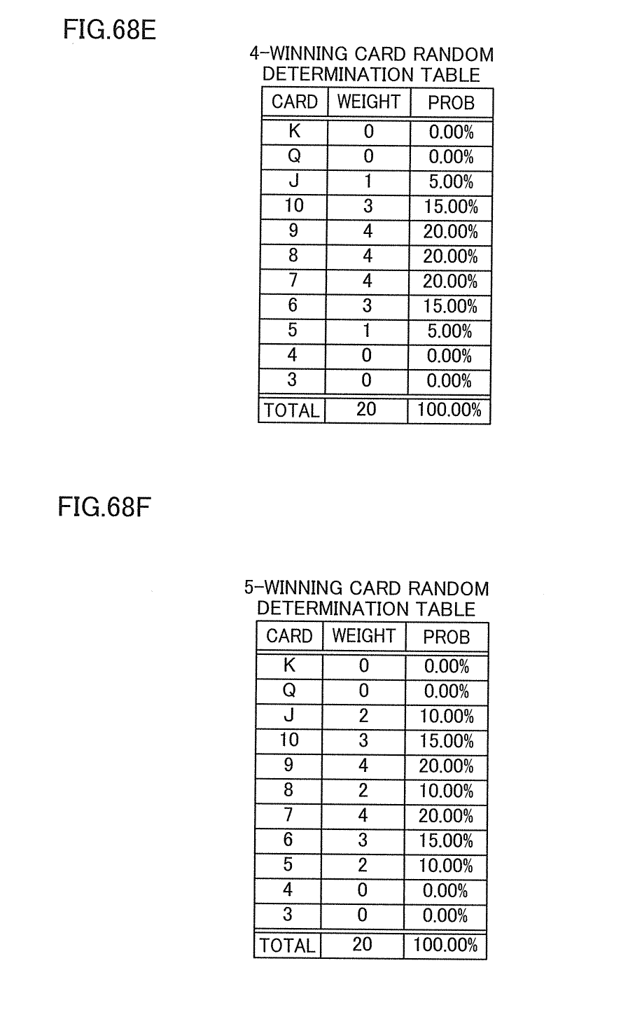

In the present embodiment, the card owned by the dealer is unchanged through all the stages. The card owned by the dealer is determined based on a card random determination table (see FIG. 68A to FIG. 68F) selected in accordance with the number of winnings determined in the above winning number random determination process. For example, a 1-winning card random determination table shown in FIG. 68B is a table used when the number of winnings determined in the winning number random determination process is 1. Each card random determination table defines a weight for each card type. Each weight represents the probability that the corresponding card type is selected as the card type of the dealer. For example, when the number of winnings determined in the winning number random determination process is 1, the probability that “8” is selected as the card type of the dealer is 6/20 (see FIG. 68B).

During the HIGH or LOW game, each upper display 700 displays thereon, as shown in FIG. 60A, a stage image 1400 showing: the current stage; and each fixed payout to be awarded after the loss of each stage and the fixed payout to be awarded after all the five stages are cleared. Further, each upper display 700 displays thereon a card image 1401 showing the card owned by the dealer in an open state so that its card type can be seen.

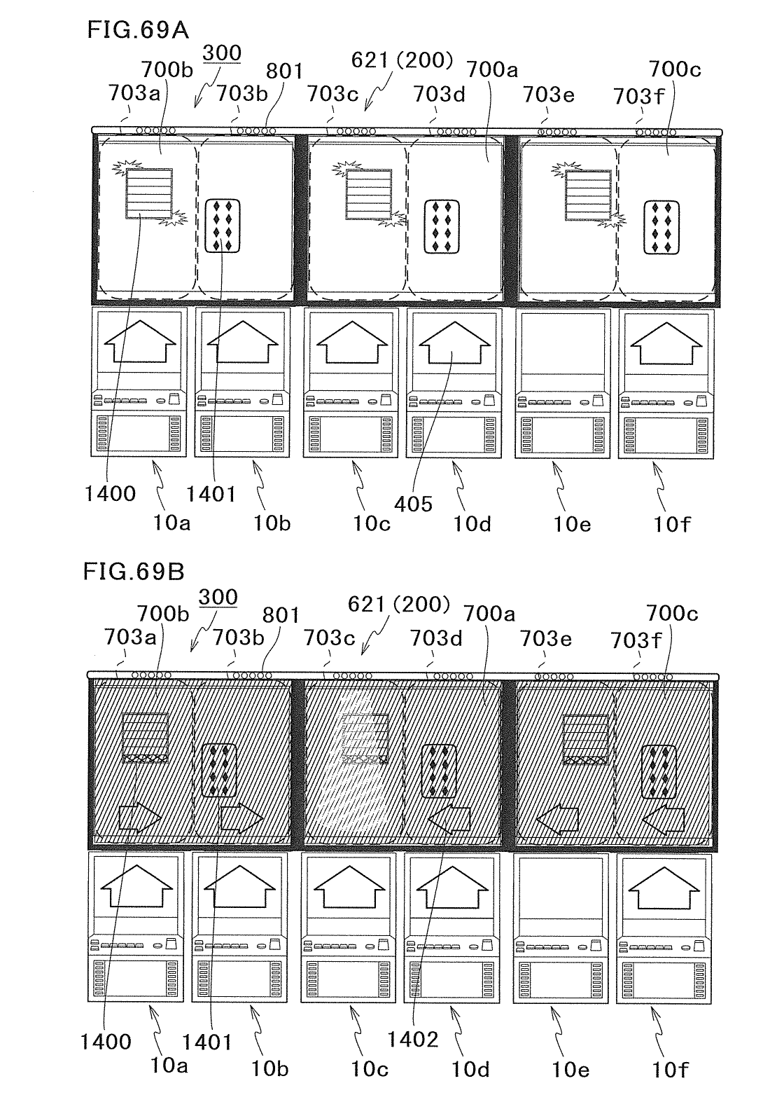

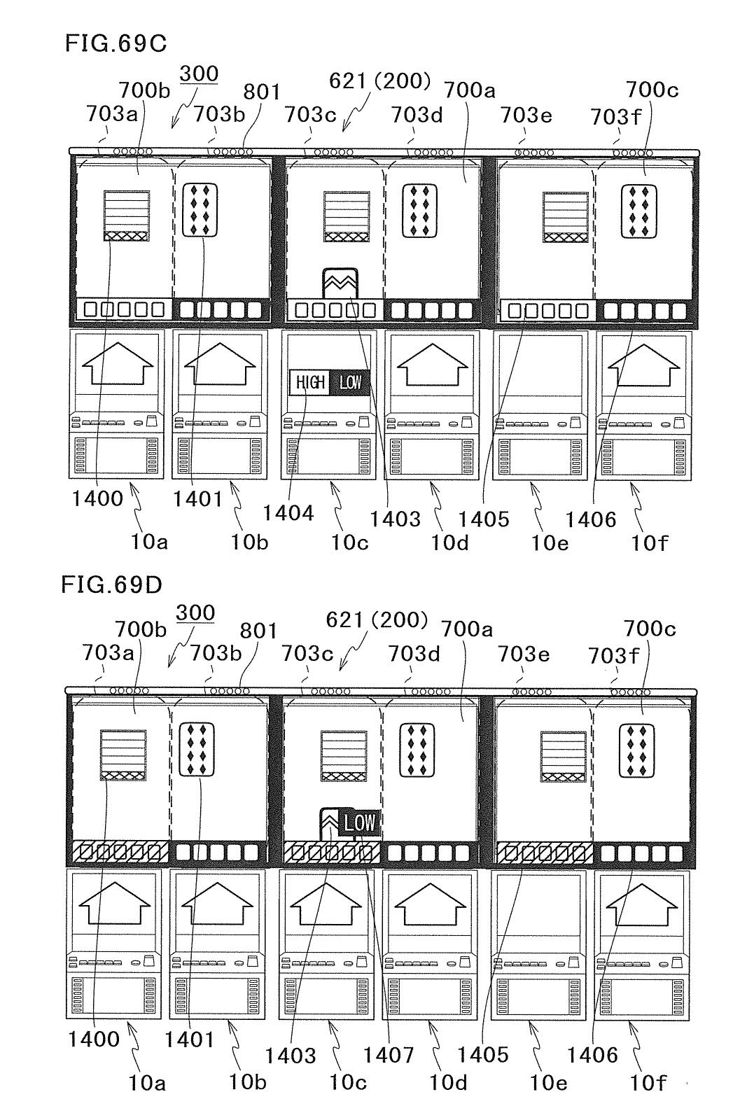

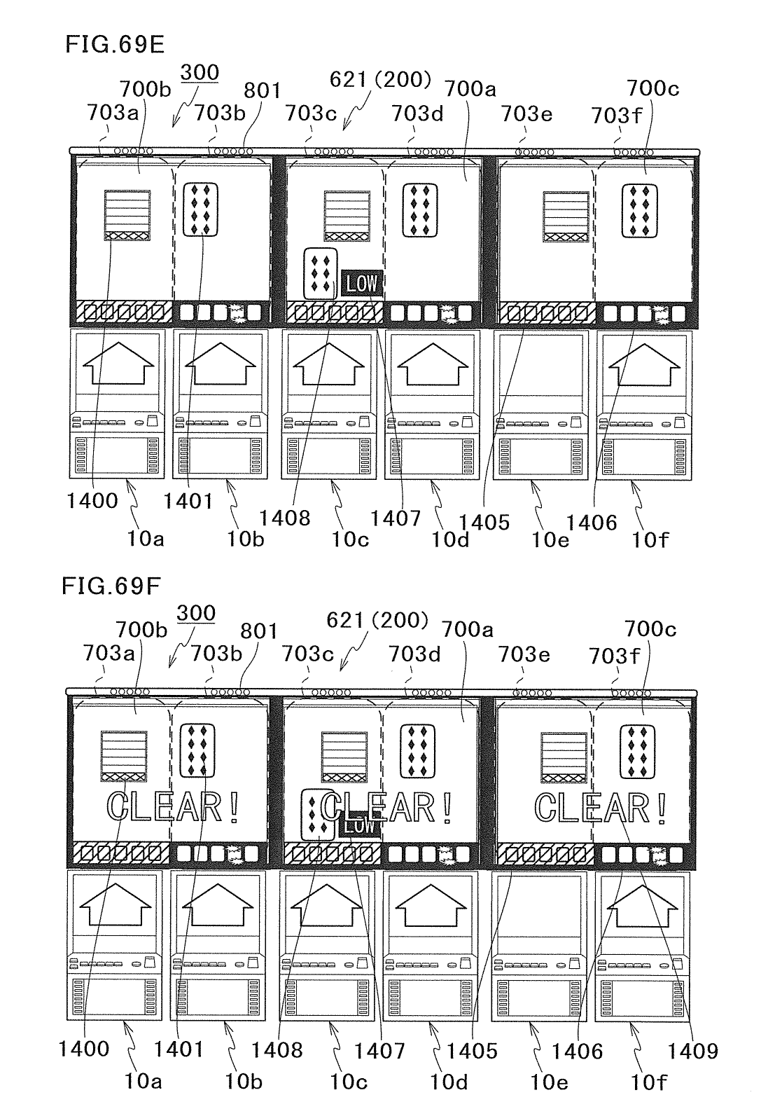

When the HIGH or LOW game is started, first, which of the gaming terminals 10 plays the role of the player who predicts high or low is selected by random determination from the gaming terminals 10 participating in the common game. Then, provided is an effect to report the gaming terminal 10 selected to play the role of the player, as shown in FIG. 69B. Meanwhile, the gaming terminal area 703 corresponding to each gaming terminal 10 which is not selected as the player making the prediction is turned dark, to display thereon an arrow image 1402 or the like pointing the gaming terminal 10 selected as the player making the prediction. Further, using the LED units 801, the gaming terminal 10 selected as the player making the prediction is spotlighted. In the example shown in FIG. 69B, the gaming terminal 10c is selected as the player making the prediction.

Then, as shown in FIG. 69C, on the gaming terminal area 703c corresponding to the gaming terminal 10c selected as the player making the prediction, there is displayed a card image 1403 showing a card of the player making the prediction in a closed state so that the card type of the player cannot be seen. Further, on the terminal image display panel 16 of the gaming terminal 10c selected as the player making the prediction, there is displayed a touch button image 1404 for inputting the prediction of the player of the gaming terminal 10c. Further, on a lower portion of each upper display 700, there is displayed an image 1405 showing card types stronger than that owned by the dealer, and an image 1406 showing card types weaker than that owned by the dealer.

After the gaming terminal 10c selected as the player making the prediction inputs the prediction, the gaming terminal area 703c displays thereon: an image 1407 showing this prediction; and one of the images 1405 and 1406 which shows the card types contrary to the prediction is turned dark, as shown in FIG. 69D.

Then, as shown in FIG. 69E, the card image 1403 is replaced to a card image 1408 showing the card of the player making the prediction in the open state so that the card type can be seen. When the prediction of the player predicting high or low is correct, an image 1409 showing that the stage is cleared is displayed on each upper display 700, as shown in FIG. 69F. Meanwhile, when the prediction of the player predicting high or low is wrong, an image showing that the stage has been lost (not illustrated) is displayed on each upper display 700.

When the HIGH or LOW game is lost at a certain stage, or when all the five stages of the game are cleared, an image similar to that in FIG. 55E, indicating the total credit amount obtained in the HIGH or LOW game is displayed on each of the terminal image display panels 16 of the gaming terminals which have participated in the common game and on each of the gaming terminal areas 703 corresponding to these gaming terminals 10.

(Mystery Bonus)

As described above, in each common game, effects are provided using the upper displays 700 which are the three upper displays 700a, 700b, and 700c. The upper displays 700 are also used to provide effects in the BONUS CHANCE WHEEL game, as described above. For this reason, it is impossible to execute each common game and the BONUS CHANCE WHEEL game simultaneously. However, each common game is the game in which only the gaming terminals 10 each having the qualification time when the common game start condition is satisfied can participate. Thus, a gaming terminal 10 which does not have the qualification time of the common game is allowed to solely execute the normal game even during the execution of the common game, there is a possibility that the right to shift to the BONUS CHANCE WHEEL game is awarded during the normal game. In this case, there may be an option of suspending the shift to the BONUS CHANCE WHEEL game until the common game ends, but this is a waste of time for the player who does not participate in the common game. Further, if the awarded right to shift to the BONUS CHANCE WHEEL game is revoked though the right is awarded, a disadvantage is brought to the player who does not participate in the common game.

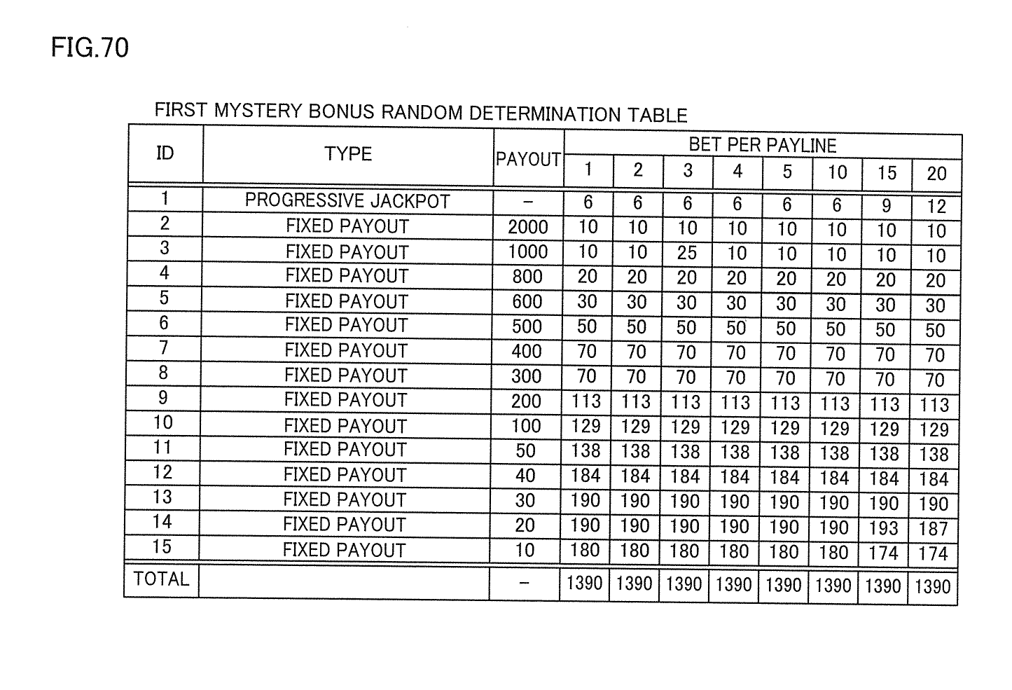

In view of the above, in the present embodiment, if the right to shift to the BONUS CHANCE WHEEL game is awarded to a gaming terminals 10 which does not participate in the common game during execution of the common game, performed is a first mystery bonus random determination process of selecting one of plural types of mystery bonuses by random determination with reference to a first mystery bonus random determination table (see FIG. 70) stored in the memory card 53, and the mystery bonus thus selected as a result of this process is awarded to this gaming terminal 10. The mystery bonuses from which the selection is made in the first mystery bonus random determination process include: four types of progressive jackpots; and fourteen types of fixed payouts. In the present embodiment, the first mystery bonus random determination process is performed in the gaming terminal 10 to which the right to shift to the BONUS CHANCE WHEEL game is awarded, however, the present disclosure is not limited to this. This process may be performed by the center controller 200. Alternatively, the following configuration is also possible: when the right to shift to the BONUS CHANCE WHEEL game is awarded, during execution of the common game, to a gaming terminal 10 which does not participate in the common game, one of the four types of progressive jackpots is always awarded to the gaming terminal 10.

In the first mystery bonus random determination table shown in FIG. 70, weights are respectively set for the mystery bonuses and for each credit amount bet per payline in the base game (BET PER LINE). Each weight represents the probability that the corresponding mystery bonus is selected in the first mystery bonus random determination process. For example, in the situation where the credit amount bet per payline in the base game is 1, the probability that the progressive jackpot is selected in the first mystery bonus random determination process is 6/1390. When the progressive jackpot is selected in the first mystery bonus random determination process, the progressive level random determination process of selecting one of the four types of jackpots to be awarded is further performed.

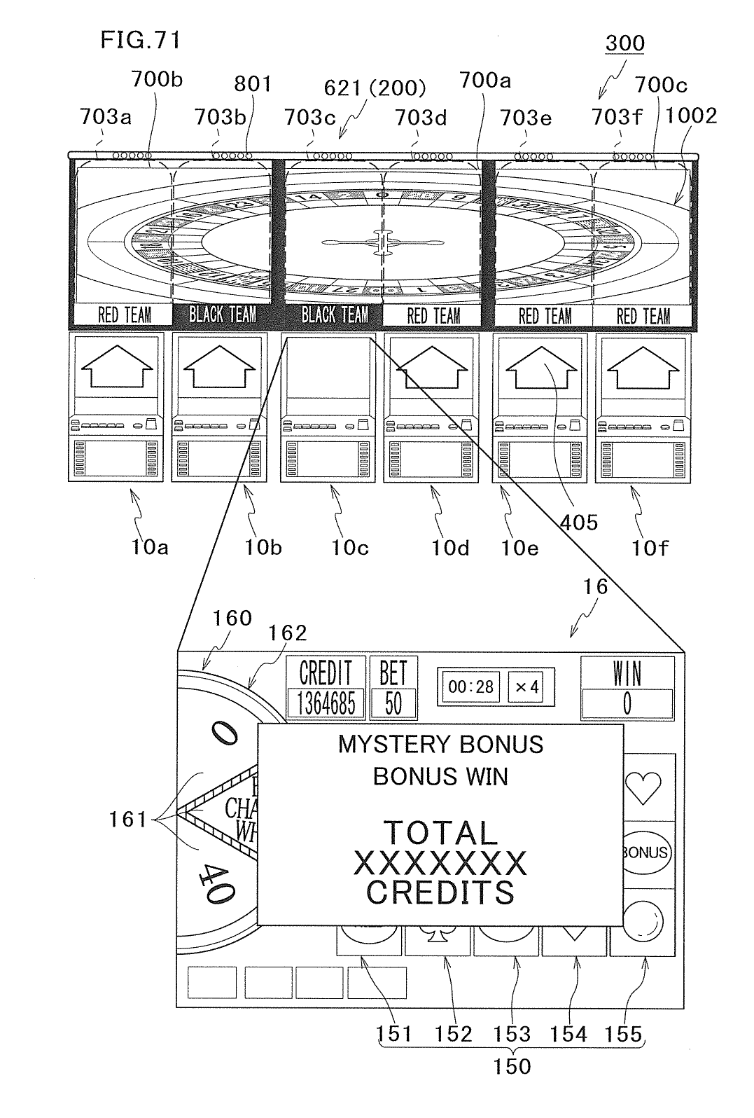

After the first mystery bonus random determination process is performed, as shown in FIG. 71, an image showing the thus selected mystery bonus is displayed on the terminal image display panel 16 of the gaming terminal 10. In the example shown in FIG. 71, the gaming terminal 10c is the gaming terminal which does not participate in the common game and to which the right to shift to the BONUS CHANCE WHEEL game has been awarded.

With the above structure, when the execution of the BONUS CHANCE WHEEL game is triggered in the situation where the other games cannot be executed using the upper displays 700 because the common game is being executed thereon, an effect of awarding a mystery bonus mysteriously is provided. As a result, the entertainment factor of the gaming machine 300 is enhanced.

In the present embodiment, the common game start random determination is made even while the common game is being executed. Thus, there is a possibility that the common game start condition is satisfied even while the common game is being executed. However, also in this event, the upper displays 700 are already used for the common game currently executed, and therefore it is impossible to execute two games simultaneously.

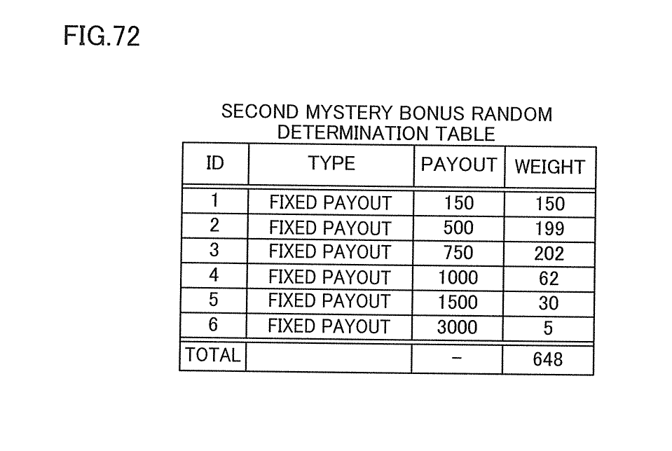

In view of the above, in the present embodiment, if the common game start condition is satisfied during execution of the common game, performed is a second mystery bonus random determination process of selecting one of plural types of mystery bonuses to be awarded to the gaming terminal 10 by random determination with reference to a second mystery bonus random determination table (see FIG. 72) stored in the memory card 263. The mystery bonus thus selected as a result of this random determination process is awarded to the gaming terminal 10 which is qualified to participate in the common game (whose qualification time is not zero). The mystery bonuses from which the selection is made in the second mystery bonus random determination process include: six types of fixed payouts. In the present embodiment, the second mystery bonus random determination process is performed by the center controller 200; however, the present disclosure is not limited to this. This process may be performed by any of the gaming terminals 10.

In the second mystery bonus random determination table shown in FIG. 72, a weight is defined for each of the mystery bonuses. Each weight represents the probability that the corresponding mystery bonus is selected in the second mystery bonus random determination process. For example, the probability that the fixed payout of 3000 is selected in the second mystery bonus random determination process is 5/648. Then, the mystery bonus thus selected in the second mystery bonus random determination process is awarded to the gaming terminal 10 qualified to participate in the common game.

Thus, when execution of the common game is further triggered during the execution of the common game, an effect of awarding a mystery bonus mysteriously is provided. As a result, the entertainment factor of the gaming machine 300 is enhanced.

Further, in the present embodiment, the gaming terminal 10 to which a mystery bonus is awarded when the common game start condition is awarded during execution of the common game is the gaming terminal 10 qualified to participate in the common game. This reduces the possibility that a mystery bonus is awarded to a gaming terminal 10 on which no player is playing a game. Note that, in the present embodiment, the gaming terminal 10 to which a mystery bonus is awarded is the gaming terminal 10 which does not currently participate in the common game, among the gaming terminals 10 qualified to participate in the common game. That is, a mystery bonus is not awarded to the gaming terminals 10 which are participating in the common game. As a modification, a mystery bonus may be awarded to the gaming terminals 10 qualified to participate in the common game. Further, in the present embodiment, the mystery bonuses to be awarded when the common game start condition is satisfied during execution of the common game do not include any progressive jackpot. However, it is possible to adopt a configuration in which one or more progressive jackpots are included in the mystery bonuses.

(Operation of Gaming Machine 300: Boot Process)

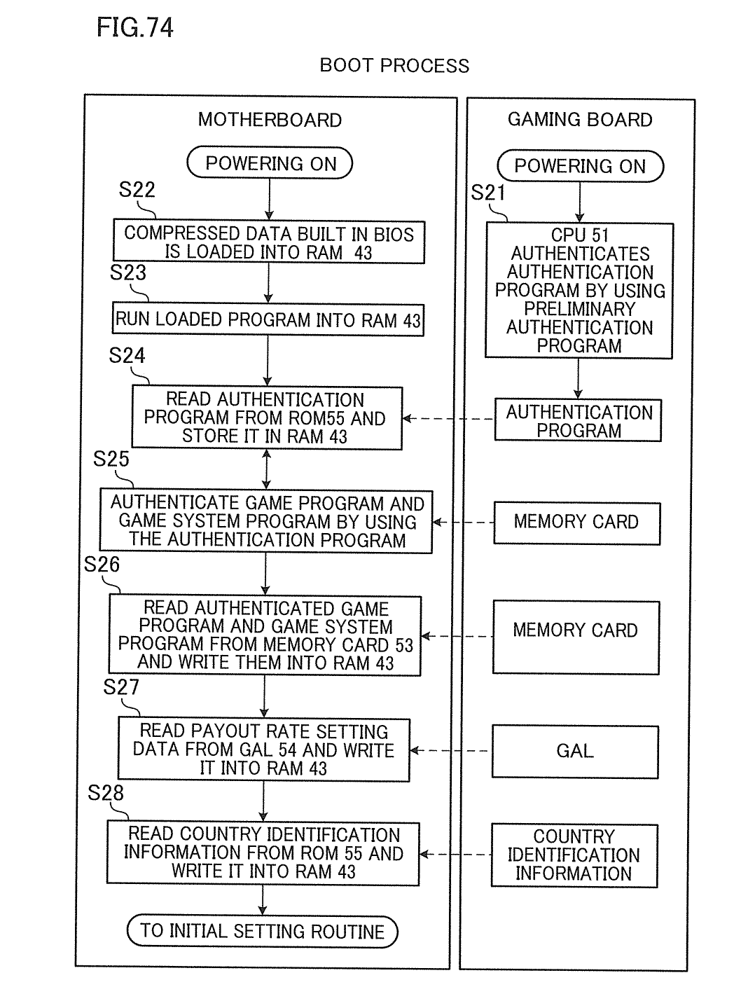

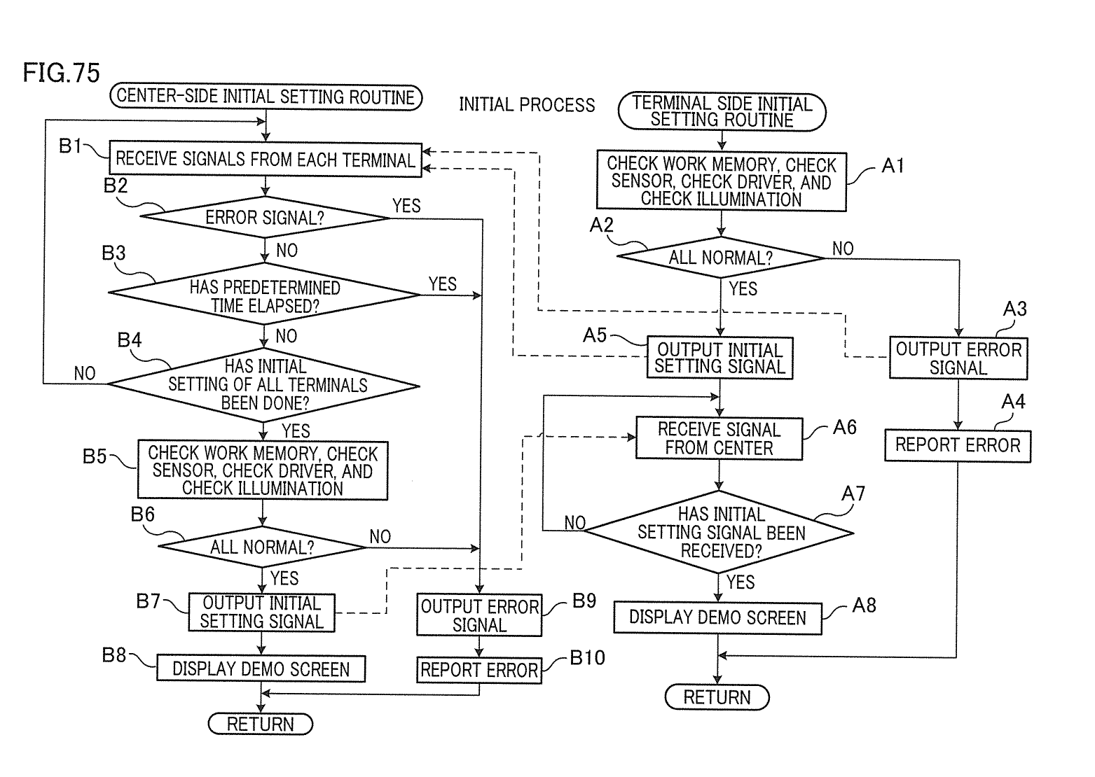

The following describes a boot process routine which takes place in the gaming machine 300. Upon powering on the gaming machine 300, a boot process routine illustrated in FIG. 74 starts in: the motherboard 240 and gaming board 260 in the center controller 200, and in the motherboard 40 and the gaming board 50 in the terminal controller 630. The memory cards 53 and 263 are assumed to be inserted into the card slots 53S and 263S of the gaming boards 50 and 260, respectively. Further, the GAL 54 and 264 are assumed to be attached to the IC socket 54S and 264S, respectively.

First, turning on the power switch of (powering on) the power supply units 45 and 245 boots the motherboards 40 and 240, and the gaming boards 50 and 260. Booting the motherboards 40 and 240 and the gaming boards 50 and 260 starts separate processes in parallel. Specifically, in the gaming boards 50 and 260, the CPUs 51 and 261 read out preliminary authentication programs stored in the boot ROMs 52 and 262, respectively. Then, preliminary authentication is performed according to the read out programs so as to confirm and verify that no falsification is made to authentication programs, before reading them in the motherboards 40 and 240, respectively (S21). Meanwhile, the main CPUs 41 and 241 of the motherboards 40 and 240 run BIOS stored in the ROMs 42 and 242 to load into the RAMs 43 and 243 compressed data built in the BIOS, respectively (S22). Then, the main CPUs 41 and 241 run a procedure of the BIOS according to the data loaded into the RAMs 43 and 243 so as to diagnose and initialize various peripheral devices (S23).

The main CPUs 41 and 241, which are respectively connected to the ROMs 55 and 265 of the gaming boards 50 and 260 via PCI buses, read out authentication programs stored in the ROMs 55 and 265 and stores them in the RAMs 43 and 243 (S24). During this step, the main CPUs 41 and 241 each derives a checksum through ADDSUM method (a standard check function) which is adopted in a standard BIOS, and store the authentication programs into RAMs 43 and 243 while confirming if the operation of storing is carried out without an error.

Next, the main CPUs 41 and 241 each checks what connects to the IDE bus. Then, the main CPUs 41 and 241 access, via the IDE buses, to the memory cards 53 and 263 inserted into the card slots 53S and 263S, and read out game programs and game system programs from the memory cards 53 and 263, respectively. In this case, the main CPUs 41 and 241 each reads out four bytes of data constituting the game program and the game system program at one time. Next, the main CPUs 41 and 241 authenticate the game program and the game system program read out to confirm and verify that these programs are not falsified, using the authentication program stored in RAMs 43 and 243 (S25).

When the authentication properly ends, the main CPUs 41 and 241 write and store the authenticated game programs and game system programs in RAMs 43 and 243 (S26).

Next, the main CPUs 41 and 241 access, via the PCI buses, to the GALs 54 and 264 attached to the IC sockets 54S and 264S, and read out payout ratio setting data from the GALs 54 and 264, respectively. The payout rate setting data read out is then written and stored in the RAMs 43 and 243 (S27).

Next, the main CPUs 41 and 241 read out, via the PCI buses, country identification information stored in the ROMs 55 and 265 of the gaming boards 50 and 260, respectively. The country identification information read out is then stored in the RAMs 43 and 243 (S28).

After this, the main CPUs 41 and 241 each perform an initial process of FIG. 75.

(Operation of Gaming Machine 300: Initial Process)

The following describes an initial process which takes place in the gaming machine 300. When the boot process of FIG. 74 is completed, the center controller 200 reads out from the RAM 243 a center-side initial setting routine shown in FIG. 75 and executes the routine. Meanwhile, when the boot process of FIG. 74 is completed, the gaming terminal 10 reads out from the RAM 43 a terminal side initial setting routine shown in FIG. 75 and executes the routine. The center-side and terminal side initial setting routines are executed in parallel.

First, the main CPU 41 of each of the gaming terminals 10 checks operations of work memories such as the RAM 43, various sensors, various driving mechanisms, and various decorative illuminations (A1). Then, the main CPU 41 determines if all the check results are normal (A2). If the main CPU 41 determines that the check results contains an error (A2: NO), the main CPU 41 outputs a signal notifying the error (hereinafter, error signal) to the center controller 200 (A3). Further, the main CPU 41 reports the error in the form of illuminating the lamp 30 or the like (A4), and then ends the routine.

On the other hand in A2, if the main CPU 41 determines that all the check results are normal (A2: YES), an initial setting signal is output to the center controller 200 (A5). Then, the supply of an initial setting signal from the center controller 200 is waited for (A6, A7: NO).

The main CPU 241 of the center controller 200 receives signals from each of the terminals (B1). Then, the main CPU 241 determines whether a signal received is an error signal (B2). If the main CPU 241 determines that the signal is an error signal (B2: YES), the main CPU 241 outputs the error signal to a server of an unillustrated host computer or the like (B9) to report the error (B10), and ends the routine.

On the other hand in B2, if the main CPU 241 determines that the signal is not an error signal (B2: NO), the main CPU 241 determines whether a predetermined time (check time) has elapsed from the time of powering on (B3). If the main CPU 241 determines that the check time has elapsed (B3: YES), B9 is executed. On the other hand, if the main CPU 241 determines that the check time has not yet elapsed (B3: NO), it is determined whether an initial setting signal is received from each of the gaming terminals 10 (B4). If the main CPU 241 determines that an initial setting signal from any one of the gaming terminals 10 is not received (B4: NO), the processing returns to B1. On the other hand, if it is determined that initial setting signals from all the gaming terminals 10 are received (B4: YES), the main CPU 241 checks operations of work memories such as RAM 243 or the like, various sensors, various driving mechanisms, and various decorative illuminations (B5). Then, the main CPU 241 determines if all the check results are normal (B6). If the main CPU 241 determines the check results contain an error (B6: NO), the main CPU 241 executes B9.

On the other hand in B6, if the main CPU 241 determines that all the check results are normal (B6: YES), the main CPU 241 outputs an initial setting signal to all the gaming terminals 10 (B7), and causes the upper displays 700 to display a demo-screen (B8). Then, the main CPU 241 ends the routine.

In A7, the main CPU 41 of each of the gaming terminals 10 determines that an initial setting signal is received from the center controller 200 (A7: YES), and causes the terminal image display panel 16 to display a demo-screen (A7). The main CPU 41 then ends the routine.

(Operation of Gaming Terminal 10: Terminal-Side Normal Game Process Routine)

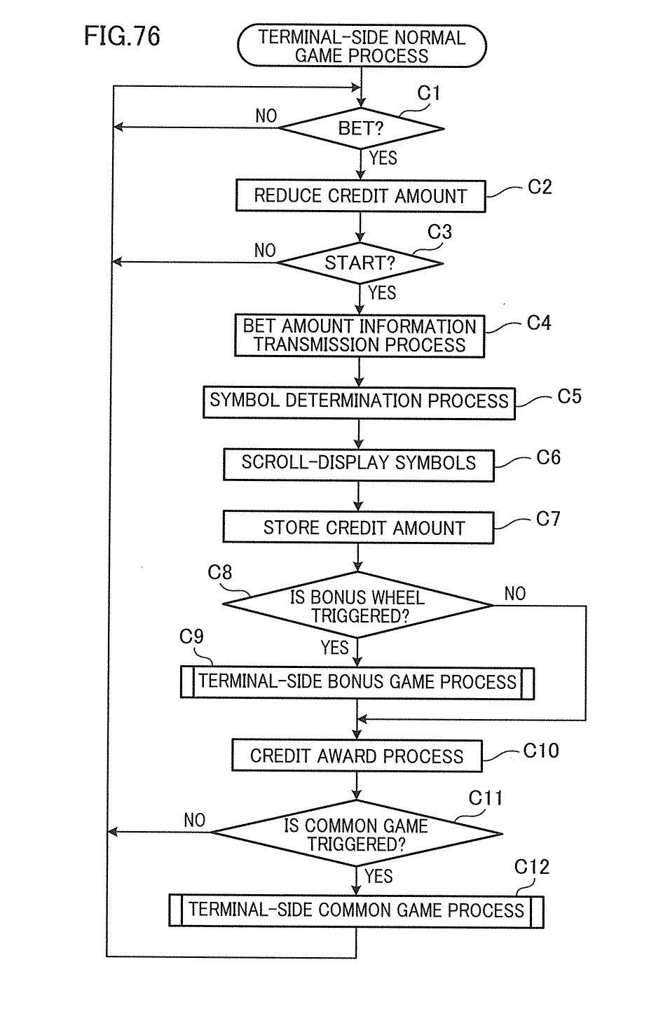

After the terminal side initial setting routine of FIG. 75, the main CPU 41 of the gaming terminal 10 performs a terminal-side normal game process routine of FIG. 76. Through this terminal-side normal game process routine executed by the main CPU 41, a normal game is executed.

As shown in FIG. 76, in this terminal-side normal game process routine, the main CPU 41 determines whether a credit is bet (C1). In this step, it is determined whether an input signal output from any of the BET switches 23S to 27S in response to pressing of corresponding one of the BET buttons 23 to 27 is received. If no credit is bet (C1: NO), a standby-state continues by repeating C1 until a credit is bet.

Meanwhile, if a credit is bet (C1: YES), the main CPU 41 reduces the credit amount stored in the RAM 43 according to the credit amount bet (C2). When the credit amount bet surpasses the credit amount stored in the RAM 43, later-described C3 is conducted without the reduction of the credit amount. When the credit amount bet exceeds the upper limit bettable to execute the game once (150 in the present embodiment), the processing goes to the later-described C3 without the reduction of the credit amount.

Then the main CPU 41 determines whether the spin button 29 is pressed to start the game (C3). If not started (C3: NO), the processing returns to C1. Here, if not started (for example, a command to end the game is input before the start), the reduction of the credit amount in C2 is canceled.

Meanwhile, if started (C3: YES), the main CPU 41 executes a bet amount information transmitting process (C4). In other words, the main CPU 41 transmits a BET amount data indicating the bet amount bet in the base game to the center controller 200. In this step, the main CPU 41 refers to the base game qualification time awarding table shown in FIG. 38, to prepare qualification time data including: an amount of qualification time newly awarded to each gaming terminal 10; and the common game payout multiplying factor associated therewith. Then, the main CPU 41 transmits the qualification time data to the center controller 200.

Subsequently, the main CPU 41 executes a symbol determination process (C5). That is, a stop symbol determining program stored in the RAM 43 is executed to determine symbols 501 to be stopped on the display windows 150.

Then, the main CPU 41 executes a scrolling process of scroll displaying symbols 501 on the terminal image display panel 16 (C6). The scrolling process is a process in which the symbols 501 determined in C5 are stopped (rearranged) on the display windows 150 after scrolling of symbols 501 in a direction indicated by arrows, as shown in FIG. 12.

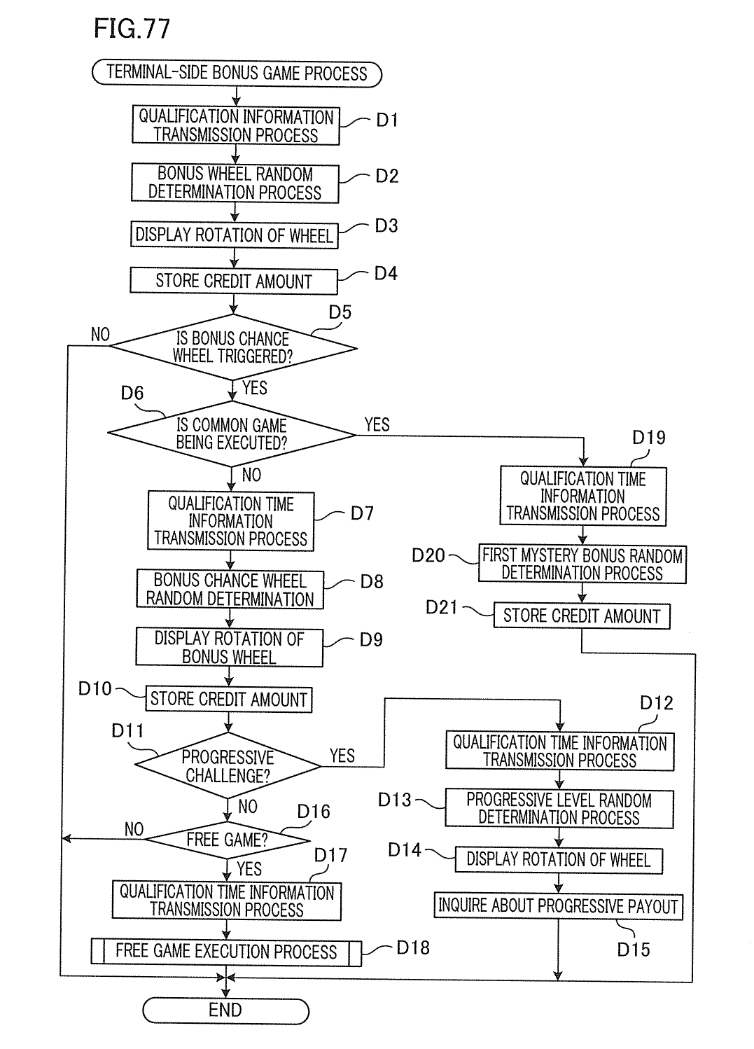

Then, the main CPU 41 executes an awarded credit amount determination process (C7). In this process, an awarded credit amount for one or more combinations of symbols possibly achieved on the paylines is determined referring to the base game payout table (see FIG. 11). The awarded credit amount thus determined is stored in an awarded credit amount storage area in the RAM 43. Thereafter, the main CPU 41 determines whether a trigger of the BONUS WHEEL game has been established (C8). In the present embodiment, when three or more “BONUS” symbols 510, which are trigger symbols for the BONUS WHEEL game, are rearranged on the display window 150 as shown in FIG. 14A, shifting to the BONUS WHEEL game occurs. When the main CPU 41 determines that the trigger of the BONUS WHEEL game has been established (C8: YES), the main CPU 41 executes a terminal-side bonus game process, which will be described later with reference to FIG. 77 (C9).

After C9, or when the main CPU 41 determines that the trigger of the BONUS WHEEL game is not established in C8 (C8: NO), the main CPU 41 executes a credit award process (C10). In this process, the value stored in the awarded credit amount storage area is added to the value stored in a credit amount storage area provided in the RAM 43. Note that, the main CPU 41 may controls the PTS device 900 based on an input through the CASHOUT switch 22S, to write the data indicating the value stored in the awarded credit amount storage area into the IC card inserted into the card slot as credit data. At this time, the main CPU 41 controls the terminal image display panel 16 to display thereon the value stored in the awarded credit amount storage area, as the total credit amount obtained in the normal game.

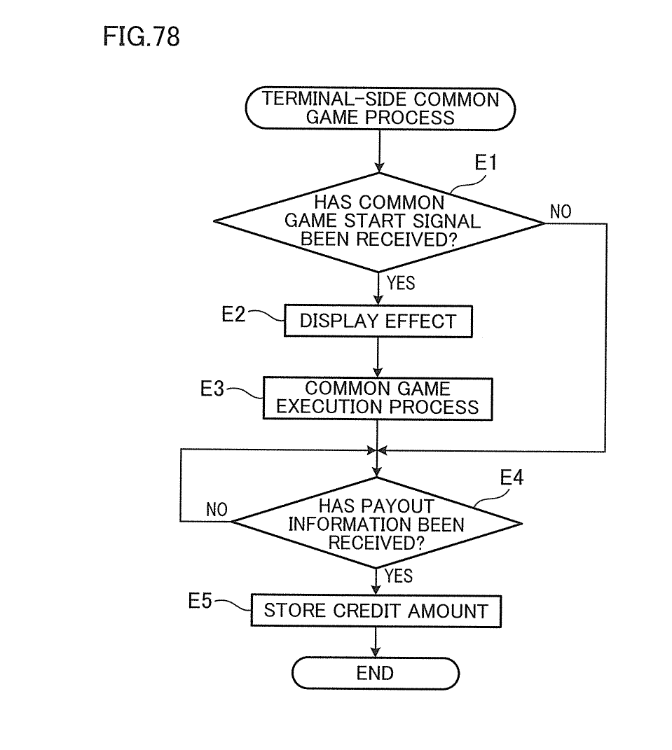

Subsequently, the main CPU 41 determines whether a common game trigger signal has been received from the center controller 200 (C11). The common game trigger signal indicates either execution of a common game or awarding of a mystery bonus is performed. When the main CPU 41 has received the common game trigger signal (C11: YES), the main CPU 41 executes a terminal-side common game process, which will be described later with reference to FIG. 78 (C12). After C12 or when the main CPU 41 determines that the common game trigger signal has not been received (C11: NO), the processing returns to C1.

(Operation of Gaming Terminal 10: Terminal-Side Bonus Game Process Routine)

The main CPU 41 of the gaming terminal 10 executes, in the terminal-side bonus game process (C9) shown in FIG. 76, a terminal-side bonus game process routine shown in FIG. 77.

As shown in FIG. 77, first of all, the main CPU 41 refers to the BONUS WHEEL game qualification time awarding table shown in FIG. 39, to prepare qualification time data including: an amount of qualification time newly awarded to each gaming terminal 10; and the common game payout multiplying factor associated therewith. Then, the main CPU 41 transmits the qualification time data to the center controller 200 (D1). Then, the main CPU 41 executes a BONUS WHEEL random determination process referring to the BONUS WHEEL random determination table shown in FIG. 15 (D2). In this process, the area 161 to be indicated by the indicator 163 when the wheel 162 of the terminal screen wheel 160 is stopped is determined.

Then, the main CPU 41 executes a process of rotating the wheel 162 on the terminal image display panel 16 (D3). In this process, the wheel 162 is rotated in a direction indicated by the arrow (see FIG. 14A), and then the area 161 determined in D2 is stopped on the position indicated by the indicator 163.

Then, the main CPU 41 refers to the BONUS WHEEL random determination table, to store the payout associated with the area 161 indicated by the indicator 163 in the awarded credit amount storage area provided in the RAM 43 (D4). Thereafter, the main CPU 41 determines whether a trigger of the BONUS CHANCE WHEEL game has been established (D5). In the present embodiment, when the indicator 163 indicates the trigger area 161a associated with the BONUS CHANCE WHEEL game as shown in FIG. 14B, shifting to the BONUS CHANCE WHEEL game occurs. When the main CPU 41 determines that the trigger of the BONUS CHANCE WHEEL game is not established (D5: NO), the terminal-side bonus game process ends. Meanwhile, when the main CPU 41 determines that the trigger of the BONUS CHANCE WHEEL game has been established (D5: YES), the main CPU 41 determines whether the common game is being executed (D6). In the present embodiment, the main CPU 41 asks the center controller 200 whether the common game is being executed or not. As a modification, determination whether the common game is being executed may be made in the following manner: during execution of a common game, the center controller 200 transmits, to each gaming terminal 10, a signal indicating that the common game is being executed; and the main CPU 41 determines whether the common game is being executed based on the presence or absence of the signal.

When the main CPU 41 determines that the common game is not being executed (D6: NO), the main CPU 41 refers to the BONUS CHANCE WHEEL game qualification time awarding table shown in FIG. 40, to prepare qualification time data including: an amount of qualification time newly awarded to each gaming terminal 10; and the common game payout multiplying factor associated therewith. Then, the main CPU 41 transmits the qualification time data to the center controller 200 (D7).

Then, the main CPU 41 executes a BONUS CHANCE WHEEL random determination process referring to the BONUS CHANCE WHEEL random determination table shown in FIG. 20 (D8). In this process, the area 761 to be indicated by the indicator 763 when the wheel 762 of the common screen wheel 760 is stopped is determined.

Then, the main CPU 41 executes a process of rotating the wheel 762 on the corresponding gaming terminal area 703 of the upper displays 700 (D9). In this process, the wheel 762 is rotated in a direction indicated by the arrow (see FIG. 19A), and then the area 761 determined in D8 is stopped on the position indicated by the indicator 763. Further, in the present embodiment, this effect on the upper displays 700 is provided by the display controller 701 controlled by the center controller 200 which has received an instruction from the main CPU 41. As a modification, it is possible to adopt the following configuration: the main CPU 41 and the display controller 701 are directly connected to each other, and the effect on the upper displays 700 is provided by the display controller 701 controlled by the main CPU 41.

Then, the main CPU 41 refers to the BONUS CHANCE WHEEL random determination table, to store the payout associated with the area 761 indicated by the indicator 763 in the awarded credit amount storage area provided in the RAM 43 (D10). Thereafter, the main CPU 41 determines whether a trigger of the progressive challenge has been established (D11). In the present embodiment, shifting to the progressive challenge occurs when the indicator 763 indicates the area 761 associated with the progressive challenge. When the main CPU 41 determines that the trigger of the progressive challenge has been established (D11: YES), the main CPU 41 refers to the progressive challenge qualification time awarding table shown in FIG. 42, to prepare qualification time data including: an amount of qualification time newly awarded to each gaming terminal 10; and the common game payout multiplying factor associated therewith. Then, the main CPU 41 transmits the qualification time data to the center controller 200 (D12).

Then, the main CPU 41 executes a progressive level random determination process of determining which type of progressive jackpot is awarded to the gaming terminal 10 referring to the progressive level random determination tables (see FIG. 24A to FIG. 24E) (D13). Then, as shown in FIG. 22A, the main CPU 41 replaces the common screen wheel 760 to the progressive challenge wheel 860 on the corresponding gaming terminal area 703 on the upper displays 700, and executes a process of rotating the wheel 862 of the progressive challenge wheel 860 (D14). In this process, the wheel 862 is rotated in a direction indicated by the arrow (see FIG. 22B), and then the area 861 indicating the type of the progressive jackpot determined in D13 is stopped on the position indicated by the indicator 863.

Then, the main CPU 41 asks the center controller 200 about the payout amount of the progressive jackpot determined in D13 (progressive payout), and stores the obtained payout amount of the awarded credit amount storage area in RAM 43 (D15). Specifically, the main CPU 41 transmits a progressive level signal indicating the type of the winning jackpot, and receives, from the center controller 200, payout information indicating the payout amount of the winning progressive jackpot. After the above is completed, the terminal-side bonus game process ends.

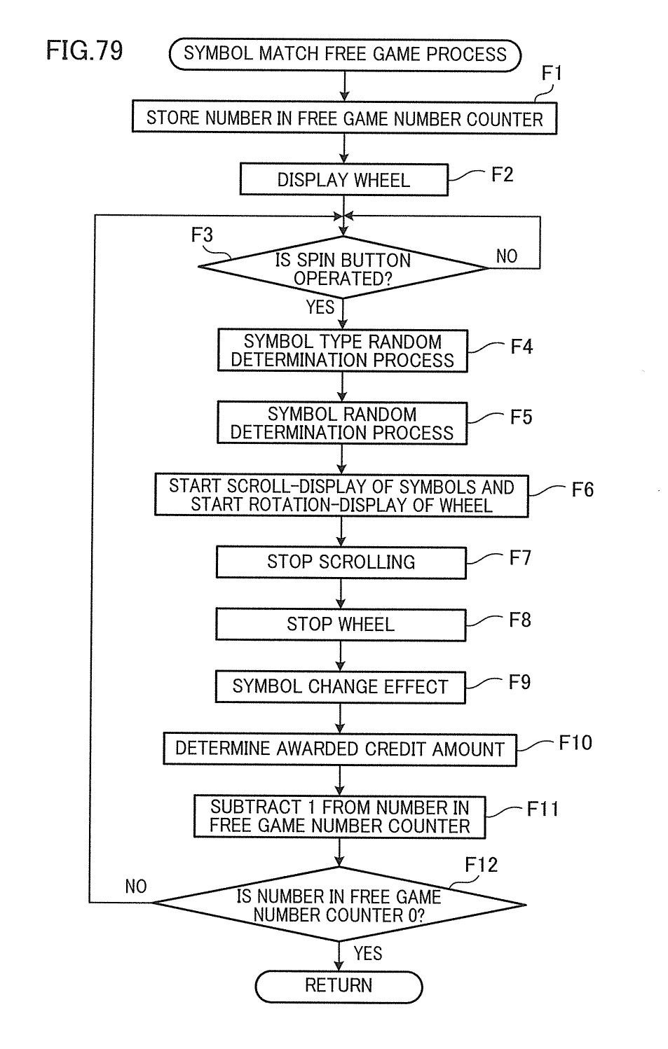

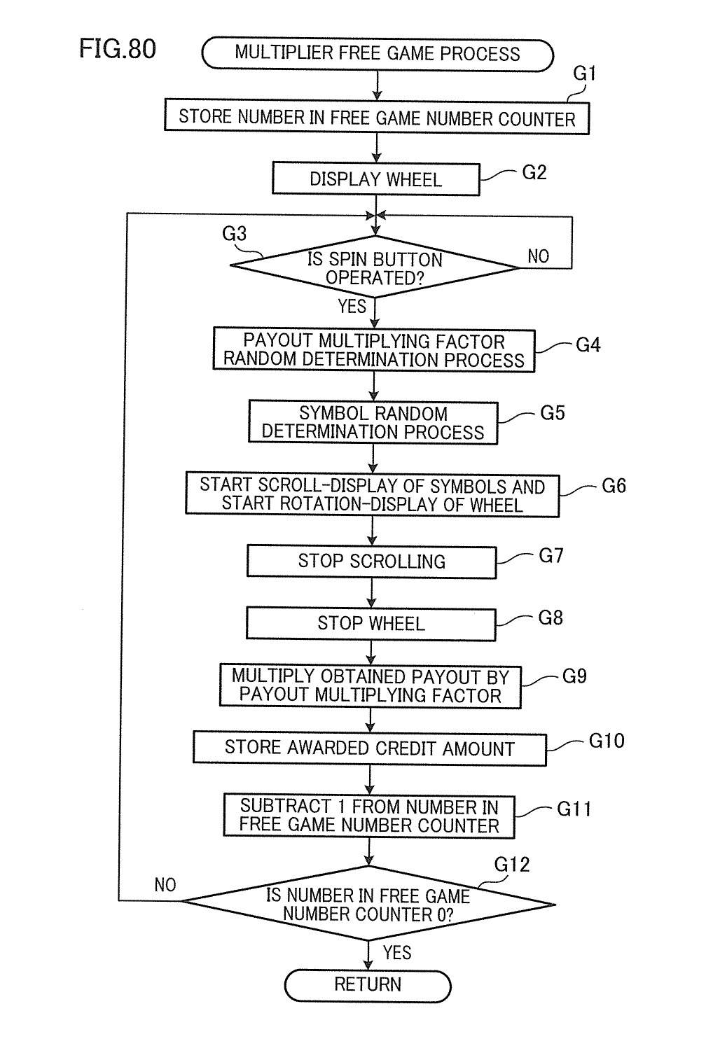

When, in D11, the main CPU 41 determines that the trigger of the progressive challenge is not established (D11: NO), the main CPU 41 determines whether a free game trigger by which shifting to one of the three types of free games occurs is established (D16). In the present embodiment, when the indicator 763 indicates the area 761 associated with any one of the three types of free games, shifting to the indicated free game occurs. When the main CPU 41 determines that the free game trigger is not established (D16: NO), the terminal-side bonus game process ends. When the main CPU 41 determines that the free game trigger has been established (D16: YES), the main CPU 41 refers to the free game qualification time awarding table shown in FIG. 41, to prepare qualification time data including: an amount of qualification time newly awarded to each gaming terminal 10; and the common game payout multiplying factor associated therewith. Then, the main CPU 41 transmits the qualification time data to the center controller 200 (D17). Then, the main CPU 41 executes one of the three types of the free games, which will be described later with reference to FIG. 79 to FIG. 81. Note that the type of the free game executed by the main CPU 41 is the type associated with the area 761 indicated by the indicator 763. After the above is completed, the terminal-side bonus game process ends.

When, in D6, the main CPU 41 determines that the common game is being executed (D6: YES), the main CPU 41 refers to the mystery bonus qualification time awarding table shown in FIG. 43, to prepare qualification time data including: an amount of qualification time newly awarded to each gaming terminal 10; and the common game payout multiplying factor associated therewith. Then, the main CPU 41 transmits the qualification time data to the center controller 200 (D19). Then, the main CPU 41 executed the first mystery bonus random determination process of selecting one of the plural types of mystery bonuses to be awarded to the gaming terminal 10 by random determination, referring to the first mystery bonus random determination table shown in FIG. 70 (D20). When the progressive jackpot is selected as the mystery bonus, the progressive level random determination process is executed in the same way as in D13, to determine which of the four types of progressive jackpots is awarded to the gaming terminal 10.

Then, the main CPU 41 stores the payout amount associated with the mystery bonus determined in D20 in the awarded credit amount storage area of RAM 43 (D21). Then, the terminal-side bonus game process ends.

(Operation of Gaming Terminal 10: Terminal-Side Common Game Process Routine)

The main CPU 41 of the gaming terminal 10 executes, in the terminal-side common game process (C12) shown in FIG. 76, a terminal-side common game process routine shown in FIG. 78.

As shown in FIG. 78, the main CPU 41 determines whether a common game start signal has been received from the center controller 200 (E1). When the main CPU 41 determines that the common game start signal has not been received (E1: NO), the processing goes to E4, to award a mystery bonus without executing the common game. Meanwhile, when determining that the common game start signal has been received (E1: YES), the main CPU 41 provides various types of effects related to the common game (E2). For example, a look-up image 405 shown in FIG. 18 is displayed on the terminal image display panel 16.

Subsequently, the main CPU 41 executes a common game execution process (E3). In this step, in response to the instruction from the center controller 200, the main CPU 41 displays various types of effect images related to the common game on the terminal image display panel 16, and receives an input of the operation by the player through the spin button 29 or the like and transmits a signal related to such an input to the center controller 200.

After E3 or when determining that the common game start signal has not been received in E1 (E1: NO), the main CPU 41 determines whether payout information has been received from the center controller 200 (E4). If the payout information has not been received, the routine is on standby (E4: NO). When the payout information has been received (E4: YES), the credit amount indicated by the received payout information is stored in the awarded credit amount storage area in the RAM 43, or is added to the value stored in the credit amount storage area in the RAM 43 (E5). At this time, the main CPU 41 controls the terminal image display panel 16 to display thereon an image indicating the obtained credit amount, as the credit amount obtained in the common game, or as the credit amount obtained as a mystery bonus. After the above is completed, the terminal-side common game process ends.

(Operation of Gaming Terminal 10: SYMBOL MATCH FREE GAME Process Routine)

The main CPU 41 of the gaming terminal 10 executes, in the free game execution process (D18) shown in FIG. 77, a SYMBOL MATCH FREE GAME process routine shown in FIG. 79 when executing the SYMBOL MATCH FREE GAME.

First of all, the main CPU 41 stores the number of times of execution of the free game to be executed (in the present embodiment, 5) in a free game number counter in the RAM 43 (F1).

Then, the main CPU 41 provides effects of: replacing the terminal screen wheel 160 displayed on the terminal image display panel 16 to the SYMBOL MATCH FREE GAME wheel 170; and replacing the video reel strips of the video reels 151 to 155 to the video reel strips for the SYMBOL MATCH FREE GAME (F2). Then the main CPU 41 determines whether the spin button 29 is pressed to start the game (F3). If not started (F3: NO), the processing returns to F3.

Meanwhile, if started (F3: YES), the main CPU 41 executes a symbol type random determination process (F4). In this step, the type(s) of symbols to be changed to the “WILD” symbols 515 is determined. Subsequently, the main CPU 41 executes a symbol determination process (F5). That is, the stop symbol determining program stored in the RAM 43 is executed to determine symbols to be stopped on the display windows 150.

Then, as shown in FIG. 28A, the main CPU 41 executes a scrolling process of scroll displaying symbols 501 on the terminal image display panel 16, and executes a process of starting the rotation of the wheel 172 of the SYMBOL MATCH FREE GAME wheel 170 (F6). Subsequently, the main CPU 41 stops the scroll displaying of the symbols (F7). That is, the symbols 501 determined in F5 are stopped (rearranged) on the display window 150. Then, the main CPU 41 stops the rotation of the wheel 172 so that the area 171 associated with the type of symbols determined in F4 is indicated by the indicator 173 (F8).

Then, the main CPU 41 provides an effect of changing one or more symbols of the type determined in F4 out of the symbols rearranged on the display window 150 to the “WILD” symbols 515 (F9).

Then, the main CPU 41 executes an awarded credit amount determination process (F10). In this process, an awarded credit amount for one or more combinations of symbols possibly achieved on the paylines is determined referring to the free game payout table (see FIG. 29). The awarded credit amount thus determined is stored in an awarded credit amount storage area in the RAM 43.

Then, the main CPU 41 subtracts 1 from the value of the free game number counter in the RAM 43, and updates the value (F11). Then, the main CPU 41 determines whether the value in the free game number counter updated in F11 is larger than 0 (F12). When the main CPU 41 determines that the value in the free game number counter is larger than 0 (F12: YES), the processing goes to F3.

When the value in the free game number counter is 0 (F12: NO), the SYMBOL MATCH FREE GAME process ends.

(Operation of Gaming Terminal 10: MULTIPLIER FREE GAME Process Routine)

The main CPU 41 of the gaming terminal 10 executes, in the free game execution process (D18) shown in FIG. 77, a SYMBOL MATCH FREE GAME process routine shown in FIG. 80 when executing the MULTIPLIER FREE GAME.

First of all, the main CPU 41 stores the number of times of execution of the free game to be executed (in the present embodiment, 5) in a free game number counter in the RAM 43 (F1).

Then, the main CPU 41 provides effects of: replacing the terminal screen wheel 160 displayed on the terminal image display panel 16 to the MULTIPLIER FREE GAME wheel 180; and replacing the video reel strips of the video reels 151 to 155 to the video reel strips for the MULTIPLIER FREE GAME (G2). Then the main CPU 41 determines whether the spin button 29 is pressed to start the game (G3). If not started (G3: NO), the processing returns to G3.

Meanwhile, if started (G3: YES), the main CPU 41 executes a payout multiplying factor random determination process referring to the payout multiplying factor random determination table shown in FIG. 31 (G4). In this process, determined is the payout multiplying factor for the payout obtained in the free game. Subsequently, the main CPU 41 executes a symbol determination process (G5). That is, the stop symbol determining program stored in the RAM 43 is executed to determine symbols to be stopped on the display windows 150.

Then, the main CPU 41 executes a scrolling process of scroll displaying symbols on the terminal image display panel 16, and executes a process of starting the rotation of the wheel 182 of the MULTIPLIER FREE GAME wheel 180 (G6). Subsequently, the main CPU 41 stops the scroll displaying of the symbols (G7). That is, the symbols determined in G5 are stopped (rearranged) on the display window 150. Then, the main CPU 41 stops the rotation of the wheel 182 so that the area 181 associated with the payout multiplying factor determined in G4 is indicated by the indicator 183 (G8).

Then, referring to the free game payout table (see FIG. 29), the main CPU 41 determines an awarded credit amount (payout) for one or more combinations of symbols possibly achieved on the paylines, and calculates the awarded credit amount storage area by multiplying the above payout by the payout multiplying factor determined in G4 (G9). The main CPU 41 stores the thus calculated awarded credit amount in the awarded credit amount storage area in the RAM 43.

Then, the main CPU 41 subtracts 1 from the value of the free game number counter in the RAM 43, and updates the value (G11). Then, the main CPU 41 determines whether the value in the free game number counter updated in G11 is larger than 0 (G12). When the main CPU 41 determines that the value in the free game number counter is larger than 0 (G12: YES), the processing goes to G3. When the value in the free game number counter is 0 (G12: NO), the MULTIPLIER FREE GAME process ends.

(Operation of Gaming Terminal 10: WILD FREE GAME Process Routine)

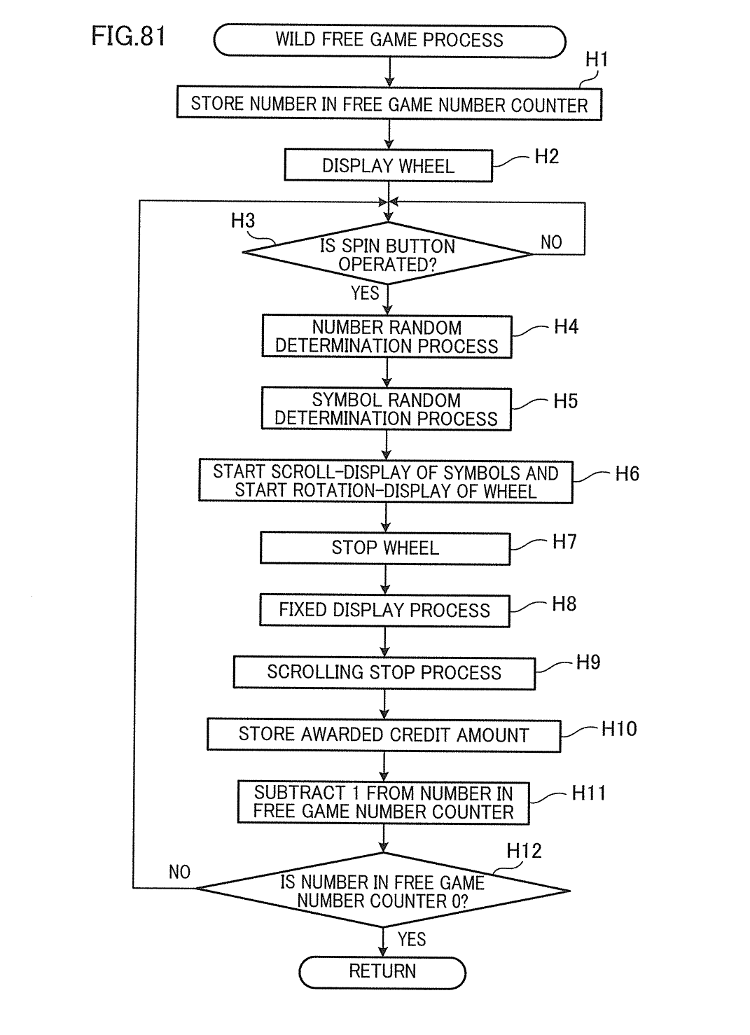

The main CPU 41 of the gaming terminal 10 executes, in the free game execution process (D18) shown in FIG. 77, a WILD FREE GAME process routine shown in FIG. 81 when executing the WILD FREE GAME.

First of all, the main CPU 41 stores the number of times of execution of the free game to be executed (in the present embodiment, 5) in a free game number counter in the RAM 43 (H1).

Then, the main CPU 41 provides effects of: replacing the terminal screen wheel 160 displayed on the terminal image display panel 16 to the WILD FREE GAME wheel 190; and replacing the video reel strips of the video reels 151 to 155 to the video reel strips for the WILD FREE GAME (H2). Then the main CPU 41 determines whether the spin button 29 is pressed to start the game (H3). If not started (G3: NO), the processing returns to H3.

Meanwhile, if started (H3: YES), the main CPU 41 executes a number random determination process referring to the number random determination table shown in FIG. 35 (H4). In this process, determined is the number of “WILD” symbols 515 displayed in a fixed manner in the free game. Subsequently, the main CPU 41 executes a symbol determination process (H5). That is, the stop symbol determining program stored in the RAM 43 is executed to determine symbols to be stopped on the display windows 150.

Then, the main CPU 41 executes a scrolling process of scroll displaying symbols on the terminal image display panel 16, and executes a process of starting the rotation of the wheel 192 of the WILD FREE GAME wheel 190 (H6). Then, the main CPU 41 stops the rotation of the wheel 182 so that the area 191 associated with the number determined in H4 is indicated by the indicator 193 (H7). Then, the main CPU 41 executes a fixed display process of displaying, in a fixed manner, the “WILD” symbol(s) 515 of which number is equal to the number determined in H4, on some of the 15 display blocks 28 of the display window 150 (H8). Once the “WILD” symbol 515 is displayed in a fixed manner on a display block 28, the “WILD” symbol 515 remains displayed on the display block 28 in the free game executed thereafter, as shown in FIG. 37D.

Subsequently, the main CPU 41 stops the scroll displaying of the symbols (H9). That is, the symbols determined in H5 are stopped (rearranged) on the display window 150.

Then, the main CPU 41 executes an awarded credit amount determination process (H10). In this process, an awarded credit amount for one or more combinations of symbols possibly achieved on the paylines is determined referring to the free game payout table (see FIG. 29). The awarded credit amount thus determined is stored in an awarded credit amount storage area in the RAM 43.

Then, the main CPU 41 subtracts 1 from the value of the free game number counter in the RAM 43, and updates the value (H11). Then, the main CPU 41 determines whether the value in the free game number counter updated in H11 is larger than 0 (H12). When the main CPU 41 determines that the value in the free game number counter is larger than 0 (H12: YES), the processing goes to H3. When the value in the free game number counter is 0 (H12: NO), the WILD FREE GAME process ends.

(Operation of Center Controller 200)

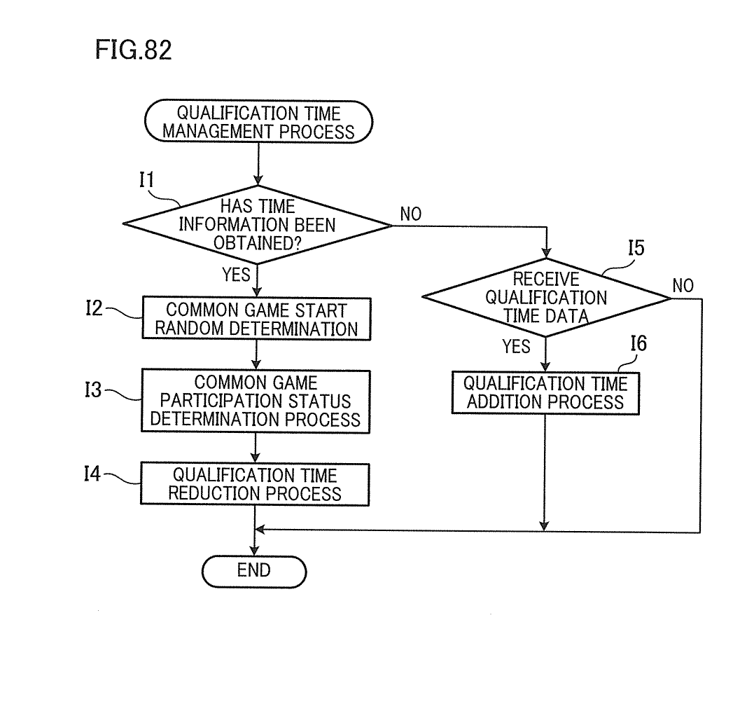

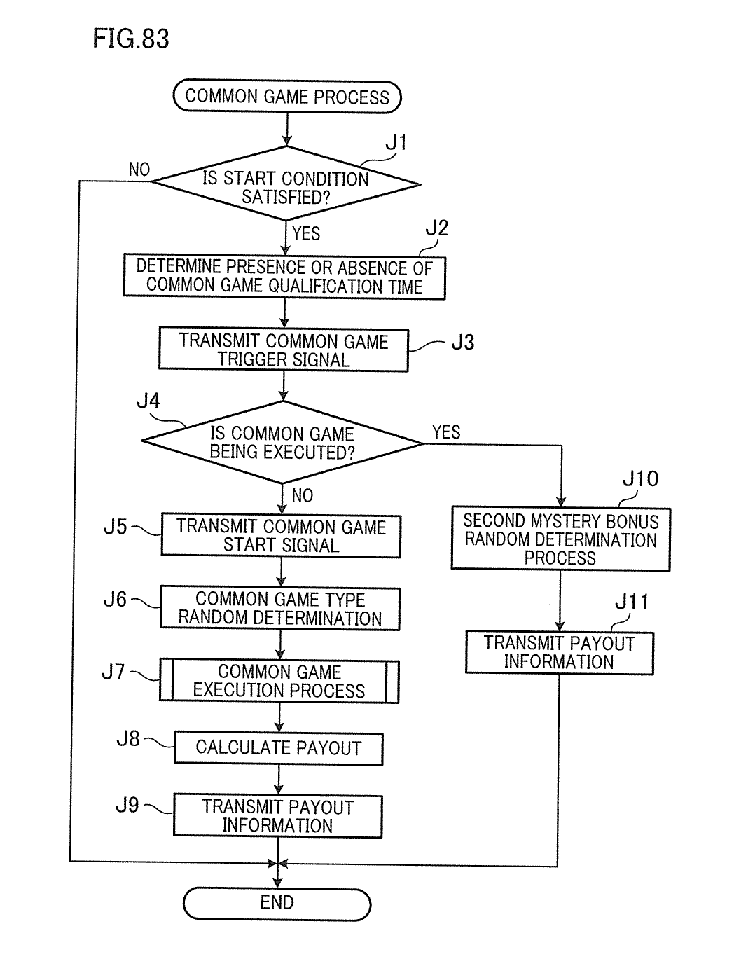

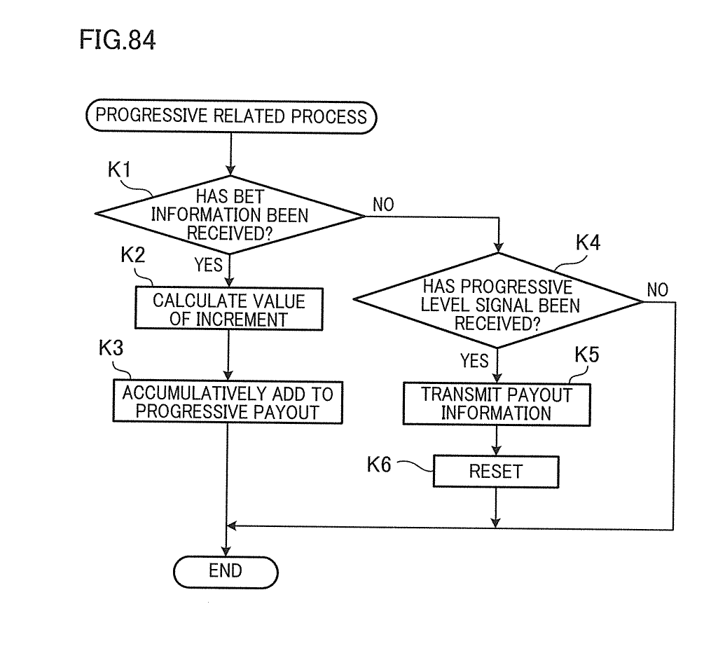

After completing the center-side initial setting routine shown in FIG. 75, the main CPU 241 of the center controller 200 executes: a qualification time management process routine shown in FIG. 82; a common game process routine shown in FIG. 83; and a progressive related process routine shown in FIG. 84, in a parallel manner. Although not illustrated, the qualification time management process routine is executed at time intervals shorter than the intervals at which the time information is output from the timer 271.

(Qualification Time Management Process Routine)

The following will describe the qualification time management process routine, with reference to FIG. 82.

As shown in FIG. 82, the main CPU 241 determines whether a time information has been received from the timer 271 (I1). When determining that the time information has been received (I1: YES), the main CPU 241 performs a common game start random determination with reference to the common game start random determination table shown in FIG. 45 (I2). As a result, it is determined whether to satisfy the common game start condition. Thereafter, the main CPU 241 determines whether each gaming terminal 10 is participating in the common game (13). The main CPU 241 uniformly reduces a predetermined amount of qualification time of each gaming terminal 10 which is not participating in the common game in I3 (I4). Specifically, the main CPU 241 reduces the qualification time corresponding to the highest multiplying factor by a unit time, which are stored in the common game qualification time management table in RAM 243. That is, in I4, the qualification time of each gaming terminal 10 participating in the common game is not reduced. After the above is completed, the qualification time management process routine ends.

When it is determined that the time information has not been received from the timer 271 in I1 (I1: NO), the main CPU 241 determines whether the qualification time data has been received from any of the gaming terminals 10 (I5). When it is determined that no qualification time data has been received (I5: NO), the qualification time management process routine ends. Meanwhile, when it is determined that the qualification time data has been received (I5: YES), the main CPU 241 executes a process of increasing the qualification time for each gaming terminal 10 which has transmitted the data (16). Specifically, based on the maximum qualification time table shown in FIG. 48 and the accumulation calculation table shown in FIG. 49, how much amount of time is added to the qualification time for each payout multiplying factor is determined, in accordance with the received qualification time data. Based on the above, the main CPU 241 updates the common game qualification time management table in RAM 243. After the above is completed, the qualification time management process routine ends.

(Common Game Process Routine)

The following will describe the common game process routine, with reference to FIG. 83. As shown in FIG. 83, the main CPU 241 determines whether the common game start condition is satisfied as a result of the common game start random determination of I2 (J1). When the main CPU 241 determines that the common game start condition is not satisfied (J1: NO), the common game process routine ends.

Meanwhile, when the main CPU 241 determines that the common game start condition is satisfied (J1: YES), the main CPU 241 refers to the common game qualification time management table shown in FIG. 44, to determine whether each of the gaming terminals 10 is qualified to participate in the common game (each gaming terminal 10 has a qualification time) (J2). Then, the main CPU 241 transmits a common game trigger signal only to the one or more gaming terminals 10 which are determined as being qualified to participate in the common game in J2 (J3).

Thereafter, the main CPU 241 determines whether the common game is being executed (J4). When the main CPU 241 determined that no common game is being executed (J4: NO), the main CPU 241 transmits a common game start signal only to the one or more gaming terminals 10 which are determined as being qualified to participate in the common game in J2 (J5). Then, the main CPU 241 executes a common game type random determination process referring to the common game type random determination table shown in FIG. 50 (J6). Then, the main CPU 241 executes the common game while synchronizing the one or more gaming terminals 10 which are determined as being qualified to participate in the common game in J2 (J7). The common game executed above is of the type determined in the common game type random determination process, i.e., one of the five types of common games: RED OR BLACK game; ROLL THE DICE game; FUN WHEEL game; LUCKY NUMBERS game; and HIGH or LOW game.

Then, the main CPU 241 calculates a value obtained by multiplying a unit payout amount obtained by each gaming terminal 10 as a result of the common game in J7 by the highest one of the common game payout multiplying factors associated with the qualification times owned by the gaming terminal 10 in the common game qualification time management table, as a payout of the common game to be awarded to the gaming terminal 10 (J8). Then, the main CPU 241 transmits the payout information indicating the thus determined payout to each gaming terminal 10 (J9), and the common game process routine ends.

When the main CPU 241 determines that the common game is being executed in J4 (J4: NO), the main CPU 241 refers to the second mystery bonus random determination table shown in FIG. 72, to execute a second mystery bonus random determination process (J10). With this, the type of the mystery bonus to be awarded to the gaming terminal 10 is determined. Then, the main CPU 241 transmits payout information indicating the payout of the mystery bonus of the type thus determined in the second mystery bonus random determination process only to the one or more gaming terminals 10 which are determined as being qualified to participate in the common game in J2 (J11), and then the common game process routine ends.

(Progressive Related Process Routine)

Now, a progressive related process routine will be described with reference to FIG. 84. As shown in FIG. 84, the main CPU 241 determines whether BET amount data has been received from any of the gaming terminals 10 (K1). When determining that the BET amount data has been received (K1: YES), the main CPU 241 calculates a value added to each progressive jackpot referring to the progressive payout setting table of FIG. 21 (K2), and accumulatively add the value to the payout amount of each progressive jackpot stored in the progressive payout storage area provided in the RAM 243. After the above is completed, the progressive related process routine ends.

When determining that no BET amount data has been received in K1 (K1: NO), the main CPU 241 determines whether a progressive level signal has been received from any of the gaming terminals 10 (K4). When it is determined that no progressive level signal has been received (K4: NO), the progressive related process routine ends. Meanwhile, when determining that the progressive level signal has been received (K4: YES), the main CPU 241 transmits, to the gaming terminal 10 which has transmitted the progressive level signal, payout information indicating the payout amount corresponding to the progressive jackpot indicated by the progressive level signal, the payout amount being stored in the progressive payout storage area provided in the RAM 243 (K5). Thereafter, the main CPU 241 resets the payout amount corresponding to the progressive jackpot indicated by the progressive level signal, which payout amount is stored in the progressive payout storage area, to a progressive initial payout value (K6). After the above is completed, the progressive related process routine ends.

(RED OR BLACK Game Process)

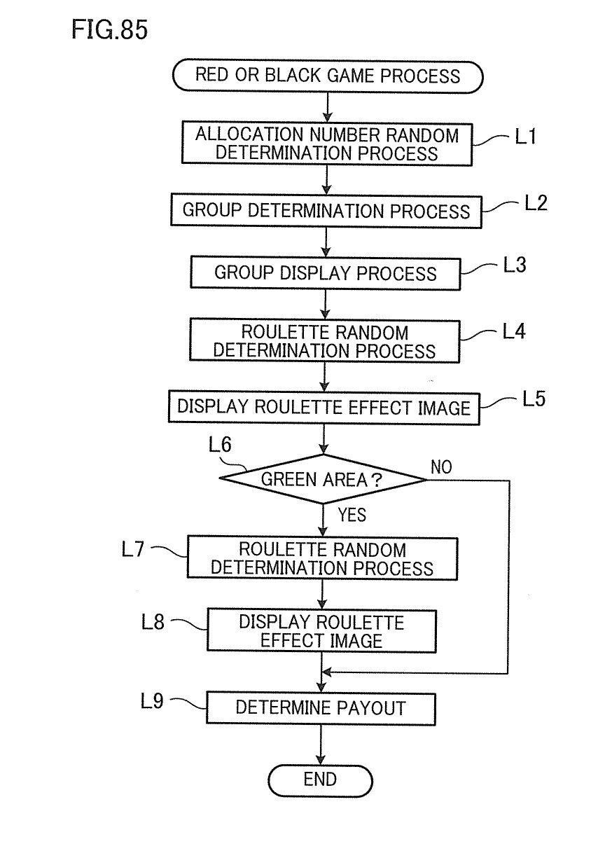

The main CPU 241 of the center controller 200 executes, in the common game execution process (J7) shown in FIG. 83, a RED OR BLACK game process routine shown in FIG. 85 when executing the RED OR BLACK game.

First, the main CPU 241 executes an allocation number random determination process referring to the allocation number random determination table shown in FIG. 54 (L1). With this, the numbers of the gaming terminals respectively allocated to a red group and a black group are determined. Then, the main CPU 241 executes a group determination process of determining which of the groups each gaming terminal 10 pertains to, by random determination (L2). Then, the main CPU 241 displays images 1005 each indicating the group to which the corresponding gaming terminal 10 pertains on the respective gaming terminal areas 703a to 703f of the upper displays 700 (see FIG. 55A) (L3).

Then, the main CPU 241 executes a roulette random determination process referring to the first roulette random determination table shown in FIG. 56 (L4). With this, on which of the areas 1001 the ball 1003 is stopped on the wheel 1002 of the roulette 1000 is determined. Then, the main CPU 241 provides a roulette effect image on the upper displays 700 (L5). In this roulette effect image, the ball 1003 is stopped on the area 1001 determined in L4.

Thereafter, the main CPU 241 determines whether the area 1000 on which the ball 1003 is stopped on the roulette 1000 is a green area 1001c (L6). When determining that the area is not the green area 1001c (L6: NO), the main CPU 241 determines the unit payout amount to be awarded to each gaming terminal 10 pertaining to the group associated with the area 1001 on which the ball 1003 is stopped, referring to the first roulette random determination table (L9). Then, the RED OR BLACK game process ends.

Meanwhile, when determining that the area is the green area 1001c (L6: YES), the main CPU 241 executes a roulette random determination process referring to the second roulette random determination table shown in FIG. 57 (L7). Then, the main CPU 241 provides a roulette effect image on the upper displays 700 (L8). In this roulette effect image, the ball 1003 is stopped on the area 1001 determined in L7. Then, the main CPU 241 determines the unit payout amount to be awarded to each gaming terminal 10 pertaining to the group associated with the area 1001 on which the ball 1003 is stopped, referring to the second roulette random determination table (L9). Then, the RED OR BLACK game process ends.

(ROLL THE DICE Game Process)

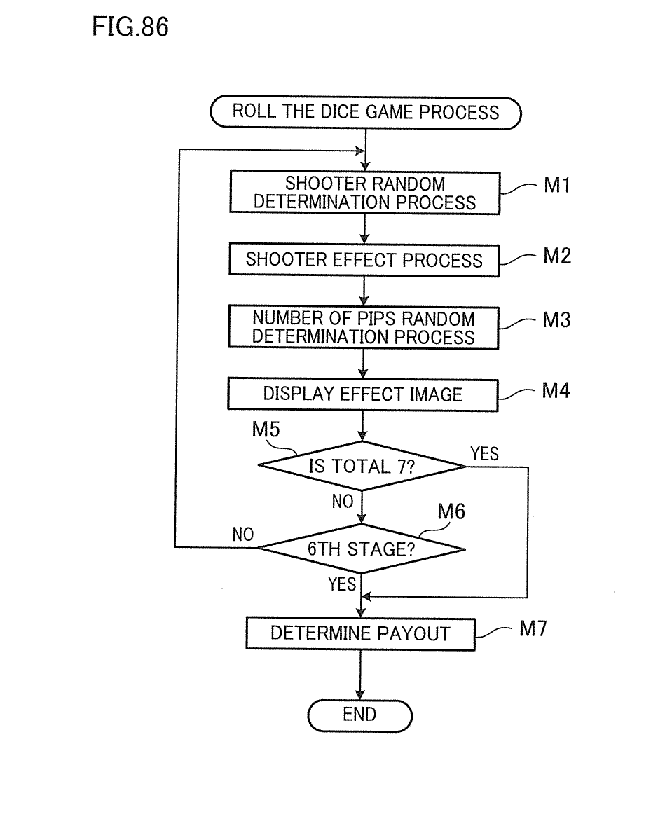

The main CPU 241 of the center controller 200 executes, in the common game execution process (J7) shown in FIG. 83, a ROLL THE DICE game process routine shown in FIG. 86 when executing the ROLL THE DICE game.

First, the main CPU 241 randomly determines which of the gaming terminals 10 plays the role of a shooter rolling the two dice from the gaming terminals 10 participating in the common game (M1). Then, the main CPU 241 provides an effect of reporting the gaming terminal 10 selected as the shooter (see FIG. 60B) (M2). Then, upon reception of a signal indicating that the spin button 29 is pressed on the gaming terminal 10 selected as the shooter from this gaming terminal 10, the main CPU 241 executes a number of pips random determination process referring to the number of pips random determination table shown in FIG. 60 (M3). With this, the number of pips of the two dice is determined. Then, the main CPU 241 provides a number of pips effect image 1107 showing the numbers of pips of the two dice determined in the number of pips random determination process (see FIG. 60E) is displayed on the upper display 700 (M4).

Then, the main CPU 241 determines whether the total number of pips of the two dice determined in the number of pips random determination process is 7 (M5). When determining that the total number of pips is not 7 (M5: NO), the main CPU 241 determines that the stage is cleared, and further determines whether the number of stages which have been cleared is 6 (M6). When it is determined that the number of cleared stage is not 6 (M6: NO), the processing returns to M1.

When determining that the total number of pipis is 7 in M5 (M5: YES), or when determining that the number of cleared stage is 6 in M6 (M6: YES), the main CPU 241 looks for the payout corresponding to the number of cleared stages in the stage payout table of FIG. 58, and determines the payout found as a unit payout amount uniformly awarded to the gaming terminals 10 participating in the common game (M7). After the above is completed, the ROLL THE DICE game process ends.

(FUN WHEEL Game Process)

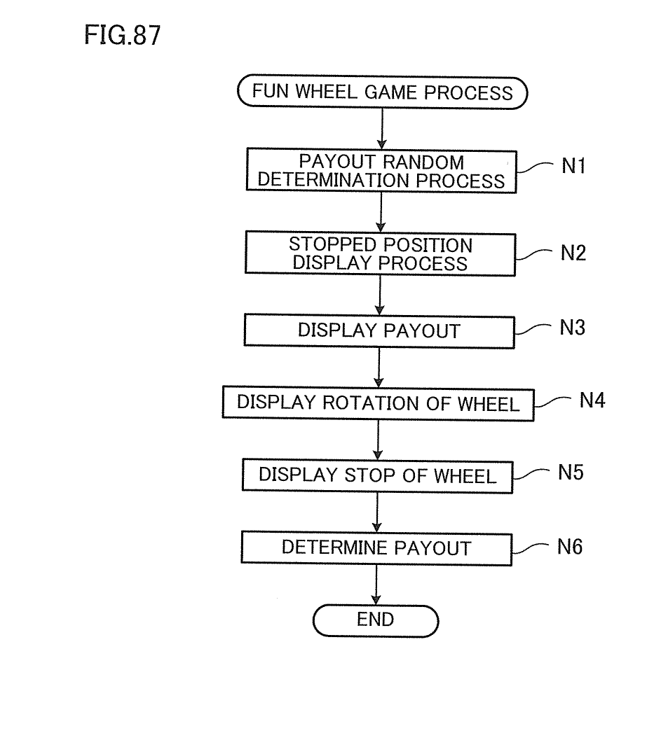

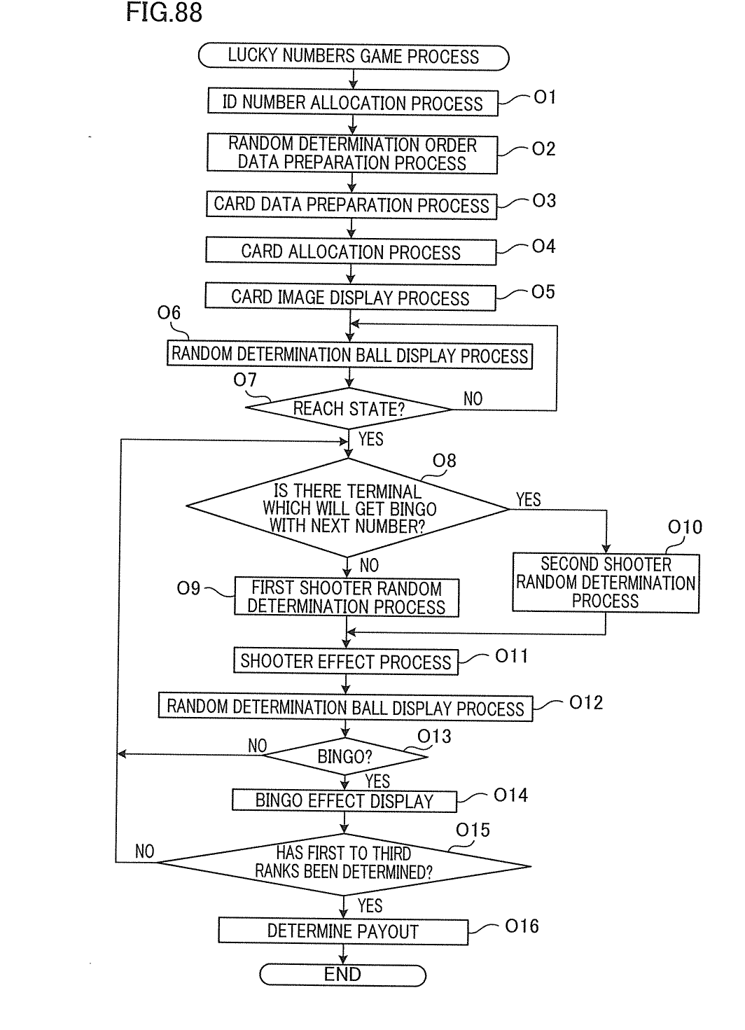

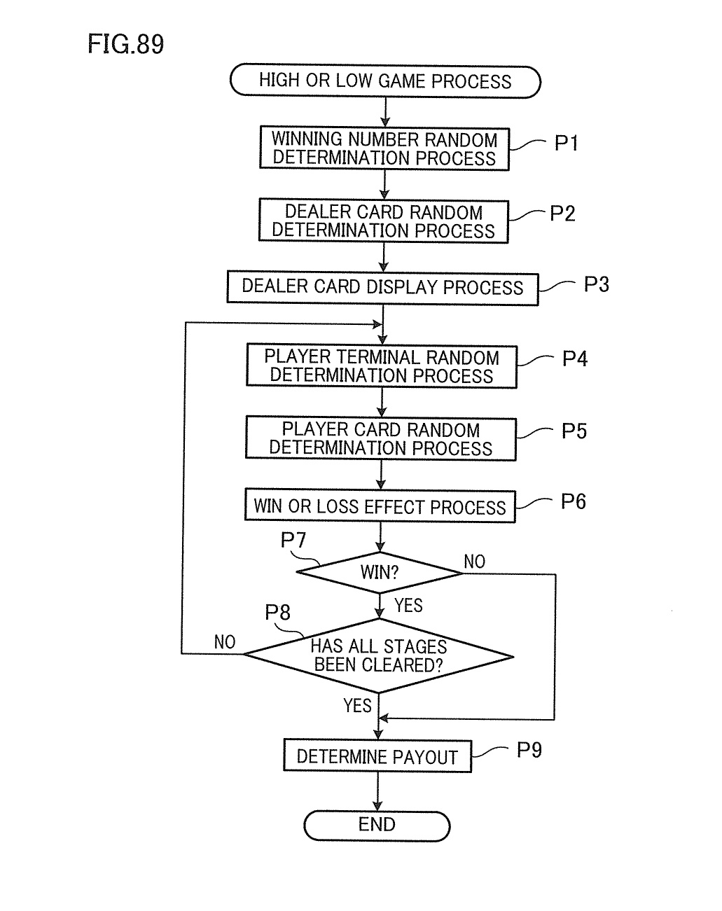

The main CPU 241 of the center controller 200 executes, in the common game execution process (J7) shown in FIG. 83, a FUN WHEEL game process routine shown in FIG. 87 when executing the FUN WHEEL game.

First, the main CPU 241 executes a payout random determination process of determining the payout to be awarded to each gaming terminal 10 participating in the common game, referring to the payout random determination table shown in FIG. 62 (N1). Then, upon reception of a signal indicating the stopped position selected by the player from each gaming terminal 10, the main CPU 241 displays the images 1205 indicating the stopped positions on the upper displays 700 (see FIG. 61C) (N2). Then, the main CPU 241 displays images indicating fixed payouts on the areas 1201 of each wheel 1202 of the FUN WHEEL 1200 on the upper displays 700 (N3), and then provides an effect of rotating each wheel 1202 on the upper displays 700 (see FIG. 61) (N4). Subsequently, the main CPU 241 provides an effect of stopping the rotation of each wheel 1202 (N5). At this time, the area 1201 having the fixed payout determined as being for each gaming terminal 10 in the payout random determination process in N1 is stopped on the stopped position selected by that gaming terminal 10. Then, the main CPU 241 determines the payout displayed on the area 1201 stopped at the stopped position selected by the player of each gaming terminal 10 as a unit payout amount awarded to the gaming terminal 10 (N6). Then, the FUN WHEEL game process ends.

(LUCKY NUMBERS Game Process)

The main CPU 241 of the center controller 200 executes, in the common game execution process (J7) shown in FIG. 83, a LUCKY NUMBERS game process routine shown in FIG. 88 when executing the LUCKY NUMBERS game.

First of all, the main CPU 241 executes an ID number allocation process of allocating the numbers from 1 to 75 to 75 types of ID numbers which are different from one another (O1). Then, the main CPU 241 prepares random determination order data (see FIG. 65D and FIG. 65E) based on the ID numbers allocated in the ID number allocation process (O2). Then, based on the ID numbers allocated in the ID number allocation process and on the prepared random determination order data, the main CPU 241 prepares 6 types of card data (see FIG. 65F and FIG. 65G) (O3), and randomly allocate the thus prepared card data to six gaming terminals 10 (O4).

Then, the main CPU 241 displays bingo cards 1301 respectively showing the contents of the card data allocated in O4 on the respective gaming terminal areas 703 of the six gaming terminals 10 (O5). On each bingo card 1301, the square having a number corresponding any of the ID numbers associated with the random determination order 1 to 5 in the random determination order data has been already marked.

Then, on each upper display 700, the main CPU 241 displays an effect image making it look as if random determination of a number is performed by an automatically appearing random determination ball 1305 with illustration thereon of the number corresponding to the 6th rank in random determination order in the random determination order data (O6). That is, if there is a number associated with the 6th rank in the random determination order exists on the bingo card 1301, the square having the number is marked. Then, the main CPU 241 determines whether any of the gaming terminals 10 establishes a REACH state (O7). When determining that none of the gaming terminals 10 establishes the REACH state (O7: NO), the main CPU 241 repeats the process similar to O6 for the 7th and subsequent ranks in the random determination order in the random determination order data, until any of the gaming terminals 10 establishes REACH state.

When determining that any of the gaming terminals 10 establishes the REACH state (O7: YES), the main CPU 241 determines whether there is a gaming terminal 10 which gets a BINGO with a number randomly selected next (O8). When determining that there is no gaming terminal 10 which gets a BINGO (O8: NO), the main CPU 241 executes a first shooter random determination process of selecting the gaming terminal 10 playing a role of a shooter from the gaming terminals 10 which have established the REACH state (O9). In the above process, the probability that each of the gaming terminals 10 which have established the REACH state is selected as the shooter is even. Meanwhile, when determining that there is a gaming terminal 10 which gets a BINGO (O8: YES), the main CPU 241 executes a second shooter random determination process of selecting the gaming terminal 10 playing the role of the shooter from the gaming terminals 10 which have established the REACH state (O10). In the above process, the probability that the gaming terminal 10 which will get a BINGO with the next randomly determined number is selected as the shooter is higher than the probability that another gaming terminal 10 is selected as the shooter.

After O9 or O10, the main CPU 241 displays the button image 1309 encouraging the player of the gaming terminal 10 selected as the shooter to press the spin button 29 (see FIG. 66E) on the gaming terminal area 703 of this gaming terminal 10 on the upper displays 700 (O11). Then, upon reception of a signal indicating that the spin button 29 is pressed on the gaming terminal 10 selected as the shooter from this gaming terminal 10, the main CPU 241 provides an effect of causing the random determination ball 1305 (see FIG. 66F) having thereon the number corresponding to the next rank in the random determination order to emerge based on the random determination order data, on the upper displays 700 (O12).

Thereafter, the main CPU 241 determines whether there is a gaming terminal 10 which has got a BINGO (O13). When it is determined that there is no gaming terminal 10 which has got a BINGO (O13: NO), the processing returns to O8. Meanwhile, when there is a the gaming terminal 10 which has got a BINGO (O13: NO), the main CPU 241 displays, on the gaming terminal area 703 of the gaming terminal 10 which has got a BINGO on the upper displays 700, the image 1311 showing a BINGO has been made and its rank (see FIG. 66G) (O14). Thereafter, the main CPU 241 determines whether the gaming terminals 10 at the first to third ranks have been determined (O15). When it is determined that the gaming terminals 10 at the first to the third ranks have not been determined (O15: NO), the processing returns to O8. When determining that the gaming terminals 10 at the first to third ranks have been determined (O15: YES), the main CPU 241 determines the unit payout amount to be awarded to each of these gaming terminals 10, referring to the LUCKY NUMBERS game payout table of FIG. 64 (O16). Then, the LUCKY NUMBERS game process ends.

(HIGH or LOW Game Process)

The main CPU 241 of the center controller 200 executes, in the common game execution process (J7) shown in FIG. 83, a HIGH or LOW game process routine shown in FIG. 87 when executing the HIGH or LOW game.

First, the main CPU 241 executes a winning number random determination process of determining the number of winnings made by a gaming terminal playing the role of a player, referring to the winning number random determination table shown in FIG. 67 (P1). The number of winning represents the number of stages which can be cleared by the gaming terminal acting as the player in the HIGH or LOW game. Thereafter, the main CPU 241 determines the card type of the dealer's card based on one of card random determination tables (see FIG. 68A to FIG. 68F) selected in accordance with the number of winnings determined in the above winning number random determination process (P2). Then, the main CPU 241 displays a card image 1401 indicating the thus determined card type of the dealer's card (see FIG. 69A) on the upper displays 700 (P3).

Then, the main CPU 241 selects, by random determination, the gaming terminal 10 which plays a role of a player who makes a prediction (“predicting player”) from the gaming terminals 10 participating in the common game, and provides an effect of reporting the gaming terminal 10 selected as the predicting player by controlling the LED unit 801 or the like (P4). Then, the main CPU 241 determines the card type of the player's card (P5). In the above step, if it has been determined that the gaming terminal acting as the player loses the game at the current stage based on the number of winnings determined in the winning number random determination process, the card type of the player's card is determined to cause a loss of the player. Meanwhile, if it has been determined that the gaming terminal acting as the player clears the current stage based on the number of winnings determined in the winning number random determination process, the card type of the player's card is determined to cause a winning of the player.

Upon receiving a signal indicating the prediction of the player input on the gaming terminal 10 acting as the player, the main CPU 241 displays the card image 1408 showing the card of the type determined in P5 (see FIG. 69E) on the upper display 700 (P6). When the gaming terminal 10 acting as the player wins (P7: YES) and all the stages have not been cleared (P8: NO), the main CPU 241 returns the processing to P4. When the gaming terminal 10 loses the game (P7: NO), or when all the stages have been cleared (P8: YES), the main CPU 241 determines a unit payout amount to be awarded to the gaming terminals 10 which have participated in the common game, referring to the winning number random determination table and in accordance with the number of winnings determined in the winning number random determination process (P9). Then, the HIGH or LOW game process ends.

The above embodiment thus described solely serves as a specific example of the present invention, and the present invention is not limited to such an example. Specific structures and various means may be suitably designed or modified. Further, the effects of the present invention described in the above embodiment are not more than examples of most preferable effects achievable by the present invention. The effects of the present invention are not limited to those described in the embodiments described above.

For example, the aspects, values, or the like concerning the effects are not limited to those recited in the embodiment above. Furthermore, the data or the like exchanged between the gaming terminals 10 and the center controller is not limited to the above. In the present embodiment, the payout amount of each progressive jackpot uses a part of a bet amount bet on the plurality of gaming terminals 10 as a capital source; however, the present disclosure is not limited to this. Each progressive jackpot may use a part of a bet amount bet on one gaming terminal 10 as a capital source.

In the present embodiment, the qualification times for the common game of the gaming terminals 10 are collectively managed in the center controller 200; however, each gaming terminal 10 may manage its own qualification time.

The above embodiment deals with the case where six persons participate as the players in each common game; however, the present disclosure is not limited to this. For example, each common game may be configured so that 2 to 5 persons participate as the players, or so that 7 or more persons participate as the players. The following describes a common game where two persons participate as players. It should be noted that descriptions for structures similar to the above embodiment are omitted.

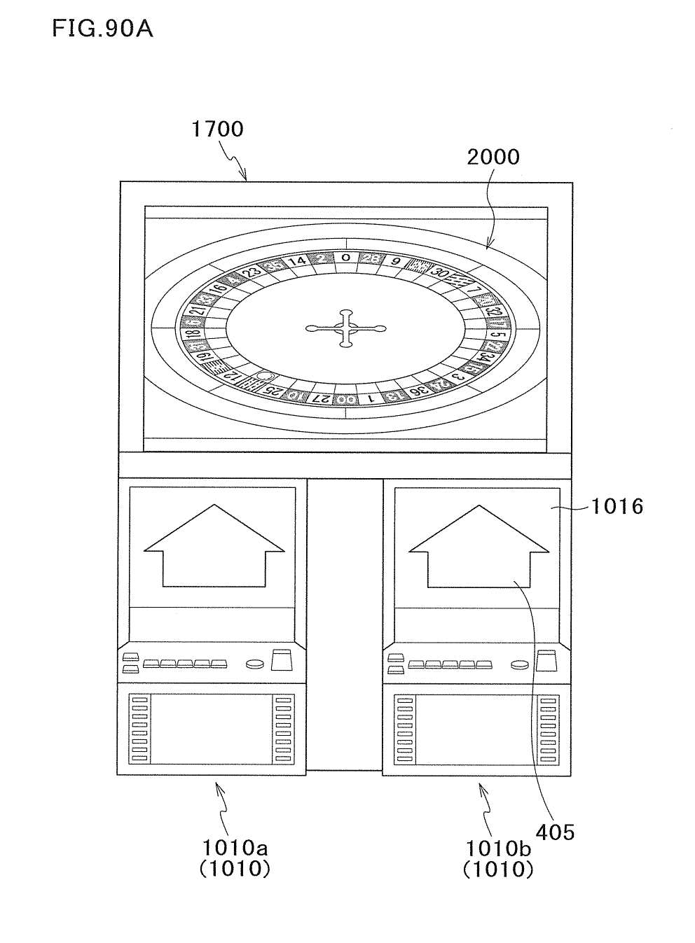

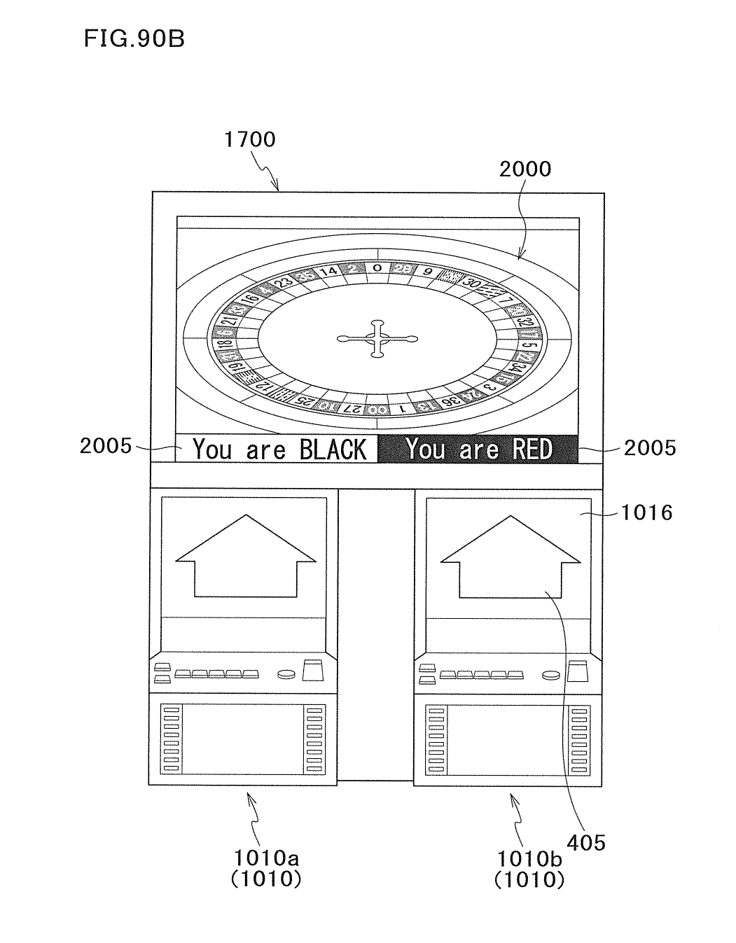

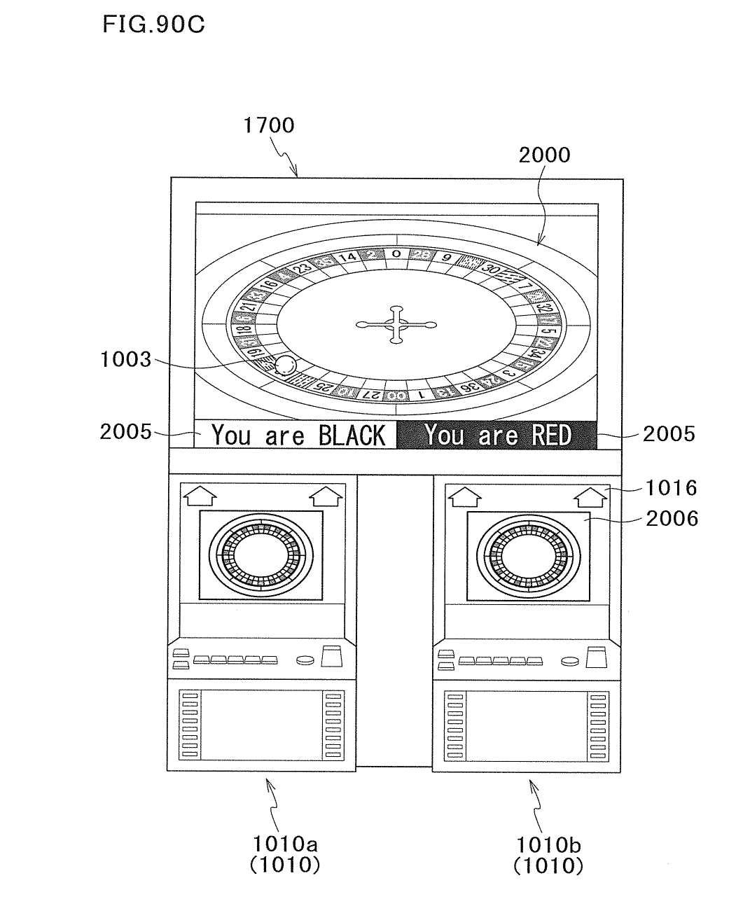

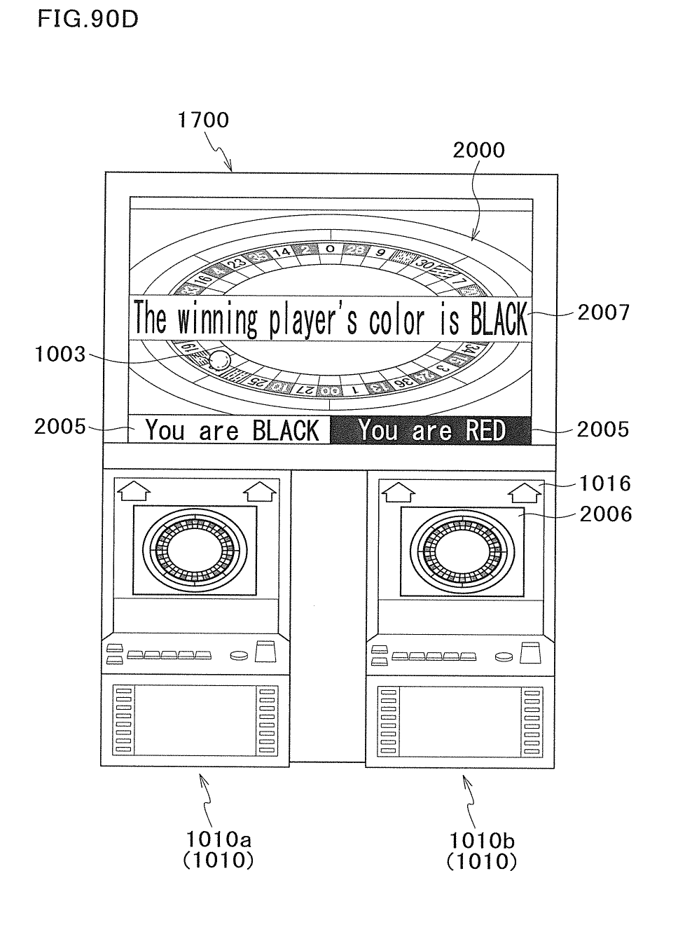

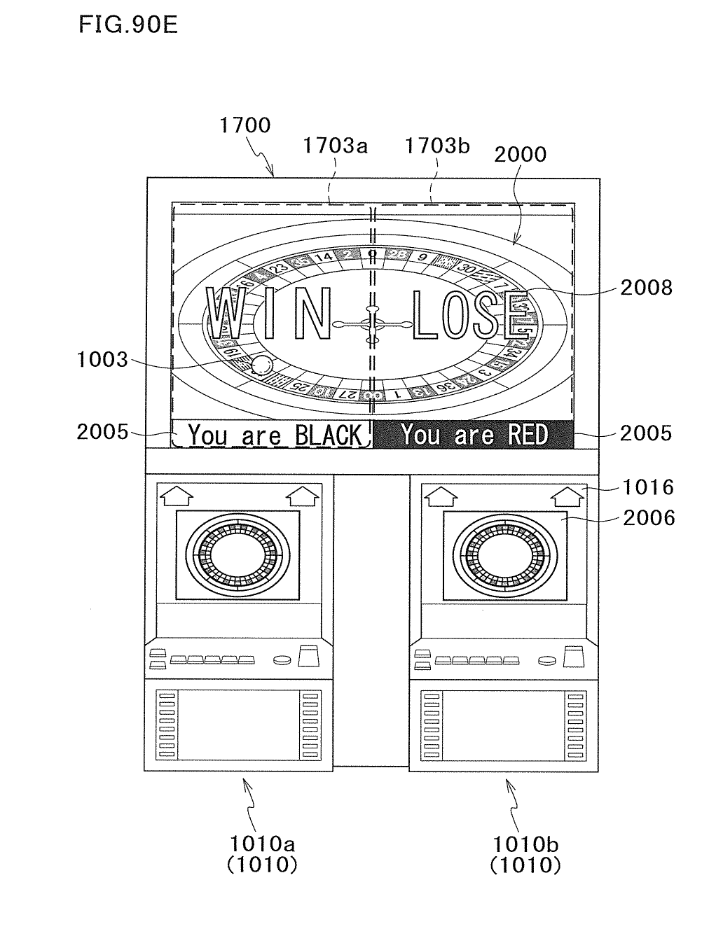

As shown in FIG. 90A, in each below-described common game, two gaming terminals 1010 (gaming terminals 1010a and 1010b) are provided side by side, and an upper display 1700 is provided over the two gaming terminals. The upper display 1700 is formed by a single display. The common game is executed on the upper display 1700, and the two gaming terminals 1010a and 1010b are allowed to participate in the common game. Thus, the common game is executed in the form of match up between the two gaming terminals. If only one of the gaming terminals 1010 participates in the common game, the other party is played by auto play, to proceed with the common game.

(Modification of RED OR BLACK Game)

FIG. 90A illustrates a display state on the upper display 1700 during the RED OR BLACK game. In FIG. 90A, the gaming terminals 1010a and 1010b are executing the common game, and the look-up images 405 are displayed on terminal image display panels 1016 of the respective gaming terminals 1010a and 1010b. One roulette 2000 is displayed on the common effect display screen of the upper display 1700. Similarly to the roulette 1000 of the above embodiment, the roulette 2000 includes: the wheel 1002 having 38 areas 1001 (red areas 1001a and black areas 1001b); and the ball 1003 for indicating a winning area 1001 (see FIG. 53).

As shown in FIG. 90B, in the RED OR BLACK game of this modification, different colors are randomly allocated to the gaming terminals 1010a and 1010b (red or black). That is, when red is allocated to the gaming terminal 1010a, black is allocated to the gaming terminal 1010b. When black is allocated to the gaming terminal 1010a, red is allocated to the gaming terminal 1010b. After the colors for the gaming terminals 1010a and 1010b are determined, there is displayed an image 2005 indicating the respective colors of the gaming terminals 1010a and 1010b. This enables each player to recognize which of the colors (red or black) is allocated to his/her gaming terminal 1010. After black or red is allocated to each gaming terminal 1010 in this way, a roulette game is executed once or twice.

In the roulette game, as shown in FIG. 90C, the upper display 1700 displays thereon a roulette effect image similar to that in the above embodiment, which makes it look as if the roulette game is executed thereon. At the same time, the terminal image display panel 1016 of each gaming terminal 1010 participating in the RED OR BLACK game displays thereon an effect image 2006 similar to the above roulette effect image.

After the effect showing that the ball 1003 is stopped either a red area 1001a or a black area 1001b is provided on the upper display 1700, as shown in FIG. 90D, an image 2007, showing the winning color, which is the color corresponding to the area 1001 on which the ball 1003 was stopped, is displayed on the upper display 1700.

Then, as shown in FIG. 90E, an image 2008 showing whether the corresponding gaming terminal 1010 has won or not is displayed on each of gaming terminal areas 1703a and 1703b of the respective gaming terminals 1010, the gaming terminal areas are created by dividing the upper display 1700 into two areas (left and right areas).

Further, an image similar to that in FIG. 55E, indicating the total credit amount obtained in the RED OR BLACK game is displayed on the terminal image display panel 1016 of the winning gaming terminal 1010 and on the gaming terminal area on the upper display 1700 corresponding to the winning gaming terminal 1010.

(Modification of ROLL THE DICE Game)

In the ROLL THE DICE game of this modification, rules are different from those in the above embodiment: when the total number of pips of two dice rolled by a gaming terminal 1010 playing the role of the shooter is 7, caused is a win of the gaming terminal acting as the shooter. When the total number of pips of the two dice rolled by the gaming terminal 1010 acting as the shooter is not 7, it is possible to proceed to the next stage. When a stage is cleared, a value calculated by multiplying the total number of pips of the dice by 30 credits is accumulatively added to a payout. The payout thus accumulated is awarded to the player of the winning gaming terminal 1010.

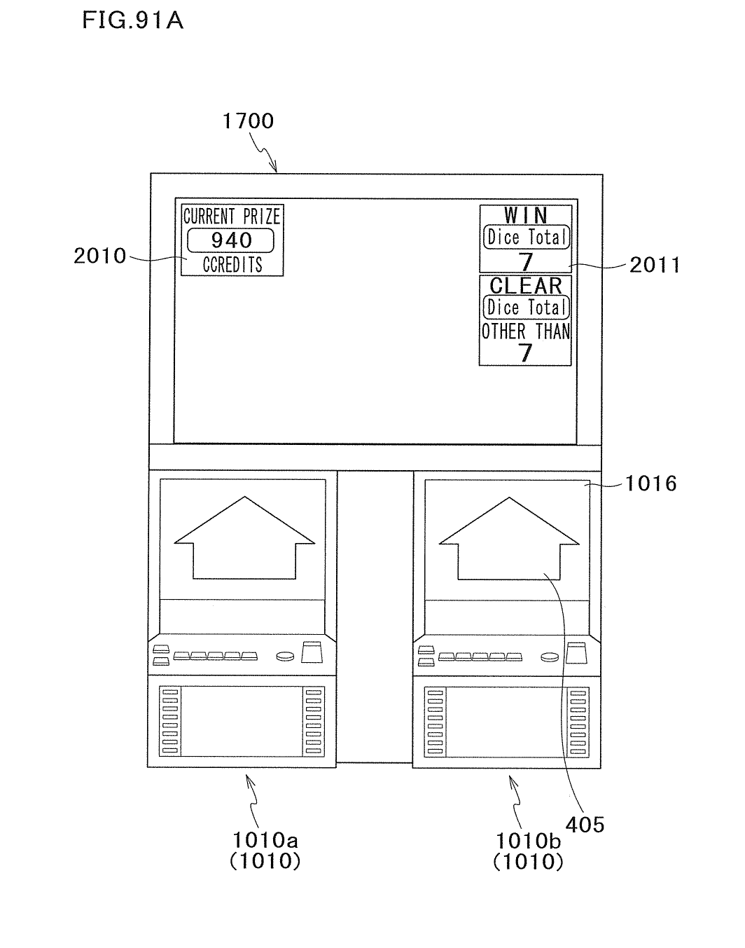

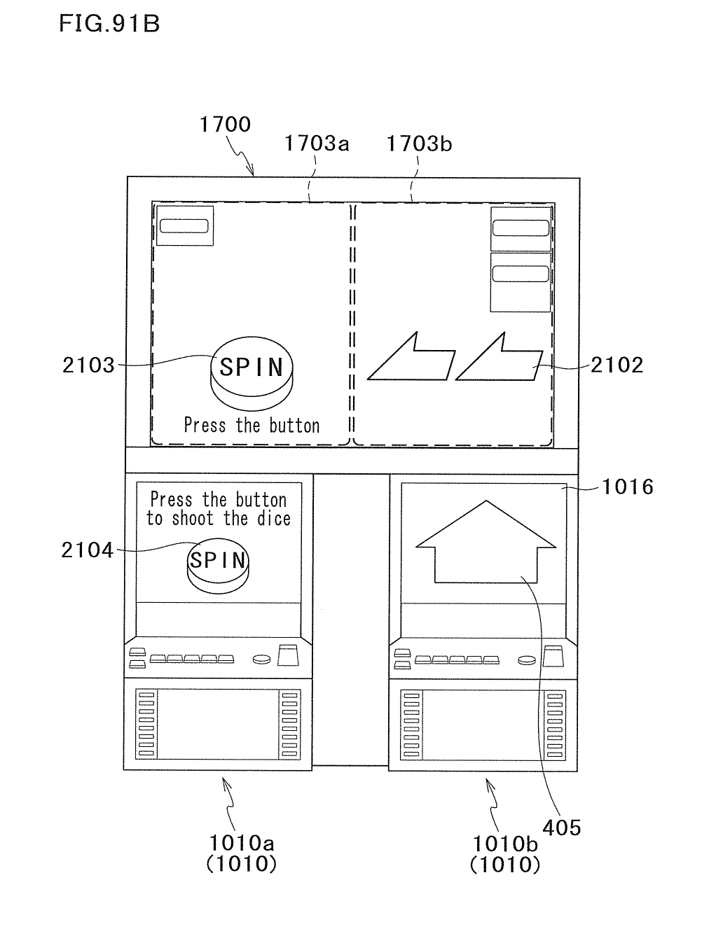

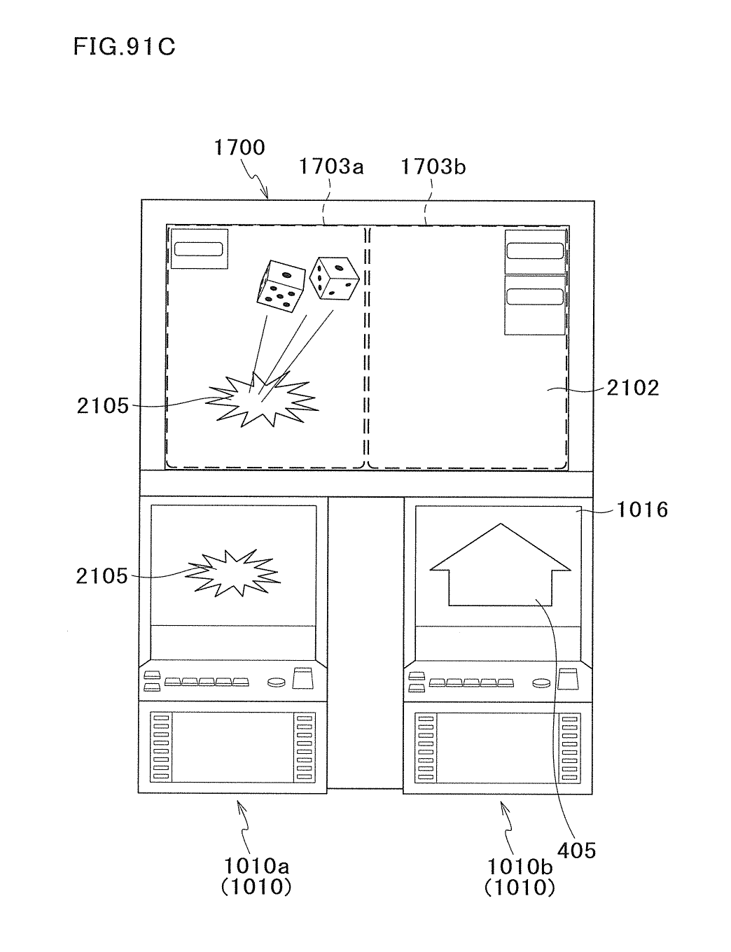

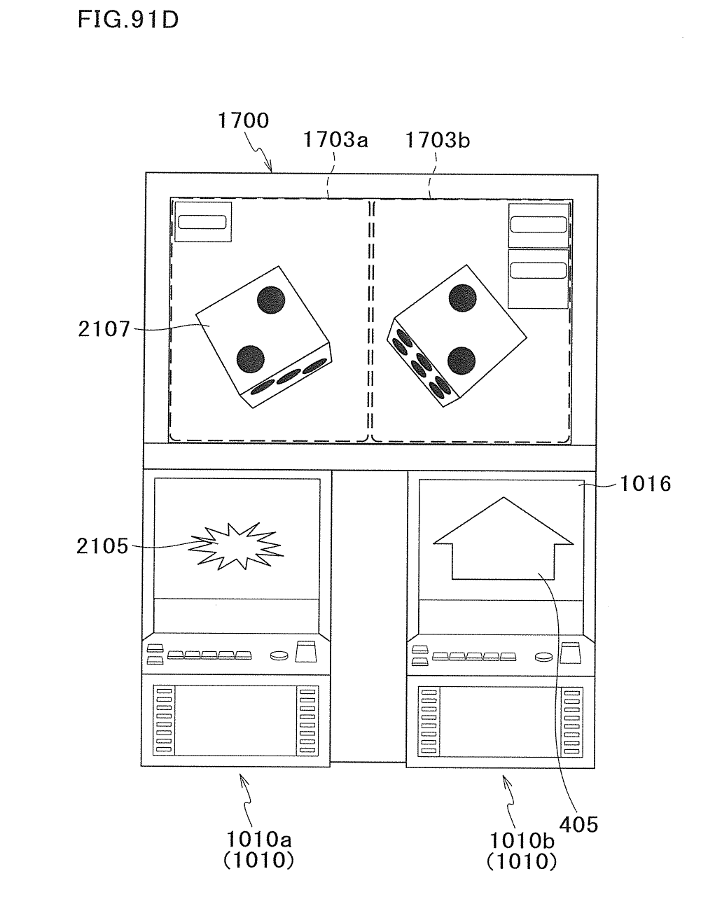

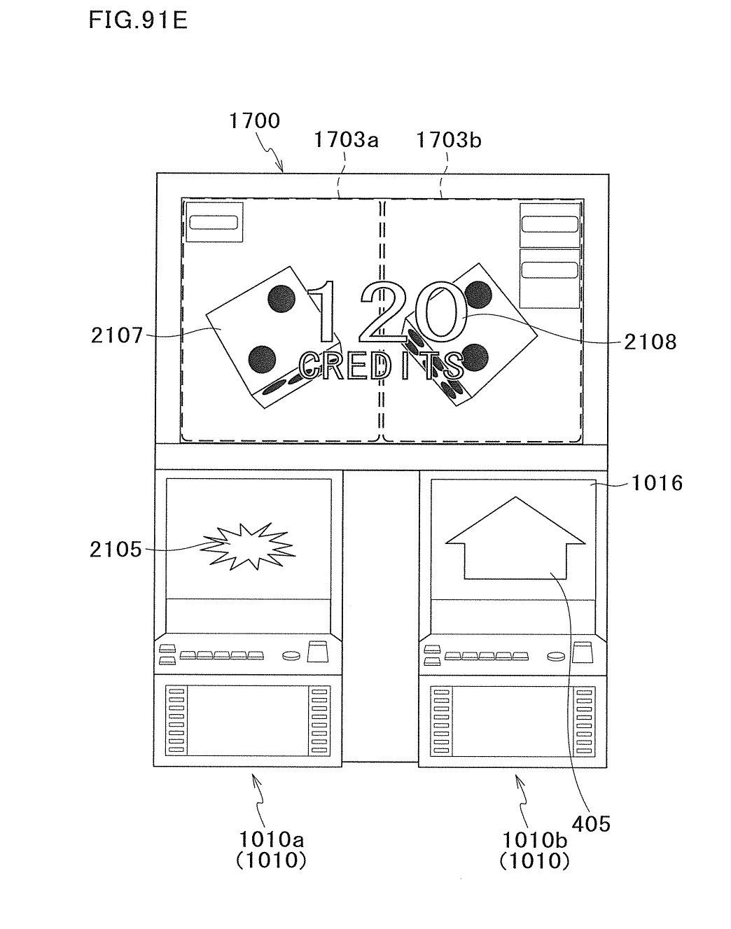

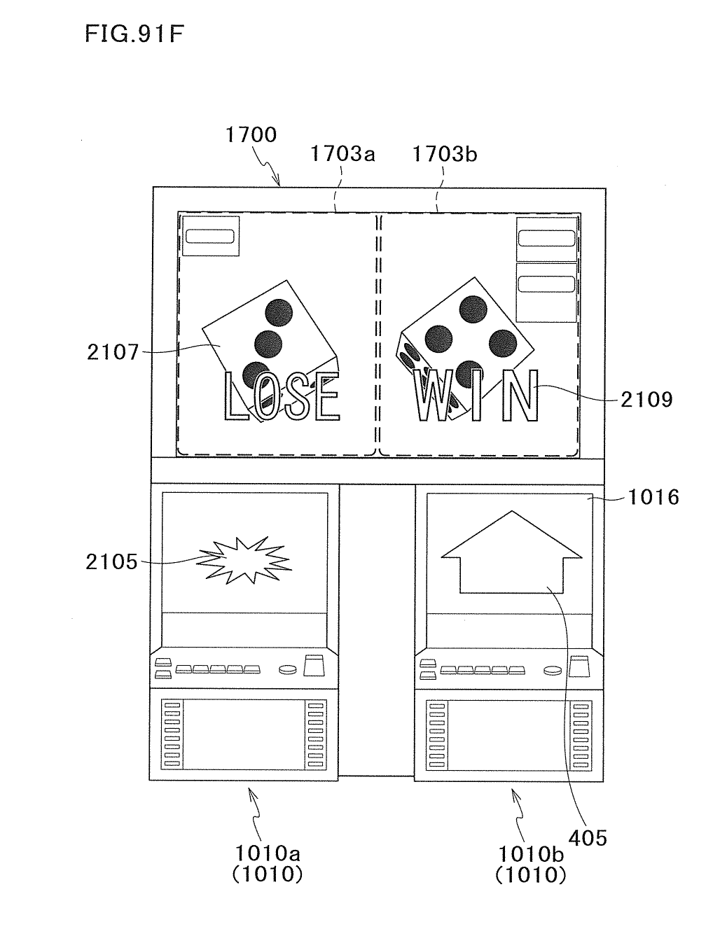

As shown in FIG. 91A, during the ROLL THE DICE game, the upper display 1700 displays thereon: a payout image 2010 indicating the payout accumulated as the ROLL THE DICE game proceeds; and a rule image 2011. The rule image 2011 shows the above-described rules of the ROLL THE DICE game.

As shown in FIG. 91B, when the ROLL THE DICE game is started, first, which of the gaming terminals 10 plays the role of the shooter rolling the two dice is selected by random determination from the two gaming terminals 1010a and 1010b. A gaming terminal 1010 which do not participate in the common game may be selected. In this case, the role is played by auto play by the center controller 200. Then, provided is an effect to report the gaming terminal 1010 selected as the shooter. Specifically, on the gaming terminal area 1703 corresponding to the gaming terminal 1010 selected as the shooter, an image 2103 indicating that the gaming terminal 1010 is selected as the shooter and facilitating the player of this gaming terminal 1010 to press the spin button 29 is displayed. At the same time, the terminal image display panel 1016 of this gaming terminal 1010 also displays thereon a button image 2104 similar to the above button image 2103. Further, the terminal image display panel 1016 displays thereon a message indicating that the dice will be shoot automatically if predetermined time elapses without pressing the spin button 29.

Meanwhile, on the gaming terminal area 1703 corresponding to the gaming terminal 1010 which is not selected as the shooter, an arrow image 2102 or the like pointing the gaming terminal 1010 selected as the shooter is displayed. Further, on the terminal image display panel 1016 corresponding to the gaming terminal 1010 which is not selected as the shooter, the look-up image 405 is displayed. In an example shown in FIG. 91B, the gaming terminal 1010a is selected as the shooter.

Then, as shown in FIG. 91C, when the spin button 29 is pressed in the gaming terminal 1010 selected as the shooter, or when the predetermined time elapses without pressing the spin button 29, an effect image 2105 showing an effect making it look as if the image 2103 is pressed and an effect making it look as if two dice are rolled on the upper display 1700. Further, on the terminal image display panel 1016 of the gaming terminal 1010 which is not selected as the shooter, an effect image 2016 making it look as if the button image 2104 is pressed, and then the look-up image 405 is displayed.

Then, as shown in FIG. 91D, a number of pips effect image 2107 showing the numbers of pips of the two dice determined in the number of pips random determination process is displayed on the upper display 1700. In the number of pips effect image 2107, the face of each of the dice having the number of pips determined in the above number of pips random determination process is blinking, to facilitate the perception of the number of pips of each of the dice.

When the total number of pips of the two dice is not 7, a credit image 2108 indicating the amount of the fixed payout added to the payout to be obtained when the common game is won is displayed on the upper display 1700, as shown in FIG. 91E. In this modification, the value indicated by the credit image 2108 is the value obtained by the total number of pips of the two dice by 30; however, the present disclosure is not limited to this. The value indicated by the credit image 2108 is added to the value indicated by a payout image 2010 (see FIG. 91A). Then, the next stage starts, and the other gaming terminal 1010 plays the role of the shooter. Thus, the gaming terminals 1010a and 1010b are alternately selected to play the role of the shooter.

The ROLL THE DICE game is repeated until 7 is produced as the number of pips of the two dice. That is, provided is the effect such that the payout amount to be awarded to the gaming terminal 1010 finally wins the game increases as the stages are repeated. The number of repeated stages; the number of pips of each of the dice at each stage; and the gaming terminal 1010 which wins the game are determined in advance at the start of the ROLL THE DICE game. The timing at the start of the ROLL THE DICE game may be any timing as long as it is before the two dice are shoot at the first stage.

When the total number of pips of the two dice is 7, as shown in FIG. 91F, images 2019 showing which of the gaming terminals 1010a and 1010b wins and which of them loses are respectively displayed on the gaming terminal areas 1703a and 1703b of the corresponding gaming terminals 1010.

In the ROLL THE DICE game, an image, similar to that in FIG. 55E, indicating the total credit amount obtained in the ROLL THE DICE game is displayed on the terminal image display panel 1016 of the winning gaming terminal 1010 and on the gaming terminal area 703 of the winning gaming terminal 1010.

(Modification of FUN WHEEL Game)

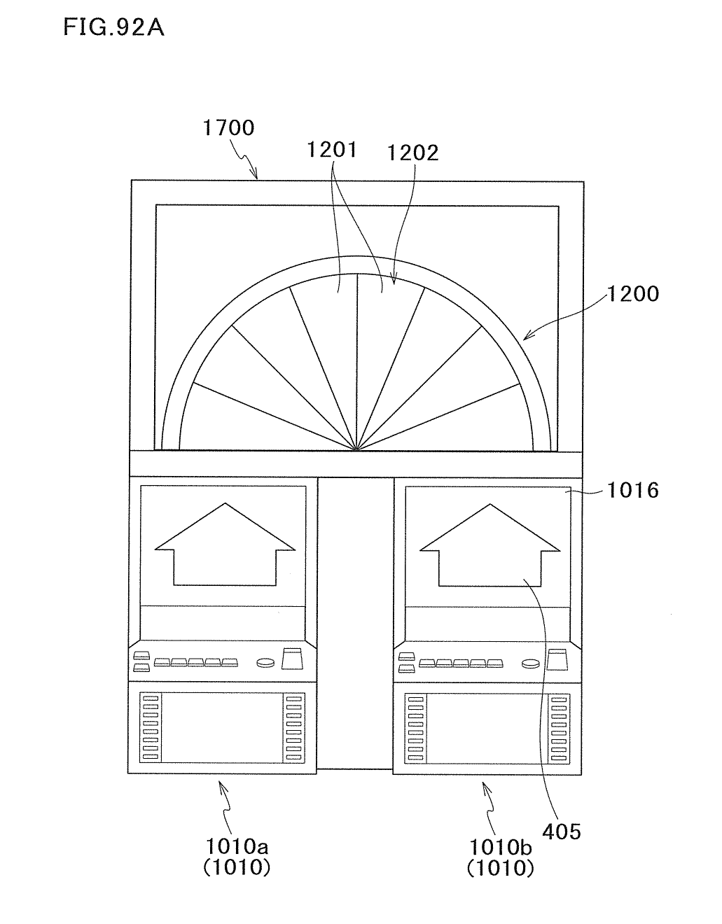

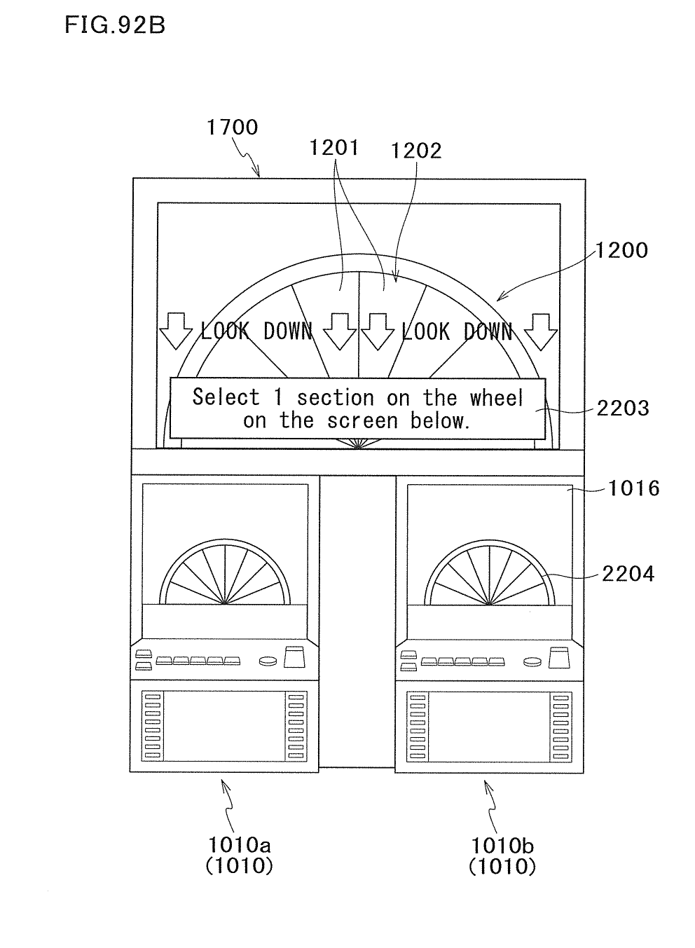

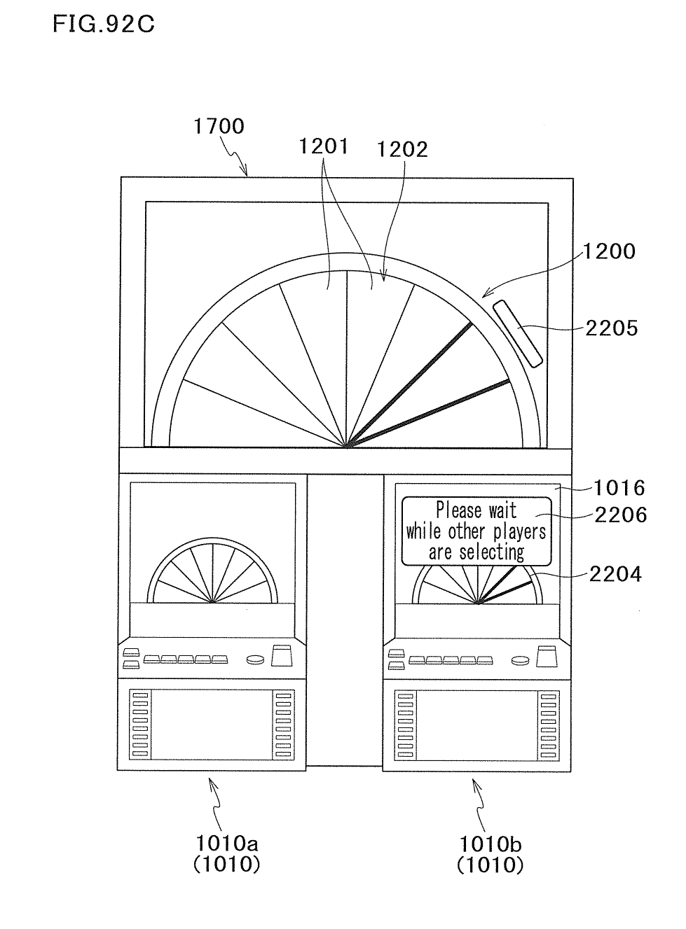

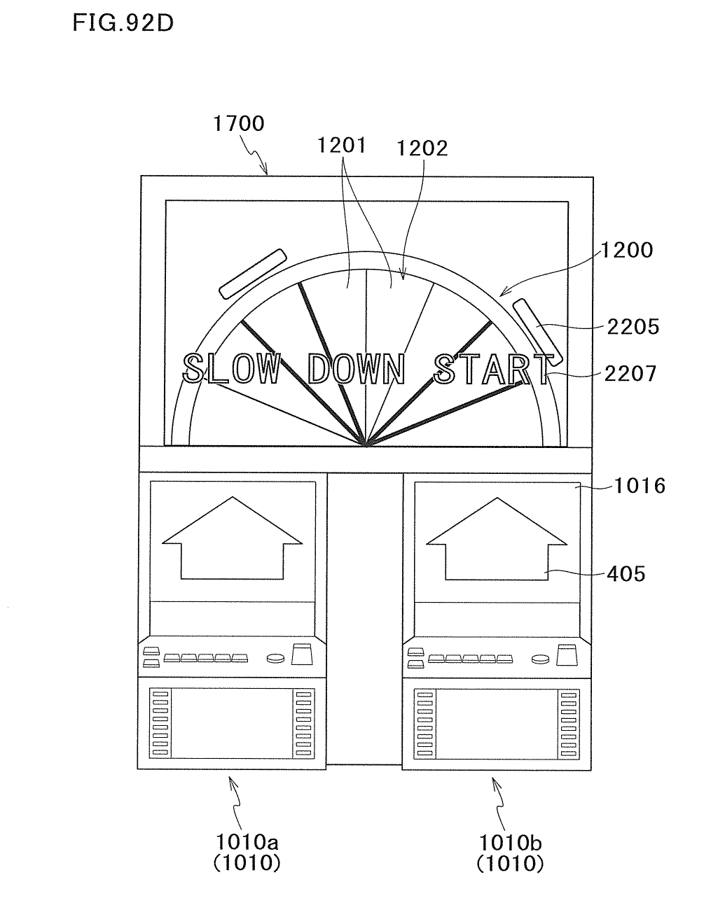

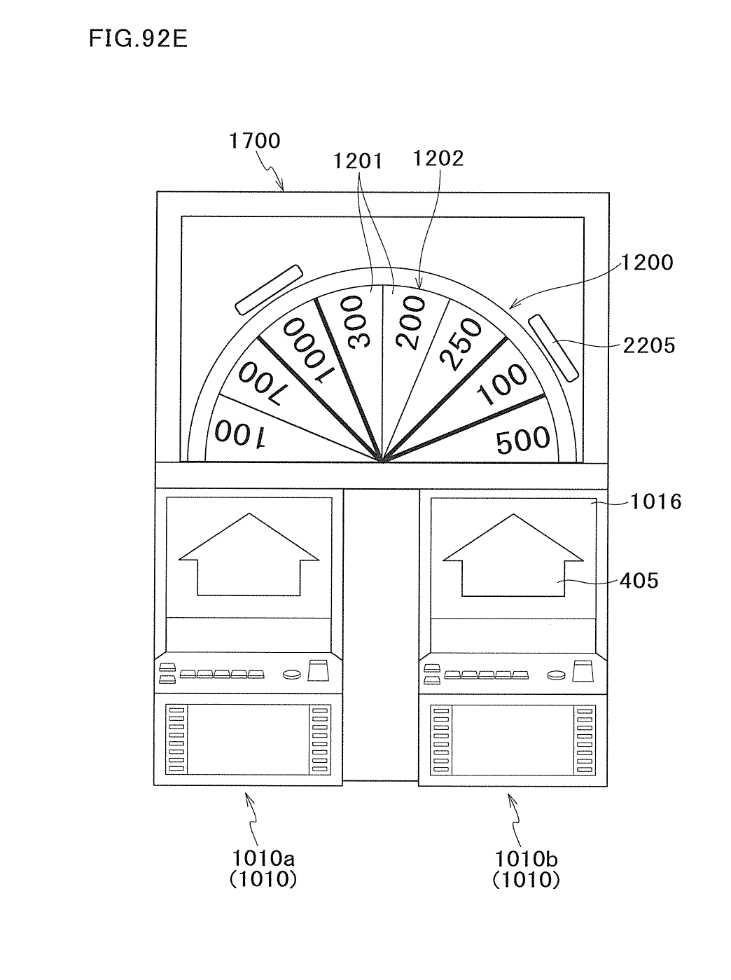

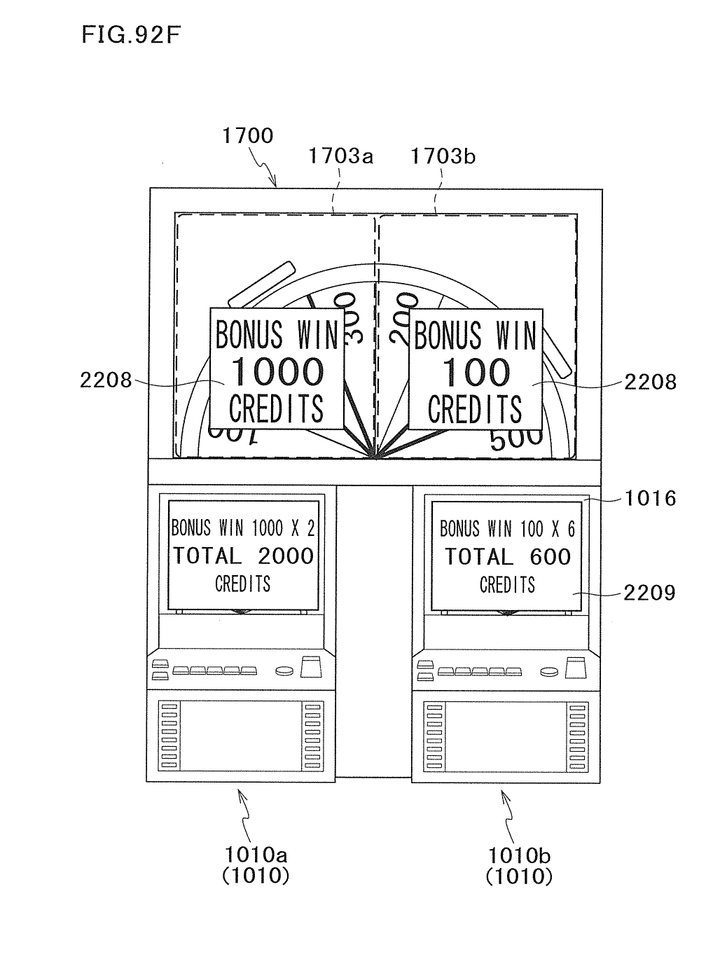

When the FUN WHEEL game of this modification is started, as shown in FIG. 92A, a single rotating FUN WHEEL 1200 is displayed on the upper display 1700. As is in the above embodiment, the FUN WHEEL 1200 has a wheel 1202 having a plurality of areas 1201. On each of the areas 1201 of the FUN WHEEL 1200, an image indicating a fixed payout is displayed. Then as explanation of the rules of the FUN WHEEL GAME is started, the speed of the rotation of the FUN WHEEL 1200 becomes faster than that at the start of the FUN WHEEL game.

Then, an image 2203 encouraging the players of the gaming terminals 1010 participating in the common game to select the stopped position is displayed on the upper display 1700, as shown in FIG. 92B. Further, on the terminal image display panel 1016 of each of the gaming terminals 1010 participating in the common game, an image 2204 for selecting a stopped position is displayed. Further, the terminal image display panel 1016 displays thereon a message indicating that the selection is made automatically if predetermined time elapses without selection of the stopped position.

After the stopped position is selected by the player, an image 2205 indicating the stopped position selected is displayed on the upper display 1700, as shown in FIG. 92C. In the image 2205 indicating the stopped positions, ID is labelled to identify the gaming terminal 1010. The present modification is configured so that the same stopped position cannot be selected by the players of the gaming terminals 1010. In each gaming terminal 1010 where the selection of the stopped position has been made by the player, there is displayed an image 2206 instructing the player to wait until the selection of the stopped position by the player of each of the other gaming terminals 1010 has been completed.

After the stopped position is selected by the player of each of the gaming terminals 1010a and 1010b, an image 2207 indicating that the speed down of the rotation of the wheel 1202 is started is displayed on the upper display 1700, as shown in FIG. 92D, and then provided is an effect display in which the speed of the rotation of the wheel 1202 is gradually decreased. At this time, on the terminal image display panel 1016 of each gaming terminal 1010, the look-up image 405 is displayed.

Then, after a predetermined period elapses from the start of speed down of the rotation of the wheel 1202, the rotation of the wheel 1202 is stopped, as shown in FIG. 92E. This enables the players to see which of the areas 1201 of the wheel 1202 is stopped at the stopped position selected by each player.

Then, as shown in FIG. 92F, an image 2208 indicating the fixed payout displayed on the area 1201 stopped at the stopped position selected by the player of each of the gaming terminals 1010a and 1010b is displayed on corresponding one of the gaming terminal areas 1703a and 1703b of the upper display 1700. Further, on the terminal image display panel 1016 of each of the gaming terminals 1010a and 1010b, an image 2209 indicating that the total credit amount obtained, which is calculated by multiplying the fixed payout indicated by the corresponding image 2208 by the common game payout multiplying factor is displayed.

(Modification of LUCKY NUMBERS Game)

Now, a modification of the LUCKY NUMBERS game will be described. The LUCKY NUMBERS game of this modification is a bingo game played using a bingo card containing 25 squares in a matrix of 5 columns and 5 rows, each of which square having a number, similarly in that of the above embodiment. After a bingo card is distributed (displayed) to each of the gaming terminals 1010, numbers selected by random determination are sequentially displayed on the upper display 1700. If the bingo card has a square having the number identical to the displayed number, the square is marked. When all the squares on a vertical, horizontal, or diagonal line are marked, a BINGO is get.

In the LUCKY NUMBERS game of this modification, the random determination of a number is performed a predetermined number of times (20 times in this modification). A payout corresponding to the number of BINGOs got by the numbers selected by the predetermined number of times of execution of the random determination is awarded to the player of each of the gaming terminals 1010a and 1010b. The effect of performing random determination of a number and displaying the thus selected number as a result of the random determination is provided on the upper display 1700. The above effect proceeds automatically, but in only the last and the second last time of execution of the random determination, input operations by the players of the gaming terminals 1010a and 1010b are respectively required. Assuming that the predetermined number of times of execution is N, the input operation is required on one of the gaming terminals 1010 at the N−1th time, and the input operation is required on the other of the gaming terminals 1010 at the Nth time. In this way, an opportunity of single time of input operation to the gaming terminal 1010 is provided to each player to start the effect of random determination of a number.

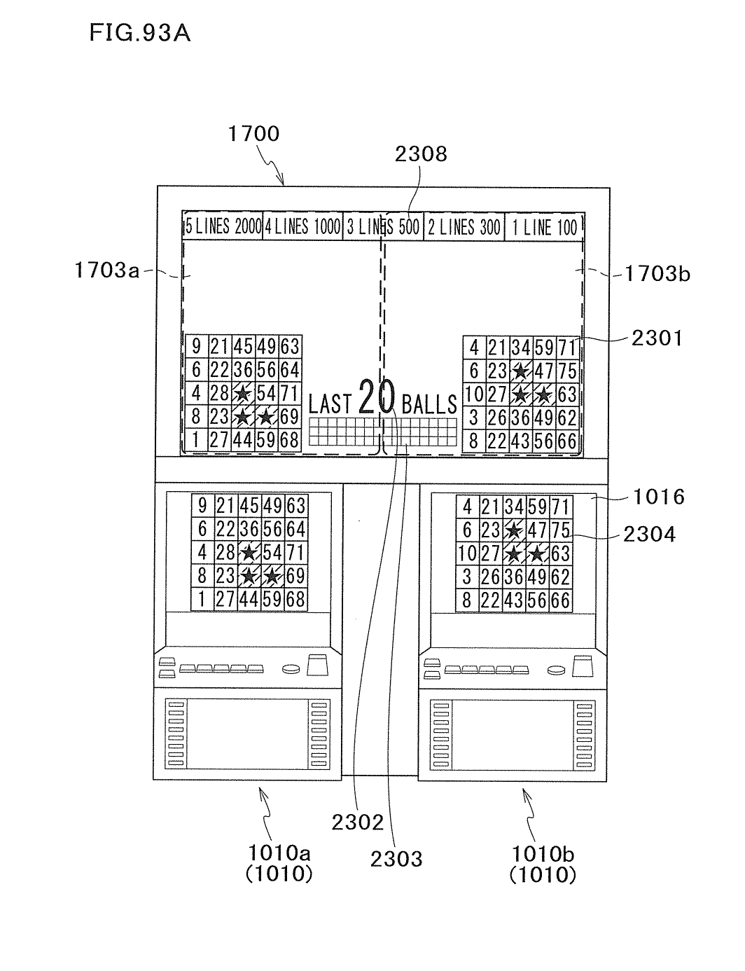

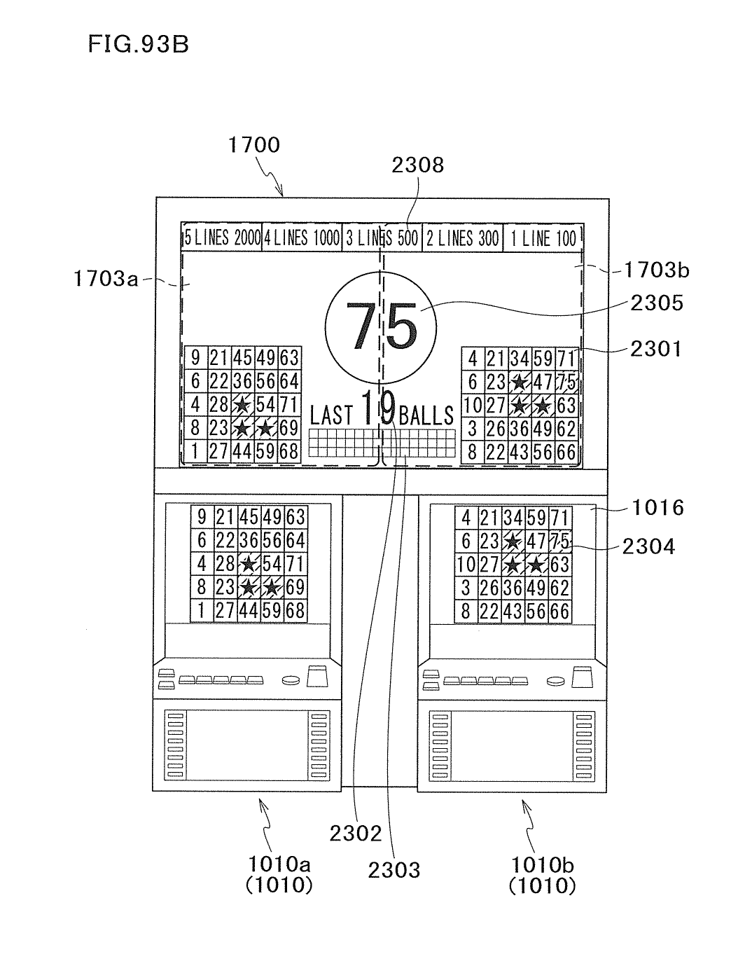

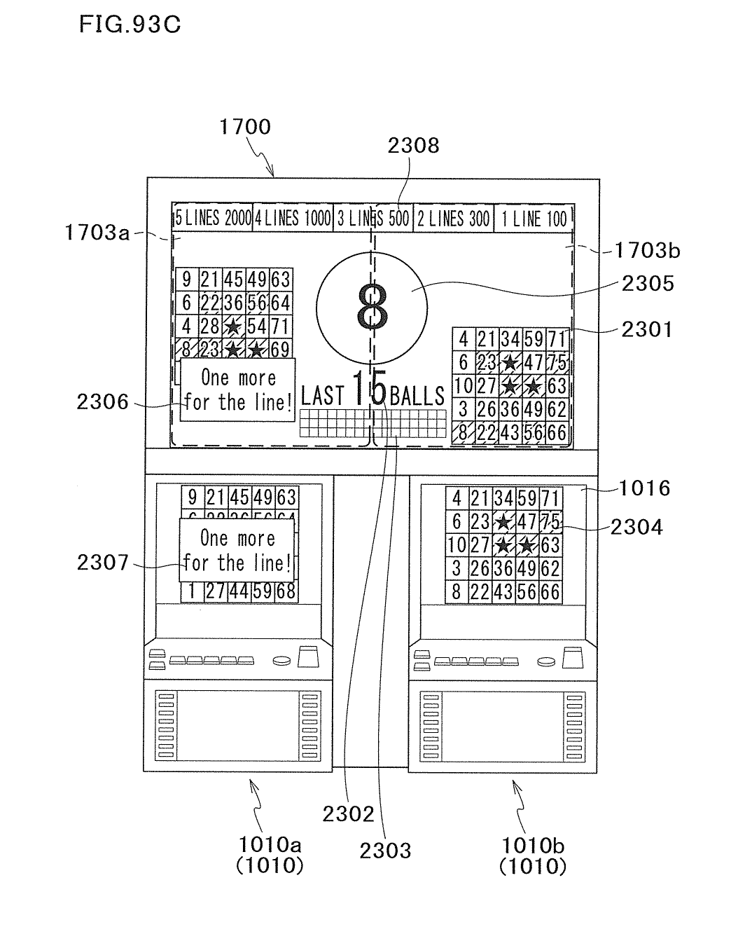

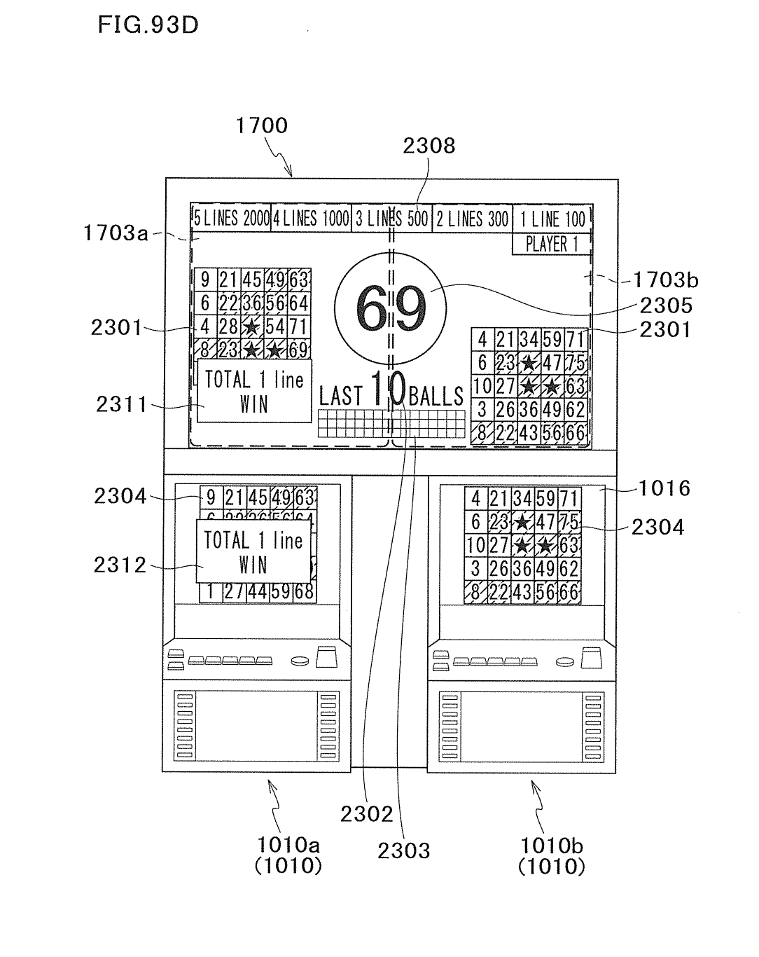

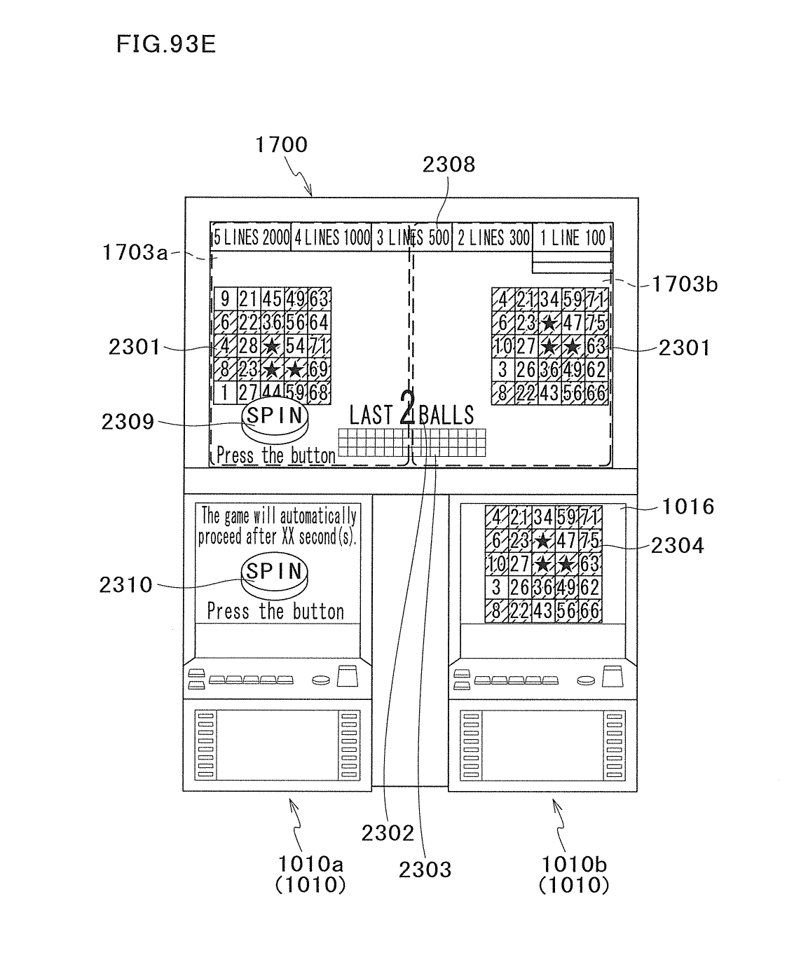

When the LUCKY NUMBERS game is started, as shown in FIG. 93A, on the gaming terminal areas 1703a and 1703b of the gaming terminals 1010a and 1010b, bingo cards 2301 are respectively distributed. Each bingo card is determined in the same way as the above embodiment. However, in this modification, three free spots are set in each bingo card of the gaming terminal 1010. That is, in the bingo card distributed to each gaming terminal 1010, three squares are already been marked. Each square marked in the bingo card is indicated by a star sign, and its background color is turned orange. The background color of the other squares is blue. Further, on a lower portion of the upper display 1700, there is displayed an image 2303 showing one or more numbers which have already been selected by random determination. Further, on an upper portion of the upper display 1700, there is displayed an image 2308 showing payout amounts associated with the number of BINGOs established. Specifically, the image 2308 has five areas aligned horizontally. The image 2308 is divided into regions by blocks, where the payout amounts for the number of BINGOs of 1 to 5 are respectively shown.

The terminal image display panel 1016 of each gaming terminal 1010 also displays thereon a bingo card 2304 similar to the bingo card 2301 displayed on the gaming terminal area 703. Further, on a middle-lower portion of the upper display 1700, there is displayed an image 2302 indicating the remaining number of times of execution of the random determination of a number. In the illustrated state, the image 2302 indicates that the remaining number of times of execution of the random determination is 20 because the random determination of a number has never been performed.

Then, as shown in FIG. 93B, the random determination ball 2305 is automatically displayed on a central portion of the upper display 1700, to show the number selected by random determination. Further, provided is an effect of subtracting 1 from the remaining number of times of execution of the random determination of a number indicated by the image 2302. When the number indicated by the random determination ball 2305 matches any of the numbers on the bingo card 2301, the square having this number is turned orange. In this way, the random determination process for selecting a number is automatically repeated for the first to 18 times.

When any of the gaming terminals 1010 establishes the REACH state, an effect of reporting the gaming terminal 1010 which has established the REACH state is performed, as shown in FIG. 93C. Specifically, on the gaming terminal area 1703 corresponding to the gaming terminal 1010 which has established the REACH state, an image 2306 indicating that the REACH state has been established, and the position of the bingo card 2301 displayed on this gaming terminal area 1703 is moved upward. At the same time, the terminal image display panel 1016 of this gaming terminal 1010 which has established the REACH state also displays thereon an image 2307 similar to the above image. In an example shown in FIG. 93C, the gaming terminal 1010a has established the REACH state. These effects are provided only the first time the REACH state has been established, on each of the gaming terminals 1010. Note that the REACH state means the state where four of the five squares on a line are marked.

Then, when any of the gaming terminals 1010 gets a BINGO, as shown in FIG. 93D, the gaming terminal area 703 of the gaming terminal 1010 which gets a BINGO displays thereon an image 2311 showing the number of BINGOs currently got; while the terminal image display panel 1016 of the gaming terminal 1010 also displays an image 2312 similar to the image 2311. When a BINGO is got, the name of the player is displayed below the area of the image 2308 which corresponds to the number of BINGOs currently established. This makes it easy to recognize how many BINGOs are currently established and the name of the player thereof.

As shown in FIG. 93E, when the 19th time of execution of the random determination process is started, the random determination ball 1305 does not appear automatically. One of the gaming terminals 1010 plays the role of the shooter, and the random determination ball 1305 appears in response to pressing of the spin button 29 on this gaming terminal 1010. Then, in an example of FIG. 93E, a button image 2309 encouraging the player of the gaming terminal 1010a acting as the shooter to press the spin button 29 is displayed on the gaming terminal area 703a. At the same time, the terminal image display panel 1016 of this gaming terminal 1010a also displays thereon a button image 2310 similar to the above button image 2309. Then, upon pressing of the spin button 29 on the gaming terminal 1010a, the random determination ball 1305 is displayed. Although not illustrated, in the 20th-time execution, the button image 2309 is displayed on the gaming terminal area 703b to the player of the gaming terminal 1010b acting as the shooter. In addition, on the terminal image display panel 1016 of the gaming terminal 1010b, there is displayed the button image 2310. Upon pressing the spin button 29, the random determination ball 1305 is displayed.

The LUCKY NUMBERS game ends when 20th-time execution of the random determination process is completed and the number of BINGOs of each gaming terminal 1010 is determined. Further, an image, similar to that in FIG. 55E, indicating the total credit amount obtained in the LUCKY NUMBERS game is displayed on the terminal image display panel 1016 of the winning gaming terminal 1010 and on the gaming terminal area 703 of the winning gaming terminal 1010. When no BINGO has been get, an image indicating this (NO LINE WIN) is displayed.

(Modification of HIGH or LOW Game)

Now, the HIGH or LOW game will be described. The HIGH or LOW game in the above embodiment is a game in which its game result is shared by the gaming terminals 10 participating in the common game. Meanwhile, in this modification, provided is a game where the two gaming terminals 1010 compete with each other. In the HIGH or LOW game of this modification, the two gaming terminals 1010a and 1010b alternately play the role of the player, to predict whether the number on the owned card is higher or lower than that of the card owned by the center controller 200, which plays the role of the dealer. When the predictions of both of the two gaming terminals 1010a and 1010b are correct, the number of winnings is increased. As the number of winnings increases, the payout amount obtained in the HIGH or LOW game increases.

When the prediction of either one of the two gaming terminals 1010a and 1010b is wrong, the gaming terminal 1010 which has the wrong prediction loses the game, and a winning payout is awarded to the player of the opponent gaming terminal 1010. The winning payout depends on the above number of winnings. In the HIGH or LOW game, which of the gaming terminals 1010 wins, and its winning payout are predetermined.

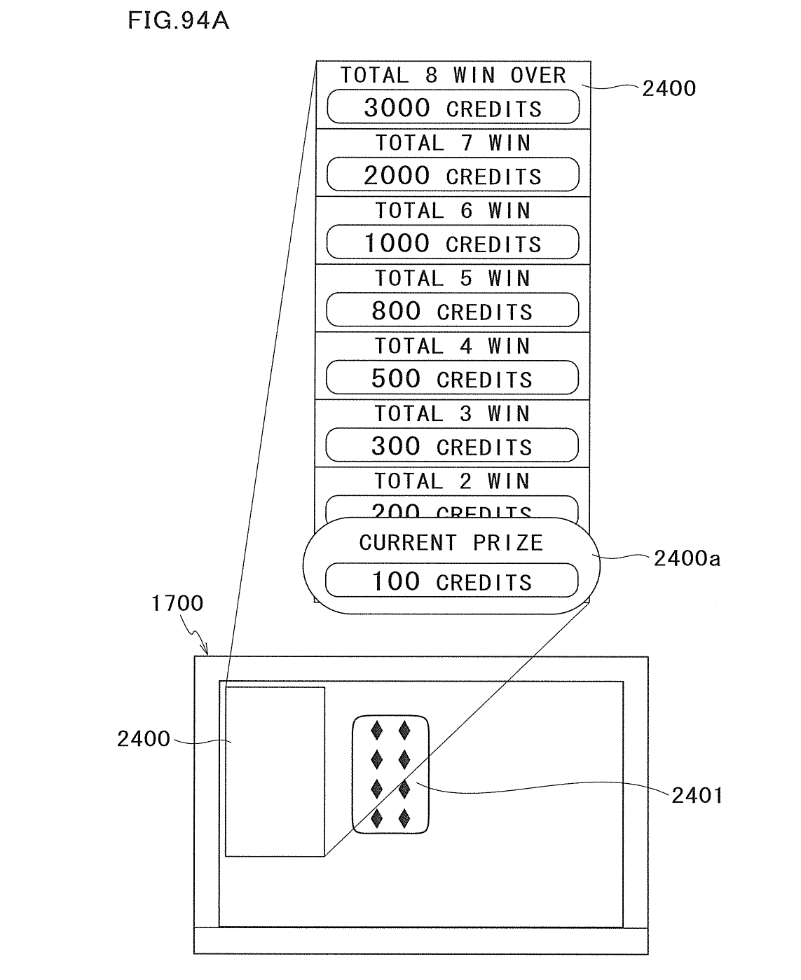

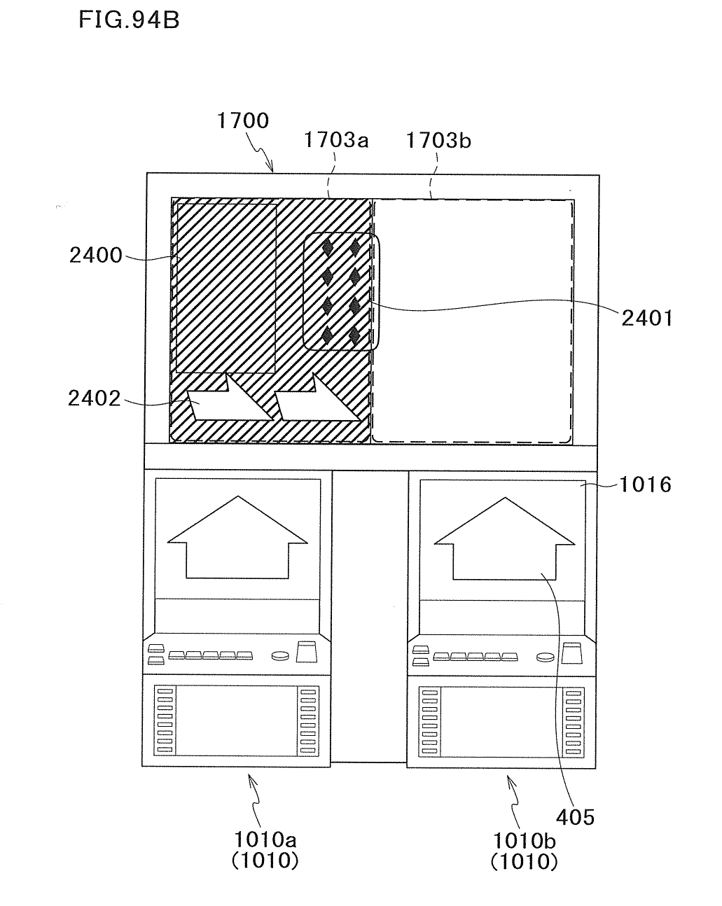

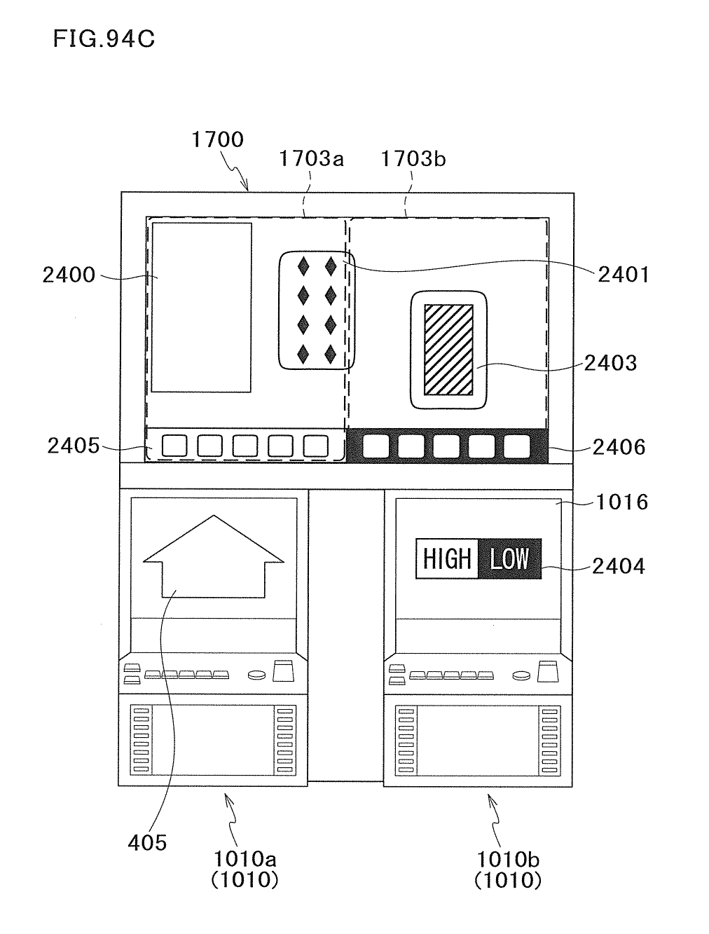

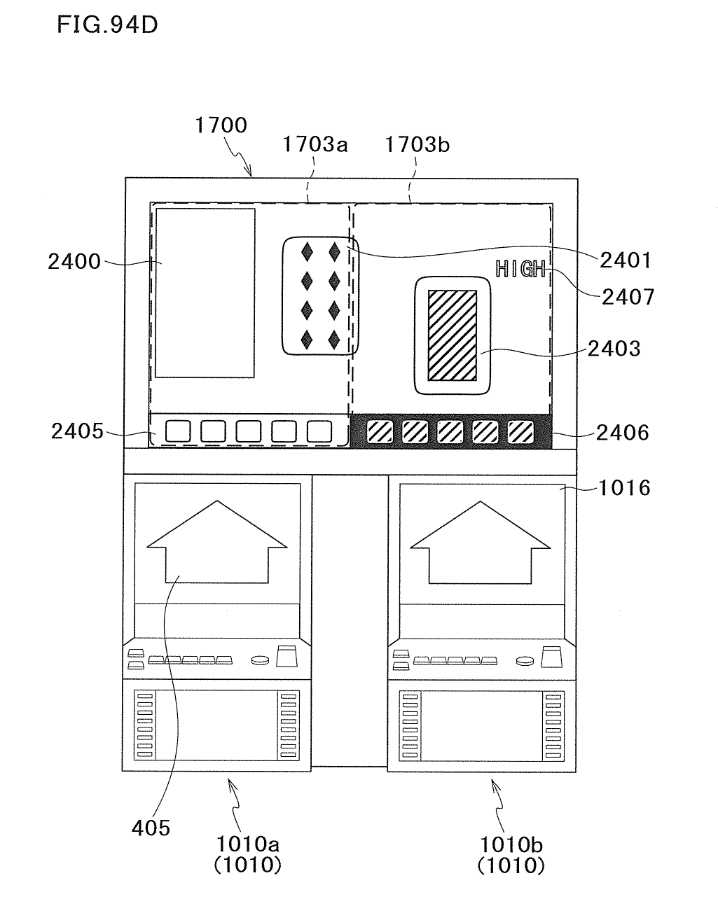

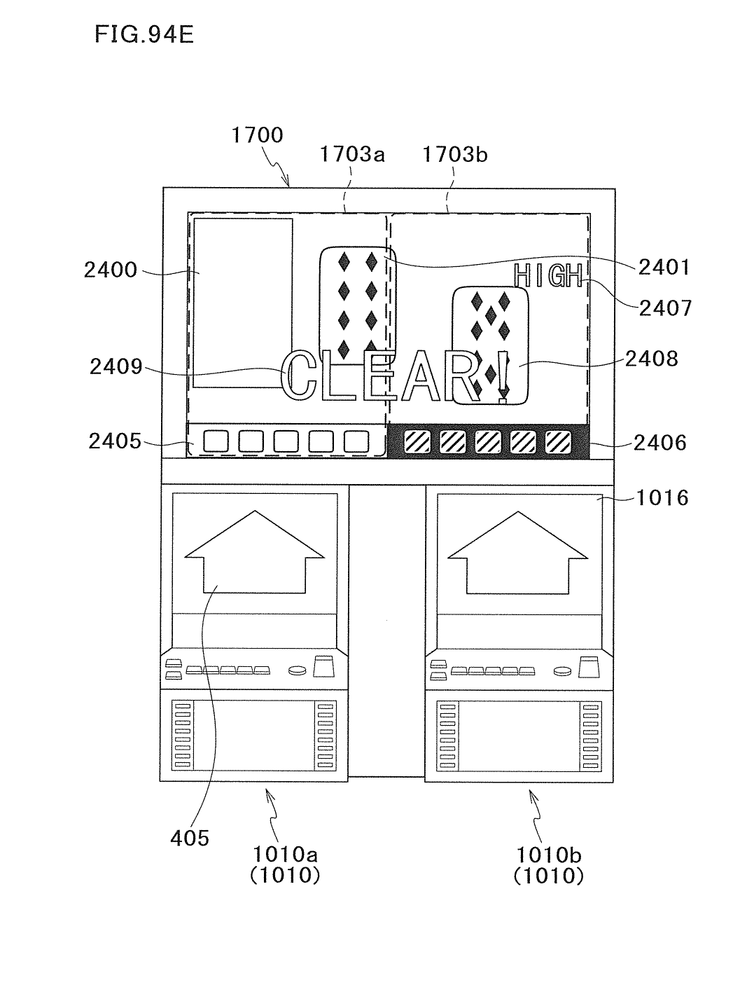

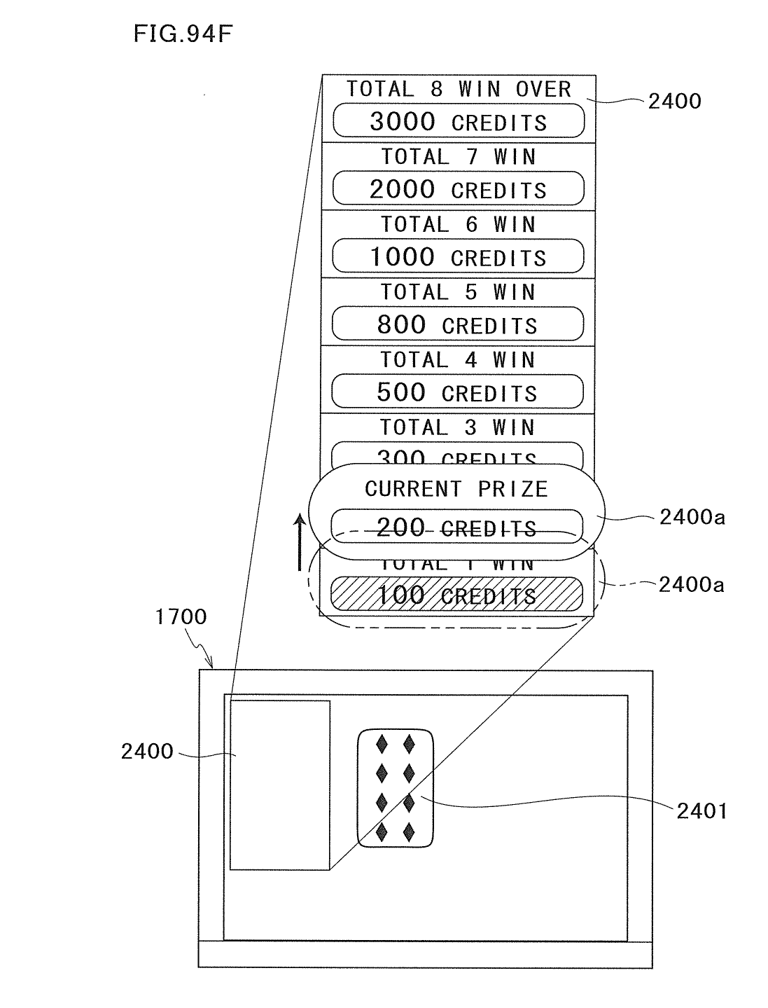

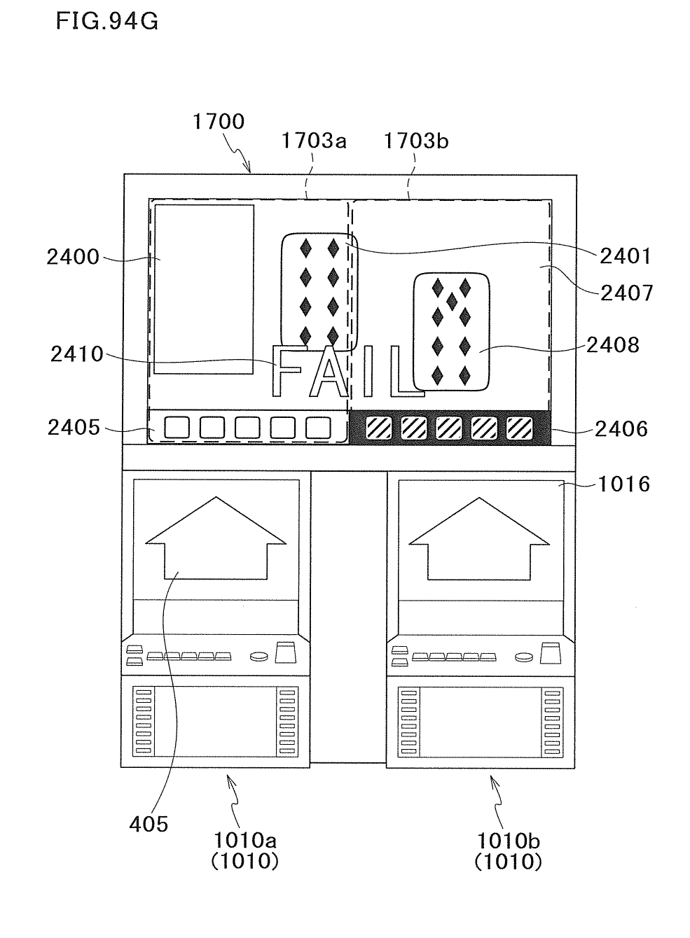

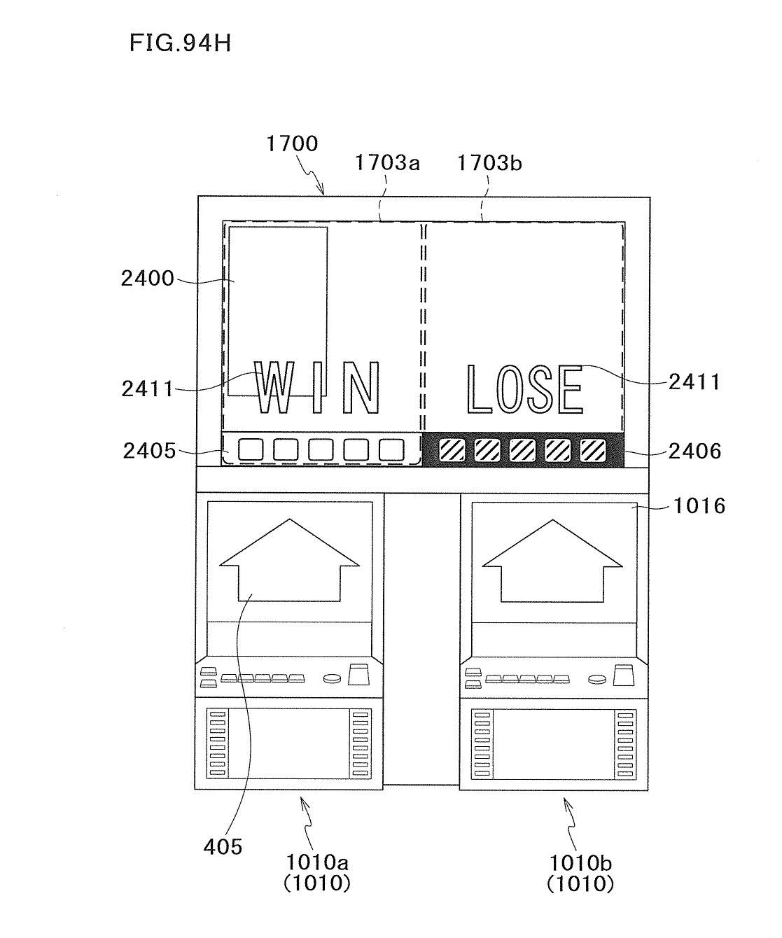

As shown in FIG. 94A, during the HIGH or LOW game, on an upper left portion of the upper display 1700, displayed is a payout table image 2400 showing the table for the number of winnings and the winning payout. In the payout table image 2400, the current number of winnings is indicated by a framed image 2400a. In this modification, the maximum number of winnings is set to 8, but the present disclosure is not limited to this. Further, the upper display 1700 displays thereon a card image 2401 showing the card owned by the dealer in an open state so that its card type can be seen.

When the HIGH or LOW game is started, provided is an effect to report the gaming terminal 1010 playing the role of the player, as shown in FIG. 94B. Specifically, the gaming terminal area 703 corresponding to the gaming terminal 1010 which is not selected as the player making the prediction is turned dark, to display thereon an arrow image 2402 or the like pointing the gaming terminal 1010 selected as the player making the prediction. In the example shown in FIG. 94B, the gaming terminal 1010b is selected as the player making the prediction. On the terminal image display panel 1016 of each gaming terminal 1010, the look-up image 405 is displayed.

Then, as shown in FIG. 94C, on the gaming terminal area 1703b, there is displayed a card image 2403 showing a card of the player making the prediction in a closed state so that the card type of the player cannot be seen. Further, on the terminal image display panel 1016 of the gaming terminal 1010b selected as the player making the prediction, there is displayed a touch button image 2404 for the player of the selected gaming terminal 1010b to input the prediction. Further, on a lower portion of the upper display 1700, there is displayed an image 2405 showing card types higher than that owned by the dealer, and an image 2406 showing card types lower than that owned by the dealer.

After the gaming terminal 1010b selected as the player making the prediction inputs the prediction, the gaming terminal area 703c displays thereon an image 2407 showing this prediction, as shown in FIG. 94D. Further, out of the images 1405 and 1406, the image indicating the card types contrary to the prediction is turned dark. In the example of FIG. 94D, because the gaming terminal 1010b acting as the player predicts that its card is higher than that owned by the dealer, the image 2406 showing card types lower than that owned by the dealer is turned dark. On the terminal image display panel 1016 of the gaming terminal 1010 on which the prediction has been completed, the look-up image 405 is displayed again.

Then, as shown in FIG. 94E, the card image 1403 is replaced to a card image 2408 showing the card of the player making the prediction in the open state so that the card type can be seen. When the prediction of the player predicting high or low is correct, an image 2409 showing that the stage is cleared is displayed on the upper display 1700. When the number of winnings of the opponent gaming terminal 1010 is smaller, the opponent gaming terminal 1010 plays the role of the player to start the prediction.

Meanwhile, when the number of winnings is even between the gaming terminals 1010, as shown in FIG. 94F, there is provided an effect of changing the payout amount indicated in the framed image 2400a is changed to the payout amount for one-rank higher number of winnings, in the payout table image 2400. Then, there is provided an effect of changing the background color of the region displaying the payout amounts at lower ranks than that of the payout amount indicated in the framed image 2400a. Then, prediction of the two gaming terminals 1010 is started again.

When the prediction of the gaming terminal playing the role of the player is wrong, an image 2410 showing the failure is displayed on the upper display 1700, as shown in FIG. 94G.

Then, as shown in FIG. 94H, an image 2411 showing whether the corresponding gaming terminal 1010 has won or not is displayed on each of gaming terminal areas 1703a and 1703b. Then, an image similar to that in FIG. 55E of the above embodiment, indicating the total credit amount obtained in the HIGH or LOW game is displayed on the terminal image display panel 1016 of the winning gaming terminal 1010 and on the gaming terminal area on the upper display 1700 corresponding to the winning gaming terminal 1010.

Now, the operation in each modification of the common game will be described, using flow charts.

(RED OR BLACK Game Process)

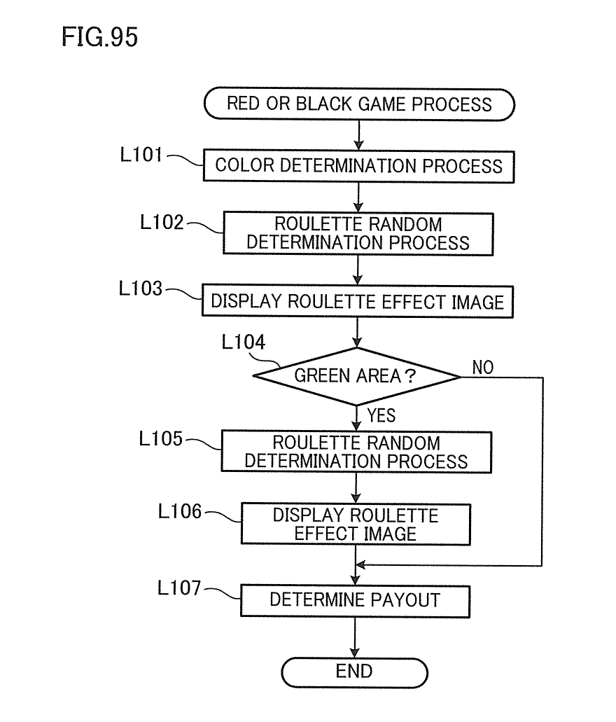

The main CPU 241 of the center controller 200 executes, a RED OR BLACK game process routine shown in FIG. 95 when executing the RED OR BLACK game.

First, the main CPU 241 executes a color determination process referring to the allocation number random determination table shown in FIG. 54 (L101). As a result, it is determined which of red and black each of the gaming terminals 1010a and 1010b is associated with.

Then, the main CPU 241 executes a roulette random determination process referring to the first roulette random determination table shown in FIG. 56 (L102). With this, on which of the areas 1001 the ball 1003 is stopped on the wheel 1002 of the roulette 2000 is determined. Then, the main CPU 241 provides a roulette effect image on the upper display 1700 (L103). In this roulette effect image, the ball 1003 is stopped on the area 1001 determined in L102.

Thereafter, the main CPU 241 determines whether the area 2000 on which the ball 1003 is stopped on the roulette 2000 is a green area 1001c (L104). When determining that the area is not the green area 1001c (L104: NO), the main CPU 241 determines the unit payout amount to be awarded to each gaming terminal 1010 of the color associated with the area 1001 on which the ball 1003 is stopped, referring to the first roulette random determination table (L107). Then, the RED OR BLACK game process ends.

Meanwhile, when determining that the area is the green area 1001c (L104: YES), the main CPU 241 executes a roulette random determination process referring to the second roulette random determination table shown in FIG. 57 (L105). Then, the main CPU 241 provides a roulette effect image on the upper display 1700 (L106). In this roulette effect image, the ball 1003 is stopped on the area 1001 determined in L105. Then, the main CPU 241 determines the unit payout amount to be awarded to each gaming terminal 1010 of the color associated with the area 1001 on which the ball 1003 is stopped, referring to the second roulette random determination table (L107). Then, the RED OR BLACK game process ends.

(ROLL THE DICE Game Process)

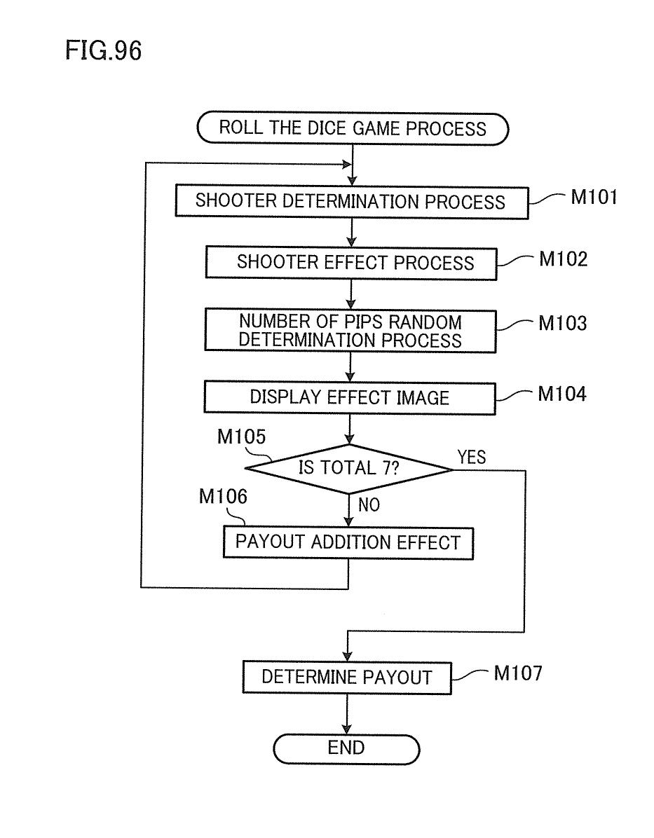

The main CPU 241 of the center controller 200 executes, a ROLL THE DICE game process routine shown in FIG. 96 when executing the ROLL THE DICE game.

First, the main CPU 241 determines which of the gaming terminals gaming terminals 1010a and 1010b plays the role of a shooter rolling the two dice (M101). The main CPU 241 alternately selects the gaming terminals gaming terminals 1010a and 1010b as the shooter. Then, the main CPU 241 provides an effect of reporting the gaming terminal 1010 selected as the shooter (see FIG. 91B) (M102). Then, upon reception of a signal indicating that the spin button 29 is pressed on the gaming terminal 1010 selected as the shooter from this gaming terminal 10, the main CPU 241 executes a number of pips random determination process referring to the number of pips random determination table shown in FIG. 60 (M103). With this, the number of pips of the two dice is determined. Then, the main CPU 241 provides a number of pips effect image 1107 showing the numbers of pips of the two dice determined in the number of pips random determination process (see FIG. 91C and FIG. 91D) is displayed on the upper display 1700 (M104).

Then, the main CPU 241 determines whether the total number of pips of the two dice determined in the number of pips random determination process is 7 (M105). When determining that the total number of pips is not 7 (M105: NO), the main CPU 241 provides an effect of adding the value obtained by multiplying the total number of pips by 30 credits to the value indicated by the payout image 2010 (see FIG. 91A) (M106). Then, the processing returns to M101.

When determining that the total number of pips is 7 in M105 (M105: YES), the main CPU 241 determines the value obtained in M106 as a unit payout amount awarded to the gaming terminal 1010 which has produced the total number of pips of 7 (M107). After the above is completed, the ROLL THE DICE game process ends.

(FUN WHEEL Game Process)

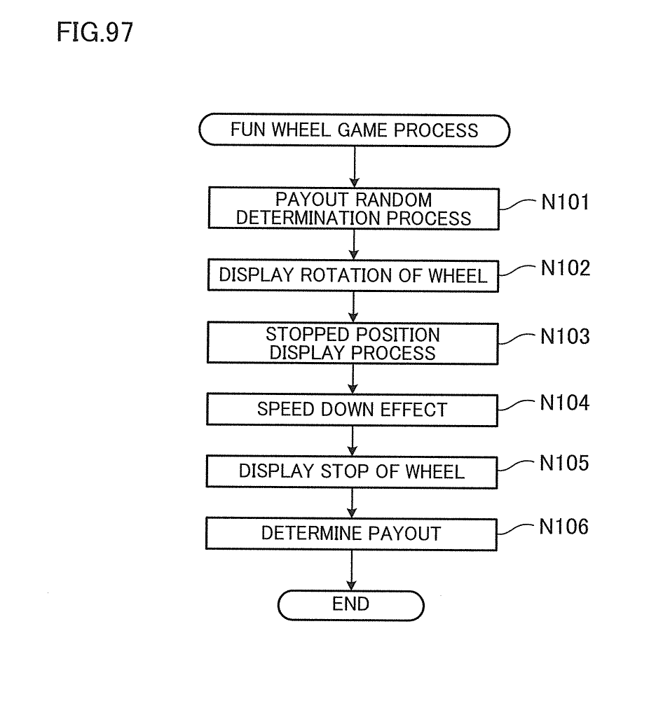

The main CPU 241 of the center controller 200 executes, a FUN WHEEL game process routine shown in FIG. 97 when executing the FUN WHEEL game.

First, the main CPU 241 executes a payout random determination process of determining the payout to be awarded to each gaming terminal 10 participating in the common game, referring to the payout random determination table shown in FIG. 62 (N101). Then, the main CPU 241 provides an effect of rotating the wheel 1202 on the upper display 1700 (N102). Then, upon reception of a signal indicating the stopped position selected by the player from each gaming terminal 1010, the main CPU 241 displays the images 2205 indicating the stopped positions on the upper displays 1700 (see FIG. 92D) (N103). Subsequently, the main CPU 241 displays an image 2207 indicating that the speed down of the rotation of the wheel 1202 is started (N104), and stops the rotation of the FUN WHEEL 1200 (N105). With this, the main CPU 241 displays images indicating fixed payouts on the areas 1201 of the FUN WHEEL 1200 on the upper display 1700. At this time, the area 1201 having the fixed payout determined as being for each gaming terminal 1010 in the payout random determination process in N101 is stopped on the stopped position selected by that gaming terminal 1010. Then, the main CPU 241 determines the payout displayed on the area 1201 stopped at the stopped position selected by the player of each gaming terminal 1010 as a unit payout amount awarded to the gaming terminal 1010 (N106). Then, the FUN WHEEL game process ends.

(LUCKY NUMBERS Game Process)

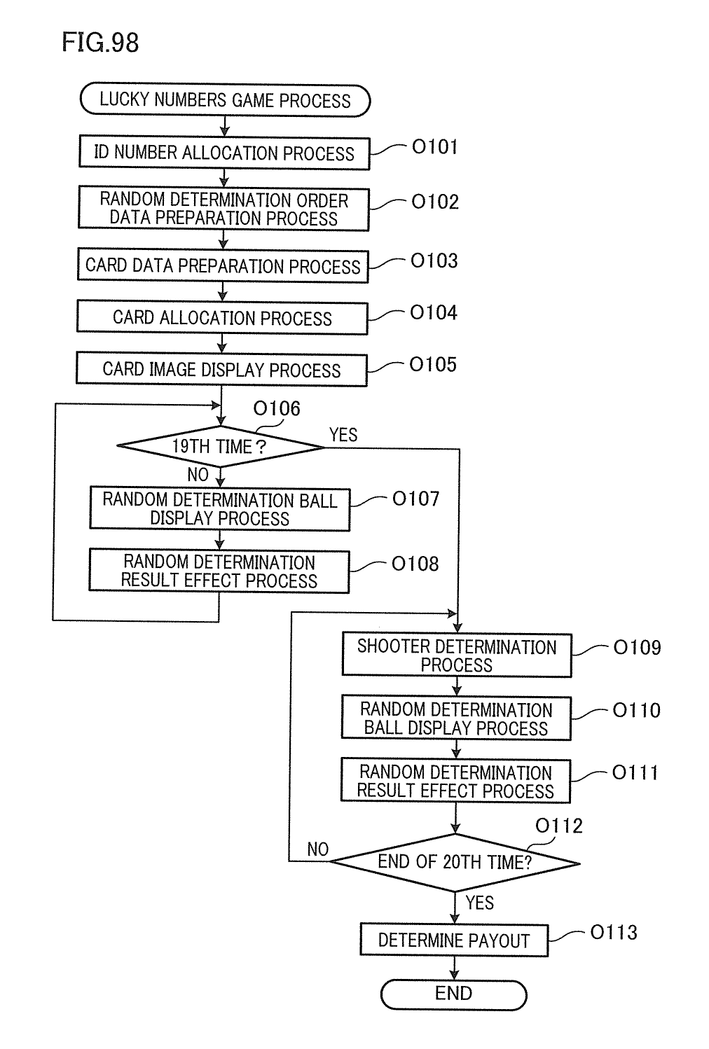

The main CPU 241 of the center controller 200 executes, a LUCKY NUMBERS game process routine shown in FIG. 98 when executing the LUCKY NUMBERS game.

First of all, the main CPU 241 executes an ID number allocation process of allocating the numbers from 1 to 75 to 75 types of ID numbers which are different from one another (O101). Then, the main CPU 241 prepares random determination order data (see FIG. 65D and FIG. 65E) based on the ID numbers allocated in the ID number allocation process (O102). Then, based on the ID numbers allocated in the ID number allocation process and on the prepared random determination order data, the main CPU 241 prepares 2 types of card data (see FIG. 65F and FIG. 65G) (O103), and randomly allocate the thus prepared card data to two gaming terminals 1010 (O104).

Then, the main CPU 241 displays bingo cards 2301 respectively showing the contents of the card data allocated in O104 on the respective gaming terminal areas 1703 of the two gaming terminals 1010 (O105). On each bingo card 2301, each square set as a free spot has been already marked.

Then, the main CPU 241 determines whether the next random determination of a number is 19th-time execution (O106). When the next random determination is not the 19th-time execution (O106: NO), the main CPU 241 displays, on the upper display 1700, an effect image making it look as if random determination of a number is performed by an automatically appearing random determination ball 2305 with illustration thereon of the number selected by random determination (O107). Then, the main CPU 241 provides REACH effect (see FIG. 93C) and the like depending on the number selected by random determination (O108). Thereafter, the processing returns to O106.

Meanwhile, when the next random determination is the 19th-time execution (O106: YES), the main CPU 241 executes a shooter determination process of determining which of the gaming terminals 1010 plays the role of the shooter (O109). In this process, either one of the gaming terminals 1010a and 1010b is determined as the shooter. When one of the gaming terminals 1010 has already determined as the shooter, the other gaming terminal 1010 is selected as the shooter. Then, the main CPU 241 displays the button image 2309 encouraging the player of the gaming terminal 1010 selected as the shooter to press the spin button 29 (see FIG. 93E) on the gaming terminal area 1703 of this gaming terminal 1010 on the upper displays 1700 (O110). Then, upon reception of a signal indicating that the spin button 29 is pressed on the gaming terminal 1010 selected as the shooter from this gaming terminal 1010, the main CPU 241 provides an effect, on the upper displays 700, of causing the random determination ball 2305 having thereon the number randomly selected to emerge (O111).

Then, the main CPU 241 determines whether the 20th-time execution of random determination of a number has been completed (O112). When the 20th-time execution of random determination has not been completed (O112: NO), the processing returns to O109. When the 20th-time execution of random determination has been completed (O112: YES), the main CPU 241 determines a unit payout amount to be awarded to each gaming terminal 1010 depending on the number of BINGOS established thereon (O113). Then, the LUCKY NUMBERS game ends.

(HIGH or LOW Game Process)

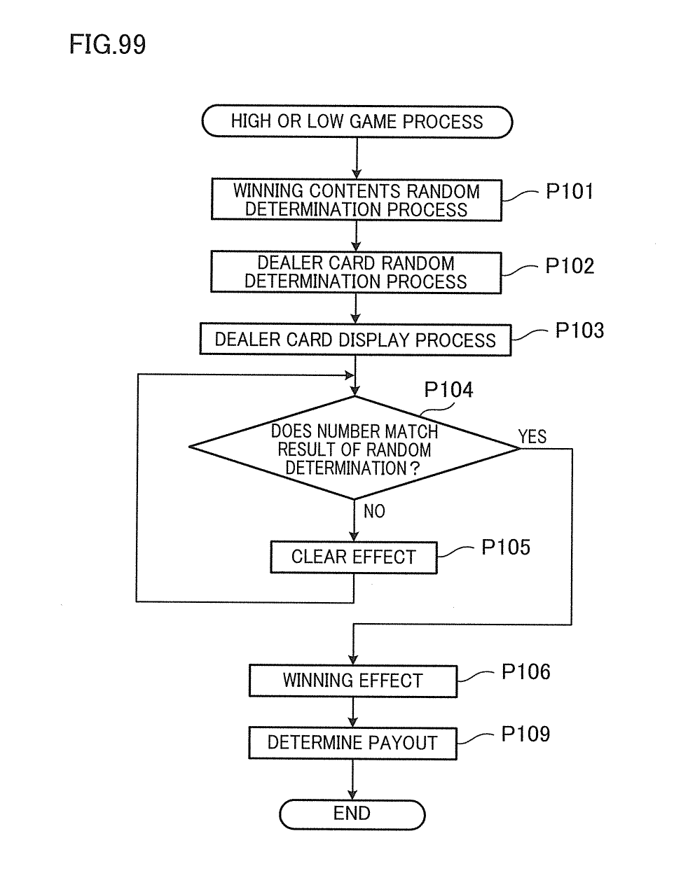

The main CPU 241 of the center controller 200 executes, a HIGH or LOW game process routine shown in FIG. 99 when executing the HIGH or LOW game.

First, the main CPU 241 executes a winning contents random determination process of determining the winning gaming terminal 1010 and the number of winnings (P101). The number of winning represents the number of stages which can be cleared by the gaming terminal acting as the player in the HIGH or LOW game. Then, the main CPU 241 determines the card type of the dealer's card, by random determination (P102). Then, the main CPU 241 displays a card image 1401 indicating the thus determined card type of the dealer's card (see FIG. 69A) on the upper display 1700 (P103).

Then, the main CPU 241 determines whether the next number of winnings matches the number of winnings determined in P101 (P104). When the numbers of winning do not match each other (P104: NO), the main CPU 241 provides a clear effect (P105) In the clear effect, upon receiving a signal indicating the prediction of the player input on the gaming terminal 1010 acting as the player, provided is an effect of displaying the card type of the gaming terminal acting as the player to each of the gaming terminals 1010 to make the prediction correct. Then, the processing returns to P104.

When the numbers of winning match each other (P104: YES), the main CPU 241 provides a winning effect (P106). In the above process, upon receiving a signal indicating the prediction of the player input on the gaming terminal 1010 acting as the player, the main CPU 241 provides the following effects: an effect of displaying the card type of the gaming terminal acting as the player to the winning gaming terminal 1010 so that the prediction is correct; and an effect of displaying the card type of the gaming terminal acting as the player to the losing gaming terminal 1010 so that the prediction is wrong.

Then, the main CPU 241 determines the unit payout amount to be awarded to each of the gaming terminals 1010 based on their respective numbers of winnings (P107). Then, the HIGH or LOW game process ends.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine configured to execute a link game on a common screen shared by a plurality of gaming terminals, the gaming machine comprising:
a terminal controller for each gaming terminal, the terminal controller configured to execute a base game on the corresponding gaming terminal, and to execute a bonus game on the common screen in accordance with a result of random determination made in the base game;
a memory configured to accumulatively store a part of a bet amount bet in each gaming terminal each time the base game is executed, as a capital source of a progressive payout;
a center controller configured to execute the link game not in sync with the base game and the bonus game executed by the terminal controller; and
a timer configured to output time information based on which the center controller makes, at predetermined time intervals, random determination about whether to execute the link game, wherein
when execution of the bonus game is triggered in accordance with the result of the random determination made in the base game, the terminal controller executes a process of awarding a special payout from the capital source of the progressive payout stored in the memory, on condition that the link game is being executed.

2. A gaming machine configured to execute a link game on a common screen shared by a plurality of gaming terminals, the gaming machine comprising:
a terminal controller for each gaming terminal, the terminal controller configured to execute a base game on the corresponding gaming terminal;
a center controller configured to execute the link game not in sync with the base game executed by the terminal controller; and
a timer configured to output time information based on which the center controller makes, at predetermined time intervals, random determination about whether to execute the link game, wherein:
the center controller executes a random determination process at predetermined time intervals based on the time information output by the timer; and when execution of the link game is triggered by a result of the random determination process, the center controller outputs a signal to cause the terminal controller to award a special payout on condition that the link game is being executed, and the terminal controller awards the special payout upon reception of the signal.

3. The gaming machine according to claim 1, wherein
the link game needs qualification time for participation, and is structured so that out of the plurality of gaming terminals only one or more gaming terminals each having the qualification time are allowed to participate in the link game, and
the center controller further comprises a counter configured to count the qualification time of each of the plurality of gaming terminals, and the center controller is configured to execute the following processes of:
awarding an amount of game qualification time to each gaming terminal each time the base game is executed on that gaming terminal, and adding the awarded amount of game qualification time to a value in the counter;
reducing the qualification time of each of the plurality of gaming terminals counted by the counter by a predetermined amount each time the random determination about whether to execute the link game is made; and
when execution of the link game is triggered as a result of the random determination whether to execute the link game, executing the link game while synchronizing the gaming terminals each having the qualification time with one another.

4. The gaming machine according to claim 3, wherein
the center controller is configured to further execute the process of awarding an amount of game qualification time to each gaming terminal when the bonus game is executed thereon, and adding the awarded amount of game qualification time to a value in the counter.

5. The gaming machine according to claim 3, wherein
the center controller reduces the qualification time counted by the counter only for one or more gaming terminals which do not participate in the link game when the random determination whether to execute the link game is made during execution of the link game.

6. The gaming machine according to claim 2, wherein:
a qualification time to participate in the link game of each of the plurality of gaming terminals is set, in association with execution of the base game, by the corresponding terminal controller or by the center controller;
whether to award the special payout in accordance with the result of the random determination process executed by the center controller is determined based on presence or absence of the qualification time; and
only the terminal controller of each gaming terminal having the qualification time awards the special payout.
